(19) United States
(12) Patent Application Publication
(10) Pub. No.: US 2025/0110320 A1
(43) Pub. Date: Apr. 3, 2025

(54) ZOOM LENS AND IMAGING APPARATUS

(71) Applicant: FUJIFILM Corporation, Tokyo (JP)

(72) Inventors: Masaru YONEZAWA, Saitama (JP); Hiroki SAITO, Saitama (JP); Yuya HIRAKAWA, Saitama (JP); Daiki KOMATSU, Saitama (JP); Kota SHIMAZAKI, Saitama (JP)

(73) Assignee: FUJIFILM Corporation, Tokyo (JP)

(21) Appl. No.: 18/886,352

(22) Filed: Sep. 16, 2024

(30) Foreign Application Priority Data
Sep. 28, 2023 (JP) 2023-168031

(51) Int. Cl. G02B 15/14; G02B 13/00; G02B 15/167

(52) U.S. Cl. CPC G02B 15/1451; G02B 13/0045; G02B 15/167

(57) ABSTRACT

A zoom lens includes: a first lens group that is disposed to be closest to an object side and that has a positive refractive power; a negative group that is disposed to be adjacent to an image side of the first lens group, that consists of two or fewer lens groups, and that has a negative refractive power as a whole; an N lens group that is disposed to be closer to the image side than the negative group and that has a negative refractive power; a P lens group that is disposed to be closer to the image side than the negative group and that has a positive refractive power; and a final lens group that is disposed to be closest to the image side. During zooming, all the spacings of adjacent lens groups change. The zoom lens satisfies predetermined conditional expressions.

### CROSS-REFERENCE TO RELATED APPLICATIONS

This application claims priority from Japanese Patent Application No. 2023-168031, filed on Sep. 28, 2023, the entire disclosure of which is incorporated herein by reference.

### BACKGROUND

### Technical Field

The technique of the present disclosure relates to a zoom lens and an imaging apparatus.

### Related Art

In the related art, a zoom lens that can be used in an imaging apparatus such as a motion picture camera is known as described in JP2016-004076A.

### SUMMARY

There is a demand for a zoom lens that is configured with a large image circle, a wide angle, and a small size and that has favorable optical performance. The demand level is increasing year by year.

The present disclosure provides a zoom lens that is configured with a large image circle, a wide angle of view, and a small size and that has favorable optical performance, and an imaging apparatus comprising the zoom lens.

According to a first aspect of the present disclosure, there is provided a zoom lens comprising: a first lens group that is disposed to be closest to an object side and that has a positive refractive power; a negative group that is disposed to be adjacent to an image side of the first lens group, that consists of two or fewer lens groups, and that has a negative refractive power as a whole; an N lens group that is disposed to be closer to the image side than the negative group and that has a negative refractive power; a P lens group that is disposed to be closer to the image side than the negative group and that has a positive refractive power; and a final lens group that is disposed to be closest to the image side, in which during zooming, all spacings between adjacent lens groups change. The zoom lens satisfies Conditional Expression (1).

$$- 6 < fN / f 1 < - 0.55 \qquad ( 1 )$$

Here, it is assumed that a focal length of the N lens group is fN and a focal length of the first lens group is f1.

According to a second aspect of the present disclosure, in the zoom lens of the first aspect, the first lens group remains stationary with respect to an image plane during zooming.

According to a third aspect of the present disclosure, in the zoom lens of the first aspect, the final lens group remains stationary with respect to an image plane during zooming.

According to a fourth aspect of the present disclosure, in the zoom lens of the first aspect, the P lens group is disposed to be adjacent to the image side of the N lens group, and the final lens group is disposed to be adjacent to the image side of the P lens group.

According to a fifth aspect of the present disclosure, in the zoom lens of the first aspect, during focusing, a part of the first lens group moves along an optical axis.

According to a sixth aspect of the present disclosure, in the zoom lens of the fifth aspect, the first lens group includes, successively in order from a position closest to the object side to the image side, at least a first a-part group, a first b-part group, and a first c-part group, and during focusing, a spacing between the first a-part group and the first b-part group changes, and a spacing between the first b-part group and the first c-part group changes.

According to a seventh aspect of the present disclosure, in the zoom lens of the fifth aspect, the first lens group consists of, in order from the object side to the image side, a first a-part group, a first b-part group, and a first c-part group, and during focusing, the first a-part group remains stationary with respect to an image plane, and the first b-part group and the first c-part group move on tracks different from each other.

According to an eighth aspect of the present disclosure, in the zoom lens of the first aspect, assuming that a distance on an optical axis from a lens surface closest to the object side in the first lens group to a paraxial entrance pupil position in a state where an infinite distance object is in focus at a wide angle end is Denw, and a focal length of the zoom lens in a state where the infinite distance object is in focus at the wide angle end is fw, Conditional Expression (2) is satisfied, which is represented by

$$1.2 < Denw / fw < 8. \qquad ( 2 )$$

According to a ninth aspect of the present disclosure, in the zoom lens of the first aspect, assuming that a focal length of the negative group is fUN, and a focal length of the N lens group is fN, Conditional Expression (3) is satisfied, which is represented by

$$0.118 < fUN / fN < 0 \text{.25} . \qquad ( 3 )$$

According to a tenth aspect of the present disclosure, in the zoom lens of the first aspect, during zooming from a wide angle end to a telephoto end, the N lens group moves along a locus convex toward the object side.

According to an eleventh aspect of the present disclosure, in the zoom lens of the first aspect, a lens closest to the object side in the zoom lens is a negative lens, and a lens which is second from the object side in the zoom lens is a positive lens.

According to a twelfth aspect of the present disclosure, in the zoom lens of the first aspect, the first lens group includes one negative lens and four or more positive lenses.

According to a thirteenth aspect of the present disclosure, in the zoom lens of the first aspect, the first lens group includes, successively in order from a position closest to the object side to the image side, a negative lens, a positive lens, and a positive lens.

According to a fourteenth aspect of the present disclosure, in the zoom lens of the first aspect, in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing, an EX group that changes a focal length of the zoom lens by being inserted in an optical path of the longest air spacing while keeping an imaging position constant is disposed to be insertable and extractable.

According to a fifteenth aspect of the present disclosure, in the zoom lens of the fourteenth aspect, a maximum image height changes as the EX group is inserted or extracted.

According to a sixteenth aspect of the present disclosure, in the zoom lens of the fifth aspect, the first lens group includes, successively in order from a position closest to the object side to the image side, at least a first a-part group and a first b-part group, a spacing between the first a-part group and the first b-part group changes during focusing. Assuming that a focal length of the first a-part group is f1a, Conditional Expression (4) is satisfied, which is represented by

$$- 0.85 < f 1 / f 1 a < 0 \text{.15} . \qquad ( 4 )$$

According to a seventeenth aspect of the present disclosure, in the zoom lens of the first aspect, assuming that a focal length of the negative group is fUN, Conditional Expression (5) is satisfied, which is represented by

$$- 0.4 < fUN / f 1 < - 0 \text{.09} . \qquad ( 5 )$$

According to an eighteenth aspect of the present disclosure, in the zoom lens of the first aspect, assuming that a distance on an optical axis from a lens surface closest to the object side in the first lens group to a paraxial entrance pupil position in a state where an infinite distance object is in focus at a wide angle end is Denw, Conditional Expression (6) is satisfied, which is represented by

$$0.4 < Denw / f 1 < 1.6 . \qquad ( 6 )$$

According to a nineteenth aspect of the present disclosure, in the zoom lens of the first aspect, assuming that a distance on an optical axis from a lens surface closest to the object side in the first lens group to a paraxial entrance pupil position in a state where an infinite distance object is in focus at a wide angle end is Denw, and a maximum image height in a state where the infinite distance object is in focus at the wide angle end is IHw, Conditional Expression (7) is satisfied, which is represented by

$$3.4 < Denw / IHw < 7.5 . \qquad ( 7 )$$

According to a twentieth aspect of the present disclosure, in the zoom lens of the first aspect, assuming that an amount of displacement of the N lens group in an optical axis direction during zooming from a wide angle end to a telephoto end is MovN, a focal length of the zoom lens in a state where an infinite distance object is in focus at the telephoto end is ft, a focal length of the zoom lens in a state where the infinite distance object is in focus at the wide angle end is fw, and a sign of the amount of displacement is negative in a case where the N lens group moves toward the object side and is positive in a case where the N lens group moves toward the image side, Conditional Expression (8) is satisfied, which is represented by

$$- 0.4 < MovN / ( f 1 / log ( f t / fw ) ) < 0.1 . \qquad ( 8 )$$

According to a twenty-first aspect of the present disclosure, in the zoom lens of the first aspect, assuming that a back focal length at an air-equivalent distance in a state where an infinite distance object is in focus at a wide angle end is Bfw, and a maximum image height in a state where the infinite distance object is in focus at the wide angle end is IHw, Conditional Expression (9) is satisfied, which is represented by

$$1.9 < Bfw / IHw < 6. \qquad ( 9 )$$

According to a twenty-second aspect of the present disclosure, in the zoom lens of the sixth aspect, the first a-part group includes an aspherical lens having at least one surface of which an absolute value of a curvature radius at a position of a maximum effective diameter is greater than an absolute value of a paraxial curvature radius.

According to a twenty-third aspect of the present disclosure, in the zoom lens of the sixth aspect, the first c-part group includes an aspherical lens having at least one surface of which an absolute value of a curvature radius at a position of a maximum effective diameter is greater than an absolute value of a paraxial curvature radius.

According to a twenty-fourth aspect of the present disclosure, in the zoom lens of the first aspect, the negative group includes an aspherical lens having at least one surface of which an absolute value of a curvature radius at a position of a maximum effective diameter is less than an absolute value of a paraxial curvature radius.

According to a twenty-fifth aspect of the present disclosure, in the zoom lens of the first aspect, the P lens group includes an aspherical lens having at least one surface of which an absolute value of a curvature radius at a position of a maximum effective diameter is greater than an absolute value of a paraxial curvature radius.

According to a twenty-sixth aspect of the present disclosure, in the zoom lens of the first aspect, in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing, assuming that a Petzval sum from a lens surface closest to the object side in the first lens group to an object side surface constituting the longest air spacing is PF, and a maximum image height in a state where the infinite distance object is in focus at the wide angle end is IHw, Conditional Expression (10) is satisfied, which is represented by

$$0.12 < PF \times I H w < 0 \text{.25} . \qquad ( 10 )$$

According to a twenty-seventh aspect of the present disclosure, there is provided an imaging apparatus comprising the zoom lens according to any one of the first to twenty-sixth aspects.

In the present specification, it should be noted that the terms “consisting of” and “consists of” mean that the lens may include not only the above-mentioned components but also lenses substantially having no refractive powers, optical elements, which are not lenses, such as a stop, a filter, and a cover glass, and mechanism parts such as a lens flange, a lens barrel, an imaging element, and a camera shaking correction mechanism.

The term “group that has a positive refractive power” in the present specification means that the group has a positive refractive power as a whole. Similarly, the term “group that has a negative refractive power” means that the group has a negative refractive power as a whole. The terms “first lens group”, “lens group”, “N lens group”, “P lens group”, “final lens group”, and “focusing group” in the present specification are not limited to a configuration consisting of a plurality of lenses, and may be a configuration consisting of only a single lens.

A compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The curvature radius, the sign of the refractive power, and the surface shape of the lens including the aspherical surface will be used in terms of the paraxial region unless otherwise specified. The sign of the curvature radius of the convex surface facing toward the object side is positive, and the sign of the curvature radius of the convex surface facing toward the image side is negative.

The term “back focal length in terms of an air-equivalent distance” is an air-equivalent distance on the optical axis from the lens surface closest to the image side in the zoom lens to the image plane. The term “focal length” used in a conditional expression means a paraxial focal length. Unless otherwise specified, the term “distance on the optical axis” used in Conditional Expression means a geometrical distance. The values used in the conditional expressions are values in a case where the d line is used as a reference in a state where the infinite distance object is in focus unless otherwise specified.

According to the present disclosure, it is possible to provide a zoom lens that is configured with a large image circle, a wide angle of view, and a small size and that has favorable optical performance, and an imaging apparatus comprising the zoom lens.

### BRIEF DESCRIPTION OF THE DRAWINGS

FIG. 1 is a cross-sectional view showing a configuration of a zoom lens according to an embodiment and a diagram showing movement loci thereof, the zoom lens corresponding to a zoom lens according to Example 1.

FIG. 2 is a cross-sectional view of a configuration of the zoom lens of FIG. 1 and a diagram for explaining symbols of conditional expressions.

FIG. 3 is a diagram for describing positions of an effective diameter and a maximum effective diameter.

FIG. 4 is a diagram showing insertion and extraction of an EX group in the zoom lens of FIG. 1 and is a diagram for explaining symbols of conditional expressions.

FIG. 5 is a cross-sectional view of a configuration of a zoom lens according to Example 1-1.

FIG. 6 is a diagram of aberrations in the zoom lens according to Example 1.

FIG. 7 is a diagram of aberrations of the zoom lens according to Example 1-1.

FIG. 8 is a cross-sectional view of a configuration of a zoom lens according to Example 2 and a diagram showing movement loci thereof.

FIG. 9 is a diagram of aberrations of the zoom lens according to Example 2.

FIG. 10 is a cross-sectional view of a configuration of a zoom lens according to Example 3 and a diagram showing movement loci thereof.

FIG. 11 is a diagram of aberrations of the zoom lens according to Example 3.

FIG. 12 is a cross-sectional view of a configuration of a zoom lens according to Example 4 and a diagram showing movement loci thereof.

FIG. 13 is a diagram of aberrations of the zoom lens according to Example 4.

FIG. 14 is a cross-sectional view of a configuration of a zoom lens according to Example 5 and a diagram showing movement loci thereof.

FIG. 15 is a diagram of aberrations of the zoom lens according to Example 5.

FIG. 16 is a cross-sectional view of a configuration of a zoom lens according to Example 6 and a diagram showing movement loci thereof.

FIG. 17 is a diagram of aberrations of the zoom lens according to Example 6.

FIG. 18 is a cross-sectional view of a configuration of a zoom lens according to Example 7 and a diagram showing movement loci thereof.

FIG. 19 is a diagram of aberrations of the zoom lens according to Example 7.

FIG. 20 is a cross-sectional view of a configuration of a zoom lens according to Example 8 and a diagram showing movement loci thereof.

FIG. 21 is a diagram of aberrations of the zoom lens according to Example 8.

FIG. 22 is a cross-sectional view of a configuration of a zoom lens according to Example 9 and a diagram showing movement loci thereof.

FIG. 23 is a diagram of aberrations of the zoom lens according to Example 9.

FIG. 24 is a cross-sectional view of a configuration of a zoom lens according to Example 10 and a diagram showing movement loci thereof.

FIG. 25 is a diagram of aberrations of the zoom lens according to Example 10.

FIG. 26 is a cross-sectional view of a configuration of a zoom lens according to Example 11 and a diagram showing movement loci thereof.

FIG. 27 is a diagram of aberrations of the zoom lens according to Example 11.

FIG. 28 is a cross-sectional view of a configuration of a zoom lens according to Example 12 and a diagram showing movement loci thereof.

FIG. 29 is a diagram of aberrations of the zoom lens according to Example 12.

FIG. 30 is a cross-sectional view of a configuration of a zoom lens according to Example 13 and a diagram showing movement loci thereof.

FIG. 31 is a diagram of aberrations of the zoom lens according to Example 13.

FIG. 32 is a cross-sectional view of a configuration of a zoom lens according to Example 13-1.

FIG. 33 is a diagram showing aberration diagrams of the zoom lens according to Example 13-1.

FIG. 34 is a cross-sectional view of a configuration of a zoom lens according to Example 14 and a diagram showing movement loci thereof.

FIG. 35 is a diagram of aberrations of the zoom lens according to Example 14.

FIG. 36 is a cross-sectional view of a configuration of a zoom lens according to Example 14-1.

FIG. 37 is a diagram of aberrations of the zoom lens according to Example 14-1.

FIG. 38 is a cross-sectional view of a configuration of a zoom lens according to Example 15 and a diagram showing movement loci thereof.

FIG. 39 is a diagram of aberrations of the zoom lens according to Example 15.

FIG. 40 is a cross-sectional view of a configuration of a zoom lens according to Example 15-1.

FIG. 41 is a diagram of aberrations of the zoom lens according to Example 15-1.

FIG. 42 is a cross-sectional view of a configuration of a zoom lens according to Example 16 and a diagram showing movement loci thereof.

FIG. 43 is a diagram of aberrations of the zoom lens according to Example 16.

FIG. 44 is a cross-sectional view of a configuration of a zoom lens according to Example 16-1.

FIG. 45 is a diagram of aberrations of the zoom lens according to Example 16-1.

FIG. 46 is a cross-sectional view of a configuration of a zoom lens according to Example 17 and a diagram showing movement loci thereof.

FIG. 47 is a diagram of aberrations of the zoom lens according to Example 17.

FIG. 48 is a cross-sectional view of a configuration of a zoom lens according to Example 18 and a diagram showing movement loci thereof.

FIG. 49 is a diagram of aberrations of the zoom lens according to Example 18.

FIG. 50 is a cross-sectional view of a configuration of a zoom lens according to Example 19 and a diagram showing movement loci thereof.

FIG. 51 is a diagram of aberrations of the zoom lens according to Example 19.

FIG. 52 is a cross-sectional view of a configuration of a zoom lens according to Example 19-1.

FIG. 53 is a diagram of aberrations of the zoom lens according to Example 19-1.

FIG. 54 is a schematic configuration diagram of an imaging apparatus according to an embodiment.

### DESCRIPTION OF EMBODIMENTS

Hereinafter, embodiments of the present disclosure will be described with reference to the accompanying drawings.

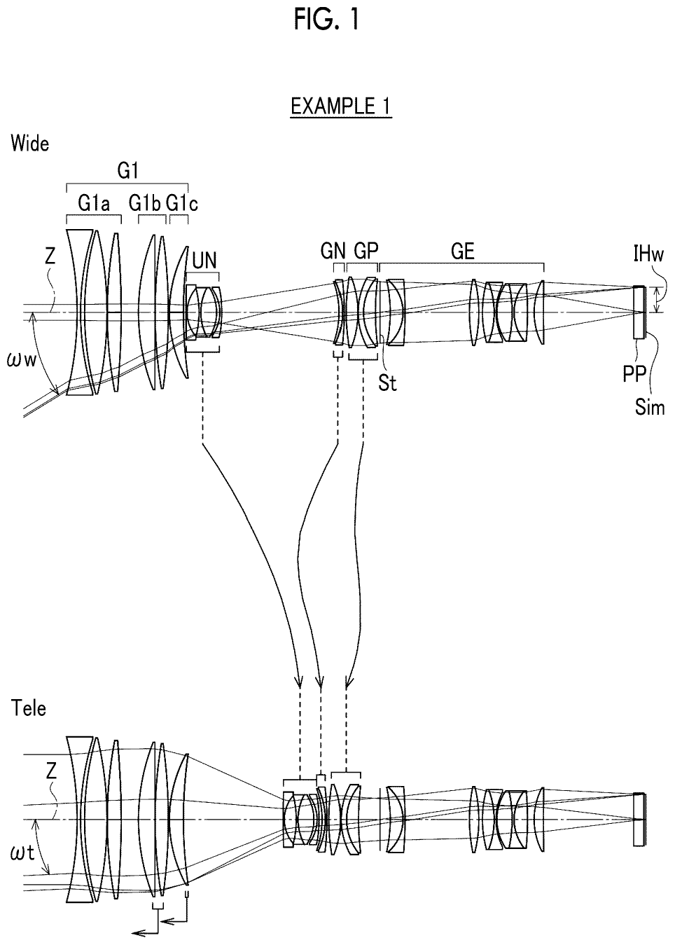

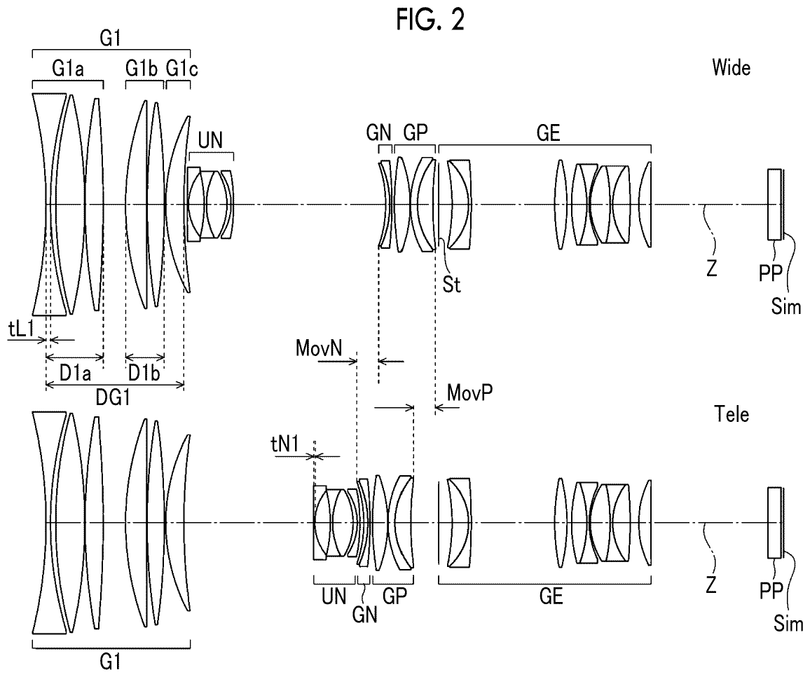

FIG. 1 shows a cross-sectional view of a configuration of a zoom lens according to an embodiment of the present disclosure and luminous flux, and movement loci thereof. FIG. 2 shows a cross-sectional view of a configuration of the zoom lens of FIG. 1. FIGS. 1 and 2 show situations where an infinite distance object is in focus, the left side thereof is an object side, and the right side thereof is an image side. In FIGS. 1 and 2, the upper part labeled “Wide” shows a wide angle end state, and the lower part labeled “Tele” shows a telephoto end state. In FIG. 1, the luminous flux indicates the on-axis luminous flux and the luminous flux of the maximum half angle of view ow at the wide angle end, and the on-axis luminous flux and the luminous flux of the maximum half angle of view ωt at the telephoto end. Examples shown in FIGS. 1 and 2 correspond to a zoom lens according to Example 1 to be described later. Hereinafter, description will be given mainly with reference to FIG. 1 and will be given with reference to FIG. 2 as necessary.

FIG. 1 shows an example in which, assuming that a zoom lens is applied to an imaging apparatus, an optical member PP having a parallel plate shape is disposed between the zoom lens and an image plane Sim. The optical member PP is a member assumed to include various filters, a cover glass, and/or the like. The various filters include a low pass filter, an infrared cut filter, and/or a filter that cuts a specific wavelength region. The optical member PP is a member that has no refractive power. It is also possible to configure the imaging apparatus by removing the optical member PP.

The zoom lens according to the present disclosure comprises a first lens group G1 that is disposed to be closest to the object side and that has a positive refractive power, a negative group UN that is disposed to be adjacent to the image side of the first lens group G1 and that has a negative refractive power as a whole, an N lens group GN that has a negative refractive power and that is disposed to be closer to the image side than the negative group UN, a P lens group GP that is disposed to be closer to the image side than the negative group UN and that has a positive refractive power, and a final lens group GE that is disposed to be closest to the image side. The negative group UN consists of two or fewer lens groups. During zooming, all the spacings of adjacent lens groups change. With the above configuration, there is an advantage in obtaining a wide image circle while maintaining the zoom ratio and achieving reduction in size while ensuring a wide angle of view.

In the present specification, a group, in which a spacing between the group and an adjacent group thereof changes in the optical axis direction during zooming, is set as one lens group. During zooming, spacing between adjacent lenses does not change inside one lens group. In the present specification, each “lens group” included in the “first lens group G1”, the “N lens group GN”, a “P lens group GP”, the “final lens group GE”, and the negative group UN is a constituent part of the zoom lens, and is a part that is separated by an air spacing that changes during zooming and that includes at least one lens. During zooming, each lens group as a unit moves or remains stationary, and the mutual spacing between the lenses in each lens group does not change. It should be noted that the “lens group” may include a constituent element other than a lens having no refractive power such as the aperture stop St.

For example, the zoom lens shown in FIG. 1 consists of, in order from the object side to the image side, a first lens group G1, a negative group UN consisting of one lens group, the N lens group GN, the P lens group GP, and the final lens group GE.

In the example of FIG. 1, each group is configured as follows. The first lens group G1 consists of, in order from the object side to the image side, a negative lens, a positive lens, a positive lens, a positive lens, a positive lens, and a positive lens. The negative group UN consists of, in order from the object side to the image side, a negative lens, a negative lens, a positive lens, and a negative lens. The N lens group GN consists of, in order from the object side to the image side, a positive lens and a negative lens. The P lens group GP consists of, in order from the object side to the image side, a positive lens, a negative lens, and a positive lens. The final lens group GE consists of, in order from the object side to the image side, an aperture stop St, a positive lens, a negative lens, a positive lens, a positive lens, a negative lens, a positive lens, a negative lens, a positive lens, and a positive lens. The aperture stop St in FIG. 1 does not indicate the shape or the size thereof, but indicates the position thereof in the optical axis direction.

In the example of FIG. 1, during zooming, the first lens group G1 and the final lens group GE remain stationary with respect to the image plane Sim, and the negative group UN, the N lens group GN, and the P lens group GP move along an optical axis Z by changing the spacings between adjacent lens groups. In FIG. 1, the arrows of the solid lines indicate schematic movement loci of the lens groups that move during zooming from the wide angle end to the telephoto end between the upper part and the lower part.

In the zoom lens according to the present disclosure, it is preferable that the first lens group G1 remains stationary with respect to the image plane Sim during zooming. In such a case, it is possible to suppress movement of the centroid during zooming.

Further, it is preferable that the final lens group GE remains stationary with respect to the image plane Sim during zooming. In such a case, it is easy to suppress fluctuation in F number during zooming.

It is preferable that the N lens group GN moves along a locus convex toward the object side during zooming from the wide angle end to the telephoto end. In such a case, there is an advantage in suppressing aberrations in an intermediate focal length state. For example, the arrow of the solid line indicating the movement locus of the N lens group GN in FIG. 1 is a curve that is convex toward the object side.

In the zoom lens according to the present disclosure, it is preferable that a lens closest to the object side in the zoom lens is a negative lens. In such a case, there is an advantage in suppressing lateral chromatic aberration. Further, it is preferable that a lens which is second from the object side in the zoom lens is a positive lens. In such a case, there is an advantage in suppressing longitudinal chromatic aberration.

It is preferable that the first lens group G1 includes, successively in order from the position closest to the object side to the image side, a negative lens, a positive lens, and a positive lens. In such a case, there is an advantage in suppressing longitudinal chromatic aberration and lateral chromatic aberration.

It is preferable that the first lens group G1 includes one negative lens and four or more positive lenses. In such a case, there is an advantage in suppressing chromatic aberration at the telephoto end.

It is preferable that the negative group UN includes an aspherical lens having at least one surface of which an absolute value of a curvature radius at a position of a maximum effective diameter is less than an absolute value of a paraxial curvature radius. In such a case, the configuration is advantageous for suppressing astigmatism.

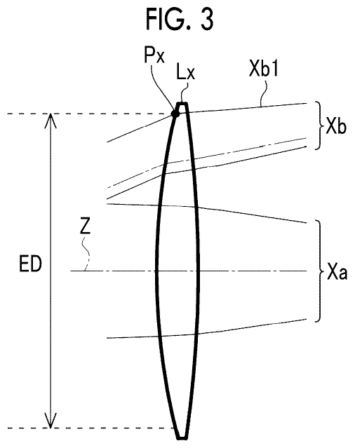

FIG. 3 shows an example of the position at the maximum effective diameter, as an explanatory diagram. In FIG. 3, the left side is the object side, and the right side is the image side. FIG. 3 shows an on-axis luminous flux Xa and an off-axis luminous flux Xb passing through the lens Lx. In the example of FIG. 3, a ray Xb1, which is the upper ray of the off-axis luminous flux Xb, is the ray passing through the outermost side. In the present specification, a distance to the optical axis Z from an intersection between the lens surface and the ray passing through the outermost side among rays incident onto the lens surface from the object side and emitted to the image side is defined as an “effective radius” of the lens surface. Twice the effective radius is defined as an “effective diameter”. The “outer side” here is the radial outside centered on the optical axis Z, that is, the side separated from the optical axis Z. In the example of FIG. 3, twice the distance to the optical axis Z from the intersection between the ray Xb1 and the object side surface of the lens Lx is the effective diameter ED of the object side surface of the lens Lx. It should be noted that a position Px of the intersection of the lens surface and the ray passing through the outermost side is defined as a position of the maximum effective diameter. In the example of FIG. 3, the upper ray of the off-axis luminous flux Xb is the ray passing through the outermost side, but which ray is the ray passing through the outermost side depends on the optical system. Further, the ray passing through the outermost side is determined in consideration of the entire zoom range.

In the zoom lens according to the present disclosure, it is preferable that the N lens group GN include a positive lens and a negative lens, successively in order from the position closest to the object side to the image side. In such a case, there is an advantage in suppressing fluctuation in longitudinal chromatic aberration during zooming.

It is preferable that the P lens group GP is disposed to be adjacent to the image side of the N lens group GN. In such a case, there is an advantage in achieving an increase in angle of view thereof.

A lens surface closest to the image side in the P lens group GP may be configured to be a concave surface. In such a case, there is an advantage in suppressing fluctuation in spherical aberration during zooming.

It is preferable that the P lens group GP includes an aspherical lens having at least one surface of which an absolute value of a curvature radius at a position of the maximum effective diameter is greater than an absolute value of a paraxial curvature radius. In such a case, there is an advantage in suppressing fluctuation in spherical aberration during zooming.

It is preferable that the final lens group GE is disposed to be adjacent to the image side of the P lens group GP. In such a case, there is an advantage in achieving reduction in size thereof.

A lens closest to the image side in the final lens group GE may be configured to be a single lens that has a positive refractive power. In such a case, it is possible to obtain a lens system in which the F number is smaller. In the present specification, the term “single lens” means one lens that is not cemented.

During focusing, a part of the first lens group G1 may be configured to move along the optical axis Z. That is, a configuration may be made in which focusing is performed by moving a part of the first lens group G1 along the optical axis Z. In such a case, it is possible to suppress fluctuation in the focusing position caused by zooming in a case where the finite distance object is imaged. Hereinafter, the group that moves along the optical axis Z during focusing is referred to as the focusing group. Focusing is performed by moving the focusing group.

The first lens group G1 may be configured to include, successively in order from the position closest to the object side to the image side, at least a first a-part group G1a, a first b-part group G1b, and a first c-part group G1c. In the configuration, during focusing, a spacing between the first a-part group G1a and the first b-part group G1b is changed, and a spacing between the first b-part group G1b and the first c-part group G1c is changed. In such a case, there is an advantage in suppressing fluctuation in aberrations during focusing.

In a case where the first lens group G1 includes at least the first a-part group G1a, the first b-part group G1b, and the first c-part group G1c, it is preferable that the first a-part group G1a includes an aspherical lens having at least one surface of which an absolute value of a curvature radius at a position of the maximum effective diameter is greater than an absolute value of a paraxial curvature radius. In such a case, there is an advantage in suppressing spherical aberration at the telephoto end.

In a case where the first lens group G1 includes at least the first a-part group G1a, the first b-part group G1b, and the first c-part group G1c, it is preferable that the first c-part group G1c includes an aspherical lens having at least one surface of which an absolute value of a curvature radius at a position of a maximum effective diameter is greater than an absolute value of a paraxial curvature radius. In such a case, there is an advantage in suppressing fluctuation in spherical aberration during focusing.

The first lens group G1 consists of the first a-part group G1a, the first b-part group G1b, and the first c-part group G1c, in order from the object side to the image side. During focusing, the first a-part group G1a remains stationary with respect to the image plane Sim, and the first b-part group G1b and the first c-part group G1c may be configured to move along loci different from each other. By adopting a configuration in which the first lens group G1 consists of three part groups having different spacings which change during focusing, there is an advantage in suppressing fluctuation in aberrations during focusing while simplifying the driving mechanism. Further, during focusing, the first b-part group G1b and the first c-part group G1c move along loci different from each other. Therefore, there is an advantage in suppressing fluctuation in aberrations during focusing. It should be noted that the expression “the first b-part group G1b and the first c-part group G1c move along loci different from each other” is the same as “the first b-part group G1b and the first c-part group G1c move by changing the mutual spacing therebetween”.

In a case where the first lens group G1 consists of the first a-part group G1a, the first b-part group G1b, and the first c-part group G1c, the first b-part group G1b in a state where the infinite distance object is in focus may be configured to be positioned on the object side as compared with the first b-part group G1b in a state where the closest range object is in focus. In such a case, it is possible to perform focusing on a closer range object.

Alternatively, in a case where the first lens group G1 consists of the first a-part group G1a, the first b-part group G1b, and the first c-part group G1c, the first b-part group G1b in a state where the infinite distance object is in focus may be configured to be positioned to be closer to the image side than the first b-part group G1b in a state where the closest range object is in focus. In such a case, there is an advantage in suppressing fluctuation in angle of view during focusing.

For example, in the first lens group G1 of the example in FIG. 1, the first lens group G1 consists of, in order from the object side to the image side, a first a-part group G1a, a first b-part group G1b, and a first c-part group G1c. During focusing from the infinite distance object to the closest range object, the first part group G1a remains stationary with respect to the image plane Sim, and the first b-part group G1b and the first c-part group G1c move toward the object side along different loci. That is, the zoom lens of the example shown in FIG. 1 includes two focusing groups of the first b-part group G1b and the first c-part group G1c, and the two focusing groups move to the object side by changing the mutual spacing therebetween during focusing. In FIG. 1, an arrow indicating the direction in which the focusing group moves during focusing from the infinite distance object to the closest range object is noted under each focusing group in the lower part of the drawing. It should be noted that each focusing group functions throughout the entire zoom range including the wide angle end state, but in FIG. 1, the arrows are noted only in the lower part of the drawing in order to avoid complication of the drawing.

In the zoom lens according to the present disclosure, as shown in the examples described later, the first lens group G1 may be configured to consist of, in order from the object side to the image side, a first a-part group G1a, a first b-part group G1b, a first c-part group G1c, and a first d-part group Gld. The first lens group G1 may be configured to change the spacings between the first a-part group G1a and the first b-part group G1b, the spacings between the first b-part group G1b and the first c-part group G1c, and the spacings between the first c-part group G1c and the first d-part group G1d, during focusing. In such a case, there is an advantage in suppressing fluctuation in aberrations during focusing.

In a case where the first lens group G1 consists of the first a-part group G1a, the first b-part group G1b, the first c-part group G1c, and the first d-part group G1d, the first a-part group G1a and the first c-part group G1c may be configured to remain stationary with respect to the image plane Sim, and the first b-part group G1b and the first d-part group G1d may be configured to move along loci different from each other during focusing. In such a case, there is an advantage in suppressing fluctuation in aberrations during focusing while simplifying the driving mechanism.

Alternatively, in a case where the first lens group G1 consists of the first a-part group G1a, the first b-part group G1b, the first c-part group G1c, and the first d-part group G1d, during focusing, the first a-part group G1a may be configured to remain stationary with respect to the image plane Sim, and the first b-part group G1b, the first c-part group G1c, and the first d-part group G1d may be configured to move along loci different from each other. In such a case, there is an advantage in suppressing fluctuation in aberrations during focusing.

In a case where the first lens group G1 consists of the first a-part group G1a, the first b-part group G1b, the first c-part group G1c, and the first d-part group G1d, the first b-part group G1b in a state where the infinite distance object is in focus may be configured to be positioned to be closer to the image side than the first b-part group G1b in a state where the closest range object is in focus. In such a case, there is an advantage in suppressing fluctuation in angle of view during focusing.

Next, preferable and possible configurations about the conditional expressions of the zoom lens according to the present disclosure will be described. In the following description of conditional expressions, in order to avoid redundant descriptions, the same symbols are used for those having the same definition, and some duplicate descriptions of the symbols will not be repeated. Further, in the following description, the term “zoom lens according to the embodiment of the present disclosure” is also simply referred to as a “zoom lens” in order to avoid redundant description.

Assuming that a focal length of the N lens group GN is fN and a focal length of the first lens group G1 is f1, it is preferable that the zoom lens satisfies Conditional Expression (1). By not allowing the corresponding value of Conditional Expression (1) to be equal to or less than the lower limit value thereof, it is possible to suppress a refractive power of the first lens group G1. Therefore, there is an advantage in suppressing fluctuation in aberrations during zooming. By not allowing the corresponding value of Conditional Expression (1) to be equal to or greater than the upper limit value thereof, it is possible to suppress the refractive power of the N lens group GN. Therefore, there is an advantage in suppressing fluctuation in aberrations during zooming.

$$- 6 < fN / f 1 < - 0.55 \qquad ( 1 )$$

In order to obtain more favorable characteristics, the lower limit value of Conditional Expression (1) is more preferably −3, yet more preferably −2.5, most preferably −2, and especially preferably −1.75. In order to obtain more favorable characteristics, the upper limit value of Conditional Expression (1) is more preferably −1.07, yet more preferably −1.08, most preferably −1.09, and especially preferably −1.1.

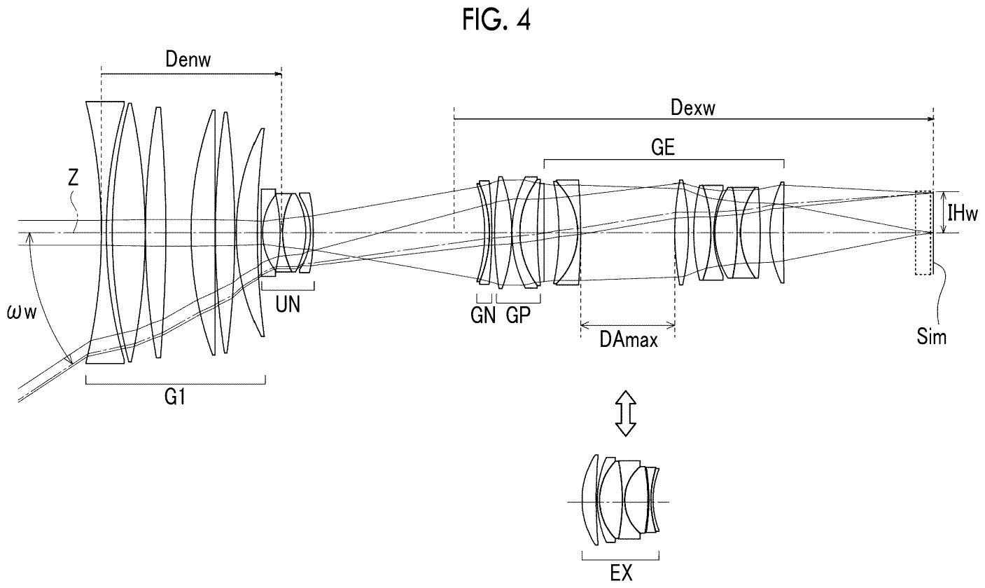

It is preferable that the zoom lens satisfies Conditional Expression (2). Here, it is assumed that a distance on the optical axis from a lens surface closest to the object side in the first lens group G1 in a state where the infinite distance object is in focus at the wide angle end to a paraxial entrance pupil position is Denw. It is assumed that a focal length of the zoom lens in a state where the infinite distance object is in focus at the wide angle end is fw. For example, FIG. 4 shows the distance Denw. FIG. 4 shows a cross-sectional view of a configuration and luminous flux of the zoom lens of FIG. 1 in a state where the infinite distance object is in focus at the wide angle end. By not allowing the corresponding value of Conditional Expression (2) to be equal to or less than the lower limit value thereof, it is possible to increase the distance on the optical axis from the lens surface closest to the object side in the first lens group G1 at the wide angle side to the paraxial entrance pupil position. Therefore, there is an advantage in suppressing fluctuation in field curvature during zooming. By not allowing the corresponding value of Conditional Expression (2) to be equal to or greater than the upper limit value thereof, it is possible to decrease the distance on the optical axis from the lens surface closest to the object side in the first lens group G1 at the wide angle side to the paraxial entrance pupil position. Therefore, there is an advantage in achieving an increase in angle of view thereof.

$$1.2 < Denw / fw < 8 \qquad ( 2 )$$

In order to obtain more favorable characteristics, the lower limit value of Conditional Expression (2) is more preferably 2.7, yet more preferably 2.75, most preferably 2.8, and especially preferably 2.85. In order to obtain more favorable characteristics, the upper limit value of Conditional Expression (2) is more preferably 4, yet more preferably 3.8, most preferably 3.6, and especially preferably 3.4.

Assuming that a focal length of the negative group UN is fUN and a focal length of the N lens group GN is fN, it is preferable that the zoom lens satisfies Conditional Expression (3). By not allowing the corresponding value of Conditional Expression (3) to be equal to or less than the lower limit value thereof, it is possible to suppress the refractive power of the negative group UN. Therefore, there is an advantage in suppressing fluctuation in aberrations during zooming. By not allowing the corresponding value of Conditional Expression (3) to be equal to or greater than the upper limit value thereof, it is possible to suppress the refractive power of the N lens group GN. Therefore, there is an advantage in suppressing fluctuation in aberrations during zooming.

$$0.118 < fUN / fN < 0.25 \qquad ( 3 )$$

In order to obtain more favorable characteristics, the lower limit value of Conditional Expression (3) is more preferably 0.125, yet more preferably 0.133, and most preferably 0.143. In order to obtain more favorable characteristics, the upper limit value of Conditional Expression (3) is more preferably 0.22, yet more preferably 0.2, and most preferably 0.19.

In a configuration in which the first lens group G1 includes at least the first a-part group G1a and the first b-part group G1b successively in order from a position closest to the object side to the image side and in which a spacing between the first a-part group G1a and the first b-part group G1b changes during focusing, it is preferable that the zoom lens satisfies Conditional Expression (4). Here, it is assumed that a focal length of the first a-part group G1a is f1a. By not allowing the corresponding value of Conditional Expression (4) to be equal to or less than the lower limit value thereof, it is possible to weaken the degree of divergence of the on-axis luminous flux by the first a-part group G1a. Therefore, there is an advantage in achieving reduction in diameter of the first b-part group G1b. By not allowing the corresponding value of Conditional Expression (4) to be equal to or greater than the upper limit value thereof, it is possible to weaken the refractive power of the first a-part group G1a. Therefore, by increasing the positive refractive power of the first b-part group G1b and the first b-part group G1b, which are closer to the image side, it is possible to reduce the amount of change in spacing during focusing. As a result, there is an advantage in achieving reduction in total length of the lens system.

$$- 0.85 < f 1 / f 1 a < 0.15 \qquad ( 4 )$$

In order to obtain more favorable characteristics, the lower limit value of Conditional Expression (4) is more preferably −0.4, yet more preferably −0.1, and most preferably −0.008. In order to obtain more favorable characteristics, the upper limit value of Conditional Expression (4) is more preferably 0.1, yet more preferably 0.08, and most preferably 0.048.

It is preferable that the zoom lens satisfies Conditional Expression (5). By not allowing the corresponding value of Conditional Expression (5) to be equal to or less than the lower limit value thereof, it is possible to increase the refractive power of the negative group UN. Therefore, it is possible to further reduce the amount of movement of the negative group UN during zooming. Therefore, there is an advantage in achieving reduction in total length of the lens system. By not allowing the corresponding value of Conditional Expression (5) to be equal to or greater than the upper limit value thereof, the refractive power of the first lens group G1 can be increased. Therefore, there is an advantage in achieving reduction in diameter and weight of the negative group UN.

$$- 0.4 < fUN / f 1 < - 0.09 \qquad ( 5 )$$

In order to obtain more favorable characteristics, the lower limit value of Conditional Expression (5) is more preferably −0.33, yet more preferably −0.28, and most preferably −0.245. In order to obtain more favorable characteristics, the upper limit value of Conditional Expression (5) is more preferably −0.12, yet more preferably −0.16, and most preferably −0.19.

It is preferable that the zoom lens satisfies Conditional Expression (6). By not allowing the corresponding value of Conditional Expression (6) to be equal to or less than the lower limit value thereof, it is possible to increase the refractive power of the first lens group G1. Therefore, there is an advantage in achieving reduction in total length of the lens system. By not allowing the corresponding value of Conditional Expression (6) to be equal to or greater than the upper limit value thereof, the position of the entrance pupil can be positioned to be closer to the object side. Therefore, there is an advantage in achieving reduction in diameter of the first lens group G1.

$$0.4 < Denw / f 1 < 1.6 \qquad ( 6 )$$

In order to obtain more favorable characteristics, the lower limit value of Conditional Expression (6) is more preferably 0.5, yet more preferably 0.6, and most preferably 0.67. In order to obtain more favorable characteristics, the upper limit value of Conditional Expression (6) is more preferably 1.4, yet more preferably 1.2, and most preferably 1.

It is preferable that the zoom lens satisfies Conditional Expression (7). Here, it is assumed that a maximum image height in a state where the infinite distance object is in focus at the wide angle end is IHw. For example, FIG. 1 shows the maximum image height IHw. By not allowing the corresponding value of Conditional Expression (7) to be equal to or less than the lower limit value thereof, it is possible to increase the distance on the optical axis from the lens surface closest to the object side in the first lens group G1 at the wide angle side to the paraxial entrance pupil position. Therefore, there is an advantage in suppressing fluctuation in field curvature during zooming. By not allowing the corresponding value of Conditional Expression (7) to be equal to or greater than the upper limit value thereof, it is possible to decrease the distance on the optical axis from the lens surface closest to the object side in the first lens group G1 at the wide angle side to the paraxial entrance pupil position. Therefore, there is an advantage in achieving an increase in angle of view thereof.

$$3.4 < Denw / IHw < 7.5 \qquad ( 7 )$$

In order to obtain more favorable characteristics, the lower limit value of Conditional Expression (7) is more preferably 3.7, yet more preferably 3.9, and most preferably 4.2. In order to obtain more favorable characteristics, the upper limit value of Conditional Expression (7) is more preferably 6.2, yet more preferably 5.6, and most preferably 5.59.

It is preferable that the zoom lens satisfies Conditional Expression (8). Here, it is assumed that an amount of displacement of the N lens group GN in the optical axis direction during zooming from the wide angle end to the telephoto end is MovN. It is assumed that a focal length of the zoom lens in a state where the infinite distance object is in focus at the telephoto end is ft. It is assumed that a focal length of the zoom lens in a state where the infinite distance object is in focus at the wide angle end is fw. It should be noted that a sign of the amount of displacement MovN is negative in a case where the N lens group GN move toward the object side and is positive in a case where the N lens group GN move toward the image side. For example, FIG. 2 shows the amount of displacement MovN. It is assumed that the amount of movement MovN is a difference between a position of the N lens group GN in the optical axis direction at the wide angle end and a position of the N lens group GN in the optical axis direction at the telephoto end, and a reference of each position is a position of the image plane Sim. By not allowing the corresponding value of Conditional Expression (8) to be equal to or less than the lower limit value thereof, it is possible to ensure a space for moving the negative group UN toward the object side at the telephoto end. Therefore, there is an advantage in achieving an increase in zoom ratio. By not allowing the corresponding value of Conditional Expression (8) to be equal to or greater than the upper limit value thereof, it is possible to further position the N lens group GN closer to the object side at the telephoto end. Therefore, there is an advantage in correcting off-axis aberrations at the telephoto end.

$$- 0.4 < M ovN / ( f 1 / log ( f t / fw ) ) < 0.1 \qquad ( 8 )$$

In order to obtain more favorable characteristics, the lower limit value of Conditional Expression (8) is more preferably −0.35, yet more preferably −0.3, and most preferably −0.24. In order to obtain more favorable characteristics, the upper limit value of Conditional Expression (8) is more preferably 0.05, yet more preferably 0.01, and most preferably −0.03.

It is preferable that the zoom lens satisfies Conditional Expression (9). Here, it is assumed that a back focal length of the whole system in terms of an air-equivalent distance in a state where the infinite distance object is in focus at the wide angle end is Bfw. By not allowing the corresponding value of Conditional Expression (9) to be equal to or less than the lower limit value thereof, there is an advantage in ensuring an amount of peripheral light. By not allowing the corresponding value of Conditional Expression (9) to be equal to or greater than the upper limit value thereof, there is an advantage in achieving reduction in total length of the lens system.

$$1.9 < Bfw / IHw < 6 \qquad ( 9 )$$

In order to obtain more favorable characteristics, the lower limit value of Conditional Expression (9) is more preferably 2.2, yet more preferably 2.45, and most preferably 2.75. In order to obtain more favorable characteristics, the upper limit value of Conditional Expression (9) is more preferably 5, yet more preferably 4.4, and most preferably 3.9.

It is preferable that the zoom lens satisfies Conditional Expression (10). Here, it is assumed that an air spacing, which has a maximum length among air spacings on the optical axis from the lens surface closest to the object side in the P lens group GP to a lens surface closest to the image side in the final lens group GE in a state where the infinite distance object is in focus at the wide angle end, is a longest air spacing DAmax. It is assumed that a Petzval sum from the lens surface closest to the object side in the first lens group G1 to the object side surface that constitutes the above-mentioned longest air spacing DAmax is PF. For example, FIG. 4 shows the longest air spacing DAmax. In the example of FIG. 4, the longest air spacing DAmax is constituted by an image side surface of the lens which is second from the object side in the final lens group and an object side surface of the lens which is third from the object side in the final lens group. By not allowing the corresponding value of Conditional Expression (10) to be equal to or less than the lower limit value thereof, it is possible to suppress excessive correction of field curvature. By not allowing the corresponding value of Conditional Expression (10) to be equal to or greater than the upper limit value thereof, there is an advantage in suppressing the field curvature that occurs at a position closer to the object side than the image side surface that constitutes the longest air spacing DAmax.

$$0.12 < PF \times I H w < 0.25 \qquad ( 10 )$$

In order to obtain more favorable characteristics, the lower limit value of Conditional Expression (10) is more preferably 0.13, yet more preferably 0.149, and most preferably 0.165. In order to obtain more favorable characteristics, the upper limit value of Conditional Expression (10) is more preferably 0.21, yet more preferably 0.203, and most preferably 0.185.

The Petzval sum PZ from a Sa-th surface to a Sb-th surface is defined by the following expression.

$$P Z = {\sum }_{i = Sa}^{Sb} ( - \frac{1}{R i} ) \times ( \frac{1}{N e i} - \frac{1}{Noi} )$$

Here,

Ri is a paraxial curvature radius of an i-th surface,

Nei is a refractive index of a medium on an incidence side of the i-th surface, and

Noi is a refractive index of a medium on an emission side of the i-th surface.

Assuming that a maximum half angle of view in a state where the infinite distance object is in focus at the wide angle end is ow, it is preferable that the zoom lens satisfies Conditional Expression (11). Here, the unit of ωw is degree. By not allowing the corresponding value of Conditional Expression (11) to be equal to or less than the lower limit value thereof, there is an advantage in achieving an increase in angle of view thereof. By not allowing the corresponding value of Conditional Expression (11) to be equal to or greater than the upper limit value thereof, there is an advantage in achieving reduction in size thereof.

$$21 < ω w < 55 \qquad ( 11 )$$

In order to obtain more favorable characteristics, the lower limit value of Conditional Expression (11) is more preferably 24, yet more preferably 27, and most preferably 30. In order to obtain more favorable characteristics, the upper limit value of Conditional Expression (11) is more preferably 50, yet more preferably 45, and most preferably 41.

It is preferable that the zoom lens satisfies Conditional Expression (12). By not allowing the corresponding value of Conditional Expression (12) to be equal to or less than the lower limit value thereof, there is an advantage in suppressing fluctuation in aberrations during zooming. By not allowing the corresponding value of Conditional Expression (12) to be equal to or greater than the upper limit value thereof, there is an advantage in achieving an increase in zoom ratio.

$$0.06 < fw / f t < 0.13 \qquad ( 12 )$$

In order to obtain more favorable characteristics, the lower limit value of Conditional Expression (12) is more preferably 0.065, yet more preferably 0.07, and most preferably 0.075. In order to obtain more favorable characteristics, the upper limit value of Conditional Expression (12) is more preferably 0.12, yet more preferably 0.11, and most preferably 0.105.

It is preferable that the zoom lens satisfies Conditional Expression (13). Here, it is assumed that a distance on the optical axis from s paraxial exit pupil position to the image plane Sim in a state where the infinite distance object is in focus at the wide angle end is Dexw. However, in a case where the optical member that does not have a refractive power is disposed between the exit pupil position and the image plane Sim, the Dexw is calculated for the optical member using the air-equivalent distance. For example, FIG. 4 schematically shows the distance Dexw. In FIG. 4, a broken line indicates a parallel plate-shaped optical member that does not have a refractive power to be calculated using the air-equivalent distance. By not allowing the corresponding value of Conditional Expression (13) to be equal to or less than the lower limit value thereof, the total length of the lens system can be shortened. Therefore, there is an advantage in achieving reduction in size. By not allowing the corresponding value of Conditional Expression (13) to be equal to or greater than the upper limit value thereof, an incidence angle of the off-axis principal ray with respect to the image plane Sim can be reduced. Therefore, there is an advantage in securing the peripheral light amount.

$$0.025 < IHw / Dexw < 0.15 \qquad ( 13 )$$

In order to obtain more favorable characteristics, the lower limit value of Conditional Expression (13) is more preferably 0.04, yet more preferably 0.05, and most preferably 0.075. In order to obtain more favorable characteristics, the upper limit value of Conditional Expression (13) is more preferably 0.14, yet more preferably 0.13, and most preferably 0.11.

It is preferable that the zoom lens satisfies Conditional Expression (14). By not allowing the corresponding value of Conditional Expression (14) to be equal to or less than the lower limit value thereof, it is possible to strengthen the refractive power of the first lens group G1. Therefore, there is an advantage in achieving reduction in total length of the lens system. By not allowing the corresponding value of Conditional Expression (14) to be equal to or greater than the upper limit value thereof, the refractive power of the first lens group G1 is prevented from becoming excessively strong. Therefore, there is an advantage in achieving an increase in angle of view while suppressing aberrations.

$$0.08 < fw / f 1 < 0.5 \qquad ( 14 )$$

In order to obtain more favorable characteristics, the lower limit value of Conditional Expression (14) is more preferably 0.12, yet more preferably 0.17, and most preferably 0.22. In order to obtain more favorable characteristics, the upper limit value of Conditional Expression (14) is more preferably 0.4, yet more preferably 0.35, and most preferably 0.32.

It is preferable that the zoom lens satisfies Conditional Expression (15). By not allowing the corresponding value of Conditional Expression (15) to be equal to or less than the lower limit value thereof, the refractive power of the negative group UN is prevented from becoming excessively strong. Therefore, there is an advantage in suppressing fluctuation in aberrations during zooming. By not allowing the corresponding value of Conditional Expression (15) to be equal to or greater than the upper limit value thereof, the refractive power of the negative group UN is prevented from becoming excessively weak. Therefore, there is an advantage in achieving reduction in size.

$$- 2.4 < fw / fUN < - 0.6 \qquad ( 15 )$$

In order to obtain more favorable characteristics, the lower limit value of Conditional Expression (15) is more preferably −2, yet more preferably −1.7, and most preferably −1.4. In order to obtain more favorable characteristics, the upper limit value of Conditional Expression (15) is more preferably −0.8, yet more preferably −1, and most preferably −1.3.

It is preferable that the zoom lens satisfies Conditional Expression (16). Here, it is assumed that a paraxial curvature radius of an image side surface of the lens closest to the object side in the zoom lens is R2. It is assumed that a paraxial curvature radius of an object side surface of the lens which is second from the object side in the zoom lens is R3. By not allowing the corresponding value of Conditional Expression (16) to be equal to or less than the lower limit value thereof, it is possible to shift the refractive power of the air lens formed between the lens closest to the object side in the zoom lens and the lens which is second from the object side in the zoom lens to a negative refractive power. Therefore, there is an advantage in suppressing distortion. By not allowing the corresponding value of Conditional Expression (16) to be equal to or greater than the upper limit value thereof, an absolute value of the curvature radius of the image side surface of the lens closest to the object side in the zoom lens is prevented from becoming excessively small. Therefore, there is an advantage in suppressing ghosts.

$$- 0.25 < ( R 2 - R 3 ) / ( R 2 + R 3 ) < 0.16 \qquad ( 16 )$$

In order to obtain more favorable characteristics, the lower limit value of Conditional Expression (16) is more preferably −0.18, yet more preferably −0.15, and most preferably −0.13. In order to obtain more favorable characteristics, the upper limit value of Conditional Expression (16) is more preferably 0.12, yet more preferably 0.08, and most preferably 0.04.

It is preferable that the zoom lens satisfies Conditional Expression (17). Here, it is assumed that a combined lateral magnification of all lenses closer to the image side than the above-mentioned longest air spacing DAmax at the wide angle end in a state where the infinite distance object is in focus is βAmaxR. By not allowing the corresponding value of Conditional Expression (17) to be equal to or less than the lower limit value thereof, there is an advantage in achieving reduction in diameter of the group consisting of all the lenses closer to the image side than the longest air spacing DAmax. By not allowing the corresponding value of Conditional Expression (17) to be equal to or greater than the upper limit value thereof, there is an advantage in suppressing fluctuation in aberrations in a case where the longest air spacing DAmax is changed due to an error.

$$- 0.05 < β AmaxR < 0.45 \qquad ( 17 )$$

In order to obtain more favorable characteristics, the lower limit value of Conditional Expression (17) is more preferably 0, yet more preferably 0.05, and most preferably 0.09. In order to obtain more favorable characteristics, the upper limit value of Conditional Expression (17) is more preferably 0.38, yet more preferably 0.33, and most preferably 0.26.

It is preferable that the zoom lens satisfies Conditional Expression (18). Here, it is assumed that a center thickness of a negative lens closest to the object side among negative lenses included in the negative group UN is tN1. It is assumed that an effective radius of an object side surface of the negative lens closest to the object side among the negative lenses included in the negative group UN is ErN1. For example, FIG. 2 shows the center thickness tN1. By not allowing the corresponding value of Conditional Expression (18) to be equal to or less than the lower limit value thereof, there is an advantage in improving the solidity of the negative lens closest to the object side among the negative lenses included in the negative group UN. By not allowing the corresponding value of Conditional Expression (18) to be equal to or greater than the upper limit value thereof, there is an advantage in achieving reduction in weight.

$$0.015 < tN 1 / ErN 1 < 0.085 \qquad ( 18 )$$

In order to obtain more favorable characteristics, the lower limit value of Conditional Expression (18) is more preferably 0.025, yet more preferably 0.03, and most preferably 0.034. In order to obtain more favorable characteristics, the upper limit value of Conditional Expression (18) is more preferably 0.075, yet more preferably 0.068, and most preferably 0.05.

It is preferable that the zoom lens satisfies Conditional Expression (19). Here, it is assumed that an amount of displacement of the P lens group GP in the optical axis direction during zooming from the wide angle end to the telephoto end is MovP. It is assumed that a sign of the amount of displacement MovP is negative in a case where the P lens group GP moves toward the object side, and is positive in a case where the P lens group GP moves toward the image side. For example, FIG. 2 shows the amount of displacement MovP. The amount of movement MoVP is a difference between a position of the P lens group GP in the optical axis direction at the wide angle end and a position of the P lens group GP in the optical axis direction at the telephoto end in a case where a position of the image plane Sim is set as a reference. By not allowing the corresponding value of Conditional Expression (19) to be equal to or less than the lower limit value thereof, it is possible to suppress movement of the P lens group GP toward the object side. Therefore, it is possible to ensure a space for a group that moves during zooming except for the P lens group GP. Thereby, there is an advantage in achieving a high zoom ratio while achieving reduction in total length of the lens system. By not allowing the corresponding value of Conditional Expression (19) to be equal to or greater than the upper limit value thereof, it is possible to further position the P lens group GP closer to the object side at the telephoto end. Therefore, there is an advantage in suppressing fluctuation in focusing position during zooming.

$$- 0.45 < MovP / ( f 1 / log ( f t / fw ) < 0.1 \qquad ( 19 )$$

In order to obtain more favorable characteristics, the lower limit value of Conditional Expression (19) is more preferably −0.38, yet more preferably −0.3, and most preferably −0.23. In order to obtain more favorable characteristics, the upper limit value of Conditional Expression (19) is more preferably 0.05, yet more preferably 0.001, and most preferably −0.03.

It is preferable that the zoom lens satisfies Conditional Expression (20). Here, it is assumed that a thickness of a group consisting of all lenses closer to the object side than a spacing closest to the object side among the spacings that change during focusing on the optical axis is D1a. It is assumed that a sum of a back focal length at the air-equivalent distance and a distance on the optical axis from the lens surface closest to the object side in the first lens group G1 to the lens surface closest to the image side in the final lens group GE in a state where the infinite distance object is in focus at the wide angle end is TLw. For example, FIG. 2 shows the thickness D1a. By not allowing the corresponding value of Conditional Expression (20) to be equal to or less than the lower limit value thereof, there is an advantage in suppressing fluctuation in aberrations during focusing of on-axis luminous flux at the telephoto end. By not allowing the corresponding value of Conditional Expression (20) to be equal to or greater than the upper limit value thereof, there is an advantage in achieving reduction in weight.

$$0.019 < D 1 a / TLw < 0.18 \qquad ( 20 )$$

In order to obtain more favorable characteristics, the lower limit value of Conditional Expression (20) is more preferably 0.025, yet more preferably 0.04, and most preferably 0.07. In order to obtain more favorable characteristics, the upper limit value of Conditional Expression (20) is more preferably 0.16, yet more preferably 0.14, and most preferably 0.125.

It is preferable that the zoom lens satisfies Conditional Expression (21). Here, it is assumed that a thickness of a group consisting of all lenses between the spacing closest to the object side and a spacing which is second from the object side among the spacings that change during focusing on the optical axis is D1b. It is assumed that a thickness of the first lens group G1 on the optical axis is DG1. For example, FIG. 2 shows the thicknesses D1b and DG1. By not allowing the corresponding value of Conditional Expression (21) to be equal to or less than the lower limit value thereof, there is an advantage in suppressing fluctuation in spherical aberration during focusing. By not allowing the corresponding value of Conditional Expression (21) to be equal to or greater than the upper limit value thereof, there is an advantage in achieving reduction in weight.

$$0.13 < D 1 b / DG 1 < 0.45 \qquad ( 21 )$$

In order to obtain more favorable characteristics, the lower limit value of Conditional Expression (21) is more preferably 0.18, yet more preferably 0.22, and most preferably 0.26. In order to obtain more favorable characteristics, the upper limit value of Conditional Expression (21) is more preferably 0.4, yet more preferably 0.35, and most preferably 0.3.

It is preferable that the zoom lens satisfies Conditional Expression (22). Here, it is assumed that a proportion of a positive lens having the maximum Abbe number at the d line among positive lenses included in the first lens group G1 is gvmax. By not allowing the corresponding value of Conditional Expression (22) to be equal to or less than the lower limit value thereof, the selectivity of the material having abnormal dispersibility is increased. Therefore, there is an advantage in correcting longitudinal chromatic aberration. By not allowing the corresponding value of Conditional Expression (22) to be equal to or greater than the upper limit value thereof, there is an advantage in achieving reduction in weight.

$$3.1 < gv max < 4.2 \qquad ( 22 )$$

In order to obtain more favorable characteristics, the lower limit value of Conditional Expression (22) is more preferably 3.2, yet more preferably 3.3, and most preferably 3.4. In order to obtain more favorable characteristics, the upper limit value of Conditional Expression (22) is more preferably 4, yet more preferably 3.8, and most preferably 3.6.

It is preferable that the zoom lens satisfies Conditional Expression (23). Here, it is assumed that a center thickness of the lens closest to the object side in the first lens group G1 is tL1. It is assumed that an effective radius of an object side surface of the lens closest to the object side in the first lens group G1 is ErL1. For example, FIG. 2 shows the center thickness tL1. By not allowing the corresponding value of Conditional Expression (23) to be equal to or less than the lower limit value thereof, there is an advantage in improving the solidity of the lens closest to the object side in the first lens group G1. By not allowing the corresponding value of Conditional Expression (23) to be equal to or greater than the upper limit value thereof, there is an advantage in achieving reduction in weight.

$$0.025 < tL 1 / ErL 1 < 0.075 \qquad ( 23 )$$

In order to obtain more favorable characteristics, the lower limit value of Conditional Expression (23) is more preferably 0.03, yet more preferably 0.034, and most preferably 0.038. In order to obtain more favorable characteristics, the upper limit value of Conditional Expression (23) is more preferably 0.065, yet more preferably 0.055, and most preferably 0.046.

The zoom lens according to the present disclosure may be configured to comprise an EX group EX that changes a focal length of the zoom lens by being inserted in or extracted from the optical path. For example, the EX group EX that changes the focal length of the zoom lens by being inserted in the optical path of the longest air spacing while keeping an imaging position constant may be configured to be insertable and extractable. In such a case, it is possible to obtain the zoom lens of which the focal length is changeable.

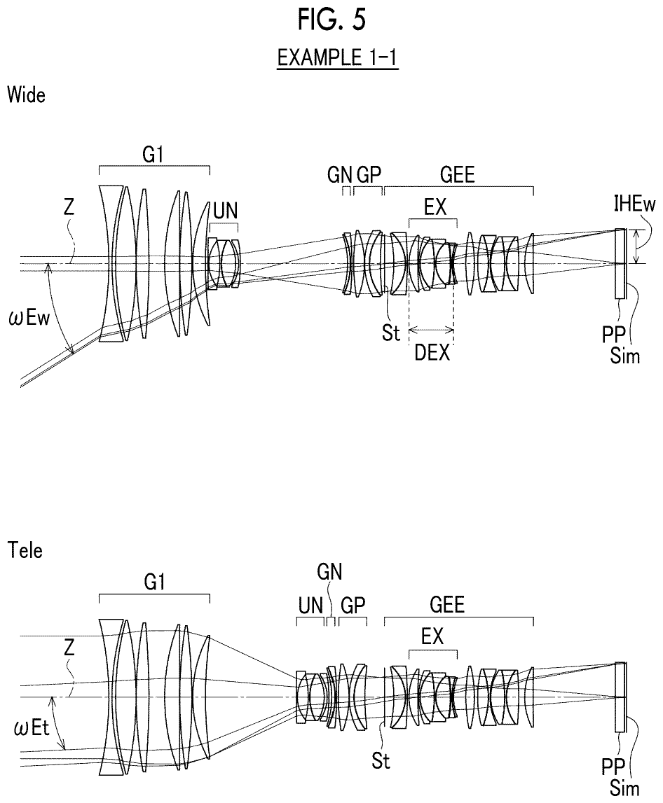

For example, FIG. 4 shows the EX group EX. The EX group EX in FIG. 4 consists of seven lenses. Further, FIG. 5 shows, as Example 1-1, a cross-sectional view showing a configuration and the luminous flux of the zoom lens in a case where the EX group EX of FIG. 4 is inserted in the zoom lens of FIG. 1. The final lens group GEE in FIG. 5 is configured to be different from the example in FIG. 1 such that the EX group EX is inserted in the final lens group GE in FIG. 1. The configuration of the other lens groups and groups in the example of FIG. 5 are the same as that in the example of FIG. 1. FIG. 5 shows a state where the infinite distance object is in focus, the left side thereof is an object side, and the right side thereof is an image side. In FIG. 5, the upper part labeled “Wide” shows a wide angle end state, and the lower part labeled “Tele” shows a telephoto end state. In FIG. 5, the luminous flux indicates the on-axis luminous flux and the luminous flux of the maximum half angle of view ωEw at the wide angle end, and the on-axis luminous flux and the luminous flux of the maximum half angle of view ωEt at the telephoto end. FIG. 5 does not show reference numerals of the first a-part group G1a, the first b-part group G1b, and the first c-part group G1c and arrows indicating movement directions during focusing.

In a case where the zoom lens comprises the above-mentioned EX group EX, the maximum image height may be configured to change by inserting or extracting the EX group EX. For example, in the wide angle end state, the maximum image height IHEw in the example shown in FIG. 5 is greater than the maximum image height IHw in the example shown in FIG. 1. With such a configuration, it is possible to obtain a zoom lens in a state of having a wider image circle while maintaining the angle of view.

It is preferable that the zoom lens satisfies Conditional Expression (24). Here, it is assumed that a focal length of the zoom lens in a state where the EX group EX is not inserted and the infinite distance object is in focus at the telephoto end is ft. It is assumed that the maximum half angle of view in a state where the EX group EX is not inserted and a state where the infinite distance object is in focus at the telephoto end is ωt. It is assumed that the focal length of the zoom lens in a state where the EX group EX is inserted and in a state where the infinite distance object is in focus at the telephoto end is fEt. It is assumed that the maximum half angle of view in a state where the EX group EX is inserted and in a state where the infinite distance object is in focus at the telephoto end is ωEt. The tan is a tangent. By not allowing the corresponding value of Conditional Expression (24) to be equal to or less than the lower limit value thereof, there is an advantage in simultaneously suppressing the various aberrations in a state where the EX group EX is not inserted and the various aberrations in a state where the EX group EX is inserted. By not allowing the corresponding value of Conditional Expression (24) to be equal to or greater than the upper limit value thereof, it is easy to obtain the image size obtained in a state where the EX group EX is inserted.

$$0.5 < ( ft \times tan ω t ) / ( fEt \times tan ω Et ) < 0.9 \qquad ( 24 )$$

In order to obtain more favorable characteristics, the lower limit value of Conditional Expression (24) is more preferably 0.55, yet more preferably 0.6, and most preferably 0.65. In order to obtain more favorable characteristics, the upper limit value of Conditional Expression (24) is more preferably 0.85, yet more preferably 0.8, and most preferably 0.75.

It is preferable that the zoom lens satisfies Conditional Expression (25). Here, it is assumed that a thickness of the EX group EX on the optical axis is DEX. For example, FIG. 5 shows the thickness DEX. By not allowing the corresponding value of Conditional Expression (25) to be equal to or less than the lower limit value thereof, there is an advantage in suppressing the aberration occurring in the EX group EX. By not allowing the corresponding value of Conditional Expression (25) to be equal to or greater than the upper limit value thereof, there is an advantage in achieving reduction in weight of the EX group EX.

$$0.05 < DEX / TLw < 0.12 \qquad ( 25 )$$

In order to obtain more favorable characteristics, the lower limit value of Conditional Expression (25) is more preferably 0.06, yet more preferably 0.07, and most preferably 0.085. In order to obtain more favorable characteristics, the upper limit value of Conditional Expression (25) is more preferably 0.11, yet more preferably 0.1, and most preferably 0.094.

It is preferable that the zoom lens satisfies Conditional Expression (26). Here, it is assumed that a focal length of a lens component closest to the image side in the EX group EX is fLExe. It should be noted that one lens component means one cemented lens or one single lens. By not allowing the corresponding value of Conditional Expression (26) to be equal to or less than the lower limit value thereof, it is possible to prevent distortion occurring in the EX group EX from becoming excessively corrected. By not allowing the corresponding value of Conditional Expression (26) to be equal to or greater than the upper limit value thereof, it is possible to correct distortion generated in the EX group EX.

$$- 2.3 < Bfw / fLExe < - 0.55 \qquad ( 26 )$$

In order to obtain more favorable characteristics, the lower limit value of Conditional Expression (26) is more preferably −2.2, yet more preferably −2.1, and most preferably −1.98. In order to obtain more favorable characteristics, the upper limit value of Conditional Expression (26) is more preferably −0.84, yet more preferably −1.1, and most preferably −1.75.

It is preferable that the zoom lens satisfies Conditional Expression (27). Here, it is assumed that a refractive index of a lens closest to the object side in the EX group EX at the d line is NEX1. By not allowing the corresponding value of Conditional Expression (27) to be equal to or less than the lower limit value thereof, there is an advantage in suppressing spherical aberration occurring in the EX group EX. By not allowing the corresponding value of Conditional Expression (27) to be equal to or greater than the upper limit value thereof, there is an advantage in suppressing longitudinal chromatic aberration occurring in the EX group EX.

$$1.4 < NEX 1 < 1.85 \qquad ( 27 )$$

In order to obtain more favorable characteristics, the lower limit value of Conditional Expression (27) is more preferably 1.45, yet more preferably 1.5, and most preferably 1.56. In order to obtain more favorable characteristics, the upper limit value of Conditional Expression (27) is more preferably 1.75, yet more preferably 1.7, and most preferably 1.65.

The example shown in FIG. 1 is an example, and various modifications can be made without departing from the scope of the technique according to the embodiment of the present disclosure. For example, the number of lenses included in the first lens group G1, the negative group UN, the N lens group GN, the P lens group GP, the final lens group GE, and the focusing groups may be different from the number in the example of FIG. 1. The number of lens groups included in the negative group UN may be different from the number in the example shown in FIG. 1. The focusing group, the position of the aperture stop St, and the lens group that moves during zooming may be configured to be different from the example shown in FIG. 1.

The above-mentioned preferred configurations and available configurations may be optionally combined without contradiction, and it is preferable to selectively adopt the configurations in accordance with necessary specification.

For example, an aspect of the present disclosure is a zoom lens including the first lens group G1 that is disposed to be closest to the object side and that has a positive refractive power, the negative group UN that is disposed to be adjacent to the image side of the first lens group G1, that has a negative refractive power as a whole, and that consists of two or fewer lens groups, the N lens group GN that has a negative refractive power and that is disposed to be closer to the image side than the negative group UN, the P lens group GP that is disposed to be closer to the image side than the negative group UN and that has a positive refractive power, and the final lens group GE that is disposed to be closest to the image side. During zooming, all spacings between adjacent lens groups change, and Conditional Expression (1) is satisfied.

Next, examples of the zoom lens according to the embodiment of the present disclosure will be described, with reference to the drawings. The reference numerals attached to the groups in the cross-sectional views of each example are used independently for each example in order to avoid complication of description and drawings due to an increase in number of digits of the reference numerals. Therefore, even in a case where common reference numerals are attached in the drawings of different examples, components do not necessarily have a common configuration.

### Example 1

FIG. 1 shows a configuration and movement loci of a zoom lens according to Example 1, and an illustration method and a configuration thereof are as described above. Therefore, some description is not repeated herein. The zoom lens according to Example 1 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

Regarding the zoom lens according to Example 1, Table 1 shows basic lens data, Table 2 shows specifications and variable surface spacings, and Table 3 shows aspherical coefficients thereof.

The table of basic lens data will be described as follows. The “Sn” column shows surface numbers in a case where the surface closest to the object side is the first surface and the number is increased one by one toward the image side. The “R” column shows a curvature radius of each surface. The “D” column shows a surface spacing between each surface and the surface adjacent to the image side on the optical axis. The “Nd” column shows a refractive index of each constituent element at the d line. The “vd” column shows an Abbe number of each constituent element based on the d line. The “θg,F” column shows a partial dispersion ratio of each constituent element between the g line and the F line. The “SG” column shows a specific gravity of each component. The “ED” column shows an effective diameter of each surface.

Assuming that a refractive indexes for the g line, F line, and C line of a certain lens are Ng, NF, and NC, respectively, and the partial dispersion ratios thereof between the g line and F line of the lens is θg,F, θg,F is defined by the following expression.

$$θ g , F = ( Ng - NF ) / ( NF - NC )$$

The “d line”, “C line”, “F line”, and “g line” described in the present specification are emission lines. The wavelength of the d line is 587.56 nm (nanometers) and the wavelength of the C line is 656.27 nm (nanometers), the wavelength of F line is 486.13 nm (nanometers), and the wavelength of g line is 435.84 nm (nanometers).

In the table of the basic lens data, the sign of the curvature radius of the convex surface facing toward the object side is positive, and the sign of the curvature radius of the convex surface facing toward the image side is negative. Table 1 also shows the aperture stop St and the optical member PP. In a cell of a surface number of a surface corresponding to the aperture stop St, the surface number and a term of (St) are noted. A value at the bottom cell of the column of D in the table indicates a spacing between the image plane Sim and the surface closest to the image side in the table. Regarding the variable surface spacing, the symbol DD[ ] is used, and the object side surface number of the spacing is given in [ ] and is noted in the column of D.

Table 2 shows the zoom ratio Zr, the focal length f, the open F number FNo, the maximum angle of view 20, the variable surface spacing, and the maximum image height IHw in a state where the infinite distance object is in focus at the wide angle end on the basis of the d line. The zoom ratio is synonymous with the zoom magnification. [°] in the cells of 2ω indicates that the unit thereof is a degree. Table 2 shows values in each object distance and each zooming state. More specifically, values in the “infinity” column are values in a state where the infinite distance object is in focus, values in the “close (0.88 m)” column are values in a state where the close range object is in focus, and values in the “Wide”, “Middle”, and “Tele” columns are values in the wide angle end state, the middle focal length state, and the telephoto end state, respectively. A numerical value in parentheses after “close to” is a distance on the optical axis from the close range object to the lens surface closest to the object side. The “m” in “(0.88 m)” is a unit of distance in meters.

In basic lens data, a reference sign * is attached to surface numbers of aspherical surfaces, and values of the paraxial curvature radius are noted into the column of the curvature radius of the aspherical surface. In Table 3, the Sn row shows surface numbers of the aspherical surfaces, and the KA and Am rows show numerical values of the aspherical coefficients for each aspherical surface. It should be noted that m of Am is an integer of 3 or more, and differs depending on the surface. For example, on the sixth surface of Example 1, m=4, 6, 8, 10, 12, 14, 16, 18, and 20. The “E±n” (n: an integer) in numerical values of the aspherical coefficients of Table 3 indicates “×10^{±n}”. KA and Am are the aspherical coefficients in the aspherical surface expression represented by the following expression.

$$Zd = C \times {h}^{2} / \{ 1 + {( 1 - KA \times {C}^{2} \times {h}^{2} )}^{1 / 2} \} + \sum Am \times {h}^{m}$$

Here,

Zd is the aspherical depth (length of a perpendicular line drawn from a point on the aspherical surface at height h to a plane perpendicular to the optical axis Z in contact which the aspherical apex),

h is the height (distance from the optical axis Z to the lens surface),

C is the reciprocal of paraxial curvature radius,

KA and Am are aspherical coefficients, and

Σ in the aspherical expression means the sum of m.

In the data of each table, degrees are used as a unit of an angle, and millimeters are used as a unit of a length, but appropriate different units may be used since the optical system can be used even in a case where the system is enlarged or reduced in proportion. Each of the following tables shows numerical values rounded off to predetermined decimal places.

TABLE 1
Example 1

| Sn | R | D | Nd | vd | θg, F | SG | ED |
|---|---|---|---|---|---|---|---|
| 1 | −194.1757 | 1.9100 | 1.67300 | 38.26 | 0.57580 | 3.01 | 94.30 |
| 2 | 161.0116 | 2.2410 | | | | | 91.97 |
| 3 | 179.5451 | 12.5010 | 1.43700 | 95.10 | 0.53364 | 3.53 | 92.17 |
| 4 | −211.4333 | 0.1370 | | | | | 92.07 |
| 5 | 251.7347 | 7.7850 | 1.43700 | 95.10 | 0.53364 | 3.53 | 89.27 |
| *6 | −441.3697 | DD[6] | | | | | 89.18 |
| 7 | 125.0018 | 9.1410 | 1.43700 | 95.10 | 0.53364 | 3.53 | 87.50 |
| 8 | ∞ | 0.1200 | | | | | 87.16 |
| 9 | 277.4352 | 7.3770 | 1.43700 | 95.10 | 0.53364 | 3.53 | 85.79 |
| 10 | −326.8651 | DD[10] | | | | | 85.33 |
| *11 | 80.2199 | 7.7870 | 1.53775 | 74.70 | 0.53936 | 3.64 | 73.72 |
| 12 | 268.9447 | DD[12] | | | | | 72.90 |
| 13 | 1161.7943 | 0.5530 | 1.91082 | 35.25 | 0.58335 | 4.85 | 30.82 |
| 14 | 21.7839 | 6.6680 | | | | | 26.47 |
| 15 | −57.2976 | 0.9860 | 1.84850 | 43.79 | 0.56197 | 5.08 | 26.22 |
| 16 | 31.0144 | 8.8030 | 1.85451 | 25.15 | 0.61031 | 3.48 | 26.34 |
| 17 | −27.7502 | 1.7930 | | | | | 26.47 |
| 18 | −23.7439 | 1.0670 | 1.84850 | 43.79 | 0.56197 | 5.08 | 26.18 |
| *19 | −91.9928 | DD[19] | | | | | 27.87 |
| 20 | −53.9899 | 1.7750 | 1.86966 | 20.02 | 0.64349 | 3.37 | 34.00 |
| 21 | −44.0616 | 0.9100 | 1.69560 | 59.05 | 0.54348 | 4.56 | 34.46 |
| 22 | −170.4444 | DD[22] | | | | | 35.90 |
| *23 | 108.2078 | 6.5630 | 1.59349 | 67.00 | 0.53667 | 3.14 | 38.55 |
| 24 | −57.4866 | 0.1200 | | | | | 39.00 |
| 25 | 42.5609 | 2.9960 | 1.89286 | 20.36 | 0.63944 | 3.61 | 39.17 |
| 26 | 31.3565 | 6.6270 | 1.49782 | 82.57 | 0.53862 | 3.86 | 37.17 |
| 27 | 153.0677 | DD[27] | | | | | 36.80 |
| 28(St) | ∞ | 5.6820 | | | | | 35.50 |
| 29 | −86.5487 | 7.1220 | 1.53775 | 74.70 | 0.53936 | 3.64 | 34.89 |
| 30 | −25.1114 | 1.1210 | 1.53996 | 59.64 | 0.54435 | 2.84 | 34.97 |
| 31 | −229.9585 | 35.8880 | | | | | 35.31 |
| 32 | 96.6349 | 5.2390 | 1.84666 | 23.84 | 0.62012 | 3.50 | 36.50 |
| 33 | −81.2401 | 1.9960 | | | | | 36.40 |
| 34 | 67.0433 | 6.5460 | 1.48749 | 70.24 | 0.53007 | 2.46 | 33.00 |
| 35 | −49.6402 | 1.0600 | 1.95375 | 32.32 | 0.59015 | 5.10 | 32.07 |
| 36 | 36.3583 | 0.4690 | | | | | 30.62 |
| 37 | 30.1314 | 8.4810 | 1.51860 | 69.89 | 0.53184 | 2.60 | 31.42 |
| 38 | −78.1901 | 1.0990 | 1.91082 | 35.25 | 0.58335 | 4.85 | 31.16 |
| 39 | 27.0365 | 7.4650 | 1.59551 | 39.24 | 0.58043 | 2.63 | 31.16 |
| 40 | −189.1203 | 3.7000 | | | | | 31.71 |
| 41 | 40.9120 | 5.1500 | 1.51742 | 52.43 | 0.55649 | 2.46 | 34.82 |
| 42 | 747.0448 | 50.3341 | | | | | 34.69 |
| 43 | ∞ | 5.7000 | 1.51633 | 64.14 | 0.53531 | 2.52 | 30.39 |
| 44 | ∞ | 1.1000 | | | | | 30.06 |

TABLE 2
Example 1

| | | |
|---|---|---|
| Object | | |
| distance | | |
| Zooming | Infinity | Close range (0.88 m) |

| state | Wide | Middle | Tele | Wide | Middle | Tele |
|---|---|---|---|---|---|---|
| Zr | 1.00 | 3.88 | 12.05 | 1.00 | 3.88 | 12.05 |
| f | 24.88 | 96.48 | 299.65 | 28.89 | 136.15 | 383.83 |
| FNo. | 2.75 | 2.75 | 3.99 | 2.75 | 2.75 | 4.39 |
| 2ω[°] | 64.78 | 16.52 | 5.40 | 52.04 | 10.58 | 0.96 |
| DD[6] | 9.6090 | 9.6090 | 9.6090 | 0.6098 | 0.6098 | 0.6098 |
| DD[10] | 0.6010 | 0.6010 | 0.6010 | 0.6996 | 0.6996 | 0.6996 |
| DD[12] | 1.4810 | 41.0731 | 55.6946 | 10.3816 | 49.9737 | 64.5952 |
| DD[19] | 65.3350 | 4.1136 | 1.7036 | 65.3350 | 4.1136 | 1.7036 |
| DD[22] | 1.0470 | 20.1861 | 1.0329 | 1.0470 | 20.1861 | 1.0329 |
| DD[27] | 2.5700 | 5.0602 | 12.0018 | 2.5700 | 5.0602 | 12.0018 |
| IHw | 14.525 | | | | | |

TABLE 3
Example 1

| Sn | 6 | 11 |
|---|---|---|
| KA | 1.000000000000000E+00 | 8.853550991435840E−01 |
| A4 | 1.125433755483720E−07 | 3.180917710255770E−08 |
| A6 | −1.876399101073500E−10 | −1.867609638494800E−10 |
| A8 | 3.990027424621460E−13 | 3.713036481136150E−13 |
| A10 | −4.592200562298620E−16 | −2.884554015023710E−16 |
| A12 | 3.031000382031970E−19 | −1.009754278380820E−19 |
| A14 | −1.094646766715590E−22 | 3.581779033550930E−22 |
| A16 | 1.692215162415680E−26 | −2.702669816759060E−25 |
| A18 | 6.239366630748930E−31 | 9.049278691615380E−29 |
| A20 | −3.579512321856370E−34 | −1.164752504033490E−32 |

| Sn | 19 |
|---|---|
| KA | 1.514466098353800E+01 |
| A3 | 0.000000000000000E+00 |
| A4 | −5.608538583185360E−06 |
| A5 | 1.115397773238520E−06 |
| A6 | −6.555955498194080E−07 |
| A7 | 2.401052542054150E−07 |
| A8 | −5.058038280369530E−08 |
| A9 | 5.914049485709190E−09 |
| A10 | −3.257086815488230E−10 |
| A11 | 1.130299892556810E−12 |
| A12 | 1.491777186220540E−13 |
| A13 | 1.083987417652890E−13 |
| A14 | −1.230033358864160E−14 |
| A15 | 5.211047989398890E−16 |
| A16 | −8.141472048909490E−18 |

| Sn | 23 |
|---|---|
| KA | 5.127139119281390E+00 |
| A4 | −2.166366819937770E−06 |
| A6 | 1.508682556296980E−09 |
| A8 | −2.282101202010240E−11 |
| A10 | 2.487750972627130E−13 |
| A12 | −1.610191519913360E−15 |
| A14 | 6.303801020519990E−18 |
| A16 | −1.468960316273520E−20 |
| A18 | 1.874933820356580E−23 |
| A20 | −1.009152679408340E−26 |

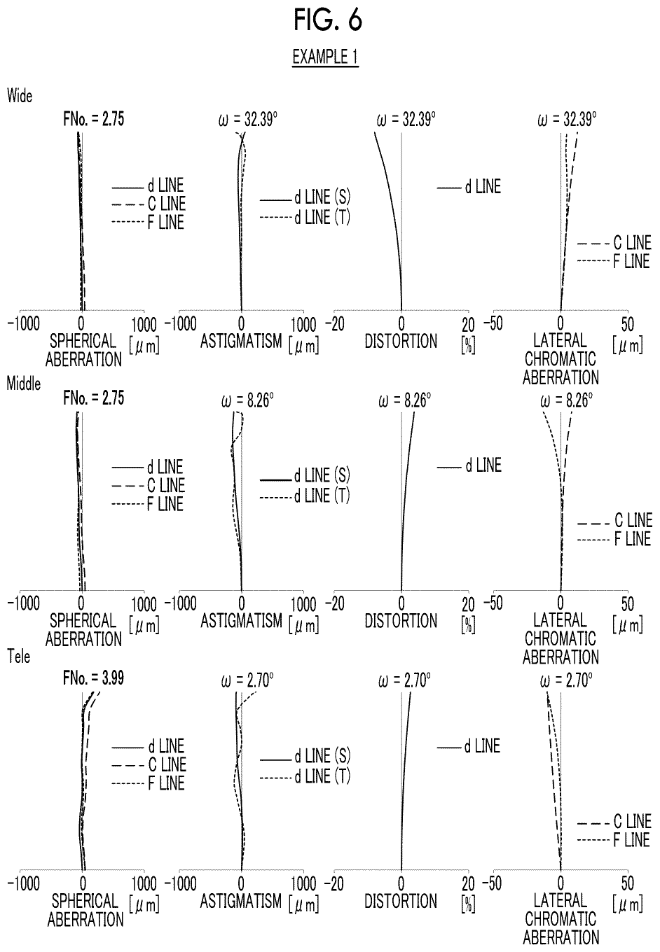

FIG. 6 is a diagram of aberrations of the zoom lens according to Example 1 in a state where the infinite distance object is in focus. FIG. 6 shows, in order from the left, spherical aberration, astigmatism, distortion, and lateral chromatic aberration. In FIG. 6, the upper part labeled “Wide” shows aberrations in the wide angle end state, the middle part labeled “Middle” shows aberrations in the middle focal length state, and the lower part labeled “Tele” shows aberrations in the telephoto end state. In the spherical aberration diagram, aberrations at the d line, the C line, and the F line are indicated by the solid line, the long broken line, and the short broken line, respectively. In the astigmatism diagram, aberration in the sagittal direction at the d line is indicated by the solid line, and aberration in the tangential direction at the d line is indicated by the short broken line. In the distortion diagram, aberration at the d line is indicated by a solid line. In the lateral chromatic aberration diagram, aberrations at the C line, and the F line are respectively indicated by the long broken line, and the short broken line. In the spherical aberration diagram, the value of the open F number is shown after FNo.=. In other aberration diagrams, the value of the maximum half angle of view is shown after ω=.

Symbols, meanings, description methods, and illustration methods of the respective data pieces according to Example 1 are basically similar to those in the following examples unless otherwise specified. Therefore, in the following description, repeated description will not be given.

### Example 1-1

Example 1-1 is an example in which the EX group EX is inserted in the zoom lens according to Example 1. FIG. 5 shows a cross-sectional view of a configuration and luminous flux of a zoom lens according to Example 1-1. The zoom lens according to Example 1-1 has a final lens group GEE in which the EX group EX is inserted in the final lens group GE of Example 1, instead of the final lens group GE of Example 1. The other lens groups and the group configuration of Example 1-1 are the same as those of the zoom lens according to Example 1.

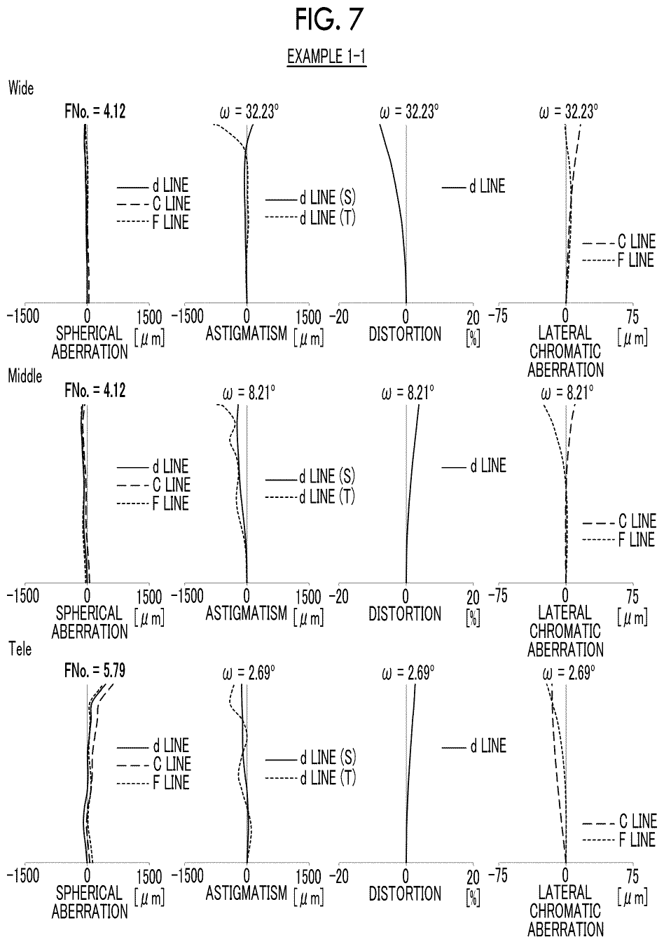

Regarding the zoom lens according to Example 1-1, Tables 4A and 4B show basic lens data, Table 5 shows specifications and variable surface spacings, and Table 6 shows aspherical coefficients thereof. FIG. 7 shows aberration diagrams. Here, the basic lens data is shown to be divided into two tables in order to avoid the lengthening of one table. Also in the following tables, the basic lens data is shown to be divided into two tables.

TABLE 4A
Example 1-1

| Sn | R | D | Nd | vd | θg, F | SG | ED |
|---|---|---|---|---|---|---|---|
| 1 | −194.1757 | 1.9100 | 1.67300 | 38.26 | 0.57580 | 3.01 | 94.30 |
| 2 | 161.0116 | 2.2410 | | | | | 91.97 |
| 3 | 179.5451 | 12.5010 | 1.43700 | 95.10 | 0.53364 | 3.53 | 92.18 |
| 4 | −211.4333 | 0.1370 | | | | | 92.08 |
| 5 | 251.7347 | 7.7850 | 1.43700 | 95.10 | 0.53364 | 3.53 | 89.27 |
| *6 | −441.3697 | DD[6] | | | | | 89.18 |
| 7 | 125.0018 | 9.1410 | 1.43700 | 95.10 | 0.53364 | 3.53 | 87.50 |
| 8 | ∞ | 0.1200 | | | | | 87.16 |
| 9 | 277.4352 | 7.3770 | 1.43700 | 95.10 | 0.53364 | 3.53 | 85.79 |
| 10 | −326.8651 | DD[10] | | | | | 85.33 |
| *11 | 80.2199 | 7.7870 | 1.53775 | 74.70 | 0.53936 | 3.64 | 73.72 |
| 12 | 268.9447 | DD[12] | | | | | 72.89 |
| 13 | 1161.7943 | 0.5530 | 1.91082 | 35.25 | 0.58335 | 4.85 | 30.82 |
| 14 | 21.7839 | 6.6680 | | | | | 26.47 |
| 15 | −57.2976 | 0.9860 | 1.84850 | 43.79 | 0.56197 | 5.08 | 26.23 |
| 16 | 31.0144 | 8.8030 | 1.85451 | 25.15 | 0.61031 | 3.48 | 26.34 |
| 17 | −27.7502 | 1.7930 | | | | | 26.47 |
| 18 | −23.7439 | 1.0670 | 1.84850 | 43.79 | 0.56197 | 5.08 | 26.13 |
| *19 | −91.9928 | DD[19] | | | | | 27.76 |
| 20 | −53.9899 | 1.7750 | 1.86966 | 20.02 | 0.64349 | 3.37 | 34.00 |
| 21 | −44.0616 | 0.9100 | 1.69560 | 59.05 | 0.54348 | 4.56 | 34.46 |
| 22 | −170.4444 | DD[22] | | | | | 35.90 |
| *23 | 108.2078 | 6.5630 | 1.59349 | 67.00 | 0.53667 | 3.14 | 38.55 |
| 24 | −57.4866 | 0.1200 | | | | | 38.95 |
| 25 | 42.5609 | 2.9960 | 1.89286 | 20.36 | 0.63944 | 3.61 | 38.70 |
| 26 | 31.3565 | 6.6270 | 1.49782 | 82.57 | 0.53862 | 3.86 | 36.64 |
| 27 | 153.0677 | DD[27] | | | | | 36.19 |

TABLE 4B
Example 1-1

| Sn | R | D | Nd | vd | θg, F | SG | ED |
|---|---|---|---|---|---|---|---|
| 28(St) | ∞ | 5.6820 | | | | | 35.10 |
| 29 | −86.5487 | 7.1220 | 1.53775 | 74.70 | 0.53936 | 3.64 | 34.03 |
| 30 | −25.1114 | 1.1210 | 1.53996 | 59.64 | 0.54435 | 2.84 | 33.96 |
| 31 | −229.9585 | 1.0710 | | | | | 33.77 |
| 32 | 31.6538 | 5.4390 | 1.63246 | 63.77 | 0.54215 | 4.29 | 33.00 |
| 33 | 200.4912 | 0.4430 | | | | | 32.33 |
| 34 | 40.2437 | 0.8890 | 2.00069 | 25.46 | 0.61364 | 4.73 | 30.49 |
| 35 | 21.1414 | 8.7040 | 1.53172 | 48.84 | 0.56309 | 2.50 | 28.10 |
| 36 | −76.8037 | 0.0420 | | | | | 27.19 |
| 37 | −76.7471 | 0.8740 | 1.78590 | 44.20 | 0.56317 | 4.40 | 27.15 |
| 38 | 16.6618 | 8.9070 | 1.72825 | 28.32 | 0.60755 | 3.01 | 24.80 |
| 39 | −71.6175 | 0.4020 | | | | | 24.22 |
| 40 | −75.8414 | 0.8020 | 1.75500 | 52.32 | 0.54757 | 4.17 | 23.85 |
| 41 | 40.5721 | 0.8100 | 1.75211 | 25.05 | 0.61924 | 3.14 | 22.99 |
| 42 | 31.4032 | 7.5050 | | | | | 22.67 |
| 43 | 96.6349 | 5.2390 | 1.84666 | 23.84 | 0.62012 | 3.50 | 25.51 |
| 44 | −81.2401 | 1.9960 | | | | | 25.90 |
| 45 | 67.0433 | 6.5460 | 1.48749 | 70.24 | 0.53007 | 2.46 | 25.65 |
| 46 | −49.6402 | 1.0600 | 1.95375 | 32.32 | 0.59015 | 5.10 | 25.03 |
| 47 | 36.3583 | 0.4690 | | | | | 25.03 |
| 48 | 30.1314 | 8.4810 | 1.51860 | 69.89 | 0.53184 | 2.60 | 26.00 |
| 49 | −78.1901 | 1.0990 | 1.91082 | 35.25 | 0.58335 | 4.85 | 26.54 |
| 50 | 27.0365 | 7.4650 | 1.59551 | 39.24 | 0.58043 | 2.63 | 27.56 |
| 51 | −189.1203 | 3.7000 | | | | | 29.05 |
| 52 | 40.9120 | 5.1500 | 1.51742 | 52.43 | 0.55649 | 2.46 | 34.57 |
| 53 | 747.0448 | 50.3255 | | | | | 34.69 |
| 54 | ∞ | 5.7000 | 1.51633 | 64.14 | 0.53531 | 2.52 | 42.10 |
| 55 | ∞ | 1.1000 | | | | | 42.65 |

TABLE 5
Example 1-1

| Object | | | | | | |
|---|---|---|---|---|---|---|
| distance | | | | | | |
| Zooming | Infinity | | | Close range (0.88 m) | | |
| state | Wide | Middle | Tele | Wide | Middle | Tele |
| Zr | 1.00 | 3.88 | 12.05 | 1.00 | 3.88 | 12.05 |
| f | 35.99 | 139.59 | 433.50 | 41.37 | 166.28 | 212.21 |
| FNo. | 4.12 | 4.12 | 5.79 | 4.12 | 4.12 | 6.50 |
| 2ω[°] | 64.46 | 16.42 | 5.38 | 51.84 | 10.52 | 0.94 |
| DD[6] | 9.6090 | 9.6090 | 9.6090 | 0.6098 | 0.6098 | 0.6098 |
| DD[10] | 0.6010 | 0.6010 | 0.6010 | 0.6996 | 0.6996 | 0.6996 |
| DD[12] | 1.4810 | 41.0731 | 55.6946 | 10.3815 | 49.9737 | 64.5951 |
| DD[19] | 65.3350 | 4.1136 | 1.7036 | 65.3350 | 4.1136 | 1.7036 |
| DD[22] | 1.0470 | 20.1861 | 1.0329 | 1.0470 | 20.1861 | 1.0329 |
| DD[27] | 2.5700 | 5.0602 | 12.0018 | 2.5700 | 5.0602 | 12.0018 |

TABLE 6
Example 1-1

| Sn | 6 | 11 |
|---|---|---|
| KA | 1.000000000000000E+00 | 8.853550991435840E−01 |
| A4 | 1.125433755483720E−07 | 3.180917710255770E−08 |
| A6 | −1.876399101073500E−10 | −1.867609638494800E−10 |
| A8 | 3.990027424621460E−13 | 3.713036481136150E−13 |
| A10 | −4.592200562298620E−16 | −2.884554015023710E−16 |
| A12 | 3.031000382031970E−19 | −1.009754278380820E−19 |
| A14 | −1.094646766715590E−22 | 3.581779033550930E−22 |
| A16 | 1.692215162415680E−26 | −2.702669816759060E−25 |
| A18 | 6.239366630748930E−31 | 9.049278691615380E−29 |
| A20 | −3.579512321856370E−34 | −1.164752504033490E−32 |

| Sn | 19 |
|---|---|
| KA | 1.514466098353800E+01 |
| A3 | 0.000000000000000E+00 |
| A4 | −5.608538583185360E−06 |
| A5 | 1.115397773238520E−06 |
| A6 | −6.555955498194080E−07 |
| A7 | 2.401052542054150E−07 |
| A8 | −5.058038280369530E−08 |
| A9 | 5.914049485709190E−09 |
| A10 | −3.257086815488230E−10 |
| A11 | 1.130299892556810E−12 |
| A12 | 1.491777186220540E−13 |
| A13 | 1.083987417652890E−13 |
| A14 | −1.230033358864160E−14 |
| A15 | 5.211047989398890E−16 |
| A16 | −8.141472048909490E−18 |

| Sn | 23 |
|---|---|
| KA | 5.127139119281390E+00 |
| A4 | −2.166366819937770E−06 |
| A6 | 1.508682556296980E−09 |
| A8 | −2.282101202010240E−11 |
| A10 | 2.487750972627130E−13 |
| A12 | −1.610191519913360E−15 |
| A14 | 6.303801020519990E−18 |
| A16 | −1.468960316273520E−20 |
| A18 | 1.874933820356580E−23 |
| A20 | −1.009152679408340E−26 |

### Example 2

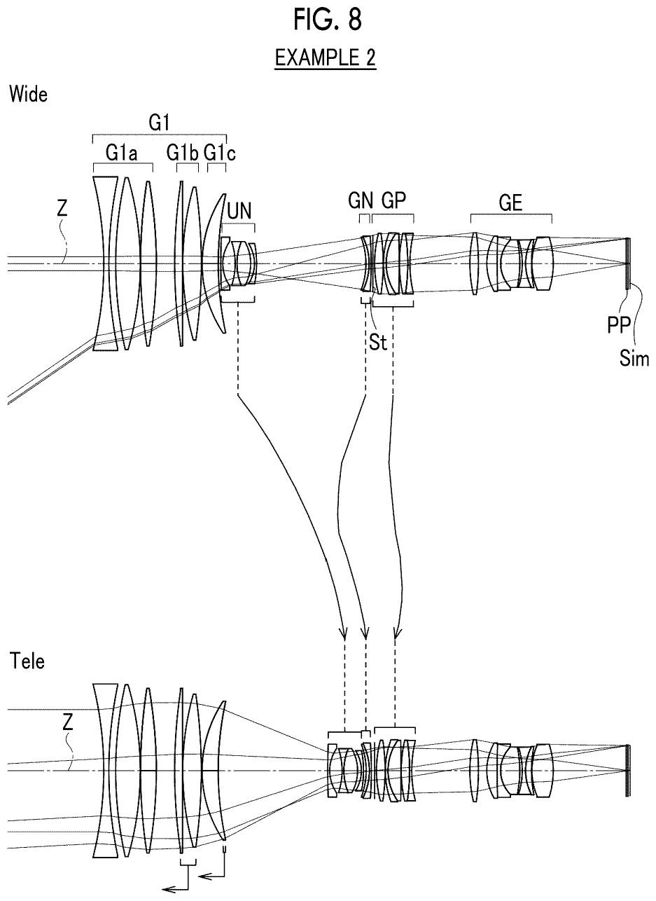

FIG. 8 shows a configuration and movement loci of the zoom lens according to Example 2. The zoom lens according to Example 2 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

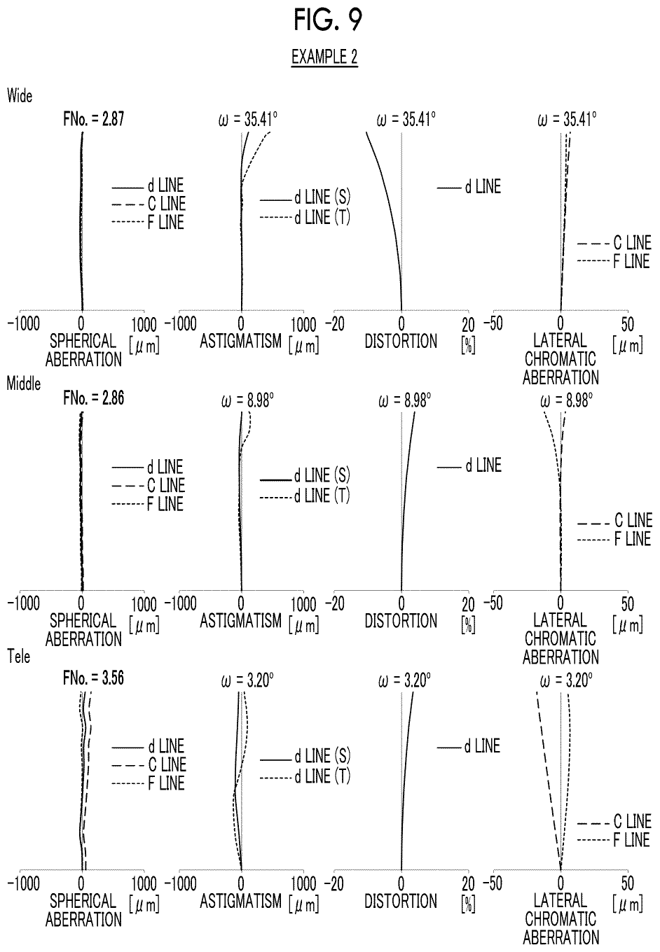

Regarding the zoom lens according to Example 2, Table 7 shows basic lens data, Table 8 shows specifications and variable surface spacings, and Table 9 shows aspherical coefficients thereof. FIG. 9 shows aberration diagrams thereof.

TABLE 7
Example 2

| Sn | R | D | Nd | vd | θg, F | SG | ED |
|---|---|---|---|---|---|---|---|
| 1 | −212.2050 | 2.8500 | 1.89119 | 38.88 | 0.57329 | 5.06 | 100.00 |
| 2 | 246.6254 | 3.8132 | | | | | 98.07 |
| 3 | 233.6185 | 13.6881 | 1.43387 | 95.18 | 0.53733 | 3.18 | 98.47 |
| 4 | −183.2698 | 0.1533 | | | | | 98.36 |
| 5 | 320.7024 | 8.7952 | 1.43700 | 95.10 | 0.53364 | 3.53 | 94.82 |
| *6 | −270.0468 | DD[6] | | | | | 94.72 |
| 7 | 324.3218 | 4.4051 | 1.43387 | 95.18 | 0.53733 | 3.18 | 91.37 |
| 8 | −48258.2421 | 0.1205 | | | | | 90.96 |
| 9 | 168.4365 | 10.3179 | 1.43387 | 95.18 | 0.53733 | 3.18 | 88.02 |
| 10 | −318.4977 | DD[10] | | | | | 87.69 |
| *11 | 73.9600 | 8.9764 | 1.59282 | 68.62 | 0.54414 | 4.13 | 80.00 |
| 12 | 193.4578 | DD[12] | | | | | 79.08 |
| 13 | 420.0354 | 1.1001 | 2.00069 | 25.46 | 0.61364 | 4.73 | 30.03 |
| 14 | 23.1839 | 6.9067 | | | | | 25.76 |
| 15 | −41.0181 | 1.0100 | 1.78035 | 50.62 | 0.55878 | 5.03 | 25.24 |
| 16 | 34.1886 | 7.6178 | 1.78469 | 23.84 | 0.61897 | 3.56 | 25.32 |
| 17 | −26.6476 | 2.1167 | | | | | 25.35 |
| 18 | −22.1201 | 1.1609 | 1.68649 | 59.63 | 0.55145 | 4.58 | 23.08 |
| *19 | −69.0940 | DD[19] | | | | | 23.14 |
| 20 | −43.8446 | 1.7903 | 1.84824 | 22.59 | 0.62881 | 3.65 | 30.10 |
| 21 | −35.6700 | 1.1154 | 1.60590 | 67.41 | 0.54405 | 4.18 | 30.52 |
| 22 | −225.4935 | DD[22] | | | | | 31.83 |
| 23(St) | ∞ | 1.0000 | | | | | 32.50 |
| 24 | 71.2284 | 4.8221 | 1.66858 | 61.35 | 0.55005 | 4.49 | 34.70 |
| *25 | −108.5076 | 0.1201 | | | | | 34.99 |
| 26 | 52.1321 | 1.5029 | 1.88142 | 31.35 | 0.59534 | 4.72 | 35.74 |
| 27 | 30.9878 | 7.2337 | 1.47602 | 87.15 | 0.53603 | 3.61 | 34.81 |
| 28 | −991.6822 | 0.1200 | | | | | 34.88 |
| 29 | 80.4886 | 4.6615 | 1.59349 | 67.00 | 0.53667 | 3.14 | 34.97 |
| 30 | −119.3197 | 1.2100 | 1.59270 | 35.31 | 0.59336 | 2.64 | 34.77 |
| 31 | 75.9760 | DD[31] | | | | | 34.16 |
| 32 | 81.3582 | 4.7653 | 1.84666 | 23.83 | 0.61603 | 5.51 | 35.67 |
| 33 | −134.7606 | 4.6672 | | | | | 35.55 |
| 34 | 32.8991 | 5.8531 | 1.48749 | 70.24 | 0.53007 | 2.46 | 31.81 |
| 35 | 1148.5073 | 1.8387 | 1.91082 | 35.25 | 0.58224 | 4.97 | 30.69 |
| 36 | 19.8353 | 10.6825 | 1.49246 | 80.63 | 0.53602 | 3.37 | 27.33 |
| 37 | −68.9180 | 1.3725 | | | | | 26.90 |
| 38 | −45.3094 | 1.8593 | 1.88300 | 40.76 | 0.56679 | 5.52 | 26.64 |
| 39 | 30.5195 | 3.2856 | 1.60788 | 62.95 | 0.54322 | 3.62 | 27.35 |
| 40 | 71.3233 | 0.2585 | | | | | 27.77 |
| 41 | 38.6356 | 11.8666 | 1.49928 | 80.09 | 0.53681 | 3.45 | 29.17 |
| 42 | −52.2377 | 40.6647 | | | | | 30.43 |
| 43 | ∞ | 1.0000 | 1.51633 | 64.14 | 0.53531 | 2.52 | 29.58 |
| 44 | ∞ | 1.1000 | | | | | 29.56 |

TABLE 8
Example 2

| Object | | | | | | |
|---|---|---|---|---|---|---|
| distance | | | | | | |
| Zooming | Infinity | | | Close range (0.91 m) | | |
| state | Wide | Middle | Tele | Wide | Middle | Tele |
| Zr | 1.00 | 3.88 | 11.00 | 1.00 | 3.88 | 11.00 |
| f | 22.81 | 88.47 | 250.79 | 26.21 | 117.73 | 261.28 |
| FNo. | 2.87 | 2.86 | 3.56 | 2.87 | 2.86 | 3.51 |
| 2ω[°] | 70.82 | 17.96 | 6.40 | 57.58 | 12.22 | 2.64 |
| DD[6] | 10.2126 | 10.2126 | 10.2126 | 0.9698 | 0.9698 | 0.9698 |
| DD[10] | 0.4536 | 0.4536 | 0.4536 | 0.4535 | 0.4535 | 0.4535 |
| DD[12] | 1.4315 | 44.8195 | 60.7212 | 10.6743 | 54.0622 | 69.9639 |
| DD[19] | 60.6510 | 2.3535 | 1.5135 | 60.6510 | 2.3535 | 1.5135 |
| DD[22] | 0.9305 | 17.2305 | 1.8283 | 0.9305 | 17.2305 | 1.8283 |
| DD[31] | 33.4183 | 32.0279 | 32.3683 | 33.4183 | 32.0279 | 32.3683 |
| IHw | 14.525 | | | | | |

TABLE 9

| Sn | 6 | 11 |
|---|---|---|
| KA | 1.000000000000000E+00 | 1.031064426166710E+00 |
| A4 | 6.073467532824110E−08 | 1.371842596699610E−08 |
| A6 | −1.385918494824520E−10 | −2.107062320909840E−10 |
| A8 | 3.718156877985170E−13 | 6.007524369373810E−13 |
| A10 | −5.493986366741920E−16 | −9.858139548586210E−16 |
| A12 | 4.996765677682700E−19 | 9.899367104182060E−19 |
| A14 | −2.858431153322430E−22 | −6.158847040969580E−22 |
| A16 | 1.005239447061690E−25 | 2.305395945192170E−25 |
| A18 | −1.992466066687110E−29 | −4.744932665592300E−29 |
| A20 | 1.709337692351000E−33 | 4.119202655935630E−33 |

| Sn | 19 |
|---|---|
| KA | 2.427150702483010E+00 |
| A3 | 2.640685218514100E−20 |
| A4 | −2.845289145409380E−06 |
| A5 | −1.792963719829360E−06 |
| A6 | 1.389780632389620E−07 |
| A7 | 1.874124089021620E−07 |
| A8 | −5.222477553890670E−08 |
| A9 | −1.368767646933710E−09 |
| A10 | 1.976032844568940E−09 |
| A11 | −1.317374385257300E−10 |
| A12 | −2.960619147243820E−11 |
| A13 | 3.569126149422890E−12 |
| A14 | 1.785164582592270E−13 |
| A15 | −3.825936898128540E−14 |
| A16 | 4.467481897992790E−17 |
| A17 | 1.915732646140740E−16 |
| A18 | −4.914684233805150E−18 |
| A19 | −3.715965141824530E−19 |
| A20 | 1.484828512811560E−20 |
| Sn | 25 |
| KA | 3.235812309977290E+00 |
| A4 | 1.844488127012060E−06 |
| A6 | 4.392872240188530E−09 |
| A8 | −7.992089695727370E−11 |
| A10 | 9.039124086396300E−13 |
| A12 | −6.443846267260440E−15 |
| A14 | 2.877181054253860E−17 |
| A16 | −7.815391704923860E−20 |
| A18 | 1.180843988462040E−22 |
| A20 | −7.609363386392900E−26 |

### Example 3

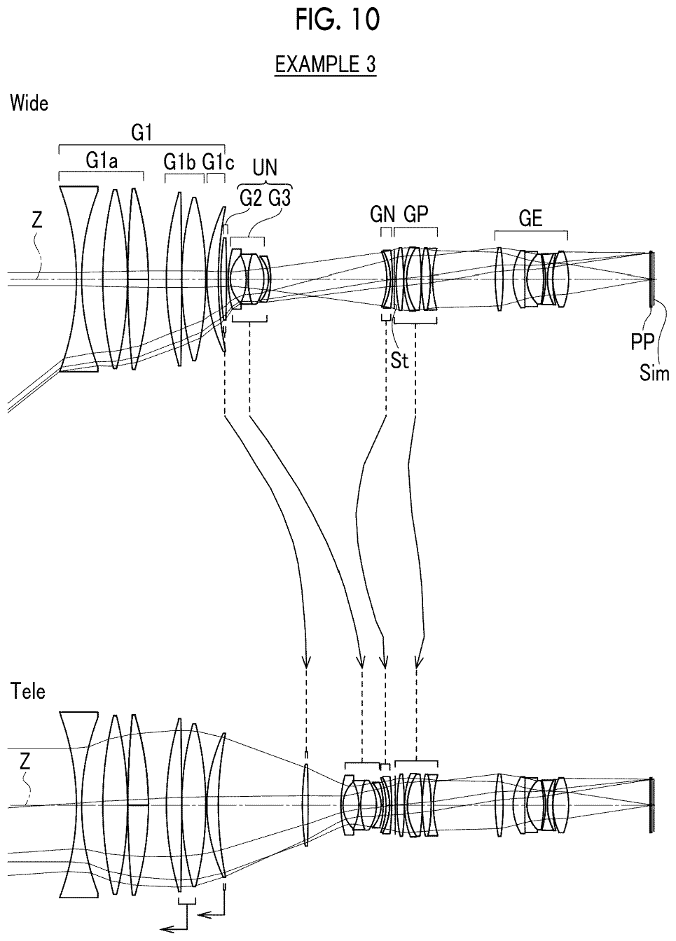

FIG. 10 shows a configuration and movement loci of the zoom lens according to Example 3. The zoom lens according to Example 3 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of two lens groups including a second lens group G2 that has a positive refractive power and a third lens group G3 that has a negative refractive power, in order from the object side to the image side.

During zooming from the wide angle end to the telephoto end, the first lens group G1 and the final lens group GE remain stationary with respect to the image plane Sim, and the second lens group G2, the third lens group G3, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

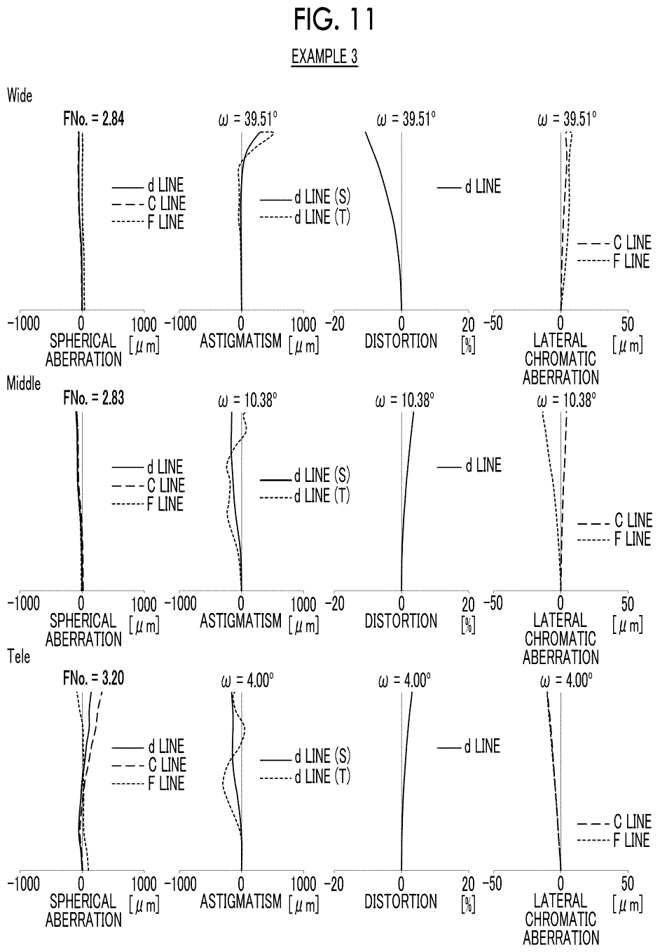

Regarding the zoom lens according to Example 3, Table 10 shows basic lens data, Table 11 shows specifications and variable surface spacings, and Table 12 shows aspherical coefficients thereof. FIG. 11 shows aberration diagrams thereof.

TABLE 10
Example 3

| Sn | R | D | Nd | vd | θg, F | SG | ED |
|---|---|---|---|---|---|---|---|
| 1 | −150.5085 | 2.7998 | 1.80440 | 39.61 | 0.57202 | 4.20 | 102.02 |
| 2 | 140.1179 | 11.3382 | | | | | 97.58 |
| 3 | 216.4804 | 13.2589 | 1.43387 | 95.18 | 0.53733 | 3.18 | 99.30 |
| 4 | −212.6906 | 0.2209 | | | | | 99.30 |
| 5 | 521.9937 | 10.9824 | 1.43700 | 95.10 | 0.53364 | 3.53 | 99.52 |
| *6 | −174.4431 | DD[6] | | | | | 99.50 |
| 7 | 173.6663 | 8.0922 | 1.43387 | 95.18 | 0.53733 | 3.18 | 94.18 |
| 8 | −3815.1665 | 0.1201 | | | | | 93.71 |
| 9 | 173.8662 | 12.9261 | 1.43387 | 95.18 | 0.53733 | 3.18 | 90.28 |
| 10 | −189.6761 | DD[10] | | | | | 89.95 |
| *11 | 91.7566 | 6.1290 | 1.59349 | 67.00 | 0.53667 | 3.14 | 80.00 |
| 12 | 208.3742 | DD[12] | | | | | 79.29 |
| 13 | 168.7386 | 3.0526 | 1.49700 | 81.54 | 0.53748 | 3.62 | 43.83 |
| 14 | −714.1840 | DD[14] | | | | | 42.86 |
| *15 | 63.4214 | 1.1000 | 2.00069 | 25.46 | 0.61364 | 4.73 | 32.17 |
| 16 | 18.1643 | 8.5182 | | | | | 26.06 |
| 17 | −29.8678 | 1.0000 | 1.79368 | 49.34 | 0.55982 | 5.09 | 26.04 |
| 18 | 44.5191 | 8.4519 | 1.78568 | 23.79 | 0.61902 | 3.56 | 26.46 |
| 19 | −24.9742 | 2.5130 | | | | | 26.65 |
| 20 | −18.8939 | 1.1002 | 1.59335 | 68.57 | 0.54418 | 4.13 | 24.57 |
| *21 | −47.6670 | DD[21] | | | | | 25.23 |
| 22 | −41.7333 | 1.9089 | 1.84900 | 22.55 | 0.62898 | 3.65 | 30.07 |
| 23 | −33.4756 | 1.1101 | 1.66415 | 61.98 | 0.54368 | 4.43 | 30.48 |
| 24 | −136.7030 | DD[24] | | | | | 31.75 |
| 25(St) | ∞ | 1.0000 | | | | | 32.50 |
| 26 | 87.5267 | 3.9576 | 1.80864 | 47.90 | 0.56098 | 5.16 | 34.28 |
| *27 | −135.5465 | 0.1201 | | | | | 34.49 |
| 28 | 50.1527 | 1.5259 | 1.88025 | 39.97 | 0.57058 | 4.98 | 35.21 |
| 29 | 33.1594 | 7.8709 | 1.43875 | 94.66 | 0.53402 | 3.59 | 34.41 |
| 30 | −127.7673 | 0.1200 | | | | | 34.47 |
| 31 | 92.9691 | 4.7707 | 1.69403 | 58.15 | 0.54206 | 3.98 | 34.26 |
| 32 | −84.6646 | 1.2000 | 1.70203 | 30.54 | 0.60243 | 2.99 | 33.97 |
| 33 | 61.5857 | DD[33] | | | | | 32.97 |
| 34 | 94.4896 | 4.1511 | 1.84666 | 23.83 | 0.61603 | 5.51 | 34.62 |
| 35 | −125.1752 | 5.3609 | | | | | 34.59 |
| 36 | 31.8026 | 6.3683 | 1.48749 | 70.24 | 0.53007 | 2.46 | 31.46 |
| 37 | 4443.5403 | 1.1035 | 1.91082 | 35.25 | 0.58224 | 4.97 | 30.22 |
| 38 | 19.3944 | 8.8654 | 1.49934 | 80.10 | 0.53683 | 3.45 | 27.35 |
| 39 | 69.8003 | 1.0610 | | | | | 27.28 |
| 40 | −50.0954 | 1.0010 | 1.88300 | 40.76 | 0.56679 | 5.52 | 27.13 |
| 41 | 30.2943 | 2.8383 | 1.59041 | 66.09 | 0.54215 | 3.62 | 27.93 |
| 42 | 61.4751 | 0.1202 | | | | | 28.31 |
| 43 | 35.9072 | 8.4523 | 1.48751 | 81.92 | 0.53598 | 3.39 | 30.03 |
| 44 | −44.9624 | 43.6922 | | | | | 30.60 |
| 45 | ∞ | 1.0000 | 1.51633 | 64.14 | 0.53531 | 2.52 | 30.55 |
| 46 | ∞ | 1.1000 | | | | | 30.55 |

TABLE 11
Example 3

| Object | | | | | | |
|---|---|---|---|---|---|---|
| distance | | | | | | |
| Zooming | Infinity | | | Close range (0.89 m) | | |
| state | Wide | Middle | Tele | Wide | Middle | Tele |
| Zr | 1.00 | 3.88 | 10.20 | 1.00 | 3.88 | 10.20 |
| f | 19.73 | 76.56 | 201.25 | 22.61 | 98.96 | 226.07 |
| FNo. | 2.84 | 2.83 | 3.20 | 2.84 | 2.83 | 3.35 |
| 2ω[°] | 79.02 | 20.76 | 8.00 | 64.94 | 15.62 | 4.56 |
| DD[6] | 9.6967 | 9.6967 | 9.6967 | 0.6037 | 0.6037 | 0.6037 |
| DD[10] | 0.5951 | 0.5951 | 0.5951 | 0.5954 | 0.5954 | 0.5954 |
| DD[12] | 1.3325 | 40.6346 | 45.0965 | 10.4252 | 49.7272 | 54.1891 |
| DD[14] | 0.9823 | 7.7421 | 17.3288 | 0.9823 | 7.7421 | 17.3288 |
| DD[21] | 62.0632 | 2.6863 | 1.5196 | 62.0632 | 2.6863 | 1.5196 |
| DD[24] | 0.9938 | 16.4471 | 1.8633 | 0.9938 | 16.4471 | 1.8633 |
| DD[33] | 33.6669 | 31.5287 | 33.2305 | 33.6669 | 31.5287 | 33.2305 |
| IHw | 14.525 | | | | | |

TABLE 12
Example 3

| Sn | 6 | 11 |
|---|---|---|
| KA | 1.000000000000000E+00 | 1.951428652621040E−01 |
| A4 | 1.334057503509990E−07 | 1.210545398724190E−07 |
| A6 | −6.372920117660790E−10 | −5.860880059297110E−10 |
| A8 | 1.542458349135190E−12 | 1.431466871563280E−12 |
| A10 | −2.190017077295270E−15 | −2.067113741439800E−15 |
| A12 | 1.960881356439260E−18 | 1.833845892722160E−18 |
| A14 | −1.120010161671760E−21 | −1.008575901295470E−21 |
| A16 | 3.964244169250820E−25 | 3.319298137735180E−25 |
| A18 | −7.936823390283900E−29 | −5.937316409387840E−29 |
| A20 | 6.883222222723480E−33 | 4.415330683415180E−33 |
| Sn | 15 | 27 |
| KA | 1.554745612658700E+00 | 3.677796987462700E+00 |
| A4 | 6.303632680163790E−07 | 1.756249264715240E−06 |
| A6 | −2.273392893653320E−08 | 1.055566516605250E−09 |
| A8 | 3.425733039463420E−10 | −3.438926968287700E−11 |
| A10 | −3.605436344889460E−12 | 4.919723470066800E−13 |
| A12 | 2.657307123002790E−14 | −3.957840992063700E−15 |
| A14 | −1.363721275799310E−16 | 1.890187590721110E−17 |
| A16 | 4.628654158922970E−19 | −5.333122987841840E−20 |
| A18 | −9.236708716745750E−22 | 8.215920785810330E−23 |
| A20 | 8.109699612558310E−25 | −5.329782067222000E−26 |

| Sn | 21 |
|---|---|
| KA | 5.567474915921330E+00 |
| A3 | 7.555126230901230E−20 |
| A4 | −5.539357485305850E−06 |
| A5 | 1.943399544012530E−06 |
| A6 | −1.206052290176850E−06 |
| A7 | 2.895329691484790E−07 |
| A8 | −2.687225404032040E−09 |
| A9 | −1.104048921354790E−08 |
| A10 | 1.441419390322220E−09 |
| A11 | 1.059418829108940E−10 |
| A12 | −3.234113301544670E−11 |
| A13 | 6.380647647125440E−13 |
| A14 | 2.932536615913270E−13 |
| A15 | −1.818340370851010E−14 |
| A16 | −1.042897716347050E−15 |
| A17 | 1.180928224519040E−16 |
| A18 | −2.542159466900190E−19 |
| A19 | −2.584828073993580E−19 |
| A20 | 6.989056795658000E−21 |

### Example 4

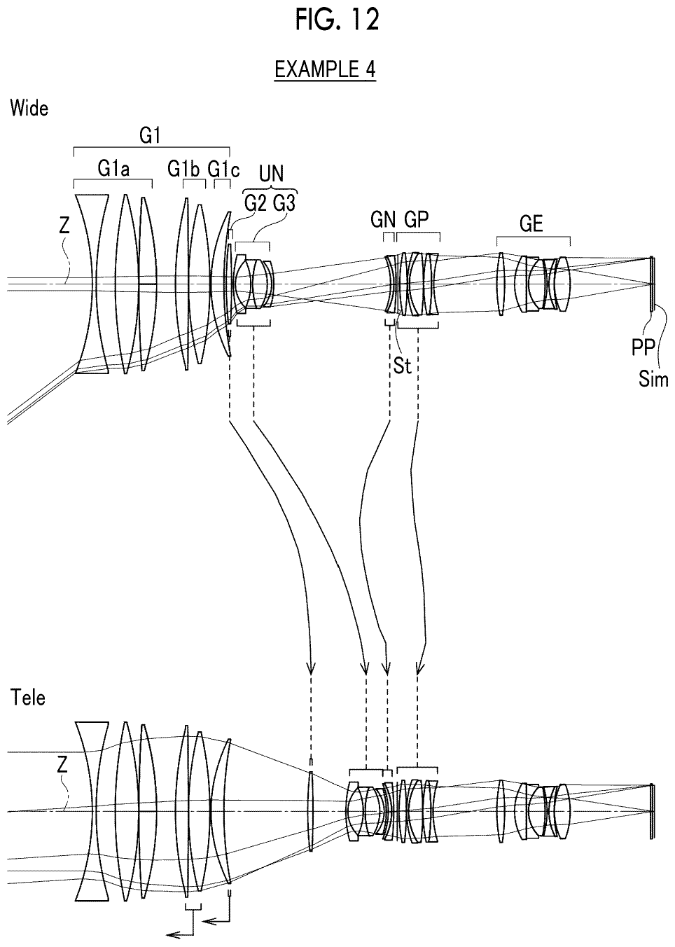

FIG. 12 shows a configuration and movement loci of the zoom lens according to Example 4. The zoom lens according to Example 4 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of two lens groups including a second lens group G2 that has a positive refractive power and a third lens group G3 that has a negative refractive power, in order from the object side to the image side.

During zooming from the wide angle end to the telephoto end, the first lens group G1 and the final lens group GE remain stationary with respect to the image plane Sim, and the second lens group G2, the third lens group G3, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

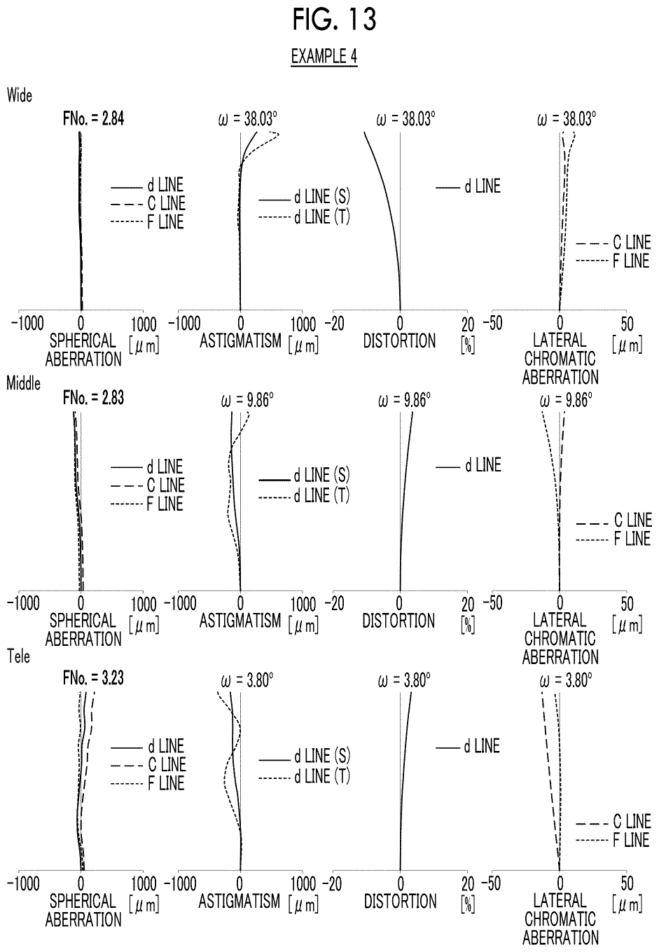

Regarding the zoom lens according to Example 4, Table 13 shows basic lens data, Table 14 shows specifications and variable surface spacings, and Table 15 shows aspherical coefficients thereof. FIG. 13 shows aberration diagrams thereof.

TABLE 13
Example 4

| Sn | R | D | Nd | vd | θg, F | SG | ED |
|---|---|---|---|---|---|---|---|
| 1 | −139.6041 | 2.0801 | 1.80440 | 39.61 | 0.57202 | 4.20 | 99.20 |
| 2 | 180.2125 | 10.2310 | | | | | 96.25 |
| 3 | 245.6058 | 12.5246 | 1.43387 | 95.18 | 0.53733 | 3.18 | 97.63 |
| 4 | −194.6909 | 0.1202 | | | | | 97.66 |
| 5 | 705.4507 | 9.5327 | 1.43700 | 95.10 | 0.53364 | 3.53 | 96.10 |
| *6 | −173.8276 | DD[6] | | | | | 96.04 |
| 7 | 197.2665 | 6.8766 | 1.43387 | 95.18 | 0.53733 | 3.18 | 91.51 |
| 8 | 4107.4361 | 0.1201 | | | | | 91.06 |
| 9 | 186.5524 | 11.4893 | 1.43387 | 95.18 | 0.53733 | 3.18 | 88.00 |
| 10 | −205.2818 | DD[10] | | | | | 87.74 |
| *11 | 87.6673 | 6.8845 | 1.59349 | 67.00 | 0.53667 | 3.14 | 80.00 |
| 12 | 219.3533 | DD[12] | | | | | 79.29 |
| 13 | 208.8117 | 2.8052 | 1.49700 | 81.54 | 0.53748 | 3.62 | 44.08 |
| 14 | −488.9367 | DD[14] | | | | | 43.38 |
| *15 | 65.0366 | 1.1001 | 2.00069 | 25.46 | 0.61364 | 4.73 | 32.51 |
| 16 | 18.6502 | 8.2349 | | | | | 26.49 |
| 17 | −31.8668 | 1.0101 | 1.78150 | 50.51 | 0.55887 | 5.03 | 26.64 |
| 18 | 44.2340 | 7.8523 | 1.78951 | 23.61 | 0.62035 | 3.58 | 26.88 |
| 19 | −25.8860 | 2.3612 | | | | | 26.95 |
| 20 | −19.5678 | 1.1001 | 1.63702 | 64.38 | 0.54759 | 4.34 | 24.76 |
| *21 | −50.5663 | DD[21] | | | | | 25.25 |
| 22 | −40.4176 | 1.8138 | 1.84892 | 22.55 | 0.62896 | 3.65 | 30.07 |
| 23 | −33.3219 | 1.1102 | 1.61947 | 66.14 | 0.54397 | 4.24 | 30.49 |
| 24 | −149.3467 | DD[24] | | | | | 31.77 |
| 25(St) | ∞ | 1.0000 | | | | | 32.50 |
| 26 | 89.6281 | 3.9445 | 1.83876 | 45.01 | 0.56333 | 5.31 | 34.26 |
| *27 | −132.7316 | 0.1201 | | | | | 34.47 |
| 28 | 53.5976 | 1.1002 | 1.78796 | 34.44 | 0.58868 | 4.02 | 34.95 |
| 29 | 32.7278 | 7.5216 | 1.44750 | 92.90 | 0.53449 | 3.59 | 34.24 |
| 30 | −157.2485 | 0.1200 | | | | | 34.22 |
| 31 | 83.5681 | 4.2474 | 1.68201 | 58.74 | 0.54216 | 3.95 | 34.00 |
| 32 | −126.2904 | 1.2000 | 1.69002 | 29.32 | 0.60611 | 3.01 | 33.72 |
| 33 | 58.2414 | DD[33] | | | | | 32.77 |
| 34 | 88.9491 | 4.1511 | 1.84666 | 23.83 | 0.61603 | 5.51 | 34.48 |
| 35 | −125.1752 | 5.3609 | | | | | 34.43 |
| 36 | 31.8026 | 6.3683 | 1.48749 | 70.24 | 0.53007 | 2.46 | 31.09 |
| 37 | 4443.5403 | 1.1035 | 1.91082 | 35.25 | 0.58224 | 4.97 | 29.77 |
| 38 | 19.3944 | 8.8654 | 1.49135 | 81.33 | 0.53632 | 3.42 | 26.93 |
| 39 | −69.8003 | 1.0610 | | | | | 26.81 |
| 40 | −50.0954 | 1.0010 | 1.88300 | 40.76 | 0.56679 | 5.52 | 26.66 |
| 41 | 30.2943 | 2.8383 | 1.54688 | 72.79 | 0.53955 | 3.57 | 27.34 |
| 42 | 61.4751 | 0.1202 | | | | | 27.78 |
| 43 | 35.9072 | 8.4523 | 1.48750 | 81.92 | 0.53598 | 3.39 | 29.37 |
| 44 | −44.9624 | 43.0301 | | | | | 30.01 |
| 45 | ∞ | 1.0000 | 1.51633 | 64.14 | 0.53531 | 2.52 | 30.37 |
| 46 | ∞ | 1.1000 | | | | | 30.38 |

TABLE 14
Example 4

| Object | | | | | | |
|---|---|---|---|---|---|---|
| distance | | | | | | |
| Zooming | Infinity | | | Close range (0.90 m) | | |
| state | Wide | Middle | Tele | Wide | Middle | Tele |
| Zr | 1.00 | 3.88 | 10.20 | 1.00 | 3.88 | 10.20 |
| f | 20.78 | 80.62 | 211.93 | 23.94 | 104.93 | 229.37 |
| FNo. | 2.84 | 2.83 | 3.23 | 2.84 | 2.84 | 3.39 |
| 2ω[°] | 76.06 | 19.72 | 7.60 | 62.08 | 14.50 | 4.18 |
| DD[6] | 10.0957 | 10.0957 | 10.0957 | 0.6019 | 0.6019 | 0.6019 |
| DD[10] | 0.5825 | 0.5825 | 0.5825 | 0.5855 | 0.5855 | 0.5855 |
| DD[12] | 1.2905 | 40.4144 | 44.9500 | 10.7814 | 49.9052 | 54.4408 |
| DD[14] | 0.9805 | 7.7402 | 17.3269 | 0.9805 | 7.7402 | 17.3269 |
| DD[21] | 62.3385 | 2.9955 | 1.0770 | 62.3385 | 2.9955 | 1.0770 |
| DD[24] | 0.9908 | 16.4440 | 1.8603 | 0.9908 | 16.4440 | 1.8603 |
| DD[33] | 33.7761 | 31.7823 | 34.1622 | 33.7761 | 31.7823 | 34.1622 |
| IHw | 14.525 | | | | | |

TABLE 15
Example 4

| Sn | 6 | 11 |
|---|---|---|
| KA | 1.000000000000000E+00 | 3.778832506144200E−01 |
| A4 | 1.284367110963340E−07 | 1.042795894849040E−07 |
| A6 | −5.581167860030040E−10 | −4.685869409575560E−10 |
| A8 | 1.344316497928210E−12 | 1.062228047793000E−12 |
| A10 | −1.948558006715410E−15 | −1.423672030076010E−15 |
| A12 | 1.821946598497980E−18 | 1.172242685386470E−18 |
| A14 | −1.107217926551360E−21 | −5.983735627299060E−22 |
| A16 | 4.229550483437630E−25 | 1.827760082836770E−25 |
| A18 | −9.226782688817930E−29 | −3.034395849525290E−29 |
| A20 | 8.761770593837450E−33 | 2.094374748153400E−33 |
| Sn | 15 | 27 |
| KA | 5.951593782398790E−01 | 3.883716276938090E+00 |
| A4 | 6.330393579811990E−07 | 1.691635514111080E−06 |
| A6 | −2.287885147336640E−08 | 9.978529915267380E−10 |
| A8 | 3.454881404798510E−10 | −3.190540268461180E−11 |
| A10 | −3.643823790795270E−12 | 4.479631493097790E−13 |
| A12 | 2.691294310653190E−14 | −3.536879455445750E−15 |
| A14 | −1.384092019861100E−16 | 1.657780943797580E−17 |
| A16 | 4.707756461796700E−19 | −4.590543994776590E−20 |
| A18 | −9.414481592877000E−22 | 6.940633586375990E−23 |
| A20 | 8.283308520489800E−25 | −4.418884444716090E−26 |

| Sn | 21 |
|---|---|
| KA | 5.884819327048410E+00 |
| A3 | 7.471499419718870E−20 |
| A4 | −5.457756007112430E−06 |
| A5 | 1.907679883367040E−06 |
| A6 | −1.179500751615780E−06 |
| A7 | 2.821102001296100E−07 |
| A8 | −2.608636353368960E−09 |
| A9 | −1.067791462627670E−08 |
| A10 | 1.388919793627120E−09 |
| A11 | 1.017052040000660E−10 |
| A12 | −3.093281179112120E−11 |
| A13 | 6.080196455874050E−13 |
| A14 | 2.784100917524910E−13 |
| A15 | −1.719908693711510E−14 |
| A16 | −9.827897262912970E−16 |
| A17 | 1.108743468877040E−16 |
| A18 | −2.377929872651550E−19 |
| A19 | −2.408887929624620E−19 |
| A20 | 6.489215307614980E−21 |

### Example 5

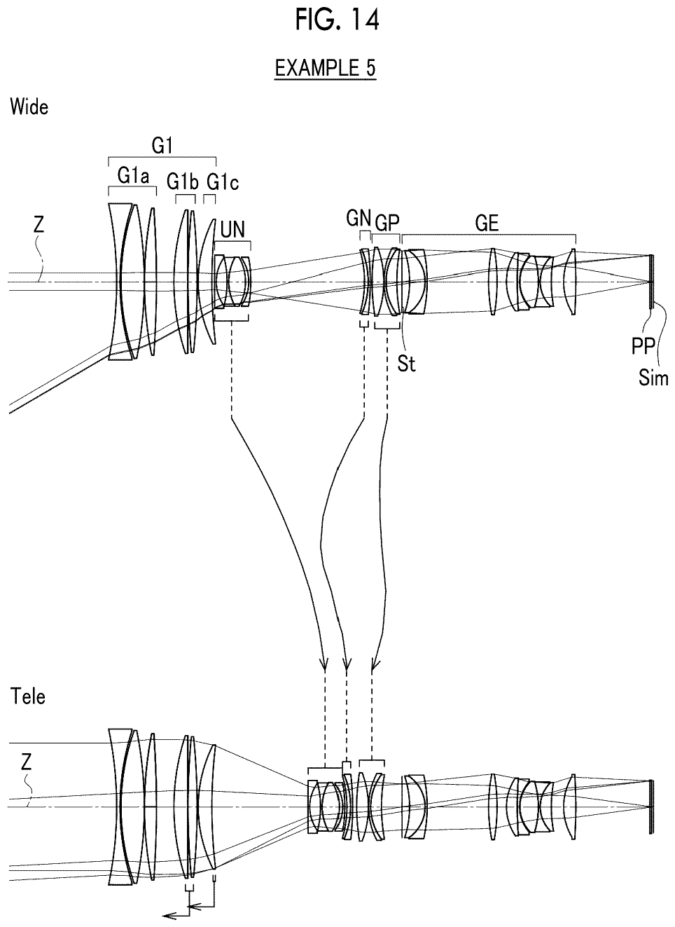

FIG. 14 shows a configuration and movement loci of the zoom lens according to Example 5. The zoom lens according to Example 5 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

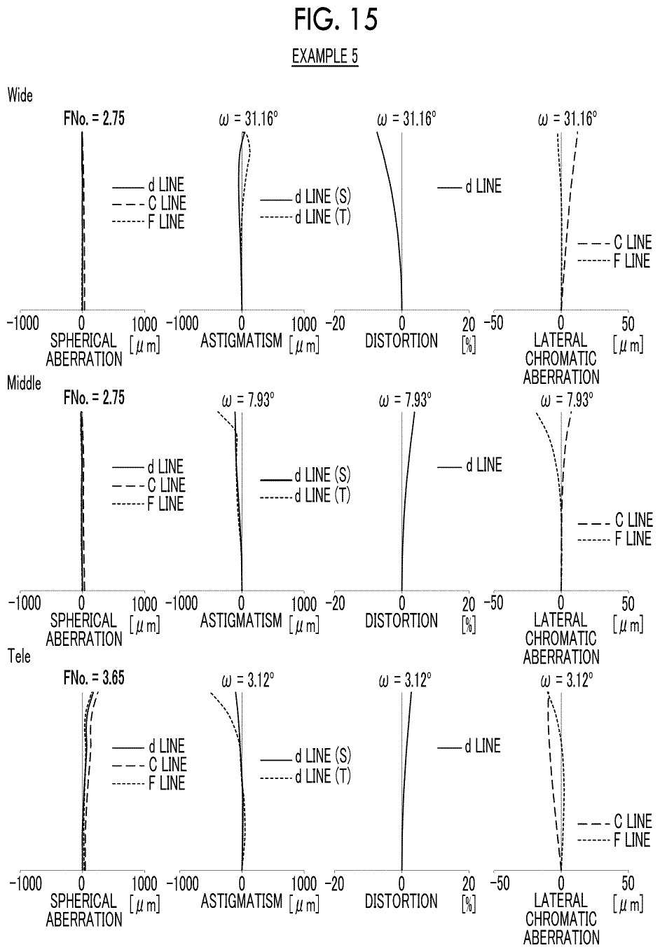

Regarding the zoom lens according to Example 5, Table 16 shows basic lens data, Table 17 shows specifications and variable surface spacings, and Table 18 shows aspherical coefficients thereof. FIG. 15 shows aberration diagrams thereof.

TABLE 16
Example 5

| Sn | R | D | Nd | vd | θg, F | SG | ED |
|---|---|---|---|---|---|---|---|
| 1 | −218.2979 | 1.8001 | 1.67300 | 38.26 | 0.57580 | 3.01 | 86.65 |
| 2 | 141.8167 | 0.5601 | | | | | 84.24 |
| 3 | 131.4841 | 12.5000 | 1.43387 | 95.18 | 0.53733 | 3.18 | 84.34 |
| 4 | −223.5308 | 0.1200 | | | | | 84.18 |
| 5 | 215.8205 | 6.4687 | 1.43700 | 95.10 | 0.53364 | 3.53 | 81.60 |
| *6 | −502.5963 | DD[6] | | | | | 81.50 |
| 7 | 130.9975 | 7.4955 | 1.43387 | 95.18 | 0.53733 | 3.18 | 79.47 |
| 8 | −24818.5810 | 0.1200 | | | | | 79.06 |
| 9 | 436.6592 | 4.8755 | 1.43387 | 95.18 | 0.53733 | 3.18 | 78.20 |
| 10 | −393.3624 | DD[10] | | | | | 77.81 |
| *11 | 78.0847 | 7.3525 | 1.59349 | 67.00 | 0.53667 | 3.14 | 69.05 |
| 12 | 302.9443 | DD[12] | | | | | 68.01 |
| 13 | 2713.9983 | 0.9000 | 1.94413 | 31.47 | 0.59324 | 5.23 | 29.34 |
| 14 | 23.0488 | 5.8137 | | | | | 25.95 |
| 15 | −55.2611 | 0.9098 | 1.84850 | 43.79 | 0.56197 | 5.08 | 25.91 |
| 16 | 28.3355 | 8.9811 | 1.85451 | 25.15 | 0.61031 | 3.48 | 26.77 |
| 17 | −27.9242 | 1.7692 | | | | | 27.07 |
| 18 | −23.4996 | 1.1002 | 1.82055 | 46.76 | 0.56191 | 5.22 | 25.99 |
| *19 | −89.4268 | DD[19] | | | | | 26.93 |
| 20 | −63.1487 | 1.9773 | 1.89999 | 20.00 | 0.64193 | 3.55 | 34.74 |
| 21 | −47.4828 | 1.1102 | 1.81524 | 47.27 | 0.56150 | 5.20 | 35.11 |
| 22 | 158.1125 | DD[22] | | | | | 36.25 |
| *23 | 107.6130 | 6.3225 | 1.59349 | 67.00 | 0.53667 | 3.14 | 37.70 |
| 24 | −55.5327 | 0.1198 | | | | | 37.99 |
| 25 | 41.3989 | 1.1000 | 1.90000 | 20.00 | 0.64194 | 3.55 | 37.17 |
| 26 | 30.6833 | 5.8172 | 1.52563 | 77.14 | 0.53871 | 3.63 | 35.93 |
| 27 | 100.5512 | DD[27] | | | | | 35.47 |
| 28(St) | ∞ | 4.0714 | | | | | 34.15 |
| 29 | −56.8207 | 8.3524 | 1.53079 | 76.10 | 0.53898 | 3.64 | 33.96 |
| 30 | −21.1516 | 1.1102 | 1.53467 | 62.39 | 0.53937 | 2.80 | 34.25 |
| 31 | −86.0987 | 33.0647 | | | | | 35.34 |
| 32 | 98.3988 | 4.5561 | 1.84666 | 23.83 | 0.61603 | 5.51 | 36.50 |
| 33 | −112.2883 | 5.0637 | | | | | 36.43 |
| 34 | 29.3486 | 5.8432 | 1.48749 | 70.24 | 0.53007 | 2.46 | 32.11 |
| 35 | 223.9626 | 1.2132 | 1.93231 | 34.77 | 0.58374 | 5.30 | 31.05 |
| 36 | 21.5953 | 0.1731 | | | | | 27.94 |
| 37 | 20.1896 | 9.9354 | 1.51860 | 69.89 | 0.53184 | 2.60 | 28.44 |
| 38 | −49.4725 | 1.0055 | 1.89548 | 37.97 | 0.57568 | 5.11 | 27.71 |
| 39 | 19.1795 | 5.9629 | 1.52049 | 76.85 | 0.53809 | 3.51 | 26.43 |
| 40 | 75.9736 | 6.6455 | | | | | 26.97 |
| 41 | 34.1796 | 6.5378 | 1.54569 | 46.43 | 0.56739 | 2.47 | 33.63 |
| 42 | −300.2075 | 39.7514 | | | | | 33.59 |
| 43 | ∞ | 1.0000 | 1.51633 | 64.14 | 0.53531 | 2.52 | 29.66 |
| 44 | ∞ | 1.1000 | | | | | 29.59 |

TABLE 17
Example 5

| Object | | | | | | |
|---|---|---|---|---|---|---|
| distance | | | | | | |
| Zooming | Infinity | | | Close range (0.91 m) | | |
| state | Wide | Middle | Tele | Wide | Middle | Tele |
| Zr | 1.00 | 3.88 | 10.00 | 1.00 | 3.88 | 10.00 |
| f | 25.93 | 100.54 | 259.10 | 29.79 | 134.89 | 293.21 |
| FNo. | 2.75 | 2.75 | 3.65 | 2.75 | 2.75 | 4.01 |
| 2ω[°] | 62.32 | 15.86 | 6.24 | 50.96 | 10.40 | 2.04 |
| DD[6] | 9.3668 | 9.3668 | 9.3668 | 0.5960 | 0.5960 | 0.5960 |
| DD[10] | 0.5922 | 0.5922 | 0.5922 | 1.3390 | 1.3390 | 1.3390 |
| DD[12] | 1.4668 | 39.5524 | 51.7472 | 9.4908 | 47.5764 | 59.7712 |
| DD[19] | 60.8985 | 1.1631 | 1.1590 | 60.8985 | 1.1631 | 1.1590 |
| DD[22] | 0.9798 | 20.6507 | 2.1504 | 0.9798 | 20.6507 | 2.1504 |
| DD[27] | 2.7576 | 4.7365 | 11.0460 | 2.7576 | 4.7365 | 11.0460 |
| IHw | 14.525 | | | | | |

TABLE 18
Example 5

| Sn | 6 | 11 |
|---|---|---|
| KA | 1.000000000000000E+00 | 8.938634643142070E−01 |
| A4 | 1.027468313332980E−07 | 5.480695905853370E−10 |
| A6 | −1.090977969026560E−10 | −9.187839556203020E−11 |
| A8 | 3.188282132213550E−13 | 2.847904630135890E−13 |
| A10 | −5.365165109964490E−16 | −5.216067288691420E−16 |
| A12 | 5.702341539179590E−19 | 5.661262315985210E−19 |
| A14 | −3.816543676514370E−22 | −3.387152531842570E−22 |
| A16 | 1.552990079034630E−25 | 8.544470626561310E−26 |
| A18 | −3.502927447196330E−29 | 5.786158909429280E−30 |
| A20 | 3.355687093560180E−33 | −4.911652479283580E−33 |
| Sn | 19 | 23 |
| KA | 1.376437308240820E+01 | 5.196181938126980E+00 |
| A4 | −4.381710617116340E−06 | −2.158575355137830E−06 |
| A6 | 1.509193247980230E−08 | 1.405841111098040E−11 |
| A8 | −5.287339649323290E−10 | 1.286323547978050E−11 |
| A10 | 1.033787213257430E−11 | −1.652414177964320E−13 |
| A12 | −1.299915864293500E−13 | 1.146227805920980E−15 |
| A14 | 1.025691822239780E−15 | −4.665517981468110E−18 |
| A16 | −4.891043039249290E−18 | 1.114474738174650E−20 |
| A18 | 1.284391690087030E−20 | −1.447918119482920E−23 |
| A20 | −1.422968040580030E−23 | 7.905680890799740E−27 |

### Example 6

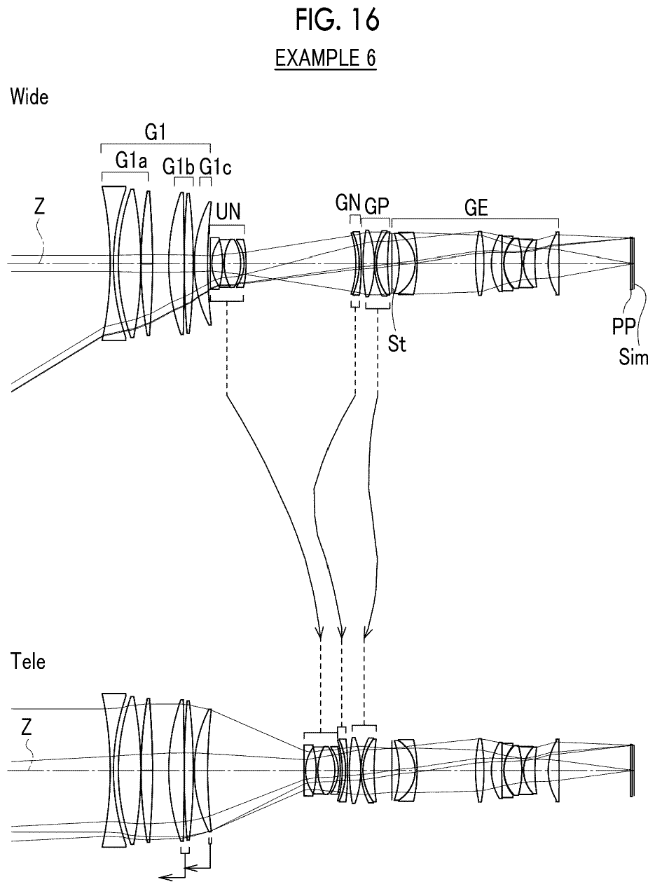

FIG. 16 shows a configuration and movement loci of the zoom lens according to Example 6. The zoom lens according to Example 6 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

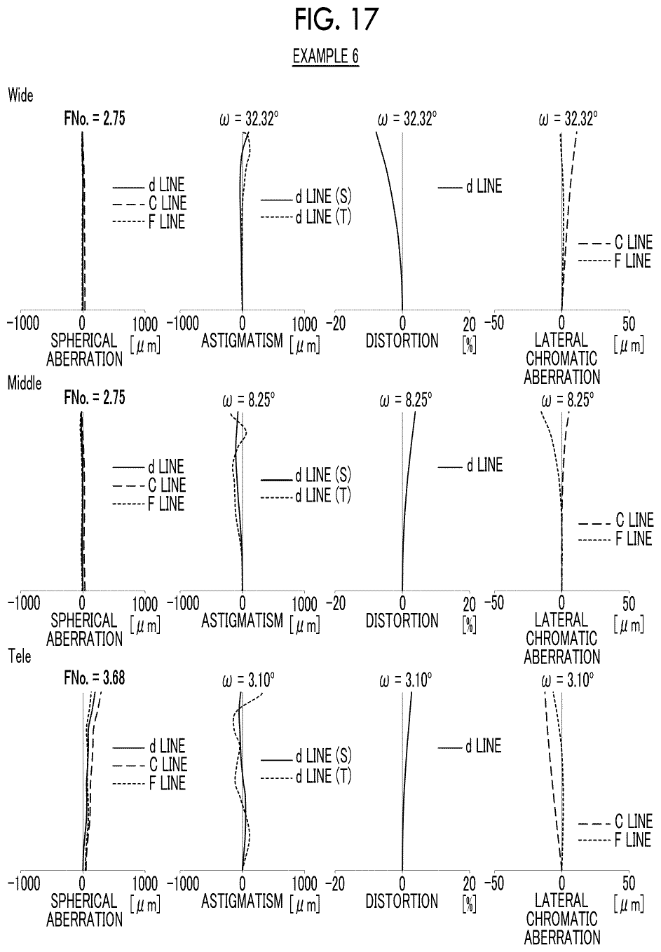

Regarding the zoom lens according to Example 6, Table 19 shows basic lens data, Table 20 shows specifications and variable surface spacings, and Table 21 shows aspherical coefficients thereof. FIG. 17 shows aberration diagrams thereof.

TABLE 19
Example 6

| Sn | R | D | Nd | vd | θg, F | SG | ED |
|---|---|---|---|---|---|---|---|
| 1 | −218.7981 | 1.8001 | 1.67300 | 38.26 | 0.57580 | 3.01 | 88.46 |
| 2 | 134.9775 | 2.7248 | | | | | 85.04 |
| 3 | 133.0591 | 12.5162 | 1.43387 | 95.18 | 0.53733 | 3.18 | 85.13 |
| 4 | −228.7675 | 0.1203 | | | | | 84.85 |
| 5 | 249.5704 | 6.4243 | 1.43700 | 95.10 | 0.53364 | 3.53 | 82.87 |
| *6 | −432.6464 | DD[6] | | | | | 82.82 |
| 7 | 126.3212 | 8.5032 | 1.43387 | 95.18 | 0.53733 | 3.18 | 81.51 |
| 8 | −2092.1575 | 0.1201 | | | | | 81.14 |
| 9 | 508.7453 | 5.0222 | 1.43387 | 95.18 | 0.53733 | 3.18 | 80.26 |
| 10 | −358.8060 | DD[10] | | | | | 79.86 |
| *11 | 79.9433 | 7.4121 | 1.59349 | 67.00 | 0.53667 | 3.14 | 70.62 |
| 12 | 299.8943 | DD[12] | | | | | 69.58 |
| 13 | 1620.7566 | 0.9000 | 1.97560 | 30.43 | 0.59585 | 5.33 | 29.43 |
| 14 | 22.8455 | 5.9324 | | | | | 26.04 |
| 15 | −54.1009 | 0.9102 | 1.84850 | 43.79 | 0.56197 | 5.08 | 26.01 |
| 16 | 28.5202 | 9.2182 | 1.85451 | 25.15 | 0.61031 | 3.48 | 27.08 |
| 17 | −27.4046 | 1.8600 | | | | | 27.45 |
| 18 | −23.1652 | 1.1000 | 1.81048 | 47.73 | 0.56113 | 5.17 | 26.32 |
| *19 | −80.1866 | DD[19] | | | | | 27.35 |
| 20 | −58.1865 | 1.9022 | 1.90000 | 20.12 | 0.64124 | 3.57 | 34.58 |
| 21 | −45.4676 | 1.1112 | 1.76582 | 52.01 | 0.55764 | 4.96 | 34.97 |
| 22 | −162.3253 | DD[22] | | | | | 36.18 |
| *23 | 103.3884 | 6.3258 | 1.59349 | 67.00 | 0.53667 | 3.14 | 37.70 |
| 24 | −56.7041 | 0.1202 | | | | | 37.99 |
| 25 | 43.7313 | 1.1000 | 1.90000 | 20.00 | 0.64194 | 3.55 | 37.35 |
| 26 | 31.2466 | 6.1542 | 1.52761 | 76.75 | 0.53881 | 3.63 | 36.11 |
| 27 | 132.3344 | DD[27] | | | | | 35.70 |
| 28(St) | ∞ | 4.1061 | | | | | 34.17 |
| 29 | −54.7858 | 8.8608 | 1.53149 | 75.96 | 0.53902 | 3.64 | 33.99 |
| 30 | −20.6153 | 1.1102 | 1.53452 | 62.76 | 0.53886 | 2.80 | 34.33 |
| 31 | −79.2630 | 32.5221 | | | | | 35.55 |
| 32 | 90.7320 | 4.6932 | 1.84666 | 23.83 | 0.61603 | 5.51 | 36.50 |
| 33 | −113.8737 | 4.1538 | | | | | 36.41 |
| 34 | 31.6375 | 5.7743 | 1.48749 | 70.24 | 0.53007 | 2.46 | 32.26 |
| 35 | 468.6795 | 1.1000 | 1.88333 | 39.66 | 0.57136 | 5.00 | 31.21 |
| 36 | 22.0435 | 0.1415 | | | | | 28.14 |
| 37 | 20.5404 | 9.9374 | 1.51860 | 69.89 | 0.53184 | 2.60 | 28.53 |
| 38 | −54.2716 | 1.0001 | 1.91472 | 36.49 | 0.57933 | 5.21 | 27.67 |
| 39 | 19.4231 | 6.2945 | 1.52055 | 76.84 | 0.53809 | 3.52 | 26.31 |
| 40 | 94.2321 | 7.3940 | | | | | 26.89 |
| 41 | 33.9190 | 6.0120 | 1.53517 | 70.27 | 0.53660 | 3.25 | 33.32 |
| 42 | −3414.4267 | 39.7490 | | | | | 33.24 |
| 43 | ∞ | 1.0000 | 1.51633 | 64.14 | 0.53531 | 2.52 | 29.87 |
| 44 | ∞ | 1.1000 | | | | | 29.82 |

TABLE 20
Example 6

| Object | | | | | | |
|---|---|---|---|---|---|---|
| distance | | | | | | |
| Zooming | Infinity | | | Close range (0.91 m) | | |
| state | Wide | Middle | Tele | Wide | Middle | Tele |
| Zr | 1.00 | 3.88 | 10.50 | 1.00 | 3.88 | 10.50 |
| f | 24.89 | 96.53 | 261.22 | 28.50 | 128.19 | 286.29 |
| FNo. | 2.75 | 2.75 | 3.68 | 2.75 | 2.75 | 4.04 |
| 2ω[°] | 64.64 | 16.50 | 6.20 | 52.92 | 11.04 | 2.06 |
| DD[6] | 9.0115 | 9.0115 | 9.0115 | 0.5994 | 0.5994 | 0.5994 |
| DD[10] | 0.5954 | 0.5954 | 0.5954 | 0.9277 | 0.9277 | 0.9277 |
| DD[12] | 1.4548 | 40.4951 | 53.6495 | 9.5346 | 48.5748 | 61.7292 |
| DD[19] | 60.9067 | 1.1291 | 1.1292 | 60.9067 | 1.1291 | 1.1292 |
| DD[22] | 0.9795 | 19.8708 | 0.9795 | 0.9795 | 19.8708 | 0.9795 |
| DD[27] | 2.3458 | 4.1919 | 9.9286 | 2.3458 | 4.1919 | 9.9286 |
| IHw | 14.525 | | | | | |

TABLE 21
Example 6

| Sn | 6 | 11 |
|---|---|---|
| KA | 1.000000000000000E+00 | 8.896534810075720E−01 |
| A4 | 9.824310493982790E−08 | −8.824486139962660E−09 |
| A6 | −1.577019772477670E−10 | −7.356804102767040E−11 |
| A8 | 5.682696624781630E−13 | 3.487336317853410E−13 |
| A10 | −1.075561304881130E−15 | −8.029916762117260E−16 |
| A12 | 1.199668666169510E−18 | 1.021976640762970E−18 |
| A14 | −8.043882939905800E−22 | −7.387442898388520E−22 |
| A16 | 3.157533490701130E−25 | 2.890729788171360E−25 |
| A18 | −6.593793268228650E−29 | −5.164214019791580E−29 |
| A20 | 5.522282075186550E−33 | 2.129131983622650E−33 |

| Sn | 19 | 23 |
|---|---|---|
| KA | 1.349730112547840E+01 | 4.795070325555810E+00 |
| A4 | −4.025790276912200E−06 | −2.126874212194400E−06 |
| A6 | 3.820589213640420E−08 | 1.374985524768440E−11 |
| A8 | −1.368172912503050E−09 | 1.248818726688780E−11 |
| A10 | 2.760219275551080E−11 | −1.592411813327520E−13 |
| A12 | −3.444111352839200E−13 | 1.096464848894710E−15 |
| A14 | 2.681660102216870E−15 | −4.430073553231070E−18 |
| A16 | −1.265333500281360E−17 | 1.050433572790200E−20 |
| A18 | 3.302770258238470E−20 | −1.354657992164910E−23 |
| A20 | −3.653009322896420E−23 | 7.341963759843910E−27 |

### Example 7

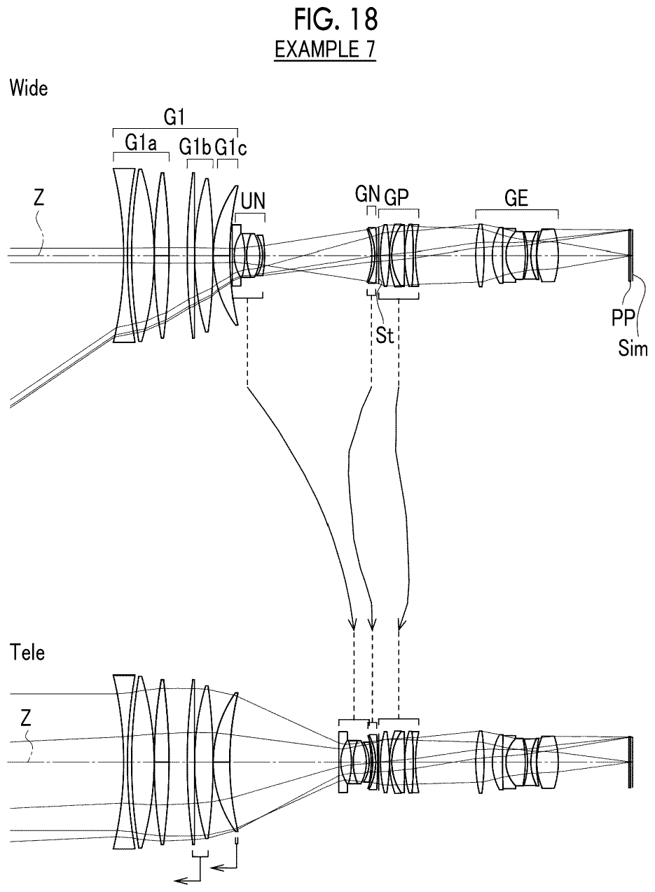

FIG. 18 shows a configuration and movement loci of the zoom lens according to Example 7. The zoom lens according to Example 7 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

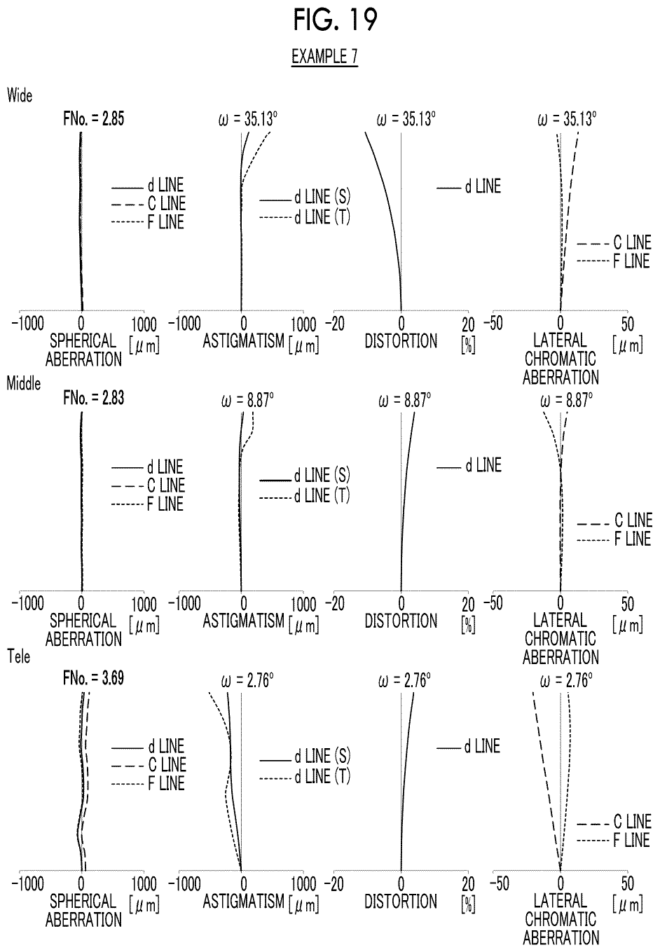

Regarding the zoom lens according to Example 7, Table 22 shows basic lens data, Table 23 shows specifications and variable surface spacings, and Table 24 shows aspherical coefficients thereof. FIG. 19 shows aberration diagrams thereof.

TABLE 22
Example 7

| Sn | R | D | Nd | vd | θg, F | SG | ED |
|---|---|---|---|---|---|---|---|
| 1 | −220.0379 | 2.1180 | 1.84909 | 36.26 | 0.58176 | 4.65 | 100.00 |
| 2 | 298.2667 | 2.3348 | | | | | 98.41 |
| 3 | 308.7502 | 12.5001 | 1.43387 | 95.18 | 0.53733 | 3.18 | 98.49 |
| 4 | −179.7676 | 0.1202 | | | | | 98.37 |
| 5 | 292.2042 | 8.2090 | 1.43700 | 95.10 | 0.53364 | 3.53 | 95.06 |
| *6 | −347.6727 | DD[6] | | | | | 94.91 |
| 7 | 358.5340 | 4.0389 | 1.43387 | 95.18 | 0.53733 | 3.18 | 91.85 |
| 8 | ∞ | 0.1200 | | | | | 91.44 |
| 9 | 161.2988 | 10.2555 | 1.43387 | 95.18 | 0.53733 | 3.18 | 88.06 |
| 10 | −349.9641 | DD[10] | | | | | 87.74 |
| *11 | 70.8798 | 9.1917 | 1.59282 | 68.62 | 0.54414 | 4.13 | 80.00 |
| 12 | 177.8674 | DD[12] | | | | | 79.08 |
| 13 | −16070.4768 | 1.1000 | 2.00069 | 25.46 | 0.61364 | 4.73 | 29.37 |
| 14 | 23.4281 | 5.9125 | | | | | 25.20 |
| 15 | −48.7085 | 1.0102 | 1.82435 | 46.39 | 0.56221 | 5.24 | 24.89 |
| 16 | 33.0663 | 7.3050 | 1.83182 | 21.67 | 0.63201 | 3.65 | 24.77 |
| 17 | −27.0002 | 1.5659 | | | | | 24.72 |
| 18 | −22.8648 | 1.1001 | 1.85258 | 43.69 | 0.56441 | 5.37 | 22.84 |
| *19 | −69.9843 | DD[19] | | | | | 23.00 |
| 20 | −43.4277 | 1.5987 | 1.84899 | 22.55 | 0.62898 | 3.65 | 30.03 |
| 21 | −34.5854 | 1.1102 | 1.61775 | 66.30 | 0.54398 | 4.23 | 30.36 |
| 22 | −235.2221 | DD[22] | | | | | 31.75 |
| 23(St) | ∞ | 1.0000 | | | | | 32.50 |
| 24 | 71.1512 | 4.9789 | 1.69874 | 58.45 | 0.55241 | 4.64 | 34.98 |
| *25 | −99.4068 | 0.1201 | | | | | 35.26 |
| 26 | 56.7246 | 1.2150 | 1.90000 | 27.35 | 0.60754 | 4.49 | 35.90 |
| 27 | 32.2703 | 7.0896 | 1.43875 | 94.66 | 0.53402 | 3.59 | 35.07 |
| 28 | −933.8438 | 0.1200 | | | | | 35.23 |
| 29 | 67.1339 | 4.8062 | 1.59349 | 67.00 | 0.53667 | 3.14 | 35.54 |
| 30 | −213.7851 | 1.2100 | 1.59270 | 35.31 | 0.59336 | 2.64 | 35.31 |
| 31 | 84.8966 | DD[31] | | | | | 34.82 |
| 32 | 80.5797 | 4.5966 | 1.84666 | 23.83 | 0.61603 | 5.51 | 35.86 |
| 33 | −137.4958 | 4.6359 | | | | | 35.73 |
| 34 | 33.4991 | 5.7134 | 1.48749 | 70.24 | 0.53007 | 2.46 | 31.82 |
| 35 | 632.6873 | 1.8314 | 1.91082 | 35.25 | 0.58224 | 4.97 | 30.67 |
| 36 | 19.8009 | 10.8114 | 1.50701 | 78.92 | 0.53730 | 3.47 | 27.28 |
| 37 | 69.8146 | 1.2970 | | | | | 26.70 |
| 38 | −45.1044 | 1.8071 | 1.88300 | 40.76 | 0.56679 | 5.52 | 26.44 |
| 39 | 30.6265 | 3.1159 | 1.52536 | 63.19 | 0.53764 | 2.73 | 26.94 |
| 40 | 71.2418 | 0.1964 | | | | | 27.38 |
| 41 | 37.9790 | 11.9841 | 1.48833 | 75.93 | 0.53274 | 3.02 | 28.70 |
| 42 | −51.6476 | 39.3324 | | | | | 30.01 |
| 43 | ∞ | 1.0000 | 1.51633 | 64.14 | 0.53531 | 2.52 | 29.49 |
| 44 | ∞ | 1.1000 | | | | | 29.48 |

TABLE 23
Example 7

| | Object distance | | | | | |
|---|---|---|---|---|---|---|
| | Infinity | | | Close range (0.92 m) | | |
| | Zooming state | | | | | |
| | Wide | Middle | Tele | Wide | Middle | Tele |
| Zr | 1.00 | 3.88 | 12.60 | 1.00 | 3.88 | 12.60 |
| f | 23.10 | 89.56 | 290.81 | 26.59 | 121.12 | 257.54 |
| FNo. | 2.85 | 2.83 | 3.69 | 2.85 | 2.83 | 3.87 |
| 2ω[°] | 70.26 | 17.74 | 5.52 | 56.90 | 11.70 | 2.08 |
| DD[6] | 10.1281 | 10.1281 | 10.1281 | 0.7974 | 0.7974 | 0.7974 |
| DD[10] | 0.1200 | 0.1200 | 0.1200 | 0.1132 | 0.1132 | 0.1132 |
| DD[12] | 1.3795 | 44.4142 | 60.4502 | 10.7170 | 53.7517 | 69.7877 |
| DD[19] | 59.5128 | 5.7708 | 0.9307 | 59.5128 | 5.7708 | 0.9307 |
| DD[22] | 1.0332 | 15.9815 | 0.5546 | 1.0332 | 15.9815 | 0.5546 |
| DD[31] | 33.5810 | 29.3400 | 33.5711 | 33.5810 | 29.3400 | 33.5711 |
| IHw | 14.525 | | | | | |

TABLE 24
Example 7

| Sn | 6 | 11 |
|---|---|---|
| KA | 1.000000000000000E+00 | 1.046873853983740E+00 |
| A4 | 5.034188237772310E−08 | 1.151610754646610E−08 |
| A6 | −7.873004698384210E−11 | −1.606409076292840E−10 |
| A8 | 1.743945170107240E−13 | 4.187438324935200E−13 |
| A10 | −2.021016261928290E−16 | −6.340571650046640E−16 |
| A12 | 1.320740422866830E−19 | 5.911894608574520E−19 |
| A14 | −4.455207872150510E−23 | −3.429411734878840E−22 |
| A16 | 4.242865977691470E−27 | 1.199755742904990E−25 |
| A18 | 1.495955089499980E−30 | −2.310251160522490E−29 |
| A20 | −3.303544572614840E−34 | 1.876653749675210E−33 |

| Sn | 19 |
|---|---|
| KA | 1.302736330353440E+00 |
| A3 | 2.654280264287650E−20 |
| A4 | −3.073473710049400E−06 |
| A5 | −1.395042018378080E−06 |
| A6 | 9.489917951145650E−10 |
| A7 | 1.937651800737650E−07 |
| A8 | −4.509157459217350E−08 |
| A9 | −2.416112078837850E−09 |
| A10 | 1.832414253109380E−09 |
| A11 | −9.879026444051700E−11 |
| A12 | −2.854477749131970E−11 |
| A13 | 3.078916118935190E−12 |
| A14 | 1.825094923806010E−13 |
| A15 | −3.440803563819830E−14 |
| A16 | −6.709505663957250E−17 |
| A17 | 1.761916763550340E−16 |
| A18 | −4.277711709771350E−18 |
| A19 | −3.470447486556700E−19 |
| A20 | 1.363672811872550E−20 |

| Sn | 25 |
|---|---|
| KA | 2.809626280963320E+00 |
| A4 | 1.857947837832880E−06 |
| A6 | 4.176215986587880E−09 |
| A8 | −8.713137646490080E−11 |
| A10 | 1.080914790799020E−12 |
| A12 | −8.144890716981210E−15 |
| A14 | 3.757538847603270E−17 |
| A16 | −1.038712592940720E−19 |
| A18 | 1.580359626366010E−22 |
| A20 | −1.017812166587140E−25 |

### Example 8

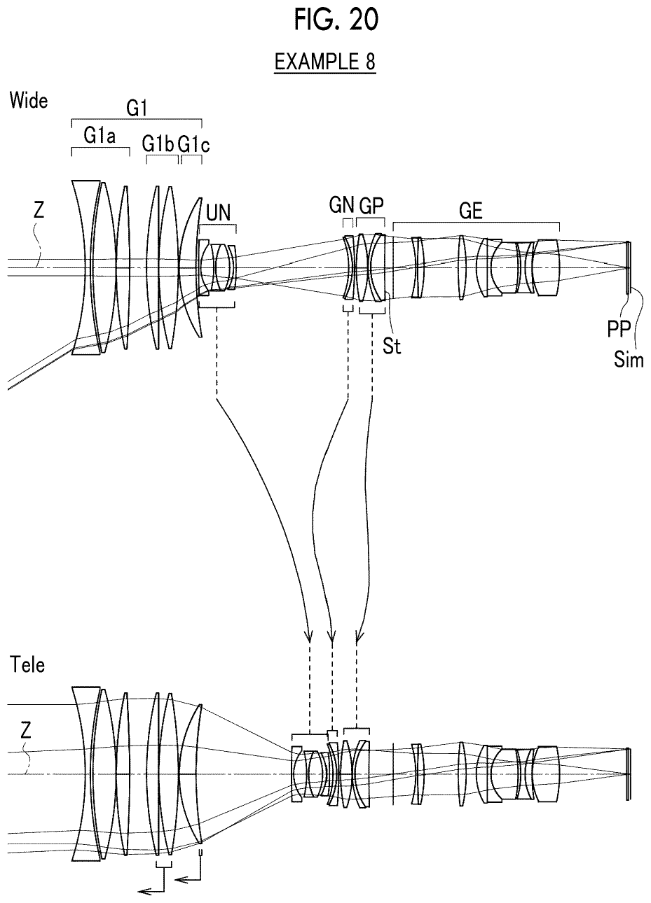

FIG. 20 shows a configuration and movement loci of the zoom lens according to Example 8. The zoom lens according to Example 8 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

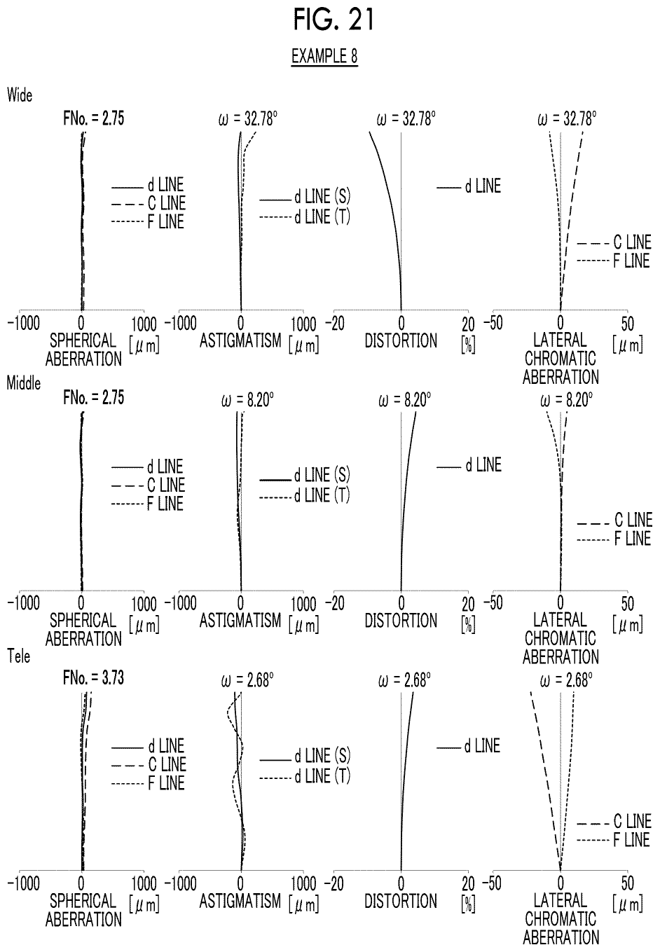

Regarding the zoom lens according to Example 8, Table 25 shows basic lens data, Table 26 shows specifications and variable surface spacings, and Table 27 shows aspherical coefficients thereof. FIG. 21 shows aberration diagrams thereof.

TABLE 25
Example 8

| Sn | R | D | Nd | vd | θg, F | SG | ED |
|---|---|---|---|---|---|---|---|
| 1 | −172.1030 | 2.8499 | 1.67820 | 36.07 | 0.58692 | 3.06 | 100.00 |
| 2 | 224.4542 | 1.4687 | | | | | 97.57 |
| 3 | 244.4908 | 12.8308 | 1.43387 | 95.18 | 0.53733 | 3.18 | 97.62 |
| 4 | −194.0722 | 0.1202 | | | | | 97.47 |
| 5 | 234.6500 | 7.4468 | 1.43700 | 95.10 | 0.53364 | 3.53 | 93.50 |
| *6 | −603.9058 | DD[6] | | | | | 93.55 |
| 7 | 204.6136 | 6.6910 | 1.43387 | 95.18 | 0.53733 | 3.18 | 93.64 |
| 8 | −53779.1896 | 0.1202 | | | | | 93.47 |
| 9 | 192.3872 | 10.8446 | 1.43387 | 95.18 | 0.53733 | 3.18 | 92.35 |
| 10 | −282.8019 | DD[10] | | | | | 91.94 |
| 11 | 77.2548 | 9.3675 | 1.59282 | 68.62 | 0.54414 | 4.13 | 80.01 |
| *12 | 256.2324 | DD[12] | | | | | 79.05 |
| 13 | 574.2363 | 1.1929 | 1.90366 | 31.31 | 0.59481 | 4.51 | 31.86 |
| 14 | 22.5831 | 7.2076 | | | | | 27.01 |
| 15 | −58.9751 | 1.0999 | 1.81600 | 46.62 | 0.55682 | 5.07 | 26.50 |
| 16 | 32.6806 | 7.7722 | 1.80809 | 22.76 | 0.63073 | 3.29 | 26.47 |
| 17 | −31.2325 | 2.1376 | | | | | 26.47 |
| 18 | −26.2768 | 1.4667 | 1.86249 | 42.73 | 0.56519 | 5.42 | 24.58 |
| *19 | −112.1193 | DD[19] | | | | | 24.90 |
| 20 | −48.6583 | 2.0744 | 1.84666 | 23.83 | 0.61603 | 5.51 | 34.25 |
| 21 | −38.5176 | 1.1448 | 1.65538 | 62.80 | 0.54374 | 4.39 | 34.71 |
| 22 | −193.8617 | DD[22] | | | | | 36.31 |
| *23 | 91.0984 | 6.4207 | 1.59282 | 68.62 | 0.54414 | 4.13 | 38.07 |
| 24 | −63.1947 | 0.1275 | | | | | 38.50 |
| 25 | 47.1135 | 1.4677 | 1.89237 | 20.39 | 0.63930 | 3.58 | 38.87 |
| 26 | 33.2746 | 7.7727 | 1.51991 | 78.30 | 0.53840 | 3.63 | 37.65 |
| 27 | 732.3081 | DD[27] | | | | | 37.29 |
| 28(St) | ∞ | 12.5202 | | | | | 35.39 |
| 29 | −64.9424 | 1.0990 | 1.69125 | 47.48 | 0.55993 | 3.53 | 33.87 |
| 30 | 371.9596 | 3.5758 | 1.44610 | 93.18 | 0.53442 | 3.59 | 34.45 |
| 31 | −80.3174 | 19.0016 | | | | | 34.70 |
| 32 | 169.2054 | 4.4042 | 1.84666 | 23.83 | 0.61603 | 5.51 | 36.62 |
| 33 | −87.0798 | 5.6325 | | | | | 36.69 |
| 34 | 33.8164 | 6.1138 | 1.48749 | 70.24 | 0.53007 | 2.46 | 33.26 |
| 35 | 52062.9707 | 2.0404 | 1.91082 | 35.25 | 0.58224 | 4.97 | 32.30 |
| 36 | 20.0713 | 15.1213 | 1.55875 | 52.63 | 0.55458 | 2.74 | 28.87 |
| 37 | −77.2712 | 1.4850 | | | | | 28.18 |
| 38 | −50.6364 | 2.4033 | 1.88300 | 40.76 | 0.56679 | 5.52 | 27.89 |
| 39 | 31.9828 | 3.9118 | 1.56967 | 69.27 | 0.54082 | 3.59 | 28.56 |
| 40 | 103.7219 | 0.1203 | | | | | 29.05 |
| 41 | 36.5346 | 15.1698 | 1.48779 | 81.87 | 0.53600 | 3.40 | 30.82 |
| 42 | −76.4886 | 37.4200 | | | | | 31.90 |
| 43 | ∞ | 1.0000 | 1.51633 | 64.14 | 0.53531 | 2.52 | 30.04 |
| 44 | ∞ | 1.1000 | | | | | 30.01 |

TABLE 26
Example 8

| | Object distance | | | | | |
|---|---|---|---|---|---|---|
| | Infinity | | | Close range (0.90 m) | | |
| | Zooming state | | | | | |
| | Wide | Middle | Tele | Wide | Middle | Tele |
| Zr | 1.00 | 3.88 | 12.05 | 1.00 | 3.88 | 12.05 |
| f | 24.90 | 96.53 | 299.74 | 28.81 | 131.12 | 292.82 |
| FNo. | 2.75 | 2.75 | 3.73 | 2.75 | 2.75 | 4.01 |
| 2ω[°] | 65.56 | 16.40 | 5.36 | 52.58 | 10.54 | 0.84 |
| DD[6] | 9.4465 | 9.4465 | 9.4465 | 0.9997 | 0.9997 | 0.9997 |
| DD[10] | 0.5226 | 0.5226 | 0.5226 | 0.5011 | 0.5011 | 0.5011 |
| DD[12] | 1.4518 | 39.1451 | 53.1792 | 9.9200 | 47.6134 | 61.6475 |
| DD[19] | 62.3800 | 5.3107 | 1.8936 | 62.3800 | 5.3107 | 1.8936 |
| DD[22] | 1.0076 | 17.8632 | 0.9995 | 1.0076 | 17.8632 | 0.9995 |
| DD[27] | 4.7742 | 7.2945 | 13.5412 | 4.7742 | 7.2945 | 13.5412 |
| IHw | 14.525 | | | | | |

TABLE 27
Example 8

| Sn | 6 | 12 |
|---|---|---|
| KA | 1.000000000000000E+00 | 1.000000000000000E+00 |
| A4 | 6.877363746308470E−08 | 4.503114089573420E−08 |
| A6 | −4.071472103054370E−11 | −7.723447250887070E−12 |
| A8 | 1.311067943292610E−13 | −1.005252448714450E−14 |
| A10 | −2.115261297595830E−16 | 3.676015390521320E−17 |
| A12 | 2.034047896489370E−19 | −5.666691531479710E−20 |
| A14 | −1.207010657759480E−22 | 5.625230644282100E−23 |
| A16 | 4.326226648740330E−26 | −3.442034523536070E−26 |
| A18 | −8.570429059018590E−30 | 1.140607224393480E−29 |
| A20 | 7.193443132953290E−34 | −1.547045005608320E−33 |

| Sn | 19 | 23 |
|---|---|---|
| KA | 1.291144000000000E+00 | 3.001550000000000E+00 |
| A4 | −5.844533057824670E−06 | −2.436048001939130E−06 |
| A6 | 4.266647802421530E−08 | 1.950449422112820E−09 |
| A8 | −1.572724685140690E−09 | −1.833853992705730E−12 |
| A10 | 3.103697113546040E−11 | −2.250757258778370E−13 |
| A12 | −3.727546015624430E−13 | 2.815743735130950E−15 |
| A14 | 2.756885905437160E−15 | −1.577537997744360E−17 |
| A16 | −1.225298981803730E−17 | 4.700173463893360E−20 |
| A18 | 3.001163566540980E−20 | −7.251590348844200E−23 |
| A20 | −3.116008872633540E−23 | 4.568577685924440E−26 |

### Example 9

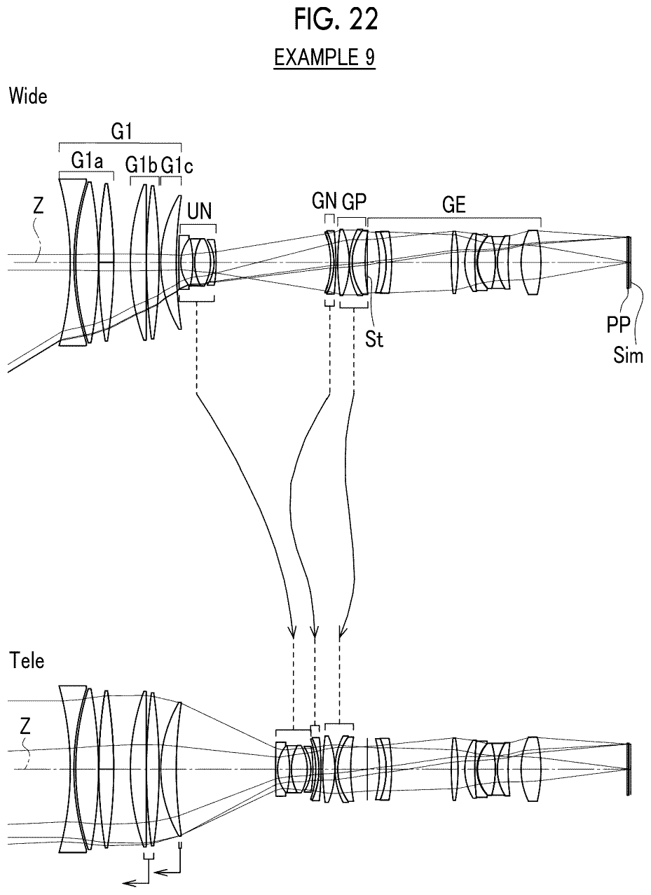

FIG. 22 shows a configuration and movement loci of a zoom lens according to Example 9. The zoom lens according to Example 9 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

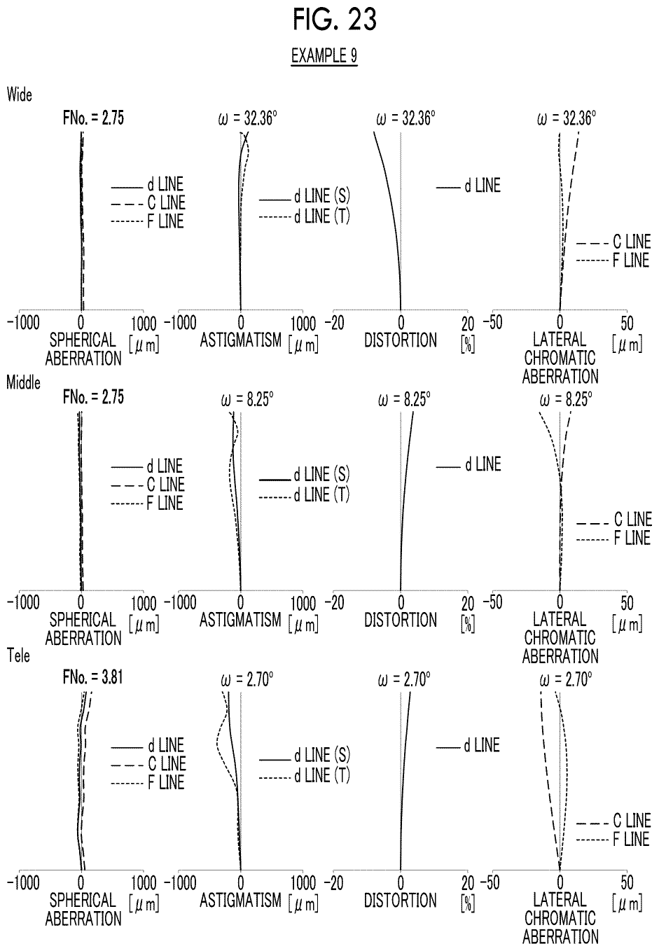

Regarding the zoom lens according to Example 9, Table 28 shows basic lens data, Table 29 shows specifications and variable surface spacings, and Table 30 shows aspherical coefficients thereof. FIG. 23 shows aberration diagrams thereof.

TABLE 28
Example 9

| Sn | R | D | Nd | vd | θg, F | SG | ED |
|---|---|---|---|---|---|---|---|
| 1 | −188.0843 | 2.0000 | 1.67300 | 38.26 | 0.57580 | 3.0 | 96.00 |
| 2 | 158.2632 | 1.0509 | | | | | 92.58 |
| 3 | 157.7165 | 12.6030 | 1.43387 | 95.18 | 0.53733 | 3.18 | 92.68 |
| 4 | −260.3266 | 0.2363 | | | | | 92.50 |
| 5 | 291.4633 | 8.2887 | 1.43700 | 95.10 | 0.53364 | 3.53 | 90.53 |
| *6 | −275.5171 | DD[6] | | | | | 90.58 |
| 7 | 137.9250 | 8.8742 | 1.43387 | 95.18 | 0.53733 | 3.18 | 89.60 |
| 8 | −18333.5614 | 0.1203 | | | | | 89.26 |
| 9 | 358.2270 | 7.0042 | 1.43387 | 95.18 | 0.53733 | 3.18 | 88.21 |
| 10 | −323.1001 | DD[10] | | | | | 87.81 |
| *11 | 77.9831 | 8.6208 | 1.59349 | 67.00 | 0.53667 | 3.14 | 77.10 |
| 12 | 259.1530 | DD[12] | | | | | 76.00 |
| 13 | 627.7558 | 1.1001 | 1.90366 | 31.31 | 0.59481 | 4.51 | 31.11 |
| 14 | 21.9441 | 6.6848 | | | | | 26.71 |
| 15 | −62.5211 | 1.0000 | 1.84850 | 43.79 | 0.56197 | 5.08 | 26.56 |
| 16 | 29.3558 | 8.8613 | 1.84666 | 23.83 | 0.61603 | 5.51 | 27.08 |
| 17 | −28.6773 | 1.9661 | | | | | 27.27 |
| 18 | −24.1274 | 1.1217 | 1.86741 | 42.26 | 0.56557 | 5.45 | 25.66 |
| *19 | −103.4754 | DD[19] | | | | | 26.37 |
| 20 | −53.4247 | 1.7795 | 1.89982 | 20.01 | 0.64188 | 3.55 | 34.57 |
| 21 | −43.8216 | 1.1107 | 1.69942 | 58.39 | 0.55246 | 4.64 | 34.98 |
| 22 | −176.8149 | DD[22] | | | | | 36.32 |
| *23 | 117.7819 | 6.4393 | 1.59349 | 67.00 | 0.53667 | 3.14 | 37.80 |
| 24 | −52.2564 | 0.1202 | | | | | 38.24 |
| 25 | 42.8671 | 1.5058 | 1.89994 | 20.00 | 0.64192 | 3.55 | 38.29 |
| 26 | 32.6145 | 7.2150 | 1.52090 | 78.10 | 0.53845 | 3.63 | 37.04 |
| 27 | 108.5063 | DD[27] | | | | | 36.32 |
| 28(St) | ∞ | 6.7132 | | | | | 35.46 |
| 29 | −71.2827 | 3.7352 | 1.53752 | 74.75 | 0.53935 | 3.64 | 34.85 |
| 30 | −48.3015 | 3.0102 | 1.54617 | 46.86 | 0.56651 | 2.49 | 35.08 |
| 31 | −109.8673 | 33.2248 | | | | | 35.54 |
| 32 | 160.2412 | 3.7458 | 1.84666 | 23.83 | 0.61603 | 5.51 | 35.91 |
| 33 | −111.4574 | 3.7781 | | | | | 35.93 |
| 34 | 32.5655 | 5.6389 | 1.48749 | 70.24 | 0.53007 | 2.46 | 33.41 |
| 35 | 171.7908 | 1.1090 | 1.91082 | 35.25 | 0.58224 | 4.97 | 32.43 |
| 36 | 22.2059 | 0.3860 | | | | | 29.63 |
| 37 | 22.6149 | 9.8622 | 1.48852 | 81.77 | 0.53608 | 3.40 | 30.03 |
| 38 | −56.1586 | 1.1100 | 1.88300 | 40.76 | 0.56679 | 5.52 | 29.77 |
| 39 | 28.8006 | 6.0061 | 1.59037 | 41.96 | 0.57503 | 2.57 | 29.91 |
| 40 | 120.8794 | 7.2218 | | | | | 30.63 |
| 41 | 43.6728 | 11.0416 | 1.48754 | 73.51 | 0.53150 | 2.90 | 36.69 |
| 42 | −85.2439 | 47.9287 | | | | | 36.94 |
| 43 | ∞ | 1.0000 | 1.51633 | 64.14 | 0.53531 | 2.52 | 29.89 |
| 44 | ∞ | 1.1000 | | | | | 29.80 |

TABLE 29
Example 9

| | Object distance | | | | | |
|---|---|---|---|---|---|---|
| | Infinity | | | Close range (0.89 m) | | |
| | Zooming state | | | | | |
| | Wide | Middle | Tele | Wide | Middle | Tele |
| Zr | 1.00 | 3.88 | 12.05 | 1.00 | 3.88 | 12.05 |
| f | 24.89 | 96.53 | 299.74 | 28.92 | 137.93 | 426.39 |
| FNo. | 2.75 | 2.75 | 3.81 | 2.75 | 2.75 | 4.21 |
| 2ω[°] | 64.72 | 16.50 | 5.40 | 52.22 | 10.62 | 1.06 |
| DD[6] | 9.2652 | 9.2652 | 9.2652 | 0.5892 | 0.5892 | 0.5892 |
| DD[10] | 0.9245 | 0.9245 | 0.9245 | 0.5891 | 0.5891 | 0.5891 |
| DD[12] | 1.4350 | 40.7058 | 55.3030 | 10.4464 | 49.7171 | 64.3144 |
| DD[19] | 63.4848 | 3.1091 | 1.6275 | 63.4848 | 3.1091 | 1.6275 |
| DD[22] | 1.0054 | 20.2478 | 0.9830 | 1.0054 | 20.2478 | 0.9830 |
| DD[27] | 1.2975 | 3.1600 | 9.3092 | 1.2975 | 3.1600 | 9.3092 |
| IHw | 14.525 | | | | | |

TABLE 30
Example 9

| Sn | 6 | 11 |
|---|---|---|
| KA | 1.000000000000000E+00 | 9.213583030570500E−01 |
| A4 | 5.932966732534540E−08 | −1.039120267293520E−08 |
| A6 | 3.122837972681680E−11 | 3.295232891154330E−12 |
| A8 | −8.740056656838660E−14 | −4.374541670872860E−15 |
| A10 | 1.430385238198350E−16 | −3.167502064959360E−18 |
| A12 | −1.473677067782560E−19 | −2.934918066773550E−20 |
| A14 | 9.916771974779270E−23 | 8.416936498513520E−23 |
| A16 | −4.185447386998730E−26 | −8.236525491772840E−26 |
| A18 | 9.940829134932520E−30 | 3.560339204701400E−29 |
| A20 | −1.006079227763270E−33 | −5.807608013315990E−33 |

| Sn | 19 | 23 |
|---|---|---|
| KA | 1.606291274529940E+01 | 4.966965969796320E+00 |
| A4 | −5.065141727255900E−06 | −2.242766181007360E−06 |
| A6 | 3.016520338570080E−08 | −1.714710805046110E−09 |
| A8 | −1.158635305488290E−09 | 6.106368877613820E−11 |
| A10 | 2.395779461845260E−11 | −7.804757857724090E−13 |
| A12 | −3.074462890360080E−13 | 5.598792018495110E−15 |
| A14 | 2.462587614598040E−15 | −2.389028555678760E−17 |
| A16 | −1.197397570263890E−17 | 6.013274453453090E−20 |
| A18 | 3.229702420858400E−20 | −8.245449048547930E−23 |
| A20 | −3.703395701325590E−23 | 4.750924510816120E−26 |

### Example 10

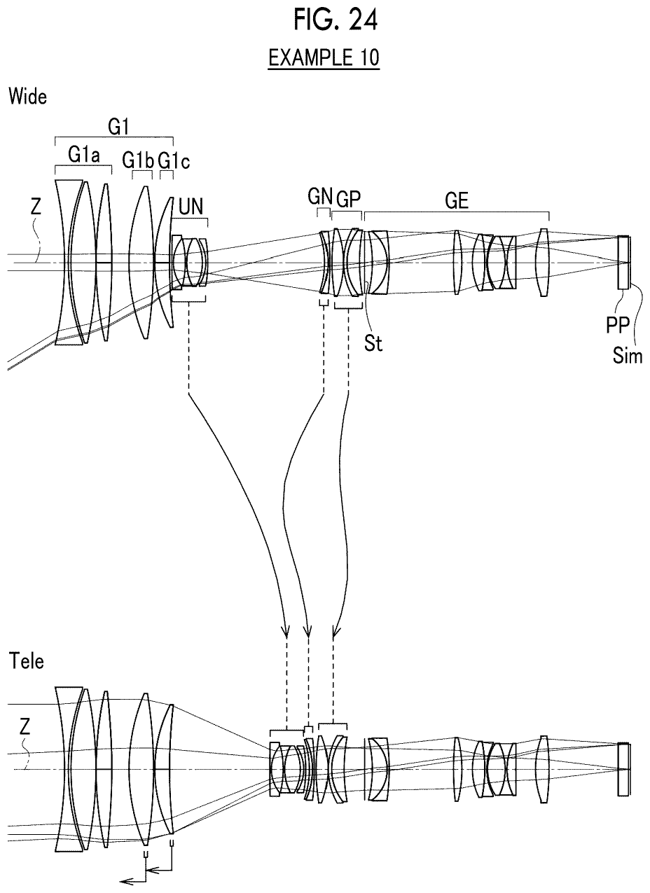

FIG. 24 shows a configuration and movement loci of the zoom lens according to Example 10. The zoom lens according to Example 10 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

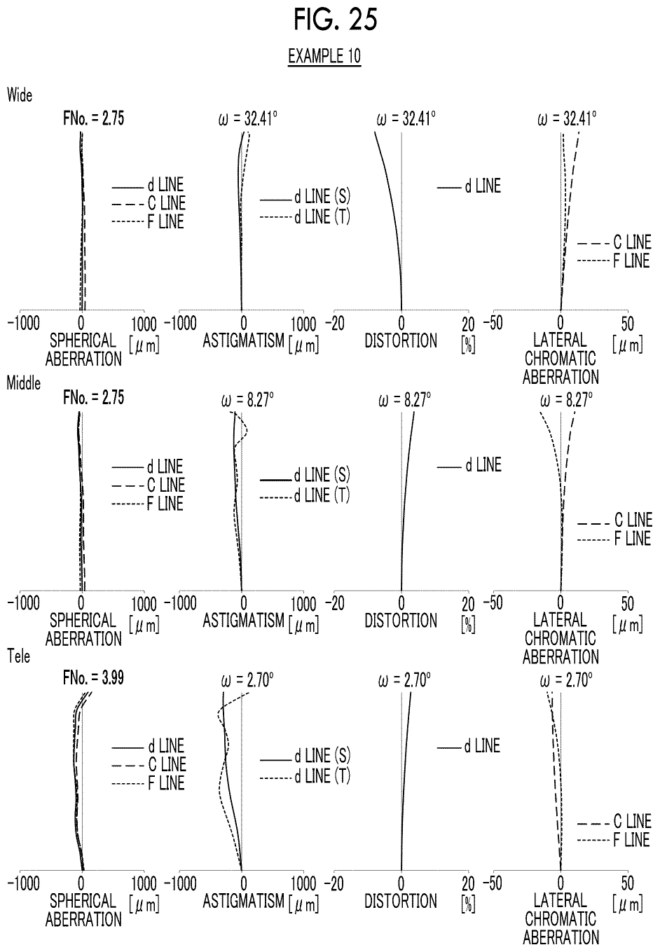

Regarding the zoom lens according to Example 10, Table 31 shows basic lens data, Table 32 shows specifications and variable surface spacings, and Table 33 shows aspherical coefficients thereof. FIG. 25 shows aberration diagrams thereof.

TABLE 31
Example 10

| Sn | R | D | Nd | vd | θg, F | SG | ED |
|---|---|---|---|---|---|---|---|
| 1 | −218.1579 | 2.1250 | 1.67300 | 38.26 | 0.57580 | 3.01 | 94.69 |
| 2 | 137.9201 | 1.4748 | | | | | 92.19 |
| 3 | 144.1647 | 13.8612 | 1.43387 | 95.18 | 0.53733 | 3.18 | 92.47 |
| 4 | −227.8710 | 0.1202 | | | | | 92.40 |
| 5 | 212.6095 | 8.7517 | 1.43700 | 95.10 | 0.53364 | 3.53 | 90.00 |
| *6 | −351.9004 | DD[6] | | | | | 89.90 |
| 7 | 116.9796 | 13.6610 | 1.43387 | 95.18 | 0.53733 | 3.18 | 87.42 |
| 8 | −282.6993 | DD[8] | | | | | 86.77 |
| *9 | 84.1675 | 8.2187 | 1.59282 | 68.62 | 0.54414 | 4.13 | 74.45 |
| 10 | 329.2305 | DD[10] | | | | | 73.00 |
| 11 | 1106.0756 | 0.8400 | 1.91082 | 35.25 | 0.58335 | 4.85 | 30.97 |
| 12 | 22.0427 | 6.5912 | | | | | 26.66 |
| 13 | −56.3075 | 0.8208 | 1.84850 | 43.79 | 0.56197 | 5.08 | 26.52 |
| 14 | 29.6428 | 8.7026 | 1.85451 | 25.15 | 0.61031 | 3.48 | 26.96 |
| 15 | −28.6033 | 1.8971 | | | | | 27.11 |
| 16 | −24.0850 | 1.1000 | 1.84850 | 43.79 | 0.56197 | 5.08 | 25.42 |
| *17 | −90.2154 | DD[17] | | | | | 26.96 |
| 18 | −54.0662 | 1.7434 | 1.89286 | 20.36 | 0.63944 | 3.61 | 33.93 |
| 19 | −44.1185 | 0.9700 | 1.69560 | 59.05 | 0.54348 | 4.56 | 34.32 |
| 20 | −175.2795 | DD[20] | | | | | 35.50 |
| *21 | 108.7408 | 6.4227 | 1.59349 | 67.00 | 0.53667 | 3.14 | 38.26 |
| 22 | −55.6381 | 0.1201 | | | | | 38.67 |
| 23 | 40.7193 | 1.8285 | 1.89286 | 20.36 | 0.63944 | 3.61 | 38.76 |
| 24 | 30.5925 | 6.9848 | 1.49782 | 82.57 | 0.53862 | 3.86 | 37.18 |
| 25 | 107.4743 | DD[25] | | | | | 36.64 |
| 26(St) | ∞ | 4.3278 | | | | | 35.48 |
| 27 | −73.4178 | 8.2706 | 1.53775 | 74.70 | 0.53936 | 3.64 | 35.19 |
| 28 | −22.8507 | 1.1101 | 1.53996 | 59.46 | 0.54418 | 2.75 | 35.36 |
| 29 | −128.9818 | 35.8298 | | | | | 36.09 |
| 30 | 179.8388 | 4.6567 | 1.84666 | 23.83 | 0.61603 | 5.51 | 36.50 |
| 31 | −78.5691 | 5.8603 | | | | | 36.55 |
| 32 | 37.6459 | 6.8950 | 1.48749 | 70.24 | 0.53007 | 2.46 | 32.32 |
| 33 | −84.8306 | 1.1531 | 1.95487 | 32.51 | 0.58956 | 5.37 | 31.35 |
| 34 | 32.7520 | 0.4065 | | | | | 29.45 |
| 35 | 27.6433 | 9.7998 | 1.51860 | 69.89 | 0.53184 | 2.60 | 29.93 |
| 36 | −35.6227 | 1.0175 | 1.89673 | 38.30 | 0.57473 | 5.10 | 29.46 |
| 37 | 34.3322 | 4.9633 | 1.52754 | 48.06 | 0.56483 | 2.49 | 29.58 |
| 38 | −25029.8702 | 10.9196 | | | | | 30.00 |
| 39 | 53.8987 | 7.5459 | 1.54139 | 47.73 | 0.56496 | 2.49 | 35.60 |
| 40 | −148.9585 | 38.4923 | | | | | 35.60 |
| 41 | ∞ | 5.7000 | 1.51633 | 64.14 | 0.53531 | 2.52 | 30.47 |
| 42 | ∞ | 1.1000 | | | | | 29.98 |

TABLE 32
Example 10

| | Object distance | | | | | |
|---|---|---|---|---|---|---|
| | Infinity | | | Close range (0.89 m) | | |
| | Zooming state | | | | | |
| | Wide | Middle | Tele | Wide | Middle | Tele |
| Zr | 1.00 | 3.88 | 12.05 | 1.00 | 3.88 | 12.05 |
| f | 24.86 | 96.38 | 299.34 | 28.70 | 136.58 | 422.32 |
| FNo. | 2.75 | 2.75 | 3.99 | 2.75 | 2.75 | 4.39 |
| 2ω[°] | 64.82 | 16.54 | 5.40 | 52.36 | 10.64 | 0.94 |
| DD[6] | 9.5678 | 9.5678 | 9.5678 | 0.6465 | 0.6465 | 0.6465 |
| DD[8] | 0.7000 | 0.7000 | 0.7000 | 0.6442 | 0.6442 | 0.6442 |
| DD[10] | 1.3506 | 41.1317 | 55.8743 | 10.3277 | 50.1087 | 64.8513 |
| DD[17] | 65.0053 | 3.5307 | 2.0472 | 65.0053 | 3.5307 | 2.0472 |
| DD[20] | 1.1506 | 20.7191 | 1.0128 | 1.1506 | 20.7191 | 1.0128 |
| DD[25] | 2.7923 | 4.9174 | 11.3645 | 2.7923 | 4.9174 | 11.3645 |
| IHw | 14.525 | | | | | |

TABLE 33
Example 10

| Sn | 6 | 9 |
|---|---|---|
| KA | 1.000000000000000E+00 | 9.102049769855680E−01 |
| A4 | 1.011146033199080E−07 | 1.501886788787270E−08 |
| A6 | −1.253225431379300E−10 | −1.621759656276780E−10 |
| A8 | 3.145100702951200E−13 | 4.256593889495670E−13 |
| A10 | −3.643195535425260E−16 | −5.231020096627080E−16 |
| A12 | 2.004228026515270E−19 | 2.668309384016620E−19 |
| A14 | −2.270102869405520E−23 | 4.325848208395130E−23 |
| A16 | −2.931660081592800E−26 | −1.158683791516630E−25 |
| A18 | 1.398179503769780E−29 | 4.981754486922120E−29 |
| A20 | −1.945726322221640E−33 | −7.176343989165740E−33 |

| Sn | 17 | 21 |
|---|---|---|
| KA | 1.469672301350010E+01 | 5.014354241165130E+00 |
| A4 | −4.359443528879800E−06 | −2.240242797847600E−06 |
| A6 | 3.161954406183140E−08 | 1.596183085767570E−09 |
| A8 | −1.167223686893370E−09 | −2.176728457203980E−11 |
| A10 | 2.281520316639720E−11 | 2.102324761010390E−13 |
| A12 | −2.738639881842420E−13 | −1.160080946594910E−15 |
| A14 | 2.061581516422070E−15 | 3.650204133588870E−18 |
| A16 | −9.509923374526310E−18 | −6.210750010879730E−21 |
| A18 | 2.457924675840010E−20 | 4.748367384765900E−24 |
| A20 | −2.724493151901210E−23 | −7.216682862077810E−28 |

### Example 11

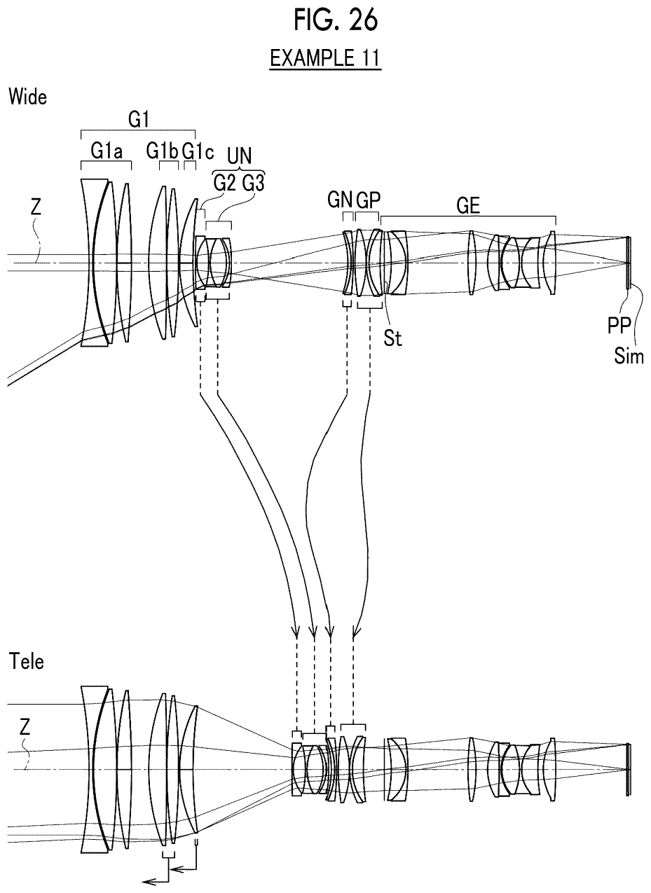

FIG. 26 shows a configuration and movement loci of the zoom lens according to Example 11. The zoom lens according to Example 11 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of two lens groups including a second lens group G2 that has a negative refractive power and a third lens group G3 that has a negative refractive power, in order from the object side to the image side.

During zooming from the wide angle end to the telephoto end, the first lens group G1 and the final lens group GE remain stationary with respect to the image plane Sim, and the second lens group G2, the third lens group G3, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

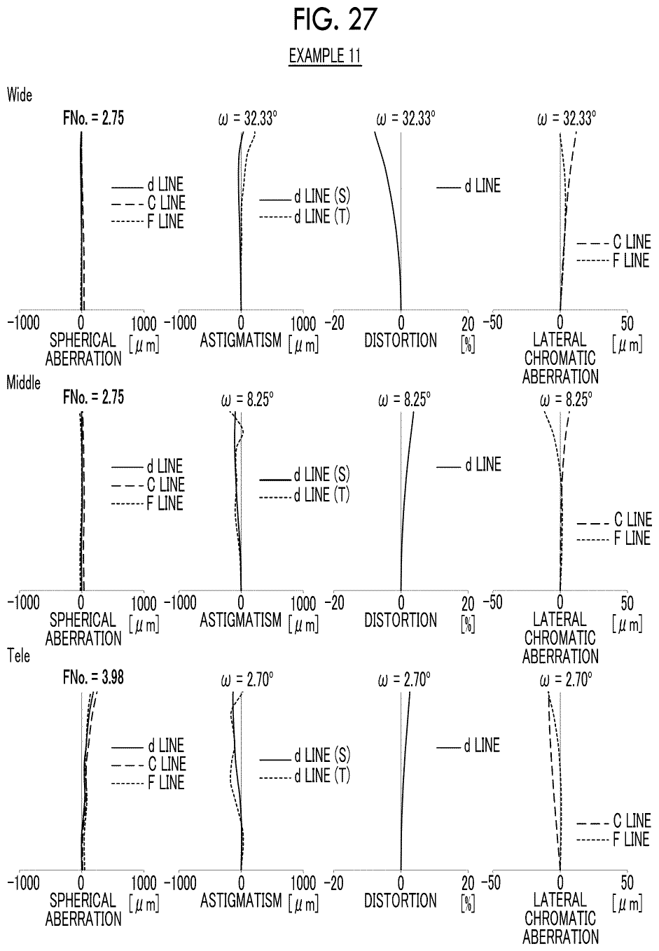

Regarding the zoom lens according to Example 11, Table 34 shows basic lens data, Table 35 shows specifications and variable surface spacings, and Table 36 shows aspherical coefficients thereof. FIG. 27 shows aberration diagrams thereof.

TABLE 34
Example 11

| Sn | R | D | Nd | vd | θg, F | SG | ED |
|---|---|---|---|---|---|---|---|
| 1 | −258.5304 | 2.0001 | 1.67300 | 38.26 | 0.57580 | 3.01 | 96.00 |
| 2 | 130.9974 | 0.5157 | | | | | 92.61 |
| 3 | 127.9493 | 12.8646 | 1.43387 | 95.18 | 0.53733 | 3.18 | 92.71 |
| 4 | −404.1969 | 0.1199 | | | | | 92.50 |
| 5 | 211.5959 | 8.1332 | 1.43700 | 95.10 | 0.53364 | 3.53 | 91.00 |
| *6 | −451.0328 | DD[6] | | | | | 90.84 |
| 7 | 127.8849 | 9.9604 | 1.43387 | 95.18 | 0.53733 | 3.18 | 87.67 |
| 8 | −1590.6811 | 0.1201 | | | | | 87.08 |
| 9 | 304.8791 | 6.5174 | 1.43387 | 95.18 | 0.53733 | 3.18 | 85.00 |
| 10 | −395.0507 | DD[10] | | | | | 84.48 |
| *11 | 81.2833 | 7.4455 | 1.59282 | 68.62 | 0.54414 | 4.13 | 73.24 |
| 12 | 264.4853 | DD[12] | | | | | 72.06 |
| 13 | 613.1278 | 0.7225 | 1.92215 | 35.74 | 0.58126 | 5.25 | 30.43 |
| 14 | 21.8835 | DD[14] | | | | | 26.62 |
| 15 | −60.9938 | 0.9100 | 1.84850 | 43.79 | 0.56197 | 5.08 | 26.52 |
| 16 | 28.9689 | 8.9627 | 1.85451 | 25.15 | 0.61031 | 3.48 | 27.30 |
| 17 | −29.4007 | 1.6934 | | | | | 27.61 |
| 18 | −24.6002 | 1.1001 | 1.85265 | 43.68 | 0.56442 | 5.37 | 26.76 |
| *19 | −99.7692 | DD[19] | | | | | 27.76 |
| 20 | −56.3163 | 1.8261 | 1.89999 | 20.00 | 0.64193 | 3.55 | 34.71 |
| 21 | −44.9279 | 1.1101 | 1.74288 | 54.22 | 0.55585 | 4.85 | 35.08 |
| 22 | −164.6680 | DD[22] | | | | | 36.28 |
| *23 | 104.8006 | 6.2139 | 1.59349 | 67.00 | 0.53667 | 3.14 | 37.70 |
| 24 | −57.5580 | 0.1200 | | | | | 38.09 |
| 25 | 44.1441 | 1.5129 | 1.90000 | 20.00 | 0.64194 | 3.55 | 38.19 |
| 26 | 32.4310 | 6.1293 | 1.51494 | 79.30 | 0.53813 | 3.63 | 36.91 |
| 27 | 137.8870 | DD[27] | | | | | 36.58 |
| 28(St) | ∞ | 3.8751 | | | | | 35.51 |
| 29 | −77.1267 | 8.1747 | 1.53410 | 75.44 | 0.53916 | 3.64 | 35.26 |
| 30 | −23.2166 | 1.1102 | 1.55073 | 54.68 | 0.55116 | 2.72 | 35.42 |
| 31 | −113.4981 | 33.4377 | | | | | 36.21 |
| 32 | 141.2113 | 4.4534 | 1.84666 | 23.83 | 0.61603 | 5.51 | 36.50 |
| 33 | −87.1104 | 6.4538 | | | | | 36.50 |
| 34 | 31.2081 | 6.4265 | 1.48749 | 70.24 | 0.53007 | 2.46 | 31.66 |
| 35 | −300.8290 | 1.1002 | 1.92331 | 35.67 | 0.58142 | 5.25 | 30.58 |
| 36 | 23.4205 | 0.4321 | | | | | 27.86 |
| 37 | 22.1115 | 9.7807 | 1.51860 | 69.89 | 0.53184 | 2.60 | 28.37 |
| 38 | −39.5229 | 1.1932 | 1.87288 | 40.71 | 0.56894 | 4.94 | 27.82 |
| 39 | 20.9177 | 9.0595 | 1.55083 | 72.18 | 0.53976 | 3.57 | 27.25 |
| 40 | 98.8025 | 3.0001 | | | | | 28.76 |
| 41 | 34.1963 | 6.9511 | 1.52157 | 50.96 | 0.55927 | 2.51 | 32.85 |
| 42 | −227.9827 | 39.5796 | | | | | 32.86 |
| 43 | ∞ | 1.0000 | 1.51633 | 64.14 | 0.53531 | 2.52 | 29.98 |
| 44 | ∞ | 1.1000 | | | | | 29.93 |

TABLE 35
Example 11

| | Object distance | | | | | |
|---|---|---|---|---|---|---|
| | Infinity | | | Close range (0.90 m) | | |
| | Zooming state | | | | | |
| | Wide | Middle | Tele | Wide | Middle | Tele |
| Zr | 1.00 | 3.88 | 12.05 | 1.00 | 3.88 | 12.05 |
| f | 24.89 | 96.53 | 299.77 | 28.88 | 132.38 | 301.45 |
| FNo. | 2.75 | 2.75 | 3.98 | 2.75 | 2.75 | 4.40 |
| 2ω[°] | 64.66 | 16.50 | 5.40 | 51.96 | 10.58 | 1.02 |
| DD[6] | 9.5889 | 9.5889 | 9.5889 | 0.5932 | 0.5932 | 0.5932 |
| DD[10] | 0.5980 | 0.5980 | 0.5980 | 0.7555 | 0.7555 | 0.7555 |
| DD[12] | 1.4302 | 40.6052 | 55.0705 | 10.2683 | 49.4433 | 63.9086 |
| DD[14] | 6.5791 | 6.7138 | 6.7717 | 6.5791 | 6.7138 | 6.7717 |
| DD[19] | 64.5143 | 3.0052 | 1.4525 | 64.5143 | 3.0052 | 1.4525 |
| DD[22] | 1.0174 | 20.8724 | 0.9250 | 1.0174 | 20.8724 | 0.9250 |
| DD[27] | 2.3349 | 4.6794 | 11.6563 | 2.3349 | 4.6794 | 11.6563 |
| IHw | 14.525 | | | | | |

TABLE 36
Example 11

| Sn | 6 | 11 |
|---|---|---|
| KA | 1.000000000000000E+00 | 8.915870115637650E−01 |
| A4 | 1.081855952203640E−07 | 8.512636739161560E−09 |
| A6 | −1.554128096553260E−10 | −1.430980889788300E−10 |
| A8 | 4.325979475171410E−13 | 4.244331900435380E−13 |
| A10 | −6.426121384215780E−16 | −6.552259913508640E−16 |
| A12 | 5.757517989633050E−19 | 5.510688463261840E−19 |
| A14 | −3.184066960744100E−22 | −2.281444998978850E−22 |
| A16 | 1.060947845740700E−25 | 1.738447548914450E−26 |
| A18 | −1.947602162072070E−29 | 1.787180537373710E−29 |
| A20 | 1.507770225619770E−33 | −4.343961125588520E−33 |
| Sn | 19 | 23 |
| KA | 1.535586074713560E+01 | 5.224296032726400E+00 |
| A4 | −4.913375094895900E−06 | −2.334100692531800E−06 |
| A6 | 3.449182808867010E−08 | 3.668957462760710E−11 |
| A8 | −1.330681659278350E−09 | 1.397761887877960E−11 |
| A10 | 2.686774643865960E−11 | −1.834944539234530E−13 |
| A12 | −3.297716218317950E−13 | 1.309028083467640E−15 |
| A14 | 2.500182707815250E−15 | −5.530936652418790E−18 |
| A16 | −1.143162428521930E−17 | 1.381088949395780E−20 |
| A18 | 2.885641405427620E−20 | −1.883371085924860E−23 |
| A20 | −3.084755378280610E−23 | 1.081865484007340E−26 |

### Example 12

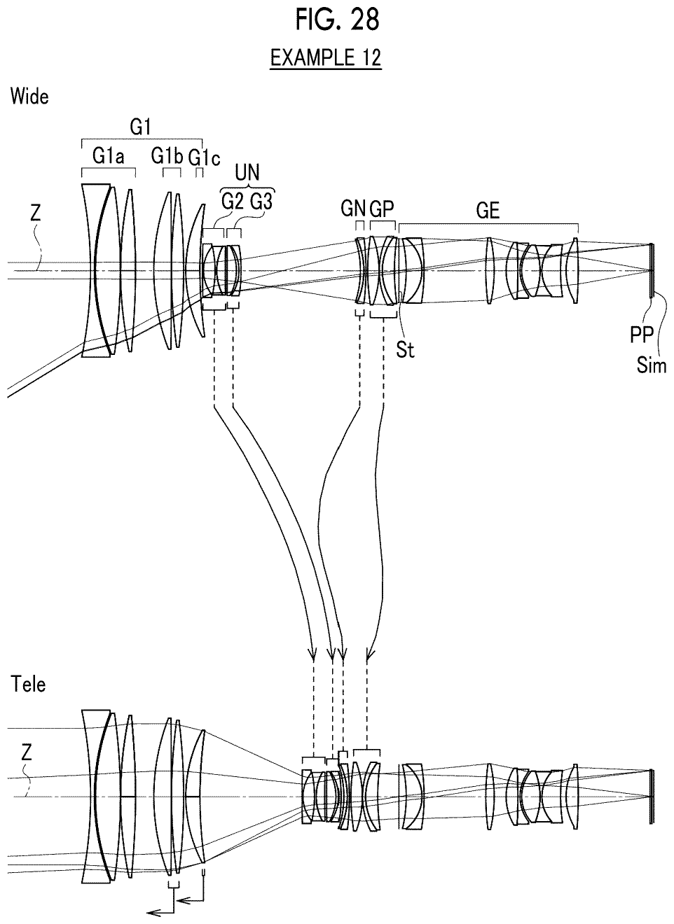

FIG. 28 shows a configuration and movement loci of the zoom lens according to Example 12. The zoom lens according to Example 12 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of two lens groups including a second lens group G2 that has a negative refractive power and a third lens group G3 that has a positive refractive power, in order from the object side to the image side.

During zooming from the wide angle end to the telephoto end, the first lens group G1 and the final lens group GE remain stationary with respect to the image plane Sim, and the second lens group G2, the third lens group G3, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

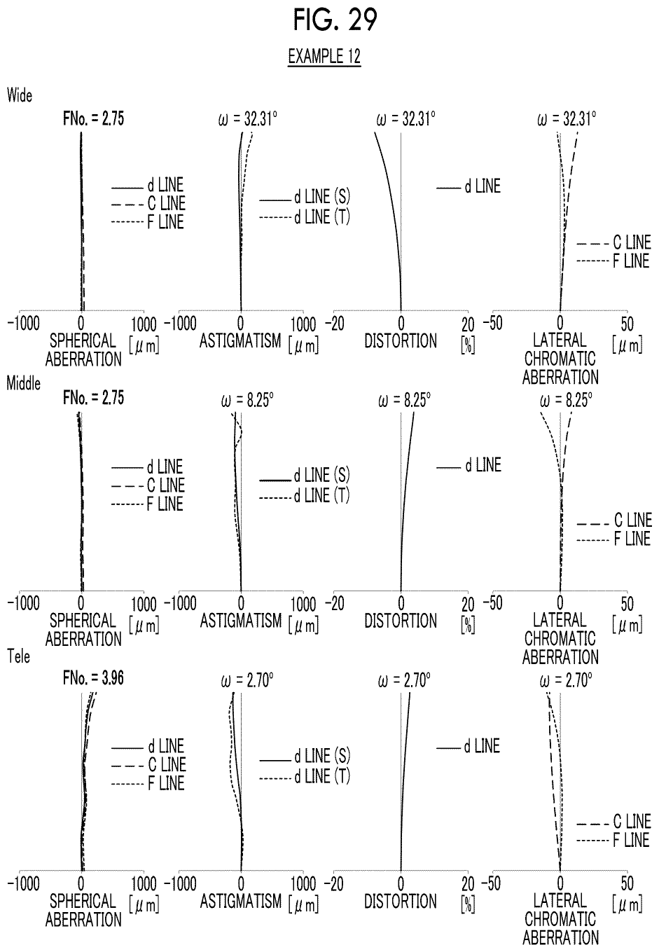

Regarding the zoom lens according to Example 12, Table 37 shows basic lens data, Table 38 shows specifications and variable surface spacings, and Table 39 shows aspherical coefficients thereof. FIG. 29 shows aberration diagrams thereof.

TABLE 37
Example 12

| Sn | R | D | Nd | vd | θg, F | SG | ED |
|---|---|---|---|---|---|---|---|
| 1 | −245.6948 | 2.0218 | 1.67300 | 38.26 | 0.57580 | 3.01 | 96.00 |
| 2 | 131.3710 | 0.6329 | | | | | 92.52 |
| 3 | 129.6831 | 13.3478 | 1.43387 | 95.18 | 0.53733 | 3.18 | 92.63 |
| 4 | −339.5895 | 0.1200 | | | | | 92.42 |
| 5 | 224.1186 | 8.0185 | 1.43700 | 95.10 | 0.53364 | 3.53 | 90.00 |
| *6 | −400.7011 | DD[6] | | | | | 89.89 |
| 7 | 124.5941 | 9.4042 | 1.43387 | 95.18 | 0.53733 | 3.18 | 87.19 |
| 8 | −5463.8107 | 0.1198 | | | | | 86.65 |
| 9 | 328.3586 | 6.4981 | 1.43387 | 95.18 | 0.53733 | 3.18 | 85.00 |
| 10 | −360.2931 | DD[10] | | | | | 84.54 |
| *11 | 80.2761 | 7.6055 | 1.59282 | 68.62 | 0.54414 | 4.13 | 73.61 |
| 12 | 262.7366 | DD[12] | | | | | 72.48 |
| 13 | 600.4326 | 0.5001 | 1.89753 | 38.25 | 0.57486 | 5.10 | 29.78 |
| 14 | 21.6965 | 6.2137 | | | | | 26.23 |
| 15 | −63.8472 | 0.9098 | 1.84850 | 43.79 | 0.56197 | 5.08 | 26.17 |
| 16 | 29.2110 | 4.5851 | 1.85451 | 25.15 | 0.61031 | 3.48 | 26.90 |
| 17 | 657.3323 | DD[17] | | | | | 27.08 |
| 18 | 1774.0945 | 4.9919 | 1.85451 | 25.15 | 0.61031 | 3.48 | 27.51 |
| 19 | −29.1839 | 1.3764 | | | | | 27.71 |
| 20 | −24.9481 | 1.1000 | 1.88116 | 40.94 | 0.56664 | 5.51 | 26.98 |
| *21 | −109.2455 | DD[21] | | | | | 27.96 |
| 22 | −58.0874 | 1.8443 | 1.89999 | 20.00 | 0.64193 | 3.55 | 34.80 |
| 23 | −45.1748 | 1.1098 | 1.76966 | 51.65 | 0.55794 | 4.98 | 35.15 |
| 24 | −159.8647 | DD[24] | | | | | 36.33 |
| *25 | 108.4334 | 6.1197 | 1.59349 | 67.00 | 0.53667 | 3.14 | 37.70 |
| 26 | −57.0951 | 0.1198 | | | | | 38.08 |
| 27 | 44.0593 | 1.6492 | 1.90000 | 20.00 | 0.64194 | 3.55 | 38.21 |
| 28 | 31.5874 | 6.4961 | 1.52937 | 76.39 | 0.53891 | 3.64 | 36.81 |
| 29 | 132.8361 | DD[29] | | | | | 36.42 |
| 30(St) | ∞ | 3.9371 | | | | | 35.52 |
| 31 | −78.8803 | 8.4605 | 1.52726 | 76.82 | 0.53879 | 3.63 | 35.28 |
| 32 | −22.9029 | 1.1303 | 1.54108 | 56.95 | 0.54760 | 2.73 | 35.43 |
| 33 | −114.5210 | 33.1100 | | | | | 36.21 |
| 34 | 143.0674 | 4.4989 | 1.84666 | 23.83 | 0.61603 | 5.51 | 36.50 |
| 35 | −85.0247 | 6.4005 | | | | | 36.50 |
| 36 | 31.5561 | 6.3540 | 1.48749 | 70.24 | 0.53007 | 2.46 | 31.54 |
| 37 | −274.7538 | 1.1226 | 1.91413 | 36.59 | 0.57905 | 5.20 | 30.46 |
| 38 | 23.3674 | 0.9035 | | | | | 27.71 |
| 39 | 22.0504 | 9.8207 | 1.51860 | 69.89 | 0.53184 | 2.60 | 28.49 |
| 40 | −40.0016 | 1.0042 | 1.88155 | 39.85 | 0.57090 | 4.99 | 27.90 |
| 41 | 20.8639 | 10.0119 | 1.55319 | 71.19 | 0.53954 | 3.52 | 27.25 |
| 42 | 101.1092 | 2.9724 | | | | | 29.00 |
| 43 | 34.3661 | 6.5047 | 1.52049 | 52.44 | 0.55636 | 2.54 | 33.00 |
| 44 | −241.6851 | 38.4991 | | | | | 33.00 |
| 45 | ∞ | 1.0000 | 1.51633 | 64.14 | 0.53531 | 2.52 | 30.02 |
| 46 | ∞ | 1.1000 | | | | | 29.97 |

TABLE 38
Example 12

| | Object distance | | | | | |
|---|---|---|---|---|---|---|
| | Infinity | | | Close range (0.90 m) | | |
| | Zooming state | | | | | |
| | Wide | Middle | Tele | Wide | Middle | Tele |
| Zr | 1.00 | 3.88 | 12.05 | 1.00 | 3.88 | 12.05 |
| f | 24.90 | 96.54 | 299.81 | 28.85 | 132.54 | 302.30 |
| FNo. | 2.75 | 2.75 | 3.96 | 2.75 | 2.75 | 4.36 |
| 2ω[°] | 64.62 | 16.50 | 5.40 | 52.02 | 10.56 | 1.00 |
| DD[6] | 9.7979 | 9.7979 | 9.7979 | 0.8022 | 0.8022 | 0.8022 |
| DD[10] | 1.1391 | 1.1391 | 1.1391 | 1.4866 | 1.4866 | 1.4866 |
| DD[12] | 1.4041 | 40.5668 | 54.7526 | 10.0523 | 49.2150 | 63.4008 |
| DD[17] | 0.9824 | 1.2338 | 0.9969 | 0.9824 | 1.2338 | 0.9969 |
| DD[21] | 63.7437 | 2.8396 | 1.4912 | 63.7437 | 2.8396 | 1.4912 |
| DD[24] | 0.9286 | 20.7836 | 0.8362 | 0.9286 | 20.7836 | 0.8362 |
| DD[29] | 2.3690 | 4.0040 | 11.3508 | 2.3690 | 4.0040 | 11.3508 |
| IHw | 14.525 | | | | | |

TABLE 39
Example 12

| Sn | 6 | 11 |
|---|---|---|
| KA | 1.000000000000000E+00 | 9.012312308705410E−01 |
| A4 | 1.021560873495490E−07 | 8.508397738703530E−09 |
| A6 | −1.426031207847270E−10 | −1.429912153928700E−10 |
| A8 | 3.857217055953060E−13 | 4.240105890142480E−13 |
| A10 | −5.567829845379690E−16 | −6.544105959208820E−16 |
| A12 | 4.847521449658430E−19 | 5.502460161790750E−19 |
| A14 | −2.605037828305380E−22 | −2.277471189296950E−22 |
| A16 | 8.434770745414990E−26 | 1.734987386082760E−26 |
| A18 | −1.504620247433720E−29 | 1.783179230749300E−29 |
| A20 | 1.131903030433110E−33 | −4.333156175392860E−33 |
| Sn | 21 | 25 |
| KA | 1.524437434497030E+01 | 5.125489356631200E+00 |
| A4 | −4.736153011392070E−06 | −2.308604561728530E−06 |
| A6 | 3.264261326812550E−08 | 3.609006129479950E−11 |
| A8 | −1.236419313285590E−09 | 1.367392264145770E−11 |
| A10 | 2.451013777847930E−11 | −1.785245090210620E−13 |
| A12 | −2.953593298424960E−13 | 1.266598151515630E−15 |
| A14 | 2.198528314625960E−15 | −5.322351481112210E−18 |
| A16 | −9.869409313040160E−18 | 1.321726198278880E−20 |
| A18 | 2.445955106593180E−20 | −1.792547727212960E−23 |
| A20 | −2.567141178541420E−23 | 1.024054511584310E−26 |

### Example 13

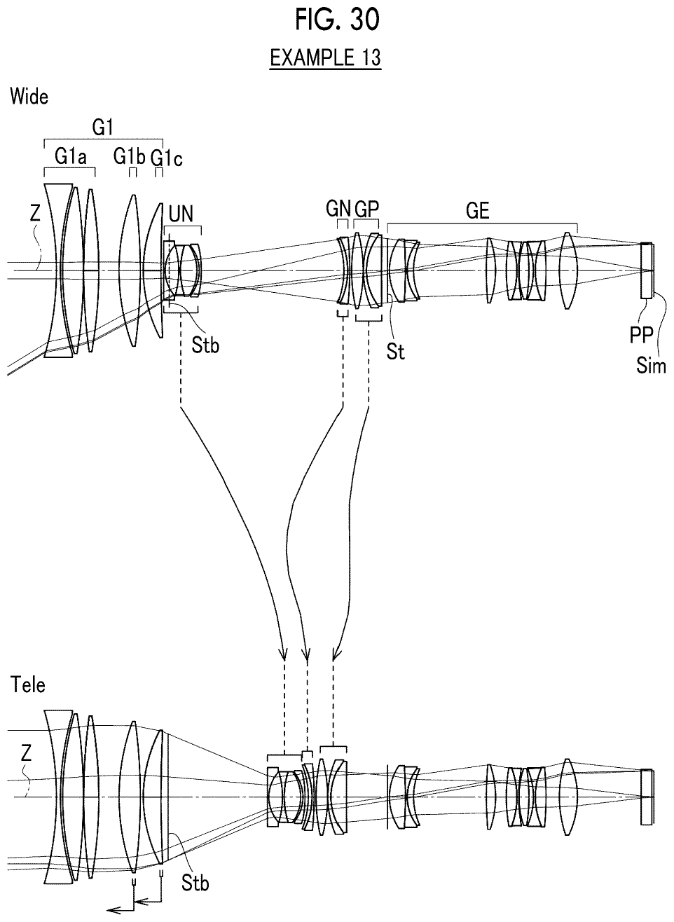

FIG. 30 shows a configuration and movement loci of the zoom lens according to Example 13. The zoom lens according to Example 13 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group. The zoom lens according to Example 13 has a secondary stop Stb in addition to the aperture stop St.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

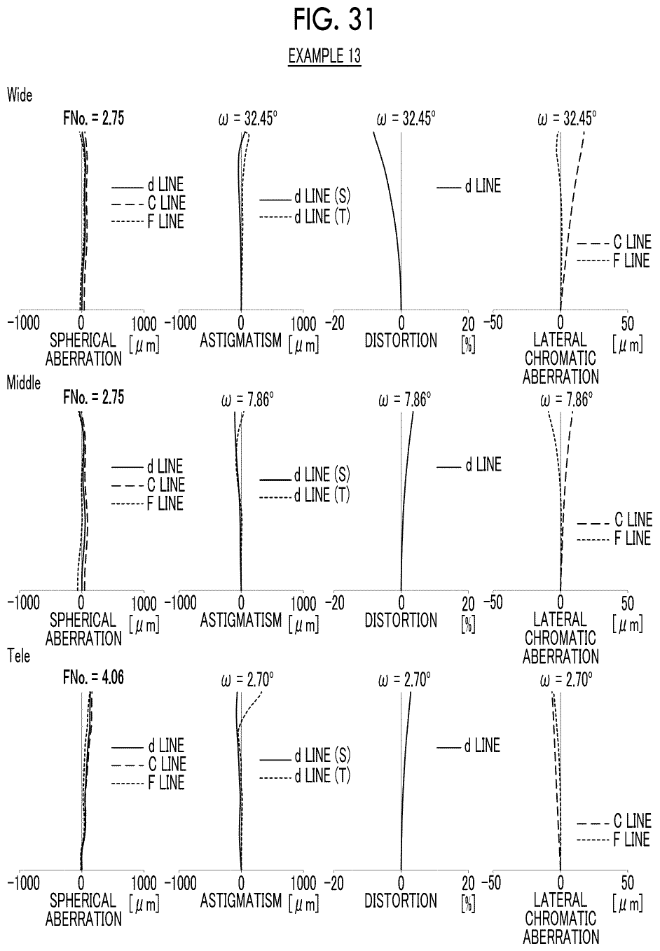

Regarding the zoom lens according to Example 13, Table 40 shows basic lens data, Table 41 shows specifications and variable surface spacings, and Table 42 shows aspherical coefficients thereof. FIG. 31 shows aberration diagrams thereof.

TABLE 40
Example 13

| Sn | R | D | Nd | vd | θg, F | SG | ED |
|---|---|---|---|---|---|---|---|
| 1 | −180.4431 | 2.1594 | 1.67300 | 38.26 | 0.57580 | 3.01 | 96.14 |
| 2 | 169.9391 | 1.2229 | | | | | 92.14 |
| 3 | 173.1223 | 11.1208 | 1.43387 | 95.18 | 0.53733 | 3.18 | 92.13 |
| 4 | −309.9827 | 0.1000 | | | | | 91.89 |
| 5 | 338.7821 | 8.1625 | 1.55032 | 75.50 | 0.54001 | 4.09 | 89.98 |
| *6 | −256.7296 | DD[6] | | | | | 89.88 |
| 7 | 125.1868 | 11.4093 | 1.43387 | 95.18 | 0.53733 | 3.18 | 83.79 |
| 8 | −320.8118 | DD[8] | | | | | 83.43 |
| *9 | 80.5866 | 9.5106 | 1.49700 | 81.61 | 0.53887 | 3.70 | 74.28 |
| 10(Stb) | ∞ | 5.0000 | | | | | 69.04 |
| 11 | 781.1673 | DD[11] | | | | | 73.27 |
| 12 | 2280.9560 | 0.8007 | 1.87070 | 40.73 | 0.56825 | 4.84 | 32.72 |
| 13 | 21.4285 | 7.2951 | | | | | 27.55 |
| 14 | −51.8581 | 0.9372 | 1.75500 | 52.32 | 0.54757 | 4.17 | 27.43 |
| 15 | 46.7340 | 8.8310 | 1.75211 | 25.05 | 0.61924 | 3.14 | 27.93 |
| 16 | −25.3484 | 1.2241 | | | | | 28.20 |
| 17 | −22.5521 | 1.1038 | 1.72047 | 34.71 | 0.58350 | 3.19 | 27.10 |
| *18 | −74.9595 | DD[18] | | | | | 29.18 |
| 19 | −49.7639 | 2.0144 | 1.86966 | 20.02 | 0.64349 | 3.37 | 35.12 |
| 20 | −41.5634 | 1.1258 | 1.57135 | 52.95 | 0.55544 | 2.98 | 35.61 |
| 21 | −184.8833 | DD[21] | | | | | 36.91 |
| 22 | 99.7135 | 6.2240 | 1.74320 | 49.29 | 0.55303 | 4.20 | 42.03 |
| *23 | −79.8160 | 0.1002 | | | | | 42.09 |
| 24 | 53.9510 | 1.6454 | 1.86966 | 20.02 | 0.64349 | 3.37 | 41.22 |
| 25 | 33.2180 | 8.0549 | 1.48071 | 85.29 | 0.53623 | 3.68 | 39.43 |
| 26 | 1886.2908 | DD[26] | | | | | 39.11 |
| 27(St) | ∞ | 1.0000 | | | | | 35.47 |
| 28 | 32.4451 | 8.5594 | 1.43700 | 95.10 | 0.53364 | 3.53 | 34.80 |
| 29 | −269.0199 | 1.0182 | 1.80400 | 46.53 | 0.55775 | 4.46 | 33.50 |
| 30 | 26.4378 | 3.3563 | 1.80809 | 22.76 | 0.63073 | 3.29 | 31.38 |
| 31 | 37.9889 | 39.0863 | | | | | 30.90 |
| 32 | 211.1131 | 4.9285 | 1.73800 | 32.33 | 0.59005 | 3.19 | 35.70 |
| 33 | −56.7975 | 5.7744 | | | | | 35.82 |
| 34 | 97.4909 | 5.6801 | 1.43700 | 95.10 | 0.53364 | 3.53 | 32.43 |
| 35 | −47.3140 | 1.0007 | 1.83481 | 42.74 | 0.56490 | 4.58 | 31.91 |
| 36 | 90.8084 | 0.0998 | | | | | 31.40 |
| 37 | 51.1629 | 5.3581 | 1.51633 | 64.14 | 0.53531 | 2.52 | 31.55 |
| 38 | −100.6880 | 2.3874 | | | | | 31.31 |
| 39 | −41.5430 | 1.0133 | 1.90366 | 31.31 | 0.59481 | 4.51 | 31.08 |
| 40 | 41.0683 | 5.7483 | 1.62004 | 36.26 | 0.58800 | 2.69 | 32.46 |
| 41 | −174.8305 | 7.1784 | | | | | 33.09 |
| 42 | 67.8365 | 9.6645 | 1.48749 | 70.44 | 0.53062 | 2.45 | 38.67 |
| 43 | −50.7956 | 34.2178 | | | | | 39.05 |
| 44 | ∞ | 5.7000 | 1.51633 | 64.14 | 0.53531 | 2.52 | 30.84 |
| 45 | ∞ | 1.1000 | | | | | 30.04 |

TABLE 41
Example 13

| | Object distance | | | | | |
|---|---|---|---|---|---|---|
| | Infinity | | | Close range (0.88 m) | | |
| | Zooming state | | | | | |
| | Wide | Middle | Tele | Wide | Middle | Tele |
| Zr | 1.00 | 4.08 | 12.05 | 1.00 | 4.08 | 12.05 |
| f | 24.89 | 101.60 | 299.73 | 29.18 | 154.13 | 820.14 |
| FNo. | 2.75 | 2.75 | 4.06 | 2.75 | 2.75 | 4.51 |
| 2ω[°] | 64.90 | 15.72 | 5.40 | 51.66 | 9.84 | 0.64 |
| DD[6] | 10.8487 | 10.8487 | 10.8487 | 1.0042 | 1.0042 | 1.0042 |
| DD[8] | 1.5989 | 1.5989 | 1.5989 | 1.5040 | 1.5040 | 1.5040 |
| DD[11] | −3.5789 | 36.9895 | 52.0495 | 6.3604 | 46.9288 | 61.9888 |
| DD[18] | 76.2212 | 5.5389 | 1.7703 | 76.2212 | 5.5389 | 1.7703 |
| DD[21] | 1.0155 | 20.8944 | 1.0137 | 1.0155 | 20.8944 | 1.0137 |
| DD[26] | 3.2384 | 13.4734 | 22.0627 | 3.2384 | 13.4734 | 22.0627 |
| IHw | 14.525 | | | | | |

TABLE 42
Example 13

| Sn | 6 | 9 |
|---|---|---|
| KA | 1.977078099296220E+00 | 2.619751455177160E−01 |
| A3 | 8.712726631218470E−23 | 0.000000000000000E+00 |
| A4 | −7.908811289424000E−08 | −5.770266487977750E−08 |
| A5 | 1.130825675536470E−08 | 1.002518456999470E−08 |
| A6 | −2.061403798812870E−10 | 1.977614786576060E−10 |
| A7 | 8.644602774440160E−12 | −2.531430082705440E−11 |
| A8 | 3.178889952022080E−13 | −8.355941630347770E−14 |
| A9 | 2.793555094192000E−15 | 3.894374633854220E−14 |
| A10 | −1.908077691413450E−16 | −3.286292549883190E−16 |
| A11 | −2.831631246895240E−19 | −2.926508731643690E−17 |
| A12 | 6.196066272522070E−20 | 4.321205103038990E−19 |
| A13 | −3.556207736927960E−23 | 1.026167424664740E−20 |
| A14 | −1.100152288612740E−23 | −1.917014562005200E−22 |
| A15 | 7.083624450153780E−27 | −1.348488510559680E−24 |
| A16 | 8.363906313238970E−28 | 2.909003329678950E−26 |

| Sn | 18 |
|---|---|
| KA | 3.188986337428290E+00 |
| A3 | 1.269977122597150E−19 |
| A4 | −6.673572198650700E−06 |
| A5 | 8.333312263777220E−07 |
| A6 | −3.297088185570400E−07 |
| A7 | 5.115314054575920E−08 |
| A8 | −1.582108586485900E−09 |
| A9 | −5.103171373423790E−10 |
| A10 | 5.244282965534530E−11 |
| A11 | 9.617270326631600E−13 |
| A12 | −3.365125046548630E−13 |
| A13 | 5.998178309429390E−15 |
| A14 | 9.864865178545810E−16 |
| A15 | −3.183747204203410E−17 |
| A16 | −1.463315574731940E−18 |
| A17 | 5.573094784277540E−20 |
| A18 | 1.035623181084530E−21 |
| A19 | −3.449987922934200E−23 |
| A20 | −2.629171369993720E−25 |
| Sn | 23 |
| KA | 1.611122825060810E+00 |
| A4 | 9.783424156379460E−07 |
| A6 | 4.784875807104330E−10 |
| A8 | −8.678854504225920E−12 |
| A10 | 6.404294068069640E−14 |
| A12 | −2.437369262288340E−16 |
| A14 | 5.178866502575800E−19 |
| A16 | −6.072590999650700E−22 |
| A18 | 3.572032171096080E−25 |
| A20 | −8.091824637432770E−29 |

### Example 13-1

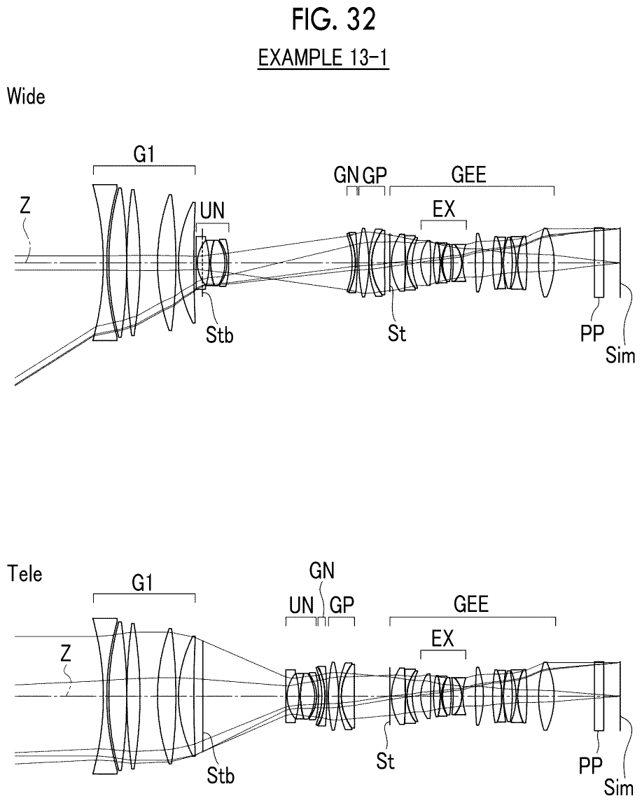

Example 13-1 is an example in which the EX group EX is inserted in the zoom lens according to Example 13. FIG. 32 shows a cross-sectional view of a configuration and luminous flux of the zoom lens according to Example 13-1. In the present example, the same illustration method as that of FIG. 5 is used for the cross-sectional views of the examples into which the following EX group EX is inserted. The zoom lens according to Example 13-1 has the final lens group GEE in which the EX group EX is inserted in the final lens group GE of Example 13, instead of the final lens group GE of Example 13. The other lens groups and the group configuration of Example 13-1 are the same as those of the zoom lens according to Example 13.

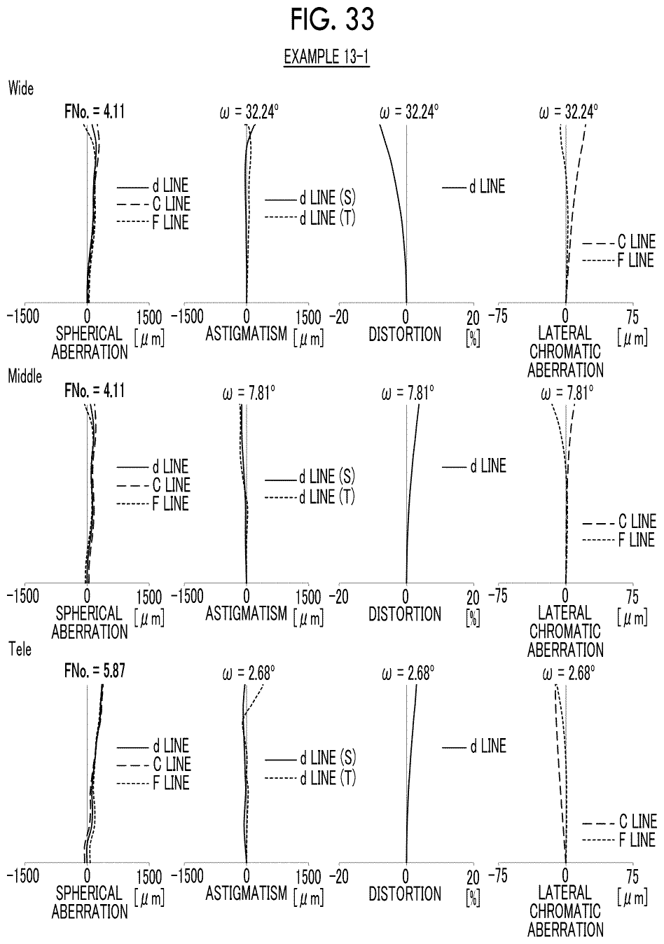

Regarding the zoom lens according to Example 13-1, Tables 43A and 43B show basic lens data, Table 44 shows specifications and variable surface spacings, and Table 45 shows aspherical coefficients thereof. FIG. 33 shows aberration diagrams.

TABLE 43A
Example 13-1

| Sn | R | D | Nd | vd | θg, F | SG | ED |
|---|---|---|---|---|---|---|---|
| 1 | −180.4431 | 2.1594 | 1.67300 | 38.26 | 0.57580 | 3.01 | 96.14 |
| 2 | 169.9391 | 1.2229 | | | | | 92.14 |
| 3 | 173.1223 | 11.1208 | 1.43387 | 95.18 | 0.53733 | 3.18 | 92.14 |
| 4 | −309.9827 | 0.1000 | | | | | 91.89 |
| 5 | 338.7821 | 8.1625 | 1.55032 | 75.50 | 0.54001 | 4.09 | 89.98 |
| *6 | −256.7296 | DD[6] | | | | | 89.88 |
| 7 | 125.1868 | 11.4093 | 1.43387 | 95.18 | 0.53733 | 3.18 | 83.79 |
| 8 | −320.8118 | DD[8] | | | | | 83.43 |
| *9 | 80.5866 | 9.5106 | 1.49700 | 81.61 | 0.53887 | 3.70 | 74.28 |
| 10 | ∞ | 5.0000 | | | | | 69.04 |
| (Stb) | | | | | | | |
| 11 | 781.1673 | DD[11] | | | | | 73.27 |
| 12 | 2280.9560 | 0.8007 | 1.87070 | 40.73 | 0.56825 | 4.84 | 32.72 |
| 13 | 21.4285 | 7.2951 | | | | | 27.55 |
| 14 | −51.8581 | 0.9372 | 1.75500 | 52.32 | 0.54757 | 4.17 | 27.43 |
| 15 | 46.7340 | 8.8310 | 1.75211 | 25.05 | 0.61924 | 3.14 | 27.93 |
| 16 | −25.3484 | 1.2241 | | | | | 28.20 |
| 17 | −22.5521 | 1.1038 | 1.72047 | 34.71 | 0.58350 | 3.19 | 27.10 |
| *18 | −74.9595 | DD[18] | | | | | 29.18 |
| 19 | 49.7639 | 2.0144 | 1.86966 | 20.02 | 0.64349 | 3.37 | 35.12 |
| 20 | −41.5634 | 1.1258 | 1.57135 | 52.95 | 0.55544 | 2.98 | 35.61 |
| 21 | −184.8833 | DD[21] | | | | | 36.91 |
| 22 | 99.7135 | 6.2240 | 1.74320 | 49.29 | 0.55303 | 4.20 | 42.03 |
| *23 | −79.8160 | 0.1002 | | | | | 42.09 |
| 24 | 53.9510 | 1.6454 | 1.86966 | 20.02 | 0.64349 | 3.37 | 41.22 |
| 25 | 33.2180 | 8.0549 | 1.48071 | 85.29 | 0.53623 | 3.68 | 39.43 |
| 26 | 1886.2908 | DD[26] | | | | | 39.11 |

TABLE 43B
Example 13-1

| Sn | R | D | Nd | νd | θg, F | SG | ED |
|---|---|---|---|---|---|---|---|
| 27(St) | ∞ | 1.0000 | | | | | 35.47 |
| 28 | 32.4451 | 8.5594 | 1.43700 | 95.10 | 0.53364 | 3.53 | 33.62 |
| 29 | −269.0199 | 1.0182 | 1.80400 | 46.53 | 0.55775 | 4.46 | 31.66 |
| 30 | 26.4378 | 3.3563 | 1.80809 | 22.76 | 0.63073 | 3.29 | 29.16 |
| 31 | 37.9889 | 5.2164 | | | | | 28.42 |
| 32 | 25.7954 | 6.2113 | 1.48749 | 70.44 | 0.53062 | 2.45 | 27.66 |
| 33 | −188.7079 | 1.7019 | | | | | 27.20 |
| 34 | 54.5986 | 4.0736 | 1.48749 | 70.44 | 0.53062 | 2.45 | 25.41 |
| 35 | −64.7170 | 0.8086 | 1.83400 | 37.34 | 0.57908 | 4.57 | 24.74 |
| 36 | 21.7610 | 0.7870 | | | | | 23.18 |
| 37 | 26.3161 | 5.2157 | 1.60342 | 38.03 | 0.58356 | 2.63 | 23.27 |
| 38 | −74.1769 | 1.3119 | | | | | 23.20 |
| 39 | −71.1026 | 5.2609 | 1.73800 | 32.33 | 0.59005 | 3.19 | 22.84 |
| 40 | −16.9510 | 0.7158 | 1.72916 | 54.68 | 0.54451 | 4.18 | 22.81 |
| 41 | 36.2909 | 7.7833 | | | | | 22.63 |
| 42 | 211.1131 | 4.9285 | 1.73800 | 32.33 | 0.59005 | 3.19 | 26.11 |
| 43 | −56.7975 | 5.7744 | | | | | 26.85 |
| 44 | 97.4909 | 5.6801 | 1.43700 | 95.10 | 0.53364 | 3.53 | 27.52 |
| 45 | −47.3140 | 1.0007 | 1.83481 | 42.74 | 0.56490 | 4.58 | 27.44 |
| 46 | 90.8084 | 0.0998 | | | | | 27.87 |
| 47 | 51.1629 | 5.3581 | 1.51633 | 64.14 | 0.53531 | 2.52 | 28.36 |
| 48 | −100.6880 | 2.3874 | | | | | 28.60 |
| 49 | −41.5430 | 1.0133 | 1.90366 | 31.31 | 0.59481 | 4.51 | 28.60 |
| 50 | 41.0683 | 5.7483 | 1.62004 | 36.26 | 0.58800 | 2.69 | 30.86 |
| 51 | −174.8305 | 7.1784 | | | | | 32.03 |
| 52 | 67.8365 | 9.6645 | 1.48749 | 70.44 | 0.53062 | 2.45 | 41.62 |
| 53 | −50.7956 | 34.2178 | | | | | 42.17 |
| 54 | ∞ | 5.7000 | 1.51633 | 64.14 | 0.53531 | 2.52 | 42.74 |
| 55 | ∞ | 1.1000 | | | | | 42.79 |

TABLE 44
Example 13-1

| Object | | | | | | |
|---|---|---|---|---|---|---|
| distance | | | | | | |
| Zooming | Infinity | | | Close range (0.88 m) | | |
| state | Wide | Middle | Tele | Wide | Middle | Tele |
| Zr | 1.00 | 4.08 | 12.05 | 1.00 | 4.08 | 12.05 |
| f | 35.99 | 146.96 | 433.44 | 41.84 | 188.60 | 307.47 |
| FNo. | 4.11 | 4.11 | 5.87 | 4.11 | 4.11 | 6.56 |
| 2ω[°] | 64.48 | 15.62 | 5.36 | 51.40 | 9.78 | 0.64 |
| DD[6] | 10.8487 | 10.8487 | 10.8487 | 1.0042 | 1.0042 | 1.0042 |
| DD[8] | 1.5989 | 1.5989 | 1.5989 | 1.5040 | 1.5040 | 1.5040 |
| DD[11] | −3.5789 | 36.9895 | 52.0495 | 6.3604 | 46.9288 | 61.9888 |
| DD[18] | 76.2212 | 5.5389 | 1.7703 | 76.2212 | 5.5389 | 1.7703 |
| DD[21] | 1.0155 | 20.8944 | 1.0137 | 1.0155 | 20.8944 | 1.0137 |
| DD[26] | 3.2384 | 13.4734 | 22.0627 | 3.2384 | 13.4734 | 22.0627 |

TABLE 45
Example 13-1

| Sn | 6 | 9 |
|---|---|---|
| KA | 1.977078099296220E+00 | 2.619751455177160E−01 |
| A3 | 8.712726631218470E−23 | 0.000000000000000E+00 |
| A4 | −7.908811289424000E−08 | −5.770266487977750E−08 |
| A5 | 1.130825675536470E−08 | 1.002518456999470E−08 |
| A6 | −2.061403798812870E−10 | 1.977614786576060E−10 |
| A7 | −8.644602774440160E−12 | −2.531430082705440E−11 |
| A8 | 3.178889952022080E−13 | −8.355941630347770E−14 |
| A9 | 2.793555094192000E−15 | 3.894374633854220E−14 |
| A10 | −1.908077691413450E−16 | −3.286292549883190E−16 |
| A11 | −2.831631246895240E−19 | −2.926508731643690E−17 |
| A12 | 6.196066272522070E−20 | 4.321205103038990E−19 |
| A13 | −3.556207736927960E−23 | 1.026167424664740E−20 |
| A14 | −1.100152288612740E−23 | −1.917014562005200E−22 |
| A15 | 7.083624450153780E−27 | −1.348488510559680E−24 |
| A16 | 8.363906313238970E−28 | 2.909003329678950E−26 |

| Sn | 18 |
|---|---|
| KA | 3.188986337428290E+00 |
| A3 | 1.269977122597150E−19 |
| A4 | −6.673572198650700E−06 |
| A5 | 8.333312263777220E−07 |
| A6 | −3.297088185570400E−07 |
| A7 | 5.115314054575920E−08 |
| A8 | −1.582108586485900E−09 |
| A9 | −5.103171373423790E−10 |
| A10 | 5.244282965534530E−11 |
| A11 | 9.617270326631600E−13 |
| A12 | −3.365125046548630E−13 |
| A13 | 5.998178309429390E−15 |
| A14 | 9.864865178545810E−16 |
| A15 | −3.183747204203410E−17 |
| A16 | 1.463315574731940E−18 |
| A17 | 5.573094784277540E−20 |
| A18 | 1.035623181084530E−21 |
| A19 | −3.449987922934200E−23 |
| A20 | −2.629171369993720E−25 |
| Sn | 23 |
| KA | 1.611122825060810E+00 |
| A4 | 9.783424156379460E−07 |
| A6 | 4.784875807104330E−10 |
| A8 | −8.678854504225920E−12 |
| A10 | 6.404294068069640E−14 |
| A12 | −2.437369262288340E−16 |
| A14 | 5.178866502575800E−19 |
| A16 | −6.072590999650700E−22 |
| A18 | 3.572032171096080E−25 |
| A20 | −8.091824637432770E−29 |

### Example 14

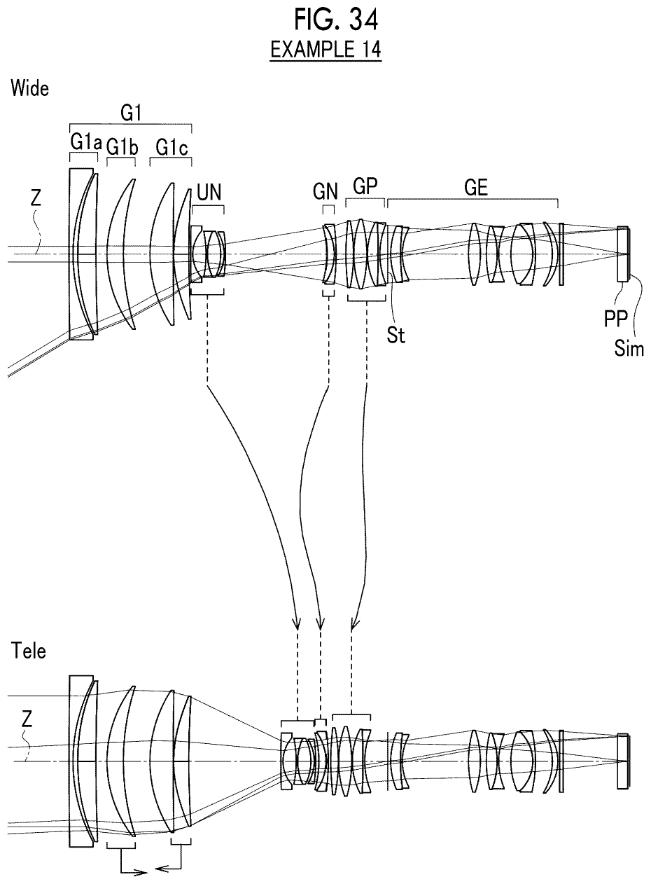

FIG. 34 shows a configuration and movement loci of the zoom lens according to Example 14. The zoom lens according to Example 14 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, the first b-part group G1b moves to the image side, and the first c-part group G1c moves to the object side.

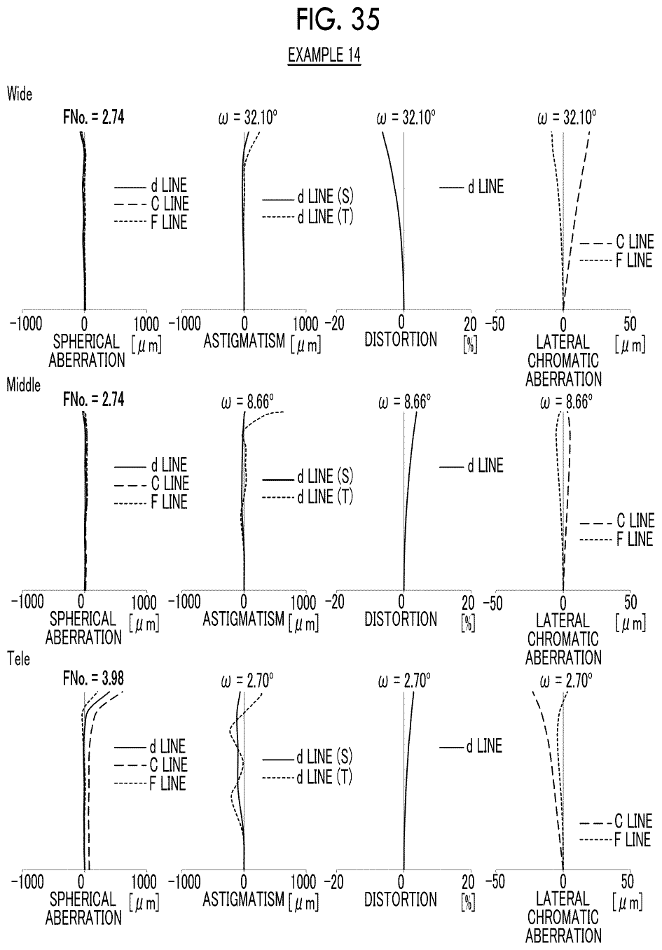

Regarding the zoom lens according to Example 14, Table 46 shows basic lens data, Table 47 shows specifications and variable surface spacings, and Tables 48A and 48B show aspherical coefficients thereof. FIG. 35 shows aberration diagrams.

TABLE 46
Example 14

| Sn | R | D | Nd | νd | θg, F | SG | ED |
|---|---|---|---|---|---|---|---|
| 1 | 3532.9627 | 2.2092 | 1.76372 | 33.76 | 0.59134 | 3.76 | 99.00 |
| 2 | 101.5960 | 2.6330 | | | | | 92.62 |
| *3 | 128.7910 | 10.1358 | 1.49700 | 81.54 | 0.53748 | 3.62 | 92.52 |
| 4 | 1085.8625 | DD[4] | | | | | 92.19 |
| 5 | 72.5289 | 9.1260 | 1.43875 | 94.66 | 0.53402 | 3.59 | 86.42 |
| 6 | 143.1459 | DD[6] | | | | | 85.94 |
| 7 | 76.7105 | 13.0056 | 1.43875 | 94.66 | 0.53402 | 3.59 | 81.83 |
| 8 | 2705.5282 | 0.1998 | | | | | 80.77 |
| *9 | 75.1108 | 8.4778 | 1.59282 | 68.62 | 0.54414 | 4.13 | 74.87 |
| 10 | 572.2175 | DD[10] | | | | | 73.91 |
| 11 | 555.5545 | 1.2046 | 1.88290 | 36.69 | 0.57961 | 4.97 | 32.82 |
| 12 | 20.7772 | 7.3884 | | | | | 27.02 |
| 13 | −66.4869 | 0.7848 | 1.85102 | 42.86 | 0.56429 | 4.80 | 26.57 |
| 14 | 32.1397 | 7.3714 | 1.84790 | 23.65 | 0.62149 | 3.63 | 26.39 |
| 15 | −30.6561 | 1.8886 | | | | | 26.33 |
| 16 | −25.0002 | 0.7500 | 1.80610 | 40.93 | 0.57019 | 4.43 | 25.11 |
| *17 | −123.7860 | DD[17] | | | | | 25.57 |
| 18 | −61.4924 | 3.9508 | 1.86576 | 22.37 | 0.63014 | 3.66 | 32.27 |
| 19 | −29.6028 | 0.9998 | 1.93220 | 34.78 | 0.58371 | 5.30 | 32.66 |
| 20 | −140.5464 | DD[20] | | | | | 34.41 |
| *21 | 129.5067 | 4.2588 | 1.59349 | 67.00 | 0.53667 | 3.14 | 37.95 |
| 22 | −100.6875 | 0.1800 | | | | | 38.42 |
| 23 | 62.4569 | 7.2330 | 1.59250 | 68.67 | 0.54339 | 3.70 | 40.07 |
| 24 | −78.6003 | 0.3684 | | | | | 39.98 |
| 25 | 41.3882 | 5.9225 | 1.49733 | 81.49 | 0.53750 | 3.55 | 36.81 |
| 26 | −459.3964 | 1.0059 | 1.87300 | 31.85 | 0.59398 | 4.69 | 36.04 |
| 27 | 45.9386 | DD[27] | | | | | 33.91 |
| 28 | ∞ | 1.6864 | | | | | 33.30 |
| (St) | | | | | | | |
| 29 | 42.6659 | 5.4639 | 1.68282 | 33.95 | 0.59304 | 3.01 | 32.38 |
| 30 | 116.4542 | 1.0098 | 1.68015 | 38.82 | 0.57926 | 3.15 | 30.93 |
| 31 | 31.6806 | 36.9151 | | | | | 29.36 |
| 32 | 68.1602 | 6.6109 | 1.57003 | 45.00 | 0.56944 | 2.56 | 35.51 |
| 33 | −56.0182 | 3.3066 | | | | | 35.52 |
| 34 | 69.9628 | 6.0447 | 1.48749 | 70.24 | 0.53007 | 2.46 | 32.36 |
| 35 | −46.4990 | 0.9000 | 1.88300 | 40.76 | 0.56679 | 5.52 | 31.80 |
| 36 | 41.5406 | 6.7215 | | | | | 30.73 |
| 37 | 43.4171 | 12.2407 | 1.53658 | 63.59 | 0.53787 | 2.84 | 33.76 |
| 38 | −23.8550 | 1.5002 | 1.81600 | 46.62 | 0.55682 | 5.07 | 33.69 |
| 39 | −79.3215 | 9.3991 | | | | | 35.38 |
| 40 | −35.4358 | 3.0728 | 1.46056 | 89.39 | 0.53495 | 3.46 | 36.05 |
| 41 | −27.8587 | 1.0000 | | | | | 36.56 |
| 42 | ∞ | 2.0000 | 1.51633 | 64.14 | 0.53531 | 2.52 | 35.58 |
| 43 | ∞ | 30.2843 | | | | | 35.42 |
| 44 | ∞ | 5.7000 | 1.51633 | 64.14 | 0.53531 | 2.52 | 31.65 |
| 45 | ∞ | 1.1000 | | | | | 31.18 |

TABLE 47
Example 14

| Object | | | | | | |
|---|---|---|---|---|---|---|
| distance | | | | | | |
| Zooming | Infinity | | | Close range (0.89 m) | | |
| state | Wide | Middle | Tele | Wide | Middle | Tele |
| Zr | 1.00 | 3.72 | 12.12 | 1.00 | 3.72 | 12.12 |
| f | 24.73 | 91.90 | 299.66 | 27.65 | 123.92 | 462.90 |
| FNo. | 2.74 | 2.74 | 3.98 | 2.74 | 2.74 | 4.34 |
| 2ω[°] | 64.20 | 17.32 | 5.40 | 56.16 | 13.00 | 1.16 |
| DD[4] | 6.1778 | 6.1778 | 6.1778 | 13.1858 | 13.1858 | 13.1858 |
| DD[6] | 14.8342 | 14.8342 | 14.8342 | 0.9993 | 0.9993 | 0.9993 |
| DD[10] | 0.9979 | 37.0662 | 51.2898 | 7.8247 | 43.8930 | 58.1166 |
| DD[17] | 56.4550 | 4.6242 | 1.8271 | 56.4550 | 4.6242 | 1.8271 |
| DD[20] | 5.4496 | 20.0359 | 1.3463 | 5.4496 | 20.0359 | 1.3463 |
| DD[27] | 4.3613 | 5.5375 | 12.8006 | 4.3613 | 5.5375 | 12.8006 |
| IHw | 14.525 | | | | | |

TABLE 48A
Example 14

| Sn | 3 | 9 |
|---|---|---|
| KA | 1.000000000000000E+00 | 1.000000000000000E+00 |
| A3 | 6.098283710545840E−22 | 2.362365638521260E−21 |
| A4 | 6.910082662765990E−08 | −4.492866049215360E−07 |
| A5 | 2.321662192790530E−08 | −3.097326511654660E−08 |
| A6 | −1.144757842668260E−09 | 1.918722743674280E−09 |
| A7 | 7.034875402582250E−12 | −3.679444443395270E−11 |
| A8 | 1.647493138495190E−12 | −3.270453725802210E−12 |
| A9 | −5.352776589733790E−14 | 1.745623533120290E−13 |
| A10 | −1.188642514731840E−15 | 1.630278761982150E−15 |
| A11 | 8.255750001564040E−17 | −2.739167603129420E−16 |
| A12 | 1.012704263342370E−19 | 1.924671411333400E−18 |
| A13 | −6.653711449409090E−20 | 2.257647151727840E−19 |
| A14 | 5.122560322110240E−22 | −3.334109624685150E−21 |
| A15 | 2.900864173632820E−23 | −1.049608849147930E−22 |
| A16 | −3.657465233382100E−25 | 2.070744603633850E−24 |
| A17 | −6.343535542929950E−27 | 2.627630727576690E−26 |
| A18 | 9.985164915294180E−29 | −6.187921942489510E−28 |
| A19 | 5.367318533030900E−31 | −2.780895799337290E−30 |
| A20 | −9.698478576809500E−33 | 7.466200696815870E−32 |

| Sn | 17 |
|---|---|
| KA | 1.000000000000000E+00 |
| A3 | 2.849171165681150E−20 |
| A4 | −5.321157705813880E−06 |
| A5 | −1.320983587980310E−06 |
| A6 | 2.636170994467220E−07 |
| A7 | 1.363656124478190E−08 |
| A8 | −1.175220482622020E−08 |
| A9 | 8.229157467989090E−10 |
| A10 | 1.646135632160220E−10 |
| A11 | −2.057933659500930E−11 |
| A12 | −1.031003624081040E−12 |
| A13 | 2.112438054884560E−13 |
| A14 | 1.925976321565140E−15 |
| A15 | −1.142764113811600E−15 |
| A16 | 1.024863338278190E−17 |
| A17 | 3.224887557531930E−18 |
| A18 | −5.867485408963400E−20 |
| A19 | −3.741968948375220E−21 |
| A20 | 8.513681170877510E−23 |

TABLE 48B
Example 14

| Sn | 21 |
|---|---|
| KA | 1.000000000000000E+00 |
| A4 | −2.774598240000000E−06 |
| A6 | 4.228796500000000E−10 |
| A8 | 2.294709060000000E−11 |
| A10 | −8.488245470000000E−13 |
| A12 | 1.183175850000000E−14 |
| A14 | −8.793456270000000E−17 |
| A16 | 3.803318690000000E−19 |
| A18 | −9.613473970000000E−22 |
| A20 | 1.318341560000000E−24 |
| A22 | −7.582328140000000E−28 |

### Example 14-1

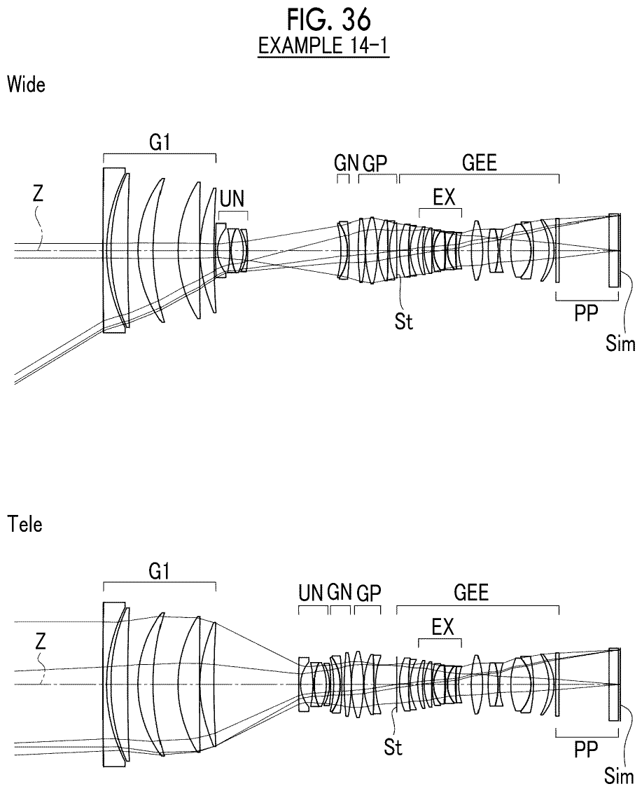

Example 14-1 is an example in which the EX group EX is inserted in the zoom lens according to Example 14. FIG. 36 shows a cross-sectional view of a configuration and luminous flux of the zoom lens according to Example 14-1. The zoom lens according to Example 14-1 has the final lens group GEE in which the EX group EX is inserted in the final lens group GE of Example 14, instead of the final lens group GE of Example 14. The other lens groups and the group configuration of Example 14-1 are the same as those of the zoom lens according to Example 14.

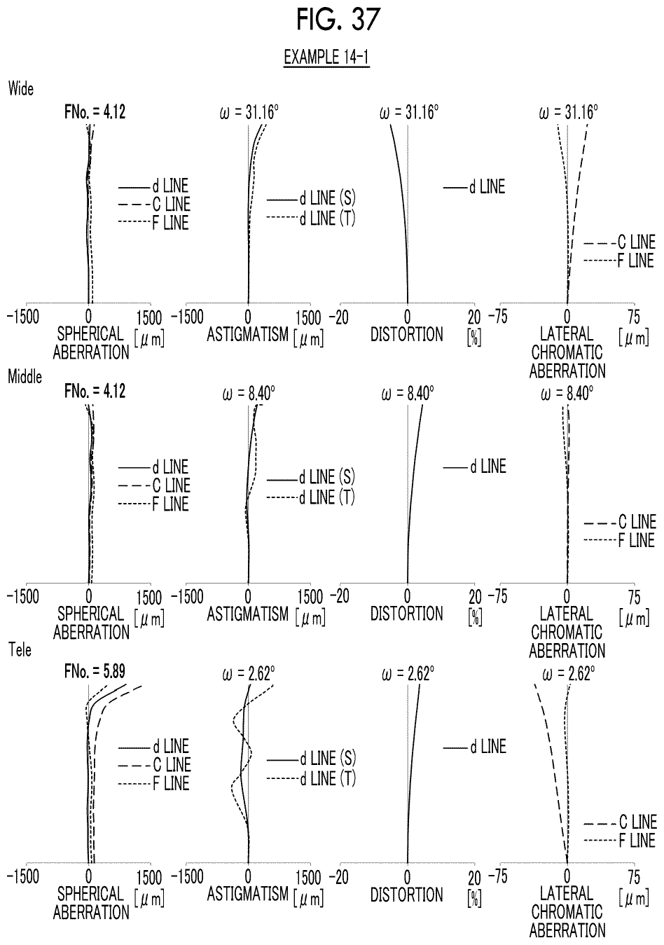

Regarding the zoom lens according to Example 14-1, Tables 49A and 49B show basic lens data, Table 50 shows specifications and variable surface spacings, and Tables 51A and 51B show aspherical coefficients thereof. FIG. 37 shows aberration diagrams.

TABLE 49A
Example 14-1

| Sn | R | D | Nd | νd | θg, F | SG | ED |
|---|---|---|---|---|---|---|---|
| 1 | 3532.9627 | 2.2092 | 1.76372 | 33.76 | 0.59134 | 3.76 | 99.00 |
| 2 | 101.5960 | 2.6330 | | | | | 92.59 |
| *3 | 128.7910 | 10.1358 | 1.49700 | 81.54 | 0.53748 | 3.62 | 92.52 |
| 4 | 1085.8625 | DD[4] | | | | | 92.21 |
| 5 | 72.5289 | 9.1260 | 1.43875 | 94.66 | 0.53402 | 3.59 | 86.42 |
| 6 | 143.1459 | DD[6] | | | | | 85.94 |
| 7 | 76.7105 | 13.0056 | 1.43875 | 94.66 | 0.53402 | 3.59 | 81.82 |
| 8 | 2705.5282 | 0.1998 | | | | | 80.77 |
| *9 | 75.1108 | 8.4778 | 1.59282 | 68.62 | 0.54414 | 4.13 | 74.87 |
| 10 | 572.2175 | DD[10] | | | | | 73.91 |
| 11 | 555.5545 | 1.2046 | 1.88290 | 36.69 | 0.57961 | 4.97 | 32.48 |
| 12 | 20.7772 | 7.3884 | | | | | 26.89 |
| 13 | −66.4869 | 0.7848 | 1.85102 | 42.86 | 0.56429 | 4.80 | 26.45 |
| 14 | 32.1397 | 7.3714 | 1.84790 | 23.65 | 0.62149 | 3.63 | 26.36 |
| 15 | −30.6561 | 1.8886 | | | | | 26.33 |
| 16 | −25.0002 | 0.7500 | 1.80610 | 40.93 | 0.57019 | 4.43 | 25.07 |
| *17 | −123.7860 | DD[17] | | | | | 25.57 |
| 18 | −61.4924 | 3.9508 | 1.86576 | 22.37 | 0.63014 | 3.66 | 32.23 |
| 19 | −29.6028 | 0.9998 | 1.93220 | 34.78 | 0.58371 | 5.30 | 32.63 |
| 20 | −140.5464 | DD[20] | | | | | 34.38 |
| *21 | 129.5067 | 4.2588 | 1.59349 | 67.00 | 0.53667 | 3.14 | 37.95 |
| 22 | −100.6875 | 0.1800 | | | | | 38.37 |
| 23 | 62.4569 | 7.2330 | 1.59250 | 68.67 | 0.54339 | 3.70 | 39.73 |
| 24 | −78.6003 | 0.3684 | | | | | 39.60 |
| 25 | 41.3882 | 5.9225 | 1.49733 | 81.49 | 0.53750 | 3.55 | 36.19 |
| 26 | −459.3964 | 1.0059 | 1.87300 | 31.85 | 0.59398 | 4.69 | 35.32 |
| 27 | 45.9386 | DD[27] | | | | | 33.29 |

TABLE 49B
Example 14-1

| Sn | R | D | Nd | νd | θg, F | SG | ED |
|---|---|---|---|---|---|---|---|
| 28(St) | ∞ | 1.6864 | | | | | 32.79 |
| 29 | 42.6659 | 5.4639 | 1.68282 | 33.95 | 0.59304 | 3.01 | 31.80 |
| 30 | 116.4542 | 1.0098 | 1.68015 | 38.82 | 0.57926 | 3.15 | 30.33 |
| 31 | 31.6806 | 4.5518 | | | | | 28.83 |
| 32 | 36.0223 | 2.8752 | 1.57561 | 49.12 | 0.56085 | 2.73 | 28.62 |
| 33 | 66.5821 | 0.9999 | | | | | 28.13 |
| 34 | 30.6443 | 4.5802 | 1.51831 | 57.18 | 0.54786 | 2.59 | 27.34 |
| 35 | 2014.1432 | 0.2661 | | | | | 26.61 |
| 36 | 52.2869 | 0.9089 | 1.99358 | 22.56 | 0.63220 | 4.27 | 25.16 |
| 37 | 18.5078 | 6.6572 | 1.61344 | 37.13 | 0.58575 | 2.56 | 23.47 |
| 38 | −274.3876 | 0.5686 | | | | | 22.96 |
| 39 | −149.2504 | 1.1111 | 1.86531 | 39.59 | 0.57206 | 4.84 | 22.80 |
| 40 | 17.1502 | 4.7904 | 1.86633 | 21.77 | 0.63270 | 3.64 | 22.03 |
| 41 | 101.5103 | 0.5233 | | | | | 21.84 |
| 42 | 356.8009 | 1.5002 | 1.85780 | 41.75 | 0.56683 | 4.86 | 21.84 |
| 43 | 32.7737 | 7.5891 | | | | | 21.64 |
| 44 | 68.1602 | 6.6109 | 1.57003 | 45.00 | 0.56944 | 2.56 | 25.29 |
| 45 | −56.0182 | 3.3066 | | | | | 25.99 |
| 46 | 69.9628 | 6.0447 | 1.48749 | 70.24 | 0.53007 | 2.46 | 26.08 |
| 47 | −46.4990 | 0.9000 | 1.88300 | 40.76 | 0.56679 | 5.52 | 25.74 |
| 48 | 41.5406 | 6.7215 | | | | | 25.89 |
| 49 | 43.4171 | 12.2407 | 1.53658 | 63.59 | 0.53787 | 2.84 | 31.35 |
| 50 | −23.8550 | 1.5002 | 1.81600 | 46.62 | 0.55682 | 5.07 | 31.81 |
| 51 | −79.3215 | 9.3991 | | | | | 33.97 |
| 52 | −35.4358 | 3.0728 | 1.46056 | 89.39 | 0.53495 | 3.46 | 36.05 |
| 53 | −27.8587 | 1.0000 | | | | | 36.72 |
| 54 | ∞ | 2.0000 | 1.51633 | 64.14 | 0.53531 | 2.52 | 38.02 |
| 55 | ∞ | 30.2591 | | | | | 38.23 |
| 56 | ∞ | 5.7000 | 1.51633 | 64.14 | 0.53531 | 2.52 | 43.18 |
| 57 | ∞ | 1.1000 | | | | | 43.80 |

TABLE 50
Example 14-1

| Object | | | | | | |
|---|---|---|---|---|---|---|
| distance | | | | | | |
| Zooming | Infinity | | | Close range (0.89 m) | | |
| state | Wide | Middle | Tele | Wide | Middle | Tele |
| Zr | 1.00 | 3.72 | 12.12 | 1.00 | 3.72 | 12.12 |
| f | 36.45 | 135.47 | 441.78 | 40.37 | 157.77 | 233.50 |
| FNo. | 4.12 | 4.12 | 5.89 | 4.12 | 4.11 | 6.18 |
| 2ω[°] | 62.32 | 16.80 | 5.24 | 54.64 | 12.50 | 1.08 |
| DD[4] | 6.1778 | 6.1778 | 6.1778 | 13.1858 | 13.1858 | 13.1858 |
| DD[6] | 14.8342 | 14.8342 | 14.8342 | 0.9992 | 0.9992 | 0.9992 |
| DD[10] | 0.9979 | 37.0662 | 51.2898 | 7.8248 | 43.8932 | 58.1168 |
| DD[17] | 56.4550 | 4.6242 | 1.8271 | 56.4550 | 4.6242 | 1.8271 |
| DD[20] | 5.4496 | 20.0359 | 1.3463 | 5.4496 | 20.0359 | 1.3463 |
| DD[27] | 4.3613 | 5.5375 | 12.8006 | 4.3613 | 5.5375 | 12.8006 |

TABLE 51A
Example 14-1

| Sn | 3 | 9 |
|---|---|---|
| KA | 1.000000000000000E+00 | 1.000000000000000E+00 |
| A3 | 6.098283710545840E−22 | 2.362365638521260E−21 |
| A4 | 6.910082662765990E−08 | −4.492866049215360E−07 |
| A5 | 2.321662192790530E−08 | −3.097326511654660E−08 |
| A6 | −1.144757842668260E−09 | 1.918722743674280E−09 |
| A7 | 7.034875402582250E−12 | −3.679444443395270E−11 |
| A8 | 1.647493138495190E−12 | −3.270453725802210E−12 |
| A9 | −5.352776589733790E−14 | 1.745623533120290E−13 |
| A10 | −1.188642514731840E−15 | 1.630278761982150E−15 |
| A11 | 8.255750001564040E−17 | −2.739167603129420E−16 |
| A12 | 1.012704263342370E−19 | 1.924671411333400E−18 |
| A13 | −6.653711449409090E−20 | 2.257647151727840E−19 |
| A14 | 5.122560322110240E−22 | −3.334109624685150E−21 |
| A15 | 2.900864173632820E−23 | −1.049608849147930E−22 |
| A16 | −3.657465233382100E−25 | 2.070744603633850E−24 |
| A17 | −6.343535542929950E−27 | 2.627630727576690E−26 |
| A18 | 9.985164915294180E−29 | −6.187921942489510E−28 |
| A19 | 5.367318533030900E−31 | −2.780895799337290E−30 |
| A20 | −9.698478576809500E−33 | 7.466200696815870E−32 |

| Sn | 17 |
|---|---|
| KA | 1.000000000000000E+00 |
| A3 | 2.849171165681150E−20 |
| A4 | −5.321157705813880E−06 |
| A5 | −1.320983587980310E−06 |
| A6 | 2.636170994467220E−07 |
| A7 | 1.363656124478190E−08 |
| A8 | −1.175220482622020E−08 |
| A9 | 8.229157467989090E−10 |
| A10 | 1.646135632160220E−10 |
| A11 | −2.057933659500930E−11 |
| A12 | −1.031003624081040E−12 |
| A13 | 2.112438054884560E−13 |
| A14 | 1.925976321565140E−15 |
| A15 | −1.142764113811600E−15 |
| A16 | 1.024863338278190E−17 |
| A17 | 3.224887557531930E−18 |
| A18 | −5.867485408963400E−20 |
| A19 | −3.741968948375220E−21 |
| A20 | 8.513681170877510E−23 |

TABLE 51B
Example 14-1

| Sn | 21 |
|---|---|
| KA | 1.000000000000000E+00 |
| A4 | −2.774598240000000E−06 |
| A6 | 4.228796500000000E−10 |
| A8 | 2.294709060000000E−11 |
| A10 | −8.488245470000000E−13 |
| A12 | 1.183175850000000E−14 |
| A14 | −8.793456270000000E−17 |
| A16 | 3.803318690000000E−19 |
| A18 | −9.613473970000000E−22 |
| A20 | 1.318341560000000E−24 |
| A22 | −7.582328140000000E−28 |

### Example 15

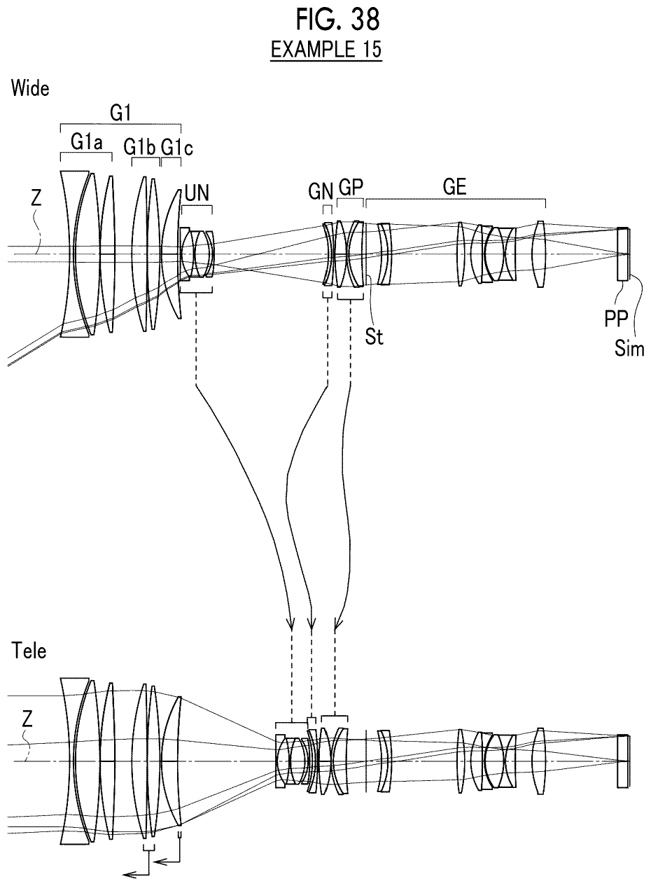

FIG. 38 shows a configuration and movement loci of the zoom lens according to Example 15. The zoom lens according to Example 15 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

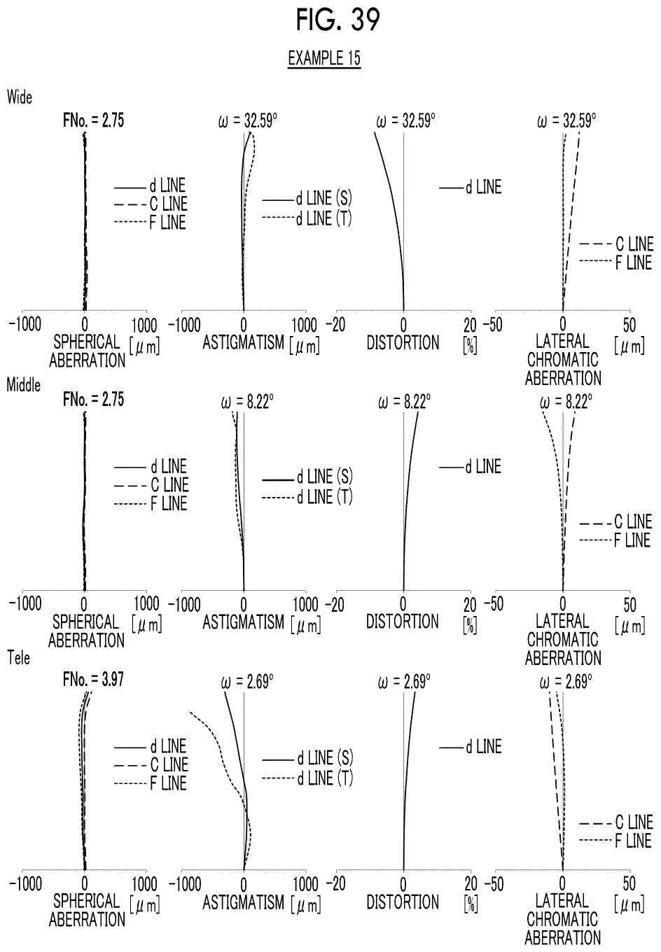

Regarding the zoom lens according to Example 15, Table 52 shows basic lens data, Table 53 shows specifications and variable surface spacings, and Table 54 shows aspherical coefficients thereof. FIG. 39 shows aberration diagrams thereof.

TABLE 52
Example 15

| Sn | R | D | Nd | νd | θg, F | SG | ED |
|---|---|---|---|---|---|---|---|
| 1 | −224.8704 | 2.1300 | 1.65412 | 39.68 | 0.57378 | 3.02 | 96.00 |
| 2 | 128.3067 | 1.1315 | | | | | 92.65 |
| 3 | 128.0728 | 13.6054 | 1.43387 | 95.18 | 0.53733 | 3.18 | 92.85 |
| 4 | −325.0488 | 0.1200 | | | | | 92.66 |
| 5 | 189.8846 | 8.2244 | 1.43700 | 95.10 | 0.53364 | 3.53 | 90.00 |
| *6 | −590.7915 | DD[6] | | | | | 89.91 |
| 7 | 153.2455 | 8.4984 | 1.43387 | 95.18 | 0.53733 | 3.18 | 88.40 |
| 8 | −1528.9101 | 0.1201 | | | | | 88.03 |
| 9 | 357.1650 | 6.9719 | 1.43387 | 95.18 | 0.53733 | 3.18 | 86.63 |
| 10 | −306.1921 | DD[10] | | | | | 86.16 |
| *11 | 76.7734 | 8.9821 | 1.53775 | 74.70 | 0.53936 | 3.64 | 74.08 |
| 12 | 344.0407 | DD[12] | | | | | 72.75 |
| 13 | −1215.8341 | 0.8000 | 1.91082 | 35.25 | 0.58335 | 4.85 | 30.49 |
| 14 | 22.3336 | 6.5621 | | | | | 26.26 |
| 15 | −53.8645 | 0.7601 | 1.84850 | 43.79 | 0.56197 | 5.08 | 26.05 |
| 16 | 33.0010 | 8.0062 | 1.85451 | 25.15 | 0.61031 | 3.48 | 26.43 |
| 17 | −27.4402 | 1.7973 | | | | | 26.55 |
| 18 | −23.5436 | 0.9002 | 1.81600 | 46.59 | 0.55661 | 4.99 | 24.71 |
| *19 | −98.8409 | DD[19] | | | | | 26.20 |
| 20 | −54.4130 | 1.7423 | 1.89286 | 20.36 | 0.63944 | 3.61 | 34.61 |
| 21 | −44.3831 | 1.1237 | 1.69560 | 59.05 | 0.54348 | 4.56 | 35.00 |
| 22 | −171.4478 | DD[22] | | | | | 36.30 |
| *23 | 108.1279 | 6.4252 | 1.55397 | 71.76 | 0.53931 | 3.66 | 37.70 |
| 24 | −54.3620 | 0.1202 | | | | | 38.11 |
| 25 | 44.8167 | 1.2500 | 1.86966 | 20.02 | 0.64349 | 3.37 | 38.25 |
| 26 | 34.4790 | 7.1886 | 1.48071 | 85.29 | 0.53623 | 3.68 | 37.24 |
| 27 | 201.0193 | DD[27] | | | | | 36.72 |
| 28 | ∞ | 8.5703 | | | | | 35.50 |
| (St) | | | | | | | |
| 29 | −69.5057 | 3.5486 | 1.53775 | 74.70 | 0.53936 | 3.64 | 34.61 |
| 30 | 41.9734 | 2.0807 | 1.54072 | 47.23 | 0.56511 | 2.52 | 34.82 |
| 31 | −117.0194 | 36.4639 | | | | | 35.38 |
| 32 | 154.0186 | 4.2398 | 1.84666 | 23.83 | 0.61603 | 5.51 | 36.50 |
| 33 | −91.7817 | 3.4192 | | | | | 36.52 |
| 34 | 34.3745 | 6.4895 | 1.48749 | 70.24 | 0.53007 | 2.46 | 33.39 |
| 35 | −281.1904 | 1.1186 | 1.94151 | 33.77 | 0.58532 | 5.11 | 32.43 |
| 36 | 27.7228 | 0.3922 | | | | | 30.03 |
| 37 | 25.8599 | 10.3329 | 1.51860 | 69.89 | 0.53184 | 2.60 | 30.44 |
| 38 | −38.6059 | 1.0000 | 1.88732 | 39.27 | 0.57012 | 4.83 | 29.91 |
| 39 | 29.0562 | 5.4519 | 1.56994 | 50.50 | 0.55980 | 3.22 | 29.81 |
| 40 | 314.4743 | 9.3232 | | | | | 30.21 |
| 41 | 50.4457 | 7.5782 | 1.52091 | 51.22 | 0.55877 | 2.51 | 35.51 |
| 42 | −135.4577 | 40.1258 | | | | | 35.55 |
| 43 | ∞ | 5.7000 | 1.51633 | 64.14 | 0.53531 | 2.52 | 30.49 |
| 44 | ∞ | 1.1000 | | | | | 30.03 |

TABLE 53
Example 15

| Object | | | | | | |
|---|---|---|---|---|---|---|
| distance | | | | | | |
| Zooming | Infinity | | | Close range (0.89 m) | | |
| state | Wide | Middle | Tele | Wide | Middle | Tele |
| Zr | 1.00 | 3.88 | 12.05 | 1.00 | 3.88 | 12.05 |
| f | 24.87 | 96.44 | 299.51 | 28.88 | 137.87 | 422.19 |
| FNo. | 2.75 | 2.75 | 3.97 | 2.75 | 2.75 | 4.37 |
| 2ω[°] | 65.18 | 16.44 | 5.38 | 52.18 | 10.52 | 1.00 |
| DD[6] | 9.4706 | 9.4706 | 9.4706 | 0.6999 | 0.6999 | 0.6999 |
| DD[10] | 0.9182 | 0.9182 | 0.9182 | 0.8986 | 0.8986 | 0.8986 |
| DD[12] | 1.5552 | 40.5982 | 54.8291 | 10.3456 | 49.3886 | 63.6195 |
| DD[19] | 63.4534 | 2.8232 | 1.5133 | 63.4534 | 2.8232 | 1.5133 |
| DD[22] | 0.7629 | 20.8364 | 0.7196 | 0.7629 | 20.8364 | 0.7196 |
| DD[27] | 2.4009 | 3.9147 | 11.1104 | 2.4009 | 3.9147 | 11.1104 |
| IHw | 14.525 | | | | | |

TABLE 54
Example 15

| Sn | 6 | 11 |
|---|---|---|
| KA | 1.000000000000000E+00 | 8.692306305817980E−01 |
| A4 | 1.061141586094320E−07 | 4.519166569966370E−09 |
| A6 | −1.100383395461520E−10 | −7.605704000792460E−11 |
| A8 | 2.662492104325870E−13 | 1.982152251285870E−13 |
| A10 | −3.823126403718280E−16 | −3.289354458653810E−16 |
| A12 | 3.478988500861970E−19 | 3.445221458359270E−19 |
| A14 | −2.010845224243580E−22 | −2.270507335086030E−22 |
| A16 | 7.144419404615680E−26 | 8.998499776856670E−26 |
| A18 | −1.421683626555190E−29 | −1.931941818308180E−29 |
| A20 | 1.211830554092010E−33 | 1.686355603507880E−33 |

| Sn | 19 | 23 |
|---|---|---|
| KA | 2.864800149726510E+01 | 4.396222611651700E+00 |
| A4 | −4.244878205258260E−06 | −2.352380059041470E−06 |
| A6 | 5.805584662658520E−08 | 6.648522687898190E−09 |
| A8 | −1.540294753771690E−09 | −1.070252225690720E−10 |
| A10 | 2.473681746626950E−11 | 1.066756937055640E−12 |
| A12 | −2.437745838343960E−13 | −6.499214495285690E−15 |
| A14 | 1.473265989360950E−15 | 2.461848078510880E−17 |
| A16 | −5.188415967776350E−18 | −5.670561123942320E−20 |
| A18 | 9.351114409357890E−21 | 7.279666989082500E−23 |
| A20 | −5.967165597712150E−24 | −3.997065048657630E−26 |

### Example 15-1

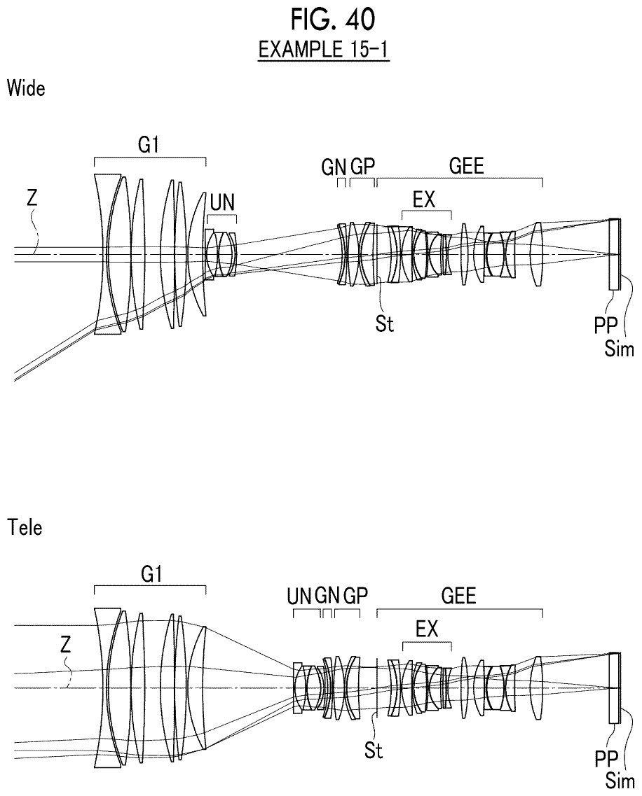

Example 15-1 is an example in which the EX group EX is inserted in the zoom lens according to Example 15. FIG. 40 shows a cross-sectional view of a configuration and luminous flux of the zoom lens according to Example 15-1. The zoom lens according to Example 15-1 has the final lens group GEE in which the EX group EX is inserted in the final lens group GE of Example 15, instead of the final lens group GE of Example 15. The other lens groups and the group configuration of Example 15-1 are the same as those of the zoom lens according to Example 15.

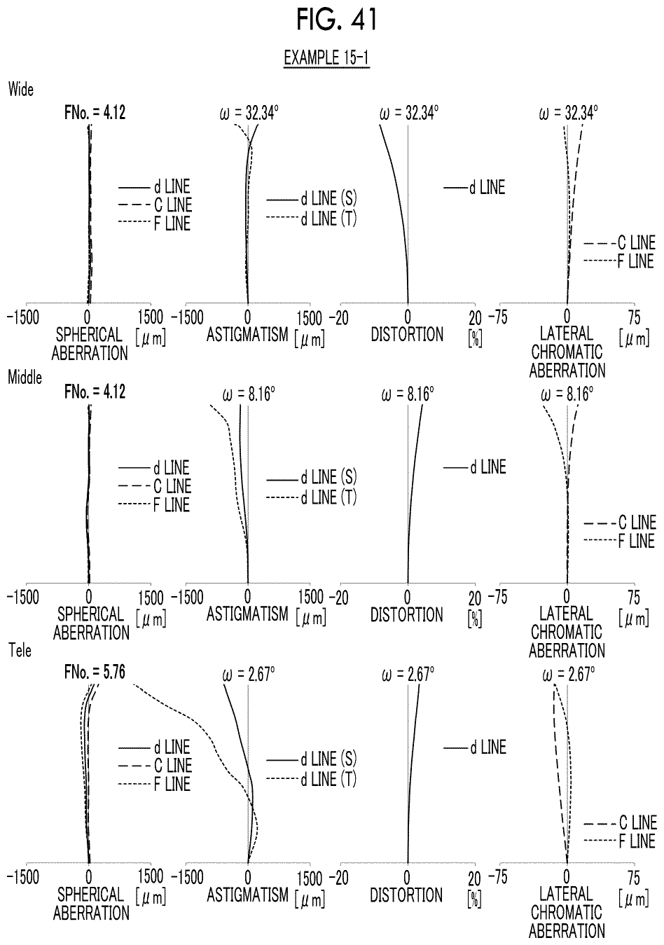

Regarding the zoom lens according to Example 15-1, Tables 55A and 55B show basic lens data, Table 56 shows specifications and variable surface spacings, and Table 57 shows aspherical coefficients thereof. FIG. 41 shows aberration diagrams.

TABLE 55A
Example 15-1

| Sn | R | D | Nd | νd | θg, F | SG | ED |
|---|---|---|---|---|---|---|---|
| 1 | −224.8704 | 2.1300 | 1.65412 | 39.68 | 0.57378 | 3.02 | 96.00 |
| 2 | 128.3067 | 1.1315 | | | | | 92.60 |
| 3 | 128.0728 | 13.6054 | 1.43387 | 95.18 | 0.53733 | 3.18 | 92.81 |
| 4 | −325.0488 | 0.1200 | | | | | 92.62 |
| 5 | 189.8846 | 8.2244 | 1.43700 | 95.10 | 0.53364 | 3.53 | 90.00 |
| *6 | −590.7915 | DD[6] | | | | | 89.91 |
| 7 | 153.2455 | 8.4984 | 1.43387 | 95.18 | 0.53733 | 3.18 | 88.41 |
| 8 | −1528.9101 | 0.1201 | | | | | 88.05 |
| 9 | 357.1650 | 6.9719 | 1.43387 | 95.18 | 0.53733 | 3.18 | 86.64 |
| 10 | −306.1921 | DD[10] | | | | | 86.17 |
| *11 | 76.7734 | 8.9821 | 1.53775 | 74.70 | 0.53936 | 3.64 | 74.08 |
| 12 | 344.0407 | DD[12] | | | | | 72.75 |
| 13 | −1215.8341 | 0.8000 | 1.91082 | 35.25 | 0.58335 | 4.85 | 30.49 |
| 14 | 22.3336 | 6.5621 | | | | | 26.23 |
| 15 | −53.8645 | 0.7601 | 1.84850 | 43.79 | 0.56197 | 5.08 | 26.03 |
| 16 | 33.0010 | 8.0062 | 1.85451 | 25.15 | 0.61031 | 3.48 | 26.41 |
| 17 | −27.4402 | 1.7973 | | | | | 26.54 |
| 18 | −23.5436 | 0.9002 | 1.81600 | 46.59 | 0.55661 | 4.99 | 24.71 |
| *19 | −98.8409 | DD[19] | | | | | 26.12 |
| 20 | −54.4130 | 1.7423 | 1.89286 | 20.36 | 0.63944 | 3.61 | 34.61 |
| 21 | −44.3831 | 1.1237 | 1.69560 | 59.05 | 0.54348 | 4.56 | 35.00 |
| 22 | −171.4478 | DD[22] | | | | | 36.30 |
| *23 | 108.1279 | 6.4252 | 1.55397 | 71.76 | 0.53931 | 3.66 | 37.70 |
| 24 | −54.3620 | 0.1202 | | | | | 38.09 |
| 25 | 44.8167 | 1.2500 | 1.86966 | 20.02 | 0.64349 | 3.37 | 38.00 |
| 26 | 34.4790 | 7.1886 | 1.48071 | 85.29 | 0.53623 | 3.68 | 36.97 |
| 27 | 201.0193 | DD[27] | | | | | 36.37 |

TABLE 55B
Example 15-1

| Sn | R | D | Nd | vd | θg,F | SG | ED |
|---|---|---|---|---|---|---|---|
| 28(St) | ∞ | 8.5703 | | | | | 35.25 |
| 29 | −69.5057 | 3.5486 | 1.53775 | 74.70 | 0.53936 | 3.64 | 33.62 |
| 30 | −41.9734 | 2.0807 | 1.54072 | 47.23 | 0.56511 | 2.52 | 33.65 |
| 31 | −117.0194 | 0.8000 | | | | | 33.72 |
| 32 | 32.4141 | 6.0233 | 1.57487 | 62.43 | 0.54107 | 3.25 | 32.86 |
| 33 | 448.9909 | 0.3007 | | | | | 32.17 |
| 34 | 41.9553 | 0.9008 | 2.00069 | 25.46 | 0.61364 | 4.73 | 30.55 |
| 35 | 24.5370 | 7.7492 | 1.53568 | 53.13 | 0.55498 | 3.05 | 28.76 |
| 36 | −110.1479 | 0.8047 | | | | | 27.74 |
| 37 | −101.6710 | 0.8816 | 1.89759 | 38.21 | 0.57280 | 4.88 | 27.02 |
| 38 | 17.0622 | 6.7842 | 1.78705 | 26.09 | 0.60955 | 4.34 | 24.82 |
| 39 | 140.3866 | 1.3479 | | | | | 24.41 |
| 40 | 236.9704 | 2.0283 | 1.62004 | 36.26 | 0.58800 | 2.69 | 24.18 |
| 41 | −122.8694 | 0.9298 | 1.61800 | 63.39 | 0.54015 | 3.52 | 23.99 |
| 42 | 32.2895 | 7.9144 | | | | | 23.39 |
| 43 | 154.0186 | 4.2398 | 1.84666 | 23.83 | 0.61603 | 5.51 | 26.19 |
| 44 | −91.7817 | 3.4192 | | | | | 26.61 |
| 45 | 34.3745 | 6.4895 | 1.48749 | 70.24 | 0.53007 | 2.46 | 26.90 |
| 46 | −281.1904 | 1.1186 | 1.94151 | 33.77 | 0.58532 | 5.11 | 26.04 |
| 47 | 27.7228 | 0.3922 | | | | | 25.30 |
| 48 | 25.8599 | 10.3329 | 1.51860 | 69.89 | 0.53184 | 2.60 | 25.91 |
| 49 | −38.6059 | 1.0000 | 1.88732 | 39.27 | 0.57012 | 4.83 | 26.00 |
| 50 | 29.0562 | 5.4519 | 1.56994 | 50.50 | 0.55980 | 3.22 | 27.01 |
| 51 | 314.4743 | 9.3232 | | | | | 28.04 |
| 52 | 50.4457 | 7.5782 | 1.52091 | 51.22 | 0.55877 | 2.51 | 37.59 |
| 53 | −135.4577 | 40.1318 | | | | | 38.00 |
| 54 | ∞ | 5.7000 | 1.51633 | 64.14 | 0.53531 | 2.52 | 42.32 |
| 55 | ∞ | 1.1000 | | | | | 42.71 |

TABLE 56
Example 15-1

| Object | | | | | | |
|---|---|---|---|---|---|---|
| distance | | | | | | |
| Zooming | Infinity | | | Close range (0.89 m) | | |
| state | Wide | Middle | Tele | Wide | Middle | Tele |
| Zr | 1.00 | 3.88 | 12.05 | 1.00 | 3.88 | 12.05 |
| f | 36.05 | 139.80 | 434.20 | 41.47 | 170.17 | 230.19 |
| FNo. | 4.12 | 4.12 | 5.76 | 4.12 | 4.12 | 6.41 |
| 2ω[°] | 64.68 | 16.32 | 5.34 | 51.86 | 10.44 | 0.98 |
| DD[6] | 9.4706 | 9.4706 | 9.4706 | 0.6999 | 0.6999 | 0.6999 |
| DD[10] | 0.9182 | 0.9182 | 0.9182 | 0.8986 | 0.8986 | 0.8986 |
| DD[12] | 1.5552 | 40.5982 | 54.8291 | 10.3456 | 49.3886 | 63.6195 |
| DD[19] | 63.4534 | 2.8232 | 1.5133 | 63.4534 | 2.8232 | 1.5133 |
| DD[22] | 0.7629 | 20.8364 | 0.7196 | 0.7629 | 20.8364 | 0.7196 |
| DD[27] | 2.4009 | 3.9147 | 11.1104 | 2.4009 | 3.9147 | 11.1104 |

TABLE 57
Example 15-1

| Sn | 6 | 11 |
|---|---|---|
| KA | 1.000000000000000E+00 | 8.692306305817980E−01 |
| A4 | 1.061141586094320E−07 | 4.519166569966370E−09 |
| A6 | −1.100383395461520E−10 | −7.605704000792460E−11 |
| A8 | 2.662492104325870E−13 | 1.982152251285870E−13 |
| A10 | −3.823126403718280E−16 | −3.289354458653810E−16 |
| A12 | 3.478988500861970E−19 | 3.445221458359270E−19 |
| A14 | −2.010845224243580E−22 | −2.270507335086030E−22 |
| A16 | 7.144419404615680E−26 | 8.998499776856670E−26 |
| A18 | −1.421683626555190E−29 | −1.931941818308180E−29 |
| A20 | 1.211830554092010E−33 | 1.686355603507880E−33 |

| Sn | 19 | 23 |
|---|---|---|
| KA | 2.864800149726510E+01 | 4.396222611651700E+00 |
| A4 | −4.244878205258260E−06 | −2.352380059041470E−06 |
| A6 | 5.805584662658520E−08 | 6.648522687898190E−09 |
| A8 | −1.540294753771690E−09 | −1.070252225690720E−10 |
| A10 | 2.473681746626950E−11 | 1.066756937055640E−12 |
| A12 | −2.437745838343960E−13 | −6.499214495285690E−15 |
| A14 | 1.473265989360950E−15 | 2.461848078510880E−17 |
| A16 | −5.188415967776350E−18 | −5.670561123942320E−20 |
| A18 | 9.351114409357890E−21 | 7.279666989082500E−23 |
| A20 | −5.967165597712150E−24 | −3.997065048657630E−26 |

### Example 16

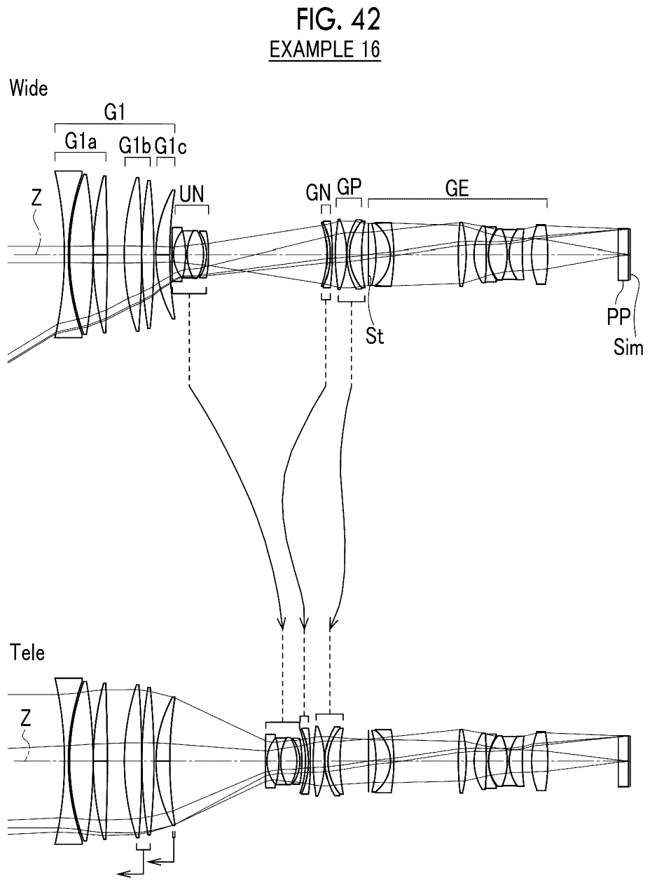

FIG. 42 shows a configuration and movement loci of the zoom lens according to Example 16. The zoom lens according to Example 16 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, and the first b-part group G1b and the first c-part group G1c move toward the object side by changing the mutual spacing therebetween.

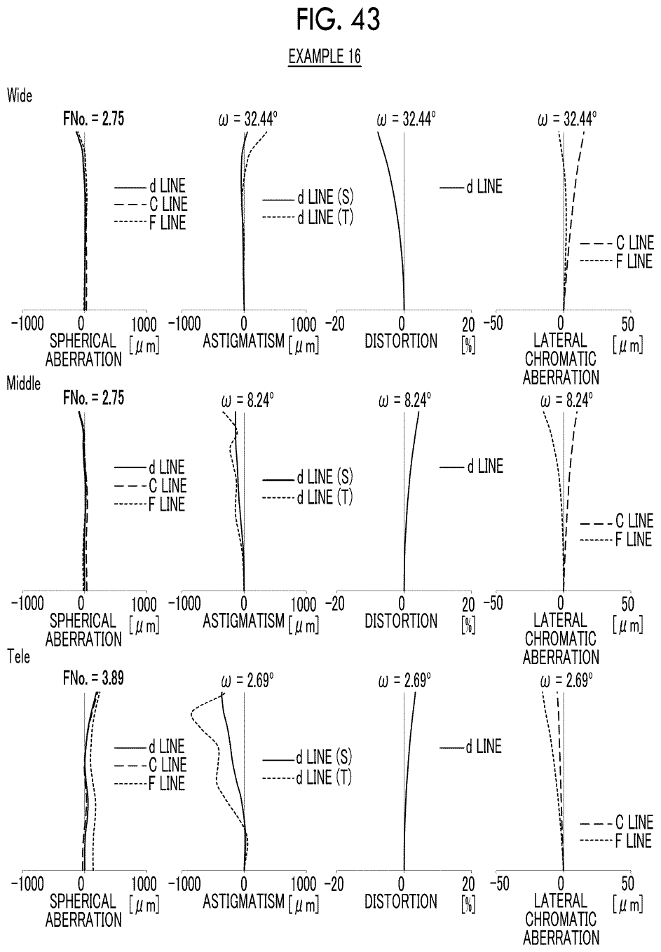

Regarding the zoom lens according to Example 16, Table 58 shows basic lens data, Table 59 shows specifications and variable surface spacings, and Table 60 shows aspherical coefficients thereof. FIG. 43 shows aberration diagrams thereof.

TABLE 58
Example 16

| Sn | R | D | Nd | νd | θg, F | SG | ED |
|---|---|---|---|---|---|---|---|
| 1 | −219.9141 | 2.1400 | 1.67300 | 38.26 | 0.57580 | 3.01 | 95.80 |
| 2 | 141.7201 | 0.7509 | | | | | 91.78 |
| 3 | 137.6314 | 13.0159 | 1.43387 | 95.18 | 0.53733 | 3.18 | 91.86 |
| 4 | −290.3780 | 0.1200 | | | | | 91.64 |
| 5 | 177.4369 | 7.8643 | 1.43700 | 95.10 | 0.53364 | 3.53 | 90.00 |
| *6 | −833.1142 | DD[6] | | | | | 89.88 |
| 7 | 146.6775 | 9.6572 | 1.43387 | 95.18 | 0.53733 | 3.18 | 88.15 |
| 8 | −615.9656 | 0.1202 | | | | | 87.73 |
| 9 | 268.1697 | 6.7157 | 1.43387 | 95.18 | 0.53733 | 3.18 | 85.00 |
| 10 | −432.5115 | DD[10] | | | | | 84.60 |
| *11 | 78.0402 | 7.6782 | 1.59282 | 68.62 | 0.54414 | 4.13 | 74.09 |
| 12 | 236.0208 | DD[12] | | | | | 73.00 |
| 13 | 471.8263 | 0.8999 | 1.95375 | 32.32 | 0.59056 | 4.94 | 30.85 |
| 14 | 21.2808 | 6.6654 | | | | | 26.42 |
| 15 | −53.9699 | 0.9100 | 1.84850 | 43.79 | 0.56197 | 5.08 | 26.31 |
| 16 | 28.2303 | 9.1146 | 1.85451 | 25.15 | 0.61031 | 3.48 | 26.93 |
| 17 | −27.8146 | 1.6591 | | | | | 27.14 |
| 18 | −23.3928 | 1.1000 | 1.80400 | 46.58 | 0.55730 | 4.72 | 25.86 |
| *19 | −86.6851 | DD[19] | | | | | 26.50 |
| 20 | −55.7254 | 1.6117 | 1.95906 | 17.47 | 0.65993 | 3.59 | 36.26 |
| 21 | −47.0266 | 1.1101 | 1.72916 | 54.67 | 0.54534 | 4.05 | 36.65 |
| 22 | −163.1027 | DD[22] | | | | | 38.00 |
| *23 | 107.0111 | 6.3493 | 1.59349 | 67.00 | 0.53667 | 3.14 | 40.00 |
| 24 | −55.3986 | 0.1199 | | | | | 40.23 |
| 25 | 40.0976 | 1.4998 | 1.89286 | 20.36 | 0.63944 | 3.61 | 39.62 |
| 26 | 30.4237 | 6.6997 | 1.48071 | 85.29 | 0.53623 | 3.68 | 38.01 |
| 27 | 98.6738 | DD[27] | | | | | 37.47 |
| 28 | ∞ | 4.1986 | | | | | 35.50 |
| (St) | | | | | | | |
| 29 | −66.5766 | 8.0198 | 1.53775 | 74.70 | 0.53936 | 3.64 | 35.25 |
| 30 | −22.9127 | 1.8655 | 1.53996 | 59.46 | 0.54418 | 2.75 | 35.46 |
| 31 | −108.9438 | 35.9169 | | | | | 36.40 |
| 32 | 170.4921 | 4.3958 | 1.84666 | 23.83 | 0.61603 | 5.51 | 36.61 |
| 33 | −80.9133 | 4.3899 | | | | | 36.50 |
| 34 | 31.4108 | 6.8688 | 1.48749 | 70.24 | 0.53007 | 2.46 | 32.42 |
| 35 | −201.1839 | 1.1000 | 1.93240 | 34.76 | 0.58376 | 5.30 | 31.32 |
| 36 | 25.6967 | 0.1201 | | | | | 28.69 |
| 37 | 23.2174 | 10.3854 | 1.51860 | 69.89 | 0.53184 | 2.60 | 29.04 |
| 38 | −37.1983 | 1.1006 | 1.95172 | 32.83 | 0.58874 | 5.36 | 28.32 |
| 39 | 25.1426 | 7.2968 | 1.66861 | 31.22 | 0.60144 | 2.85 | 28.06 |
| 40 | 115.4639 | 5.1495 | | | | | 28.83 |
| 41 | 47.7239 | 9.0433 | 1.54183 | 47.16 | 0.56609 | 2.47 | 32.50 |
| 42 | −107.4568 | 39.2482 | | | | | 32.78 |
| 43 | ∞ | 5.7000 | 1.51633 | 64.14 | 0.53531 | 2.52 | 29.49 |
| 44 | ∞ | 1.1000 | | | | | 29.18 |

TABLE 59
Example 16

| Object | | | | | | |
|---|---|---|---|---|---|---|
| distance | | | | | | |
| Zooming | Infinity | | | Close range (3.69 m) | | |
| state | Wide | Middle | Tele | Wide | Middle | Tele |
| Zr | 1.00 | 3.88 | 12.05 | 1.00 | 3.88 | 12.05 |
| f | 24.79 | 96.14 | 298.56 | 26.34 | 106.07 | 319.70 |
| FNo. | 2.75 | 2.75 | 3.89 | 5.50 | 5.50 | 5.47 |
| 2ω[°] | 64.88 | 16.48 | 5.38 | 58.94 | 14.44 | 4.08 |
| DD[6] | 9.4460 | 9.4460 | 9.4460 | 0.9918 | 0.9918 | 0.9918 |
| DD[10] | 1.1351 | 1.1351 | 1.1351 | 10.4933 | 10.4933 | 10.4933 |
| DD[12] | 1.2642 | 39.1435 | 53.1996 | 0.3602 | 38.2395 | 52.2956 |
| DD[19] | 65.9268 | 4.4620 | 2.0653 | 65.9268 | 4.4620 | 2.0653 |
| DD[22] | 1.6313 | 20.9826 | 1.4716 | 1.6313 | 20.9826 | 1.4716 |
| DD[27] | 3.8334 | 8.0677 | 15.9193 | 3.8334 | 8.0677 | 15.9193 |
| IHw | 14.525 | | | | | |

TABLE 60
Example 16

| Sn | 6 | 11 |
|---|---|---|
| KA | 1.000000000000000E+00 | 8.958568700000000E−01 |
| A4 | 1.140840184372290E−07 | 5.805296316054730E−09 |
| A6 | −1.724454287036440E−10 | −1.367131472961710E−10 |
| A8 | 4.824474666934210E−13 | 4.144627544786460E−13 |
| A10 | −7.030108963851240E−16 | −6.286652578087040E−16 |
| A12 | 6.053994920508140E−19 | 5.067525799937350E−19 |
| A14 | −3.146788331698800E−22 | −1.911918343572760E−22 |
| A16 | 9.556149310526860E−26 | 3.129710679266330E−27 |
| A18 | −1.520978755207600E−29 | 1.956958679632280E−29 |
| A20 | 9.285369990157280E−34 | −4.186245554460900E−33 |

| Sn | 19 | 23 |
|---|---|---|
| KA | 1.533223200000000E+01 | 5.262697500000000E+00 |
| A4 | −4.666342149621550E−06 | −2.233732664981790E−06 |
| A6 | 4.543855701925070E−08 | 1.049077459653630E−09 |
| A8 | −1.602078722473130E−09 | −8.462541806193590E−12 |
| A10 | 2.962047165842600E−11 | 5.847223313548000E−14 |
| A12 | −3.304999609594570E−13 | −2.475602691031050E−16 |
| A14 | 2.281657802734890E−15 | 6.641337306673350E−19 |
| A16 | −9.549643776956620E−18 | −1.223209755297580E−21 |
| A18 | 2.221784553137310E−20 | 1.543363387541660E−24 |
| A20 | −2.205515200925760E−23 | −9.856271302148610E−28 |

### Example 16-1

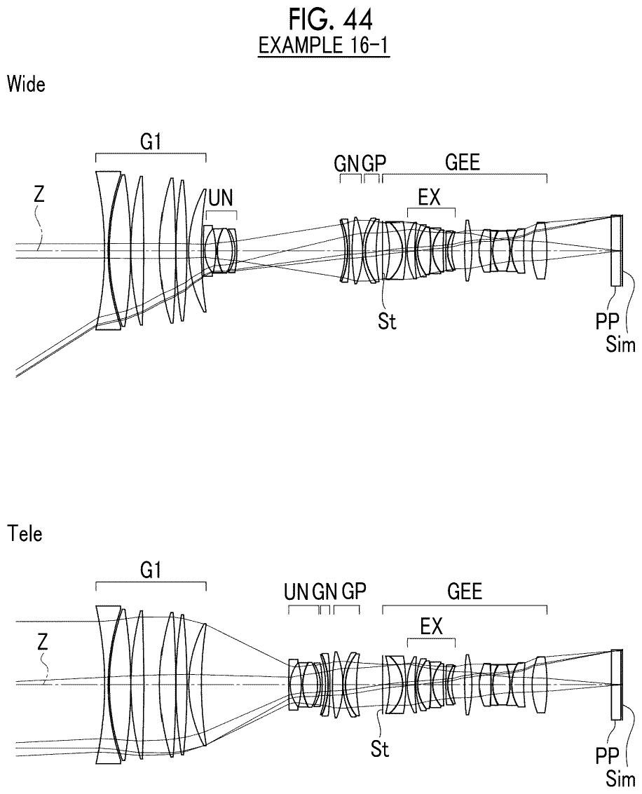

Example 16-1 is an example in which the EX group EX is inserted in the zoom lens according to Example 16. FIG. 44 shows a cross-sectional view of a configuration and luminous flux of the zoom lens according to Example 16-1. The zoom lens according to Example 16-1 includes a final lens group GEE in which the EX group EX is inserted in the final lens group GE of Example 16, instead of the final lens group GE of Example 16. The other lens groups and the group configuration of Example 16-1 are the same as those of the zoom lens according to Example 16.

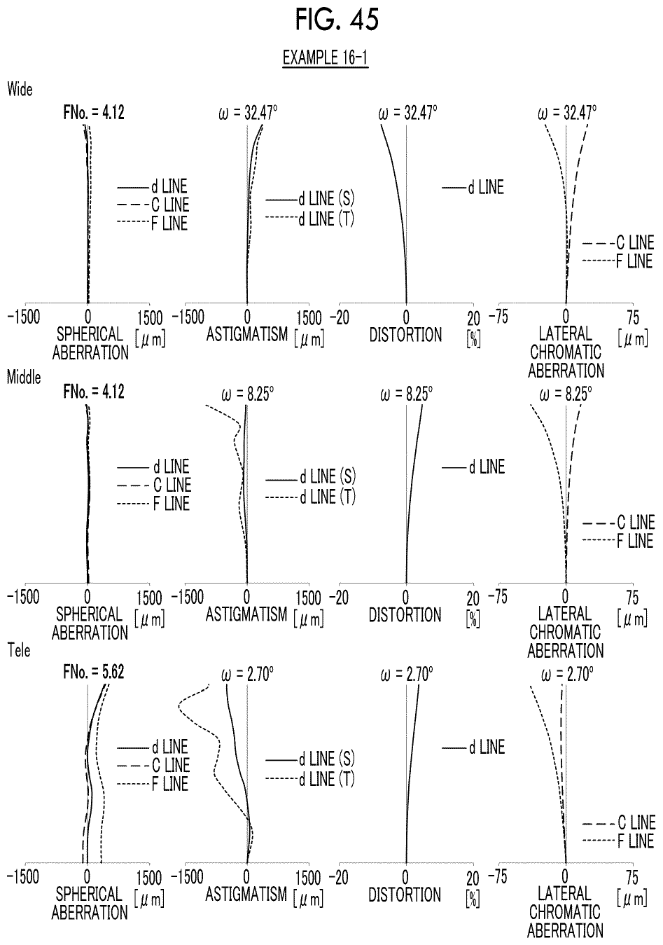

Regarding the zoom lens according to Example 16-1, Tables 61A and 61B show basic lens data, Table 62 shows specifications and variable surface spacings, and Table 63 shows aspherical coefficients thereof. FIG. 45 shows aberration diagrams.

TABLE 61A
Example 16-1

| Sn | R | D | Nd | νd | θg, F | SG | ED |
|---|---|---|---|---|---|---|---|
| 1 | −219.9141 | 2.1400 | 1.67300 | 38.26 | 0.57580 | 3.01 | 95.80 |
| 2 | 141.7201 | 0.7509 | | | | | 91.79 |
| 3 | 137.6314 | 13.0159 | 1.43387 | 95.18 | 0.53733 | 3.18 | 91.87 |
| 4 | −290.3780 | 0.1200 | | | | | 91.64 |
| 5 | 177.4369 | 7.8643 | 1.43700 | 95.10 | 0.53364 | 3.53 | 90.00 |
| *6 | −833.1142 | DD[6] | | | | | 89.88 |
| 7 | 146.6775 | 9.6572 | 1.43387 | 95.18 | 0.53733 | 3.18 | 87.86 |
| 8 | −615.9656 | 0.1202 | | | | | 87.43 |
| 9 | 268.1697 | 6.7157 | 1.43387 | 95.18 | 0.53733 | 3.18 | 85.00 |
| 10 | −432.5115 | DD[10] | | | | | 84.49 |
| *11 | 78.0402 | 7.6782 | 1.59282 | 68.62 | 0.54414 | 4.13 | 74.12 |
| 12 | 236.0208 | DD[12] | | | | | 73.00 |
| 13 | 471.8263 | 0.8999 | 1.95375 | 32.32 | 0.59056 | 4.94 | 30.85 |
| 14 | 21.2808 | 6.6654 | | | | | 26.42 |
| 15 | −53.9699 | 0.9100 | 1.84850 | 43.79 | 0.56197 | 5.08 | 26.31 |
| 16 | 28.2303 | 9.1146 | 1.85451 | 25.15 | 0.61031 | 3.48 | 26.93 |
| 17 | −27.8146 | 1.6591 | | | | | 27.14 |
| 18 | −23.3928 | 1.1000 | 1.80400 | 46.58 | 0.55730 | 4.72 | 25.86 |
| *19 | −86.6851 | DD[19] | | | | | 26.50 |
| 20 | −55.7254 | 1.6117 | 1.95906 | 17.47 | 0.65993 | 3.59 | 36.26 |
| 21 | −47.0266 | 1.1101 | 1.72916 | 54.67 | 0.54534 | 4.05 | 36.65 |
| 22 | −163.1027 | DD[22] | | | | | 38.00 |
| *23 | 107.0111 | 6.3493 | 1.59349 | 67.00 | 0.53667 | 3.14 | 40.00 |
| 24 | −55.3986 | 0.1199 | | | | | 40.20 |
| 25 | 40.0976 | 1.4998 | 1.89286 | 20.36 | 0.63944 | 3.61 | 39.13 |
| 26 | 30.4237 | 6.6997 | 1.48071 | 85.29 | 0.53623 | 3.68 | 37.50 |
| 27 | 98.6738 | DD[27] | | | | | 36.93 |

TABLE 61B
Example 16-1

| Sn | R | D | Nd | νd | θg, F | SG | ED |
|---|---|---|---|---|---|---|---|
| 28(St) | ∞ | 4.1986 | | | | | 35.50 |
| 29 | −66.5766 | 8.0198 | 1.53775 | 74.70 | 0.53936 | 3.64 | 34.92 |
| 30 | −22.9127 | 1.8655 | 1.53996 | 59.46 | 0.54418 | 2.75 | 34.92 |
| 31 | −108.9438 | 0.9069 | | | | | 34.91 |
| 32 | 35.9509 | 4.6762 | 1.82163 | 38.31 | 0.57679 | 4.50 | 34.00 |
| 33 | 146.6405 | 0.6182 | | | | | 33.36 |
| 34 | 42.6998 | 1.1002 | 1.96212 | 20.05 | 0.63403 | 5.25 | 31.50 |
| 35 | 23.1273 | 7.9390 | 1.48750 | 76.66 | 0.51950 | 2.80 | 29.10 |
| 36 | −118.8790 | 0.1200 | | | | | 28.13 |
| 37 | −159.7073 | 1.1213 | 1.96994 | 31.01 | 0.59420 | 5.25 | 27.80 |
| 38 | 19.0603 | 6.3369 | 1.88294 | 20.85 | 0.62780 | 4.84 | 25.52 |
| 39 | 206.5828 | 1.6331 | | | | | 25.01 |
| 40 | 182.2120 | 1.1000 | 1.75500 | 52.32 | 0.54757 | 4.17 | 24.29 |
| 41 | 21.2033 | 2.5316 | 1.75211 | 25.05 | 0.61924 | 3.14 | 23.11 |
| 42 | 31.9941 | 7.8340 | | | | | 22.80 |
| 43 | 170.4921 | 4.3958 | 1.84666 | 23.83 | 0.61603 | 5.51 | 25.37 |
| 44 | −80.9133 | 4.3899 | | | | | 25.81 |
| 45 | 31.4108 | 6.8688 | 1.48749 | 70.24 | 0.53007 | 2.46 | 25.85 |
| 46 | −201.1839 | 1.1000 | 1.93240 | 34.76 | 0.58376 | 5.30 | 24.79 |
| 47 | 25.6967 | 0.1201 | | | | | 23.95 |
| 48 | 23.2174 | 10.3854 | 1.51860 | 69.89 | 0.53184 | 2.60 | 24.39 |
| 49 | −37.1983 | 1.1006 | 1.95172 | 32.83 | 0.58874 | 5.36 | 24.25 |
| 50 | 25.1426 | 7.2968 | 1.66861 | 31.22 | 0.60144 | 2.85 | 25.10 |
| 51 | 115.4639 | 5.1495 | | | | | 26.84 |
| 52 | 47.7239 | 9.0433 | 1.54183 | 47.16 | 0.56609 | 2.47 | 32.98 |
| 53 | −107.4568 | 39.2183 | | | | | 33.99 |
| 54 | ∞ | 5.7000 | 1.51633 | 64.14 | 0.53531 | 2.52 | 41.96 |
| 55 | ∞ | 1.1000 | | | | | 42.69 |

TABLE 62
Example 16-1

| | Object distance | | | | | |
|---|---|---|---|---|---|---|
| | Infinity | | | Close range (3.69 m) | | |
| Zooming state | Wide | Middle | Tele | Wide | Middle | Tele |
| Zr | 1.00 | 3.88 | 12.05 | 1.00 | 3.88 | 12.05 |
| f | 35.70 | 138.51 | 429.94 | 40.94 | 163.11 | 203.77 |
| FNo. | 4.12 | 4.12 | 5.62 | 4.12 | 4.12 | 6.27 |
| 2ω[°] | 64.94 | 16.50 | 5.40 | 52.24 | 10.58 | 0.76 |
| DD[6] | 9.4460 | 9.4460 | 9.4460 | 0.9918 | 0.9918 | 0.9918 |
| DD[10] | 1.1351 | 1.1351 | 1.1351 | 0.9790 | 0.9790 | 0.9790 |
| DD[12] | 1.2642 | 39.1435 | 53.1996 | 9.8745 | 47.7539 | 61.8099 |
| DD[19] | 65.9268 | 4.4620 | 2.0653 | 65.9268 | 4.4620 | 2.0653 |
| DD[22] | 1.6313 | 20.9826 | 1.4716 | 1.6313 | 20.9826 | 1.4716 |
| DD[27] | 3.8334 | 8.0677 | 15.9193 | 3.8334 | 8.0677 | 15.9193 |

TABLE 63
Example 16-1

| Sn | 6 | 11 |
|---|---|---|
| KA | 1.000000000000000E+00 | 8.958568700000000E−01 |
| A4 | 1.140840184372290E−07 | 5.805296316054730E−09 |
| A6 | −1.724454287036440E−10 | −1.367131472961710E−10 |
| A8 | 4.824474666934210E−13 | 4.144627544786460E−13 |
| A10 | −7.030108963851240E−16 | −6.286652578087040E−16 |
| A12 | 6.053994920508140E−19 | 5.067525799937350E−19 |
| A14 | −3.146788331698800E−22 | −1.911918343572760E−22 |
| A16 | 9.556149310526860E−26 | 3.129710679266330E−27 |
| A18 | −1.520978755207600E−29 | 1.956958679632280E−29 |
| A20 | 9.285369990157280E−34 | −4.186245554460900E−33 |

| Sn | 19 | 23 |
|---|---|---|
| KA | 1.533223200000000E+01 | 5.262697500000000E+00 |
| A4 | −4.666342149621550E−06 | −2.233732664981790E−06 |
| A6 | 4.543855701925070E−08 | 1.049077459653630E−09 |
| A8 | −1.602078722473130E−09 | −8.462541806193590E−12 |
| A10 | 2.962047165842600E−11 | 5.847223313548000E−14 |
| A12 | −3.304999609594570E−13 | −2.475602691031050E−16 |
| A14 | 2.281657802734890E−15 | 6.641337306673350E−19 |
| A16 | −9.549643776956620E−18 | −1.223209755297580E−21 |
| A18 | 2.221784553137310E−20 | 1.543363387541660E−24 |
| A20 | −2.205515200925760E−23 | −9.856271302148610E−28 |

### Example 17

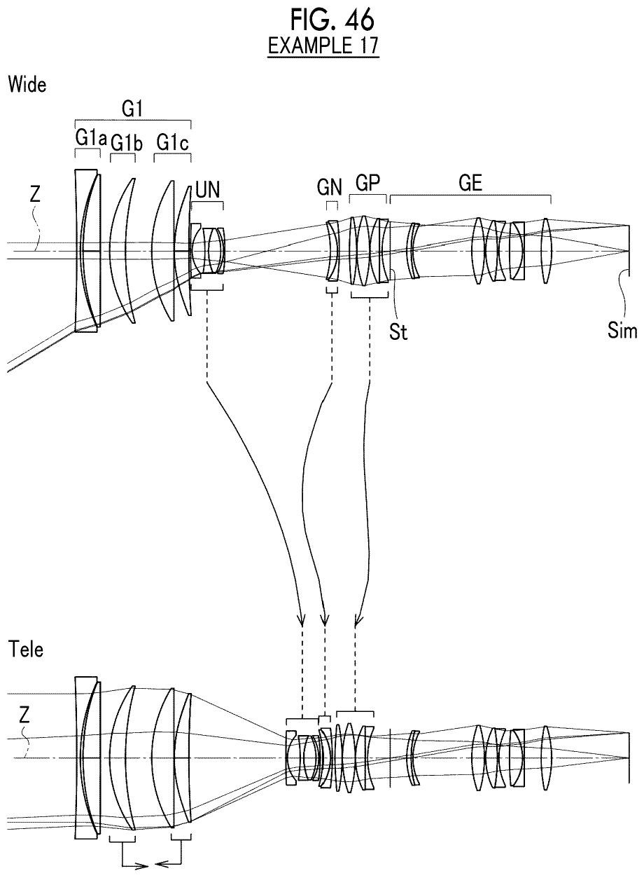

FIG. 46 shows a configuration and movement loci of the zoom lens according to Example 17. The zoom lens according to Example 17 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, and a first c-part group G1c, in order from the object side to the image side. During focusing from the infinite distance object to the closest range object, the first a-part group G1a remains stationary with respect to the image plane Sim, the first b-part group G1b moves to the image side, and the first c-part group G1c moves to the object side.

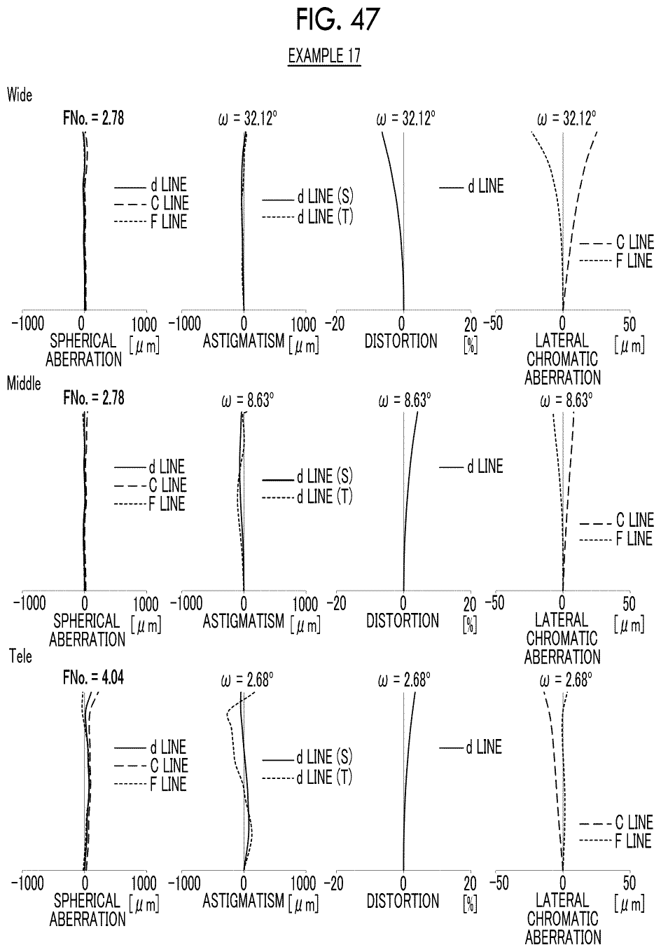

Regarding the zoom lens according to Example 17, Table 64 shows basic lens data, Table 65 shows specifications and variable surface spacings, and Tables 66A and 66B show aspherical coefficients thereof. FIG. 47 shows aberration diagrams.

TABLE 64
Example 17

| Sn | R | D | Nd | νd | θg, F | SG | ED |
|---|---|---|---|---|---|---|---|
| 1 | −1178.2304 | 1.9998 | 1.76634 | 35.82 | 0.57931 | 3.47 | 93.40 |
| 2 | 107.6021 | 1.5409 | | | | | 87.51 |
| *3 | 135.9162 | 9.6076 | 1.49700 | 81.54 | 0.53748 | 3.62 | 87.48 |
| 4 | −14478.3163 | DD[4] | | | | | 87.23 |
| 5 | 73.9988 | 8.8297 | 1.43387 | 95.18 | 0.53733 | 3.18 | 82.93 |
| 6 | 161.3281 | DD[6] | | | | | 82.57 |
| 7 | 79.6344 | 12.3972 | 1.43387 | 95.18 | 0.53733 | 3.18 | 80.31 |
| 8 | 272400.4304 | 0.1998 | | | | | 79.45 |
| *9 | 77.2313 | 8.1230 | 1.59282 | 68.62 | 0.54414 | 4.13 | 74.03 |
| 10 | 556.1671 | DD[10] | | | | | 73.11 |
| 11 | 558.8955 | 0.8498 | 1.88100 | 40.14 | 0.57010 | 5.40 | 31.15 |
| 12 | 20.1741 | 7.1135 | | | | | 26.09 |
| 13 | −78.1414 | 2.0102 | 1.79952 | 42.22 | 0.56727 | 4.41 | 25.62 |
| 14 | 33.2555 | 6.8040 | 1.80518 | 25.42 | 0.61616 | 3.37 | 25.33 |
| 15 | −30.0844 | 1.5441 | | | | | 25.25 |
| 16 | −25.0656 | 0.7498 | 1.80420 | 46.50 | 0.55727 | 4.40 | 24.76 |
| *17 | −113.2659 | DD[17] | | | | | 25.85 |
| 18 | −59.8607 | 3.9794 | 1.84666 | 23.78 | 0.62054 | 3.54 | 32.19 |
| 19 | −29.1027 | 0.9998 | 1.90043 | 37.37 | 0.57720 | 5.19 | 32.58 |
| 20 | −145.9512 | DD[20] | | | | | 34.34 |
| *21 | 137.8782 | 3.9998 | 1.61800 | 63.39 | 0.54015 | 3.52 | 37.86 |
| 22 | −99.9991 | 0.1801 | | | | | 38.25 |
| 23 | 62.7253 | 7.0923 | 1.59282 | 68.62 | 0.54414 | 4.13 | 39.78 |
| 24 | −79.9442 | 0.1798 | | | | | 39.69 |
| 25 | 42.6986 | 5.3745 | 1.49700 | 81.54 | 0.53748 | 3.62 | 36.68 |
| 26 | −3217.3411 | 1.3794 | 1.87409 | 30.55 | 0.60188 | 4.55 | 35.97 |
| 27 | 43.9797 | DD[27] | | | | | 33.71 |
| 28(St) | ∞ | 9.2269 | | | | | 33.30 |
| 29 | 42.1382 | 2.4493 | 1.67270 | 32.10 | 0.59891 | 2.91 | 31.43 |
| 30 | 60.8606 | 1.0138 | 1.67003 | 47.23 | 0.56276 | 3.48 | 30.88 |
| 31 | 32.9173 | 32.8150 | | | | | 29.87 |
| 32 | 59.1585 | 7.0284 | 1.58267 | 46.60 | 0.56688 | 2.91 | 37.54 |
| 33 | −70.1407 | 0.7501 | | | | | 37.47 |
| 34 | 40.0771 | 6.4645 | 1.48749 | 70.24 | 0.53007 | 2.46 | 34.45 |
| 35 | −105.1110 | 0.8999 | 1.88300 | 40.76 | 0.56679 | 5.52 | 33.73 |
| 36 | 37.3507 | 5.8866 | | | | | 31.55 |
| 37 | 189.6900 | 7.2765 | 1.56888 | 62.96 | 0.53742 | 3.06 | 31.83 |
| 38 | 27.2638 | 0.9999 | 1.81600 | 46.62 | 0.55682 | 5.07 | 31.83 |
| 39 | −2409.4802 | 9.3874 | | | | | 32.97 |
| 40 | 95.7036 | 5.8052 | 1.45650 | 90.27 | 0.53477 | 3.60 | 36.70 |
| 41 | −63.5115 | 43.2605 | | | | | 36.83 |

TABLE 65
Example 17

| | Object distance | | | | | |
|---|---|---|---|---|---|---|
| | Infinity | | | Close range (0.89 m) | | |
| Zooming state | Wide | Middle | Tele | Wide | Middle | Tele |
| Zr | 1.00 | 3.72 | 12.12 | 1.00 | 3.72 | 12.12 |
| f | 24.73 | 91.90 | 299.65 | 27.75 | 124.14 | 452.47 |
| FNo. | 2.78 | 2.78 | 4.04 | 2.78 | 2.78 | 4.44 |
| 2ω[°] | 64.24 | 17.26 | 5.36 | 55.88 | 12.76 | 1.14 |
| DD[4] | 5.1897 | 5.1897 | 5.1897 | 11.4980 | 11.4980 | 11.4980 |
| DD[6] | 14.6405 | 14.6405 | 14.6405 | 0.9997 | 0.9997 | 0.9997 |
| DD[10] | 1.0003 | 38.8465 | 54.1052 | 8.3328 | 46.1790 | 61.4378 |
| DD[17] | 58.5203 | 4.5702 | 1.4997 | 58.5203 | 4.5702 | 1.4997 |
| DD[20] | 5.6459 | 20.2241 | 1.4988 | 5.6459 | 20.2241 | 1.4988 |
| DD[27] | 4.5238 | 6.0496 | 12.5865 | 4.5238 | 6.0496 | 12.5865 |
| IHw | 14.525 | | | | | |

TABLE 66A
Example 17

| Sn | 3 | 9 |
|---|---|---|
| KA | 1.000000000000000E+00 | 1.000000000000000E+00 |
| A3 | −4.878626968436670E−21 | −6.562126773670160E−22 |
| A4 | 1.192527023858050E−07 | −5.177136163398360E−07 |
| A5 | 2.417394460102630E−08 | −2.344133978853510E−08 |
| A6 | −1.550991388648140E−09 | 1.884275300535670E−09 |
| A7 | 9.413945732237860E−12 | −4.738898912906760E−11 |
| A8 | 2.837709232375960E−12 | −2.907137952123800E−12 |
| A9 | −7.543840538163060E−14 | 1.795116940091010E−13 |
| A10 | −2.853344285565830E−15 | 7.969015114756280E−16 |
| A11 | 1.279312067253450E−16 | −2.624392496957770E−16 |
| A12 | 1.283247544097190E−18 | 2.948414066302980E−18 |
| A13 | −1.113567614507460E−19 | 2.034383406021430E−19 |
| A14 | 1.481380266793640E−22 | −4.049750045156980E−21 |
| A15 | 5.263028286220100E−23 | −8.810169164569260E−23 |
| A16 | −3.828940707816510E−25 | 2.353650152977050E−24 |
| A17 | −1.275116207836690E−26 | 2.021789899220440E−26 |
| A18 | 1.372863939463440E−28 | −6.775246903343690E−28 |
| A19 | 1.240947675962020E−30 | −1.926782657726250E−30 |
| A20 | −1.609143157085270E−32 | 7.972111211963240E−32 |

| Sn | 17 |
|---|---|
| KA | 1.000000000000000E+00 |
| A3 | 2.630004152936450E−20 |
| A4 | −8.642513698052230E−06 |
| A5 | −1.354720950506650E−07 |
| A6 | 5.674419962424700E−08 |
| A7 | 8.746745431064620E−09 |
| A8 | −4.002113037978000E−09 |
| A9 | 1.136232101168760E−10 |
| A10 | 5.598570985106580E−11 |
| A11 | −2.798060543802990E−12 |
| A12 | −4.173517396330280E−13 |
| A13 | 1.656386137637240E−14 |
| A14 | 2.382784847716670E−15 |
| A15 | −2.049939664233370E−17 |
| A16 | −1.157286593486640E−17 |
| A17 | −1.040980171922720E−19 |
| A18 | 3.600380522145200E−20 |
| A19 | 2.723990510198260E−22 |
| A20 | −4.802631830459600E−23 |

TABLE 66B
Example 17

| Sn | 21 |
|---|---|
| KA | 1.000000000000000E+00 |
| A4 | −2.642036405366130E−06 |
| A6 | 7.628567578787460E−10 |
| A8 | 2.145588069135180E−11 |
| A10 | −8.480536757388010E−13 |
| A12 | 1.184284212554910E−14 |
| A14 | −8.794249434335040E−17 |
| A16 | 3.802582701102840E−19 |
| A18 | −9.613917553087650E−22 |
| A20 | 1.319225113332250E−24 |
| A22 | −7.594625362423640E−28 |

### Example 18

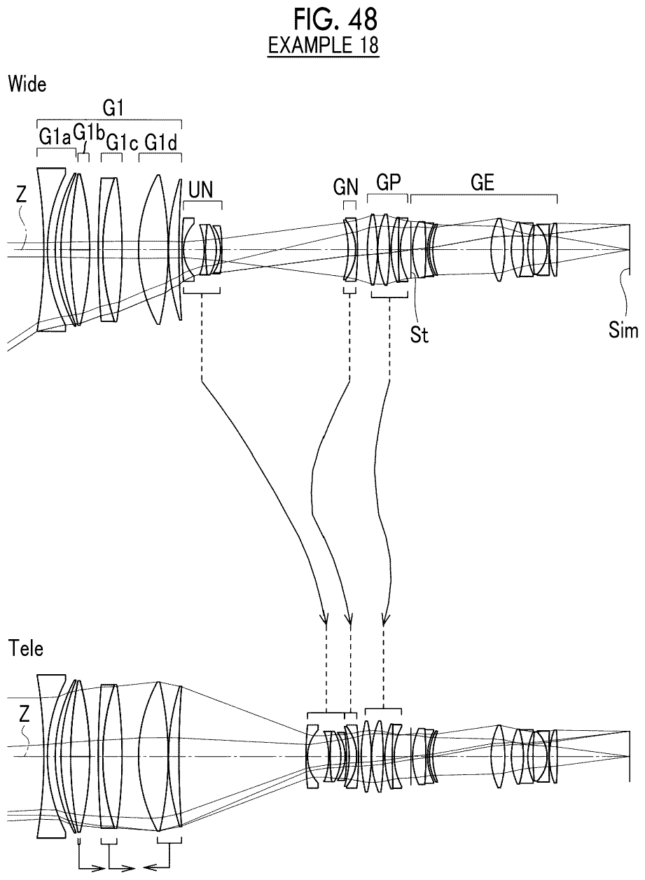

FIG. 48 shows a configuration and movement loci of the zoom lens according to Example 18. The zoom lens according to Example 18 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, a first c-part group G1c, and a first d-part group G1d, in order from the object side to the image side. During focusing from the infinite distance object to the closest range object, the first a-part group G1a remains stationary with respect to the image plane Sim, the first b-part group G1b and the first c-part group G1c move to the image side by changing the mutual spacing therebetween, and the first d-part group G1d moves to the object side.

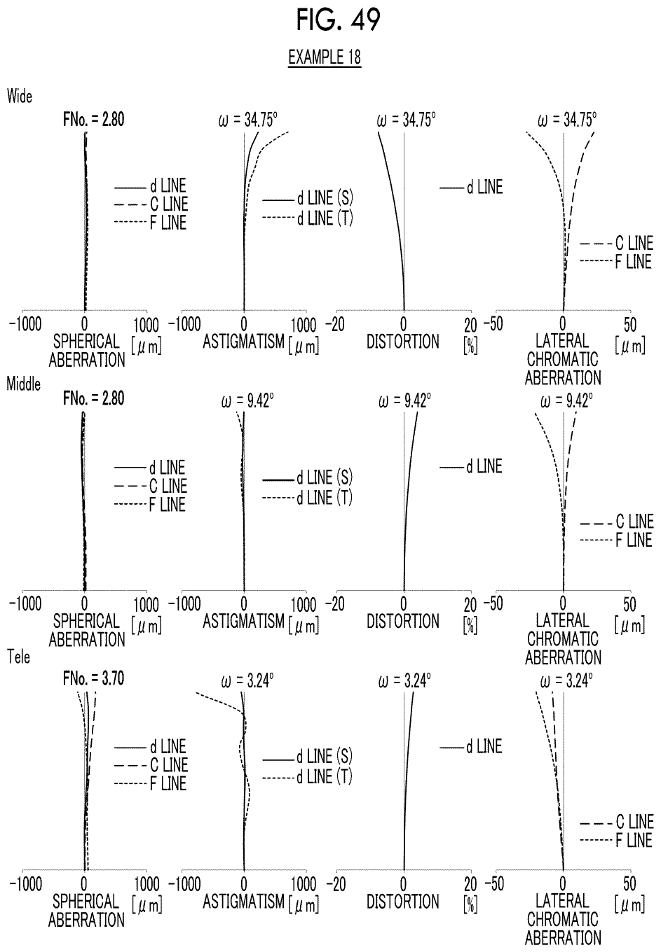

Regarding the zoom lens according to Example 18, Table 67 shows basic lens data, Table 68 shows specifications and variable surface spacings, and Table 69 shows aspherical coefficients thereof. FIG. 49 shows aberration diagrams thereof.

TABLE 67
Example 18

| Sn | R | D | Nd | νd | θg, F | SG | ED |
|---|---|---|---|---|---|---|---|
| 1 | −293.1344 | 2.0002 | 1.80610 | 40.97 | 0.56882 | 4.31 | 94.54 |
| 2 | 98.8570 | 4.3522 | | | | | 86.98 |
| 3 | 96.0703 | 3.1894 | 1.80809 | 22.76 | 0.63073 | 3.29 | 87.62 |
| 4 | 118.1719 | DD[4] | | | | | 87.26 |
| *5 | 235.3739 | 10.6249 | 1.49700 | 81.54 | 0.53748 | 3.62 | 87.20 |
| 6 | −180.8965 | DD[6] | | | | | 87.03 |
| 7 | 512.8863 | 2.5000 | 1.80809 | 22.76 | 0.63073 | 3.29 | 82.00 |
| 8 | 133.9475 | 10.7750 | 1.49700 | 81.54 | 0.53748 | 3.62 | 82.57 |
| 9 | −293.5253 | DD[9] | | | | | 82.87 |
| 10 | 93.4067 | 16.4998 | 1.43387 | 95.18 | 0.53733 | 3.18 | 85.98 |
| 11 | −199.3054 | 0.2002 | | | | | 85.70 |
| *12 | 128.2936 | 5.8167 | 1.72825 | 28.46 | 0.60772 | 3.06 | 81.01 |
| 13 | 552.1734 | DD[13] | | | | | 80.50 |
| 14 | 195.6991 | 0.8500 | 1.72342 | 37.95 | 0.58370 | 3.67 | 36.40 |
| 15 | 22.7393 | 11.5080 | | | | | 30.47 |
| 16 | −42.8730 | 0.7600 | 1.80400 | 46.53 | 0.55775 | 4.46 | 28.77 |
| 17 | 114.4392 | 5.9999 | 1.80518 | 25.42 | 0.61616 | 3.37 | 28.94 |
| 18 | −30.4880 | 2.3711 | | | | | 29.00 |
| 19 | −24.5451 | 0.7500 | 1.54678 | 62.74 | 0.53735 | 2.84 | 27.45 |
| *20 | 123.2853 | DD[20] | | | | | 27.63 |
| 21 | −57.4584 | 4.2192 | 1.80518 | 25.42 | 0.61616 | 3.37 | 34.01 |
| 22 | −29.2402 | 1.0002 | 1.84850 | 43.79 | 0.56197 | 5.08 | 34.40 |
| 23 | −175.8450 | DD[23] | | | | | 36.37 |
| *24 | 77.8094 | 5.6022 | 1.69680 | 55.53 | 0.54341 | 3.70 | 40.50 |
| 25 | −101.8784 | 0.1801 | | | | | 40.75 |
| 26 | 55.5401 | 6.5345 | 1.59282 | 68.62 | 0.54414 | 4.13 | 41.05 |
| 27 | −153.8577 | 0.9166 | | | | | 40.72 |
| 28 | 54.2480 | 4.1506 | 1.49700 | 81.54 | 0.53748 | 3.62 | 37.35 |
| 29 | 690.8442 | 1.0000 | 1.85025 | 30.05 | 0.59797 | 4.00 | 36.65 |
| 30 | 37.4241 | DD[30] | | | | | 34.09 |
| 31(St) | 00 | 1.0001 | | | | | 32.78 |
| 32 | 39.6735 | 7.3523 | 1.59551 | 39.24 | 0.58043 | 2.63 | 32.21 |
| 33 | 251.0076 | 1.0001 | 1.74400 | 44.79 | 0.56560 | 4.32 | 30.83 |
| 34 | 33.1819 | 1.0000 | | | | | 29.14 |
| 35 | 31.9410 | 1.8955 | 1.53775 | 74.70 | 0.53936 | 3.64 | 29.28 |
| 36 | 40.7753 | 32.5002 | | | | | 29.00 |
| 37 | 43.7549 | 7.6829 | 1.49700 | 81.54 | 0.53748 | 3.62 | 36.00 |
| 38 | −68.0153 | 3.6061 | | | | | 35.85 |
| 39 | 39.3724 | 6.7423 | 1.49700 | 81.54 | 0.53748 | 3.62 | 31.56 |
| 40 | −55.7578 | 2.4164 | 1.85545 | 36.60 | 0.57920 | 4.50 | 30.81 |
| 41 | 34.5149 | 2.9618 | | | | | 28.21 |
| 42 | 149.2894 | 7.8453 | 1.67270 | 32.10 | 0.59891 | 2.91 | 28.28 |
| 43 | −20.7992 | 1.0001 | 1.85150 | 40.78 | 0.56958 | 4.70 | 28.27 |
| 44 | 458.6153 | 0.2368 | | | | | 29.41 |
| 45 | 44.2035 | 4.3844 | 1.45650 | 90.27 | 0.53477 | 3.60 | 30.41 |
| 46 | −269.1698 | 40.3695 | | | | | 30.43 |

TABLE 68
Example 18

| | Object distance | | | | | |
|---|---|---|---|---|---|---|
| | Infinity | | | Close range (0.87 m) | | |
| Zooming state | Wide | Middle | Tele | Wide | Middle | Tele |
| Zr | 1.00 | 3.72 | 11.03 | 1.00 | 3.72 | 11.03 |
| f | 22.66 | 84.23 | 249.86 | 23.80 | 96.70 | 236.92 |
| FNo. | 2.80 | 2.80 | 3.70 | 2.80 | 2.79 | 3.79 |
| 2ω[°] | 69.50 | 18.84 | 6.48 | 63.18 | 14.48 | 2.42 |
| DD[4] | 5.3777 | 5.3777 | 5.3777 | 12.9822 | 12.9822 | 12.9822 |
| DD[6] | 4.7627 | 4.7627 | 4.7627 | 0.9998 | 0.9998 | 0.9998 |
| DD[9] | 9.1786 | 9.1786 | 9.1786 | 1.0003 | 1.0003 | 1.0003 |
| DD[13] | 1.7285 | 49.1355 | 70.8324 | 6.0652 | 53.4722 | 75.1691 |
| DD[20] | 70.0466 | 2.2312 | 1.4987 | 70.0466 | 2.2312 | 1.4987 |
| DD[23] | 5.5091 | 19.8738 | 1.4976 | 5.5091 | 19.8738 | 1.4976 |
| DD[30] | 5.7944 | 11.8382 | 9.2499 | 5.7944 | 11.8382 | 9.2499 |
| DD[46] | 40.3587 | 40.3782 | 40.3520 | 40.3616 | 40.4192 | 40.7382 |
| IHw | 14.525 | | | | | |

TABLE 69
Example 18

| Sn | 5 | 12 |
|---|---|---|
| KA | 1.000000000000000E+00 | 1.000000000000000E+00 |
| A4 | −1.831401824429240E−08 | −6.441634103745720E−08 |
| A6 | 3.343186939461500E−11 | −4.334365104773690E−11 |
| A8 | −2.198079702348000E−14 | 3.602280244191030E−14 |
| A10 | 1.752331827337470E−18 | −3.719058573853740E−17 |
| A12 | 6.165562876708380E−21 | 7.914190667865100E−21 |
| A14 | −6.227037343144990E−25 | 1.671753249022880E−23 |
| A16 | −2.847116920103840E−27 | −1.734357853606790E−26 |
| A18 | 1.448604224950300E−30 | 6.767298954407350E−30 |
| A20 | −2.077134407741960E−34 | −9.847374407398970E−34 |
| Sn | 20 | 24 |
| KA | −1.999248518713330E+02 | 1.000000000000000E+00 |
| A4 | −1.983031887625600E−05 | −2.546120157964920E−06 |
| A6 | 7.177076856377400E−08 | 6.068093239166660E−10 |
| A8 | −3.092084767717830E−10 | −2.324847002862040E−13 |
| A10 | −2.096247997067960E−13 | −1.984436309492110E−15 |
| A12 | 6.958352578723050E−15 | 4.452189433007260E−18 |
| A14 | 3.075706001551370E−17 | 3.401030271055960E−21 |
| A16 | −6.282442270253770E−19 | −6.299537852164630E−24 |
| A18 | 2.768300204133130E−21 | −5.107533206471560E−26 |
| A20 | −4.064996355153540E−24 | 8.278133313541900E−29 |

### Example 19

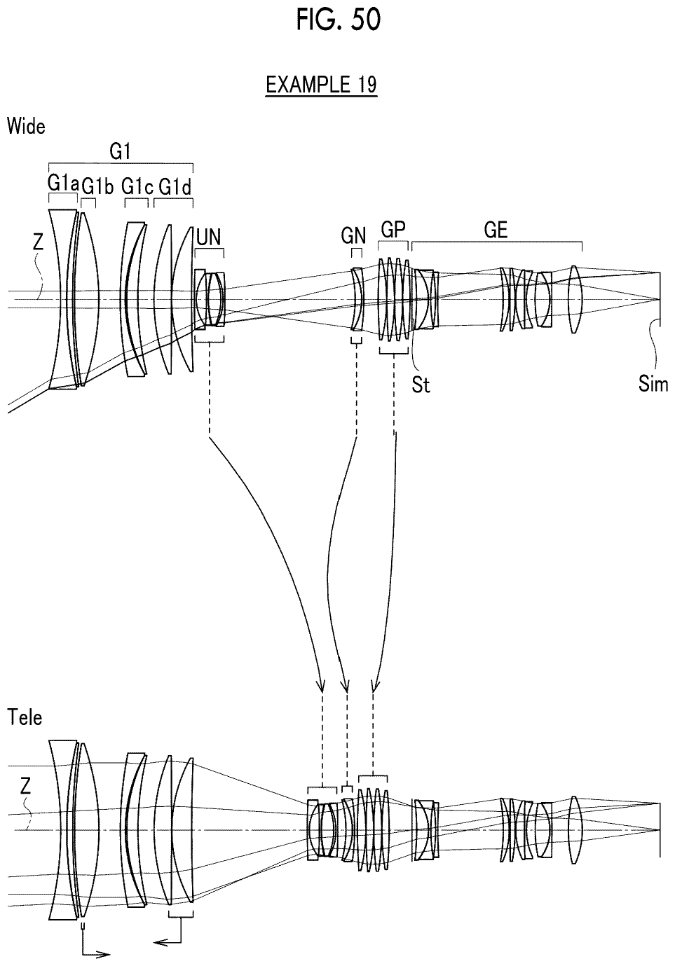

FIG. 50 shows a configuration and movement loci of the zoom lens according to Example 19. The zoom lens according to Example 19 consists of, in order from the object side to the image side, a first lens group G1 that has a positive refractive power, a negative group UN that has a negative refractive power as a whole, an N lens group GN that has a negative refractive power, a P lens group GP that has a positive refractive power, and a final lens group GE that has a positive refractive power. The negative group UN consists of one lens group.

During zooming from the wide angle end to the telephoto end, the first lens group G1 and the final lens group GE remain stationary with respect to the image plane Sim, and the negative group UN, the N lens group GN, and the P lens group GP move along the optical axis Z by changing the spacings between the adjacent lens groups.

The first lens group G1 consists of a first a-part group G1a, a first b-part group G1b, a first c-part group G1c, and a first d-part group G1d, in order from the object side to the image side. During focusing from the infinite distance object to the closest range object, the first a-part group G1a and the first c-part group G1c remain stationary with respect to the image plane Sim, the first b-part group G1b moves toward the image side, and the first d-part group G1d moves toward the object side.

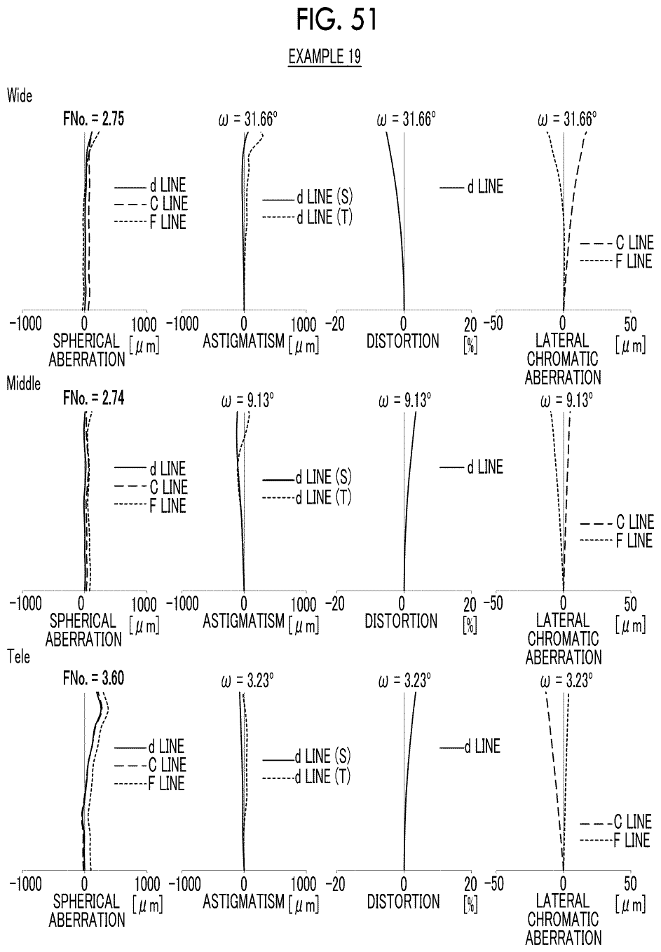

Regarding the zoom lens according to Example 19, Tables 70A and 70B show basic lens data, Table 71 shows specifications and variable surface spacings, and Table 72 shows aspherical coefficients thereof. FIG. 51 shows aberration diagrams.

TABLE 70A
Example 19

| Sn | R | D | Nd | νd | θg, F | SG | ED |
|---|---|---|---|---|---|---|---|
| 1 | −196.9396 | 3.1494 | 1.80400 | 46.53 | 0.55775 | 4.46 | 98.73 |
| 2 | 219.6156 | 0.1269 | | | | | 95.94 |
| 3 | 224.8088 | 3.0855 | 1.86966 | 20.02 | 0.64349 | 3.37 | 95.94 |
| 4 | 358.6466 | DD[4] | | | | | 95.73 |
| 5 | 309.3670 | 12.9566 | 1.60137 | 66.73 | 0.54368 | 4.07 | 95.14 |
| *6 | −141.1671 | DD[6] | | | | | 95.11 |
| 7 | 224.6833 | 2.6632 | 1.85478 | 24.80 | 0.61232 | 3.49 | 84.78 |
| 8 | 87.4828 | 0.7873 | | | | | 81.96 |
| 9 | 93.8796 | 5.9029 | 1.57144 | 71.61 | 0.54193 | 4.11 | 81.96 |
| 10 | 179.8538 | DD[10] | | | | | 81.78 |
| 11 | 111.8342 | 9.3062 | 1.59522 | 67.73 | 0.54426 | 4.17 | 81.89 |
| 12 | −4092.4970 | 0.1001 | | | | | 81.71 |
| 13 | 84.1313 | 10.5763 | 1.59522 | 67.73 | 0.54426 | 4.17 | 79.33 |
| 14 | 994.9235 | DD[14] | | | | | 78.65 |
| 15 | 444.1012 | 1.0476 | 1.94771 | 33.23 | 0.58771 | 5.35 | 33.02 |
| 16 | 24.4553 | 5.3684 | | | | | 28.58 |
| 17 | −220.3608 | 0.9679 | 1.74365 | 53.64 | 0.54586 | 4.17 | 28.55 |
| 18 | 68.1263 | 0.1145 | | | | | 28.56 |
| 19 | 54.7244 | 6.5695 | 1.81621 | 22.31 | 0.63247 | 3.27 | 28.75 |
| 20 | −35.9009 | 1.1865 | | | | | 28.67 |
| 21 | −30.9000 | 0.9696 | 1.95236 | 32.76 | 0.58891 | 5.37 | 28.37 |
| *22 | −383.0770 | DD[22] | | | | | 29.61 |
| 23 | −65.7884 | 3.4687 | 1.86966 | 20.02 | 0.64349 | 3.37 | 32.91 |
| 24 | −33.4454 | 1.1263 | 1.93161 | 34.75 | 0.58381 | 5.30 | 33.23 |
| 25 | −125.5533 | DD[25] | | | | | 34.56 |
| *26 | 233.3788 | 4.4873 | 1.73918 | 54.08 | 0.54522 | 4.15 | 43.98 |
| 27 | −95.7153 | 0.1002 | | | | | 44.34 |
| 28 | 288.5767 | 4.0404 | 1.72951 | 55.02 | 0.54408 | 4.11 | 45.44 |
| 29 | −113.7254 | 0.1000 | | | | | 45.54 |
| 30 | 195.8368 | 4.2096 | 1.72977 | 55.01 | 0.54409 | 4.11 | 45.17 |
| 31 | −146.5555 | 0.1000 | | | | | 44.99 |
| 32 | 136.7788 | 3.8729 | 1.74072 | 53.93 | 0.54544 | 4.16 | 43.15 |
| 33 | −228.1011 | DD[33] | | | | | 42.65 |

TABLE 70B
Example 19

| Sn | R | D | Nd | νd | θg, F | SG | ED |
|---|---|---|---|---|---|---|---|
| 34(St) | ∞ | 2.4639 | | | | | 34.33 |
| 35 | −146.9965 | 6.3307 | 1.83085 | 32.03 | 0.59459 | 4.33 | 32.92 |
| 36 | −26.8128 | 1.2157 | 1.85478 | 24.80 | 0.61232 | 3.49 | 32.28 |
| 37 | 88.5532 | 2.5510 | | | | | 29.87 |
| 38 | −96.2633 | 1.1766 | 1.74500 | 41.29 | 0.57153 | 3.80 | 29.84 |
| 39 | 267.6256 | 34.8165 | | | | | 29.86 |
| 40 | −98.8182 | 3.1708 | 1.79375 | 25.58 | 0.61595 | 3.51 | 34.42 |
| 41 | −44.0841 | 0.4475 | | | | | 34.77 |
| 42 | 1749.9018 | 2.6591 | 1.77830 | 23.91 | 0.62490 | 3.30 | 34.35 |
| 43 | −99.6919 | 0.3524 | | | | | 34.28 |
| 44 | 38.6026 | 4.6412 | 1.51009 | 75.78 | 0.53590 | 3.29 | 32.17 |
| 45 | 558.2089 | 1.0715 | 1.85383 | 42.47 | 0.56513 | 4.82 | 31.41 |
| 46 | 35.3787 | 4.6242 | | | | | 29.52 |
| 47 | 73.0039 | 7.8442 | 1.43700 | 95.10 | 0.53364 | 3.53 | 29.24 |
| 48 | −26.1095 | 1.0129 | 1.98106 | 29.89 | 0.59749 | 5.31 | 28.86 |
| 49 | −1385.1813 | 8.7870 | | | | | 30.05 |
| 50 | 82.0789 | 7.4176 | 1.43937 | 94.57 | 0.53385 | 3.54 | 34.70 |
| 51 | −47.5054 | 41.4560 | | | | | 35.04 |

TABLE 71
Example 19

| | Object distance | | | | | |
|---|---|---|---|---|---|---|
| | Infinity | | | Close range (0.88 m) | | |
| Zooming state | Wide | Middle | Tele | Wide | Middle | Tele |
| Zr | 1.00 | 3.51 | 10.00 | 1.00 | 3.51 | 10.00 |
| f | 25.31 | 88.84 | 252.85 | 27.40 | 111.13 | 300.72 |
| FNo. | 2.75 | 2.74 | 3.60 | 2.75 | 2.74 | 3.59 |
| 2ω[°] | 63.32 | 18.26 | 6.46 | 56.38 | 13.66 | 3.38 |
| DD[4] | 1.0160 | 1.0160 | 1.0160 | 11.3928 | 11.3928 | 11.3928 |
| DD[6] | 11.3817 | 11.3817 | 11.3817 | 1.0049 | 1.0049 | 1.0049 |
| DD[10] | 8.6022 | 8.6022 | 8.6022 | 1.0059 | 1.0059 | 1.0059 |
| DD[14] | 1.5048 | 45.1993 | 61.5104 | 9.1011 | 52.7955 | 69.1066 |
| DD[22] | 69.0194 | 10.1337 | 4.0223 | 69.0194 | 10.1337 | 4.0223 |
| DD[25] | 7.6539 | 20.1777 | 1.5046 | 7.6539 | 20.1777 | 1.5046 |
| DD[33] | 1.0047 | 3.6721 | 12.1454 | 1.0047 | 3.6721 | 12.1454 |
| IHw | 14.775 | | | | | |

TABLE 72
Example 19

| Sn | 6 | 22 |
|---|---|---|
| KA | 3.739213114894200E+00 | −5.000000065874430E+00 |
| A3 | 2.502380972107790E−20 | 6.938893903907230E−19 |
| A4 | 1.845717125098290E−07 | −7.503368545844070E−06 |
| A5 | 3.264482404852800E−09 | 3.160647276543530E−06 |
| A6 | −3.750874551403670E−10 | −1.257596385659710E−06 |
| A7 | 2.172644649230880E−11 | 2.507771385779290E−07 |
| A8 | −5.618415211608210E−13 | −2.316974409598310E−08 |
| A9 | 3.330508707266680E−15 | 6.310351632369120E−11 |
| A10 | 1.473194557559940E−16 | 1.701136652807970E−10 |
| A11 | −4.248882528187570E−18 | −1.087188914314710E−11 |
| A12 | 1.071760161280980E−19 | −2.009181700262970E−13 |
| A13 | −1.900625949846000E−21 | 4.081761219559100E−14 |
| A14 | −1.040859696932540E−23 | −7.186138144148140E−16 |
| A15 | 7.723000277946610E−25 | −4.438498502817680E−17 |
| A16 | −6.637080207837440E−27 | 1.394133320444420E−18 |

| Sn | 26 |
|---|---|
| KA | −4.537462678642240E+00 |
| A3 | 8.881784197001250E−20 |
| A4 | −2.448749283647750E−06 |
| A5 | 6.494407661669210E−07 |
| A6 | −1.621065628775970E−07 |
| A7 | 1.993991270424150E−08 |
| A8 | −1.005453772108440E−09 |
| A9 | −2.573903815784000E−11 |
| A10 | 5.301307955694800E−12 |
| A11 | −1.591151218289110E−13 |
| A12 | −5.571723189261670E−15 |
| A13 | 3.892562699520670E−16 |
| A14 | −2.408658920873080E−18 |
| A15 | −2.351232470570690E−19 |
| A16 | 4.218144120320240E−21 |

### Example 19-1

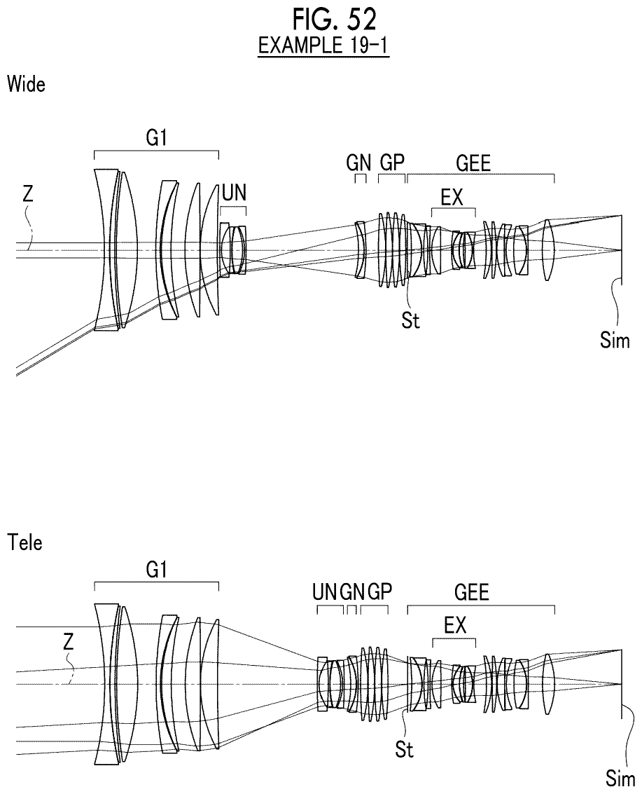

Example 19-1 is an example in which the EX group EX is inserted in the zoom lens according to Example 19. FIG. 52 shows a cross-sectional view of a configuration and luminous flux of the zoom lens according to Example 19-1. The zoom lens according to Example 19-1 includes a final lens group GEE in which the EX group EX is inserted in the final lens group GE of Example 19, instead of the final lens group GE of Example 19. The other lens groups and the group configuration of Example 19-1 are the same as those of the zoom lens according to Example 19.

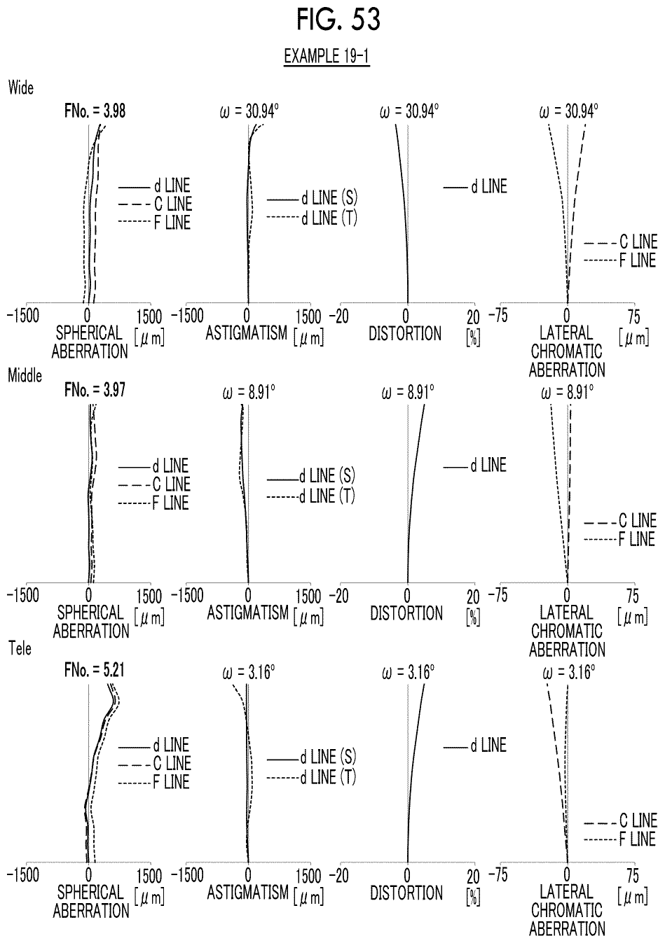

Regarding the zoom lens according to Example 19-1, Tables 73A and 73B show basic lens data, Table 74 shows specifications and variable surface spacings, and Table 75 shows aspherical coefficients thereof. FIG. 53 shows aberration diagrams.

TABLE 73A
Example 19-1

| Sn | R | D | Nd | νd | θg, F | SG | ED |
|---|---|---|---|---|---|---|---|
| 1 | −196.9396 | 3.1494 | 1.80400 | 46.53 | 0.55775 | 4.46 | 98.73 |
| 2 | 219.6156 | 0.1269 | | | | | 95.91 |
| 3 | 224.8088 | 3.0855 | 1.86966 | 20.02 | 0.64349 | 3.37 | 95.91 |
| 4 | 358.6466 | DD[4] | | | | | 95.69 |
| 5 | 309.3670 | 12.9566 | 1.60137 | 66.73 | 0.54368 | 4.07 | 95.14 |
| *6 | −141.1671 | DD[6] | | | | | 95.12 |
| 7 | 224.6833 | 2.6632 | 1.85478 | 24.80 | 0.61232 | 3.49 | 84.78 |
| 8 | 87.4828 | 0.7873 | | | | | 81.96 |
| 9 | 93.8796 | 5.9029 | 1.57144 | 71.61 | 0.54193 | 4.11 | 81.96 |
| 10 | 179.8538 | DD[10] | | | | | 81.78 |
| 11 | 111.8342 | 9.3062 | 1.59522 | 67.73 | 0.54426 | 4.17 | 81.89 |
| 12 | −4092.4970 | 0.1001 | | | | | 81.70 |
| 13 | 84.1313 | 10.5763 | 1.59522 | 67.73 | 0.54426 | 4.17 | 79.33 |
| 14 | 994.9235 | DD[14] | | | | | 78.65 |
| 15 | 444.1012 | 1.0476 | 1.94771 | 33.23 | 0.58771 | 5.35 | 32.96 |
| 16 | 24.4553 | 5.3684 | | | | | 28.58 |
| 17 | −220.3608 | 0.9679 | 1.74365 | 53.64 | 0.54586 | 4.17 | 28.56 |
| 18 | 68.1263 | 0.1145 | | | | | 28.58 |
| 19 | 54.7244 | 6.5695 | 1.81621 | 22.31 | 0.63247 | 3.27 | 28.76 |
| 20 | −35.9009 | 1.1865 | | | | | 28.67 |
| 21 | −30.9000 | 0.9696 | 1.95236 | 32.76 | 0.58891 | 5.37 | 28.38 |
| *22 | −383.0770 | DD[22] | | | | | 29.61 |
| 23 | −65.7884 | 3.4687 | 1.86966 | 20.02 | 0.64349 | 3.37 | 32.82 |
| 24 | −33.4454 | 1.1263 | 1.93161 | 34.75 | 0.58381 | 5.30 | 33.16 |
| 25 | −125.5533 | DD[25] | | | | | 34.56 |
| *26 | 233.3788 | 4.4873 | 1.73918 | 54.08 | 0.54522 | 4.15 | 43.98 |
| 27 | −95.7153 | 0.1002 | | | | | 44.36 |
| 28 | 288.5767 | 4.0404 | 1.72951 | 55.02 | 0.54408 | 4.11 | 45.44 |
| 29 | −113.7254 | 0.1000 | | | | | 45.54 |
| 30 | 195.8368 | 4.2096 | 1.72977 | 55.01 | 0.54409 | 4.11 | 45.17 |
| 31 | −146.5555 | 0.1000 | | | | | 44.99 |
| 32 | 136.7788 | 3.8729 | 1.74072 | 53.93 | 0.54544 | 4.16 | 43.15 |
| 33 | −228.1011 | DD[33] | | | | | 42.65 |

TABLE 73B
Example 19-1

| Sn | R | D | Nd | νd | θg, F | SG | ED |
|---|---|---|---|---|---|---|---|
| 34(St) | ∞ | 2.4639 | | | | | 34.33 |
| 35 | −146.9965 | 6.3307 | 1.83085 | 32.03 | 0.59459 | 4.33 | 32.80 |
| 36 | −26.8128 | 1.2157 | 1.85478 | 24.80 | 0.61232 | 3.49 | 32.07 |
| 37 | 88.5532 | 2.5510 | | | | | 29.36 |
| 38 | −96.2633 | 1.1766 | 1.74500 | 41.29 | 0.57153 | 3.80 | 29.29 |
| 39 | 267.6256 | 1.2339 | | | | | 29.12 |
| 40 | 29.0522 | 5.4949 | 1.57183 | 68.95 | 0.54096 | 3.59 | 29.04 |
| 41 | −1248.1799 | 6.7311 | | | | | 28.45 |
| 42 | 67.8092 | 0.7862 | 1.99744 | 27.95 | 0.60331 | 5.09 | 23.51 |
| 43 | 15.9538 | 3.8727 | 1.67949 | 31.47 | 0.60047 | 2.87 | 21.61 |
| 44 | 31.8885 | 0.1054 | | | | | 21.54 |
| 45 | 27.0120 | 2.5035 | 1.44760 | 64.82 | 0.52862 | 2.79 | 21.76 |
| 46 | 64.0122 | 1.1537 | | | | | 21.76 |
| 47 | −404.5886 | 4.4325 | 1.84992 | 22.95 | 0.62661 | 3.64 | 21.77 |
| 48 | −21.1185 | 0.7511 | 1.80102 | 47.90 | 0.55492 | 4.48 | 21.94 |
| 49 | 55.6393 | 7.7515 | | | | | 22.34 |
| 50 | −98.8182 | 3.1708 | 1.79375 | 25.58 | 0.61595 | 3.51 | 25.26 |
| 51 | −44.0841 | 0.4475 | | | | | 26.05 |
| 52 | 1749.9018 | 2.6591 | 1.77830 | 23.91 | 0.62490 | 3.30 | 26.59 |
| 53 | −99.6919 | 0.3524 | | | | | 26.79 |
| 54 | 38.6026 | 4.6412 | 1.51009 | 75.78 | 0.53590 | 3.29 | 26.77 |
| 55 | 558.2089 | 1.0715 | 1.85383 | 42.47 | 0.56513 | 4.82 | 26.17 |
| 56 | 35.3787 | 4.6242 | | | | | 25.48 |
| 57 | 73.0039 | 7.8442 | 1.43700 | 95.10 | 0.53364 | 3.53 | 26.41 |
| 58 | −26.1095 | 1.0129 | 1.98106 | 29.89 | 0.59749 | 5.31 | 26.63 |
| 59 | −1385.1813 | 8.7870 | | | | | 28.31 |
| 60 | 82.0789 | 7.4176 | 1.43937 | 94.57 | 0.53385 | 3.54 | 36.35 |
| 61 | −47.5054 | 41.4560 | | | | | 36.91 |

TABLE 74
Example 19-1

| | Object distance | | | | | |
|---|---|---|---|---|---|---|
| | Infinity | | | Close range (0.88 m) | | |
| Zooming state | Wide | Middle | Tele | Wide | Middle | Tele |
| Zr | 1.00 | 3.51 | 10.00 | 1.00 | 3.51 | 10.00 |
| f | 36.62 | 128.54 | 365.62 | 39.33 | 143.49 | 225.50 |
| FNo. | 3.98 | 3.97 | 5.21 | 3.98 | 3.97 | 5.20 |
| 2ω[°] | 61.88 | 17.82 | 6.32 | 55.24 | 13.36 | 3.30 |
| DD[4] | 1.0160 | 1.0160 | 1.0160 | 11.3928 | 11.3928 | 11.3928 |
| DD[6] | 11.3817 | 11.3817 | 11.3817 | 1.0049 | 1.0049 | 1.0049 |
| DD[10] | 8.6022 | 8.6022 | 8.6022 | 1.0059 | 1.0059 | 1.0059 |
| DD[14] | 1.5048 | 45.1993 | 61.5104 | 9.1011 | 52.7955 | 69.1066 |
| DD[22] | 69.0194 | 10.1337 | 4.0223 | 69.0194 | 10.1337 | 4.0223 |
| DD[25] | 7.6539 | 20.1777 | 1.5046 | 7.6539 | 20.1777 | 1.5046 |
| DD[33] | 1.0047 | 3.6721 | 12.1454 | 1.0047 | 3.6721 | 12.1454 |

TABLE 75
Example 19-1

| Sn | 6 | 22 |
|---|---|---|
| KA | 3.739213114894200E+00 | −5.000000065874430E+00 |
| A3 | 2.502380972107790E−20 | 6.938893903907230E−19 |
| A4 | 1.845717125098290E−07 | −7.503368545844070E−06 |
| A5 | 3.264482404852800E−09 | 3.160647276543530E−06 |
| A6 | −3.750874551403670E−10 | −1.257596385659710E−06 |
| A7 | 2.172644649230880E−11 | 2.507771385779290E−07 |
| A8 | −5.618415211608210E−13 | −2.316974409598310E−08 |
| A9 | 3.330508707266680E−15 | 6.310351632369120E−11 |
| A10 | 1.473194557559940E−16 | 1.701136652807970E−10 |
| A11 | −4.248882528187570E−18 | −1.087188914314710E−11 |
| A12 | 1.071760161280980E−19 | −2.009181700262970E−13 |
| A13 | −1.900625949846000E−21 | 4.081761219559100E−14 |
| A14 | −1.040859696932540E−23 | −7.186138144148140E−16 |
| A15 | 7.723000277946610E−25 | −4.438498502817680E−17 |
| A16 | −6.637080207837440E−27 | 1.394133320444420E−18 |

| Sn | 26 |
|---|---|
| KA | −4.537462678642240E+00 |
| A3 | 8.881784197001250E−20 |
| A4 | −2.448749283647750E−06 |
| A5 | 6.494407661669210E−07 |
| A6 | −1.621065628775970E−07 |
| A7 | 1.993991270424150E−08 |
| A8 | −1.005453772108440E−09 |
| A9 | −2.573903815784000E−11 |
| A10 | 5.301307955694800E−12 |
| A11 | −1.591151218289110E−13 |
| A12 | −5.571723189261670E−15 |
| A13 | 3.892562699520670E−16 |
| A14 | −2.408658920873080E−18 |
| A15 | −2.351232470570690E−19 |
| A16 | 4.218144120320240E−21 |

Tables 76 and 79 each show corresponding values of Conditional Expressions (1) to (23) of the zoom lenses according to Examples 1 to 19. Table 80 shows the corresponding values of Conditional Expressions (24) to (27) of the zoom lenses according to Examples 1-1, 13-1 to 16-1, and 19-1. Corresponding values of Conditional Expressions (1) to (23) are values in a state where the EX group EX is not inserted, and corresponding values of Conditional Expressions (24) to (27) are values in a state where the EX group EX is inserted. Preferable ranges of the conditional expressions may be set by using the corresponding values of the examples shown in Tables 76 to 80 as the upper or lower limits of the conditional expressions.

TABLE 76

| Expression | | | | | | |
|---|---|---|---|---|---|---|
| Number | | Example 1 | Example 2 | Example 3 | Example 4 | Example 5 |
| (1) | fN/f1 | −1.4678 | −1.1651 | −1.2134 | −1.1778 | −1.6630 |
| (2) | Denw/fw | 2.7355 | 2.8750 | 3.2166 | 3.0779 | 2.4896 |
| (3) | fUN/fN | 0.1497 | 0.1861 | 0.1997 | 0.2011 | 0.1380 |
| (4) | f1/f1a | −0.0051 | −0.0043 | −0.1874 | −0.1627 | 0.0458 |
| (5) | fUN/f1 | −0.2197 | −0.2168 | −0.2423 | −0.2369 | −0.2296 |
| (6) | Denw/f1 | 0.7919 | 0.7385 | 0.7469 | 0.7311 | 0.7696 |
| (7) | Denw/IHw | 4.6854 | 4.5155 | 4.3696 | 4.4041 | 4.4441 |
| (8) | MovN/(f1/log(ft/fw)) | −0.1182 | 0.0016 | −0.0050 | −0.0145 | −0.1127 |
| (9) | Bfw/IHw | 3.7999 | 2.9208 | 3.1292 | 3.0836 | 2.8579 |
| (10) | PF/IHw | 0.1788 | 0.1774 | 0.1938 | 0.1909 | 0.1563 |
| (11) | ωw | 32.3908 | 35.4103 | 39.5124 | 38.0334 | 31.1578 |
| (12) | fw/ft | 0.0830 | 0.0910 | 0.0980 | 0.0981 | 0.1001 |
| (13) | IHw/Dexw | 0.0796 | 0.1042 | 0.1036 | 0.1078 | 0.1009 |
| (14) | fw/f1 | 0.2895 | 0.2569 | 0.2322 | 0.2375 | 0.3091 |
| (15) | fw/fUN | −1.3177 | −1.1847 | −0.9582 | −1.0027 | −1.3466 |
| (16) | (R2 − R3)/(R2 + R3) | −0.0544 | 0.0271 | −0.2141 | −0.1536 | 0.0378 |
| (17) | βAmaxR | 0.1945 | 0.1789 | 0.1860 | 0.1919 | 0.2142 |
| (18) | tN1/ErN1 | 0.0359 | 0.0733 | 0.0684 | 0.0677 | 0.0614 |
| (19) | MovP/(f1/log(ft/fw)) | −0.1184 | 0.0121 | 0.0053 | −0.0045 | −0.0987 |
| (20) | D1a/TLw | 0.0781 | 0.1001 | 0.1248 | 0.1147 | 0.0744 |
| (21) | D1b/DG1 | 0.2810 | 0.2327 | 0.2776 | 0.2621 | 0.2437 |
| (22) | gνmax | 3.5300 | 3.1800 | 3.1800 | 3.1800 | 3.1800 |
| (23) | tL1/ErL1 | 0.0405 | 0.0570 | 0.0549 | 0.0419 | 0.0415 |

TABLE 77

| Expression | | | | | | |
|---|---|---|---|---|---|---|
| Number | | Example 6 | Example 7 | Example 8 | Example 9 | Example 10 |
| (1) | fN/f1 | −1.5647 | −1.1092 | −1.3357 | −1.4231 | −1.4592 |
| (2) | Denw/fw | 2.5680 | 2.8048 | 2.8715 | 2.7599 | 2.7300 |
| (3) | fUN/fN | 0.1482 | 0.1829 | 0.1592 | 0.1506 | 0.1490 |
| (4) | f1/f1a | 0.0199 | 0.0208 | −0.0040 | −0.0019 | 0.0528 |
| (5) | fUN/fl | −0.2320 | −0.2029 | −0.2126 | −0.2143 | −0.2174 |
| (6) | Denw/f1 | 0.7645 | 0.7227 | 0.8462 | 0.7967 | 0.7841 |
| (7) | Denw/IHw | 4.4012 | 4.4606 | 4.9220 | 4.7302 | 4.6716 |
| (8) | MovN/(f1/log(ft/fw)) | −0.0925 | 0.0059 | −0.1119 | −0.1002 | −0.1051 |
| (9) | Bfw/IHw | 2.8577 | 2.8291 | 2.6974 | 3.4209 | 2.9846 |
| (10) | PF/IHw | 0.1579 | 0.1715 | 0.1740 | 0.1723 | 0.1781 |
| (11) | ωw | 32.3137 | 35.1240 | 32.7762 | 32.3592 | 32.4047 |
| (12) | fw/ft | 0.0953 | 0.0794 | 0.0831 | 0.0831 | 0.0830 |
| (13) | IHw/Dexw | 0.1036 | 0.1090 | 0.1164 | 0.0667 | 0.0697 |
| (14) | fw/f1 | 0.2977 | 0.2577 | 0.2947 | 0.2887 | 0.2872 |
| (15) | fw/fUN | −1.2835 | −1.2702 | −1.3861 | −1.3471 | −1.3212 |
| (16) | (R2 − R3)/(R2 + R3) | 0.0072 | −0.0173 | −0.0427 | 0.0017 | −0.0221 |
| (17) | βAmaxR | 0.2273 | 0.2230 | 0.0952 | 0.2516 | 0.2042 |
| (18) | tN1/ErN1 | 0.0612 | 0.0749 | 0.0749 | 0.0707 | 0.0542 |
| (19) | MovP/(f1/log(ft/fw)) | −0.0925 | 0.0000 | −0.1120 | −0.1004 | −0.1068 |
| (20) | D1a/TLw | 0.0810 | 0.0893 | 0.0816 | 0.0776 | 0.0842 |
| (21) | D1b/DG1 | 0.2515 | 0.2437 | 0.2861 | 0.2712 | 0.2336 |
| (22) | gνmax | 3.1800 | 3.1800 | 3.1800 | 3.1800 | 3.1800 |
| (23) | tL1/ErL1 | 0.0407 | 0.0424 | 0.0570 | 0.0417 | 0.0449 |

TABLE 78

| Expression | | Example | Example | Example | Example | Example |
|---|---|---|---|---|---|---|
| Number | | 11 | 12 | 13 | 14 | 15 |
| (1) | fN/f1 | −1.4812 | −1.5257 | −1.5839 | −1.2898 | −1.5081 |
| (2) | Denw/fw | 2.7555 | 2.7645 | 2.7537 | 3.1263 | 2.7984 |
| (3) | fUN/fN | 0.1460 | 0.1414 | 0.1483 | 0.1723 | 0.1427 |
| (4) | f1/f1a | −0.0033 | 0.0032 | 0.0275 | −0.3136 | 0.0028 |
| (5) | fUN/fl | −0.2163 | −0.2157 | −0.2348 | −0.2222 | −0.2153 |
| (6) | Denw/f1 | 0.7939 | 0.8023 | 0.7590 | 0.9478 | 0.8132 |
| (7) | Denw/IHw | 4.7220 | 4.7384 | 4.7182 | 5.3232 | 4.7918 |
| (8) | MovN/(f1/log(ft/fw)) | −0.1152 | −0.1118 | −0.2251 | −0.0578 | −0.1094 |
| (9) | Bfw/IHw | 2.8461 | 2.7717 | 2.6903 | 2.5792 | 3.0971 |
| (10) | PF/IHw | 0.1631 | 0.1635 | 0.1778 | 0.1849 | 0.1779 |
| (11) | ωw | 32.3302 | 32.3097 | 32.4451 | 32.0958 | 32.5855 |
| (12) | fw/ft | 0.0830 | 0.0830 | 0.0830 | 0.0825 | 0.0830 |
| (13) | IHw/Dexw | 0.1080 | 0.1078 | 0.0310 | 0.0633 | 0.0687 |
| (14) | fw/f1 | 0.2881 | 0.2902 | 0.2756 | 0.3032 | 0.2906 |
| (15) | fw/fUN | −1.3318 | −1.3456 | −1.1737 | −1.3645 | −1.3499 |
| (16) | (R2 − R3)/(R2 + R3) | 0.0118 | 0.0065 | −0.0093 | −0.1180 | 0.0009 |
| (17) | βAmaxR | 0.2428 | 0.2621 | 0.2161 | 0.1805 | 0.2184 |
| (18) | tN1/ErN1 | 0.0475 | 0.0336 | 0.0489 | 0.0734 | 0.0525 |
| (19) | MovP/(f1/log(ft/fw)) | −0.1163 | −0.1129 | −0.2251 | −0.1123 | −0.1099 |
| (20) | D1a/TLw | 0.0786 | 0.0800 | 0.0715 | 0.0484 | 0.0813 |
| (21) | D1b/DG1 | 0.2868 | 0.2729 | 0.2033 | 0.1366 | 0.2591 |
| (22) | gνmax | 3.1800 | 3.1800 | 3.1800 | 3.5900 | 3.1800 |
| (23) | tL1/ErL1 | 0.0417 | 0.0421 | 0.0449 | 0.0446 | 0.0444 |

TABLE 79

| Expression | | Example | Example | Example | Example |
|---|---|---|---|---|---|
| Number | | 16 | 17 | 18 | 19 |
| (1) | fN/f1 | −1.5419 | −1.2306 | −1.0419 | −1.3152 |
| (2) | Denw/fw | 2.7804 | 2.9623 | 3.0072 | 2.9935 |
| (3) | fUN/fN | 0.1432 | 0.1831 | 0.2614 | 0.1719 |
| (4) | f1/f1a | 0.0061 | −0.3405 | −0.8486 | −0.6461 |
| (5) | fUN/f1 | −0.2208 | −0.2253 | −0.2724 | −0.2261 |
| (6) | Denw/f1 | 0.8166 | 0.8690 | 0.7470 | 0.7422 |
| (7) | Denw/IHw | 4.7453 | 5.0440 | 4.6917 | 5.1270 |
| (8) | MovN/(f1/log(ft/fw)) | −0.1521 | −0.0504 | 0.0064 | −0.0482 |
| (9) | Bfw/IHw | 3.0366 | 2.9783 | 2.7793 | 2.8058 |
| (10) | PF/IHw | 0.1809 | 0.1757 | 0.1676 | 0.1653 |
| (11) | ωw | 32.4344 | 32.1197 | 34.7495 | 31.6569 |
| (12) | fw/ft | 0.0830 | 0.0825 | 0.0907 | 0.1001 |
| (13) | IHw/Dexw | 0.0917 | 0.0646 | 0.1266 | 0.0633 |
| (14) | fw/f1 | 0.2937 | 0.2934 | 0.2484 | 0.2479 |
| (15) | fw/fUN | −1.3303 | −1.3019 | −0.9119 | −1.0964 |
| (16) | (R2 − R3)/(R2 + R3) | 0.0146 | −0.1163 | 0.0143 | −0.0117 |
| (17) | βAmaxR | 0.2123 | 0.1730 | 0.1715 | 0.2236 |
| (18) | tN1/ErN1 | 0.0583 | 0.0546 | 0.0467 | 0.0634 |
| (19) | MovP/(f1/log(ft/fw)) | −0.1541 | −0.1036 | −0.0394 | −0.1085 |
| (20) | D1a/TLw | 0.0763 | 0.0427 | 0.0293 | 0.0200 |
| (21) | D1b/DG1 | 0.2812 | 0.1412 | 0.1411 | 0.1860 |
| (22) | gνmax | 3.1800 | 3.1800 | 3.1800 | 4.1100 |
| (23) | tL1/ErL1 | 0.0447 | 0.0428 | 0.0423 | 0.0638 |

TABLE 80

| Expression | | | | |
|---|---|---|---|---|
| Number | | Example 1-1 | Example 13-1 | Example 14-1 |
| (24) | (ft × tanωt)/(fEt × tanωEt) | 0.6951 | 0.6944 | 0.6980 |
| (25) | DEX/TLw | 0.0868 | 0.0820 | 0.0800 |
| (26) | Bfw/fLExe | −1.8874 | −1.1975 | −0.8885 |
| (27) | NEX1 | 1.6325 | 1.4875 | 1.5756 |

| Expression | | | | |
|---|---|---|---|---|
| Number | | Example 15-1 | Example 16-1 | Example 19-1 |
| (24) | (ft × tanωt)/(fEt × tanωEt) | 0.6952 | 0.6935 | 0.7080 |
| (25) | DEX/TLw | 0.0895 | 0.0868 | 0.0811 |
| (26) | Bfw/fLExe | −0.7384 | −0.8514 | −0.5903 |
| (27) | NEX1 | 1.5749 | 1.8216 | 1.5718 |

The zoom lenses according to Examples 1 to 19 have a small configuration and have a maximum image height of 14.5 or more in a state where the infinite distance object is in focus at the wide angle end, and have a large image circle. Further, in each of the zoom lenses according to Examples 1 to 19, the maximum half angle of view in a state where the infinite distance object is in focus at the wide angle end is 30 degrees or more. The zoom lenses each are configured to have a wide angle. In addition, the zoom lenses each maintain high optical performance by satisfactorily correcting various aberrations.

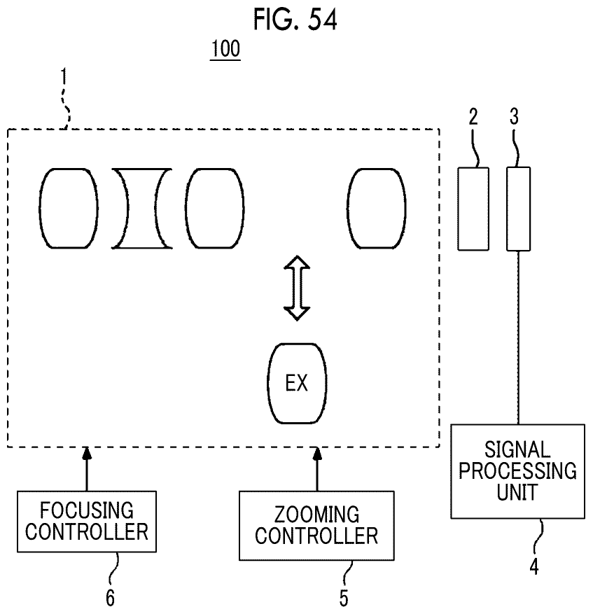

Next, an imaging apparatus according to an embodiment of the present disclosure will be described. FIG. 54 is a schematic configuration diagram of an imaging apparatus 100 according to an embodiment of the present disclosure. The imaging apparatus 100 is configured to include a zoom lens 1 according to an embodiment of the present disclosure. Examples of the imaging apparatus 100 may include a movie camera, a broadcast camera, a surveillance camera, a digital camera, a video camera, and the like.

The imaging apparatus 100 includes a zoom lens 1, a filter 2 disposed on the image side of the zoom lens 1, and an imaging element 3 disposed on the image side of the filter 2. The zoom lens 1 in FIG. 54 is conceptually shown. The zoom lens 1 includes the EX group EX that changes a focal length of the zoom lens by being inserted in or extracted from an optical path while keeping an imaging position constant.

The imaging element 3 converts an optical image formed by the zoom lens 1 into an electric signal, and for example, a charge coupled device (CCD) or a complementary metal oxide semiconductor (CMOS) or the like can be used. The imaging element 3 is disposed such that the imaging surface thereof coincides with the image plane of the zoom lens 1. In addition, although only one imaging element 3 is shown in FIG. 54, the imaging apparatus 100 may be a so-called three-plate type imaging apparatus comprising three imaging elements.

The imaging apparatus 100 further comprises a signal processing unit 4, a zooming controller 5, and a focusing controller 6. The signal processing unit 4 performs calculation processing on an output signal from the imaging element 3. The zooming controller 5 controls zooming of the zoom lens 1. The focusing controller 6 controls focusing of the zoom lens 1.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, the Abbe number, and the aspherical coefficient of each lens are not limited to the values shown in the examples, and different values may be used therefor.

Regarding the above-mentioned embodiments and examples, the following Supplementary Notes will be further disclosed.

### Supplementary Note 1

A zoom lens comprising:
a first lens group that is disposed to be closest to an object side and that has a positive refractive power;
a negative group that is disposed to be adjacent to an image side of the first lens group, that consists of two or fewer lens groups, and that has a negative refractive power as a whole;
an N lens group that is disposed to be closer to the image side than the negative group and that has a negative refractive power;
a P lens group that is disposed to be closer to the image side than the negative group and that has a positive refractive power; and
a final lens group that is disposed to be closest to the image side,
wherein during zooming, all spacings between adjacent lens groups change, and
assuming that
   a focal length of the N lens group is fN, and
   a focal length of the first lens group is f1,
   a conditional Expression (1) is satisfied, which is represented by

$$- 6 < fN / f 1 < - 0.55 . \qquad ( 1 )$$

### Supplementary Note 2

The zoom lens according to Supplementary Note 1, in which the first lens group remains stationary with respect to an image plane during zooming.

### Supplementary Note 3

The zoom lens according to Supplementary Note 1 or 2, in which the final lens group remains stationary with respect to an image plane during zooming.

### Supplementary Note 4

The zoom lens according to any one of Supplementary Notes 1 to 3,
in which the P lens group is disposed to be adjacent to the image side of the N lens group, and
the final lens group is disposed to be adjacent to the image side of the P lens group.

### Supplementary Note 5

The zoom lens according to any one of Supplementary Notes 1 to 4, in which during focusing, a part of the first lens group moves along an optical axis.

### Supplementary Note 6

The zoom lens according to Supplementary Note 5,
in which the first lens group includes, successively in order from a position closest to the object side to the image side, at least a first a-part group, a first b-part group, and a first c-part group, and
during focusing, a spacing between the first a-part group and the first b-part group changes, and a spacing between the first b-part group and the first c-part group changes.

### Supplementary Note 7

The zoom lens according to Supplementary Note 5,
in which the first lens group consists of, in order from the object side to the image side, a first a-part group, a first b-part group, and a first c-part group, and
during focusing, the first a-part group remains stationary with respect to an image plane, and the first b-part group and the first c-part group move on tracks different from each other.

### Supplementary Note 8

The zoom lens according to any one of Supplementary Notes 1 to 7, in which assuming that
a distance on an optical axis from a lens surface closest to the object side in the first lens group to a paraxial entrance pupil position in a state where an infinite distance object is in focus at a wide angle end is Denw, and
a focal length of the zoom lens in a state where the infinite distance object is in focus at the wide angle end is fw,

Conditional Expression (2) is satisfied, which is represented by

$$1.2 < Denw / fw < 8. \qquad ( 2 )$$

### Supplementary Note 9

The zoom lens according to any one of Supplementary Notes 1 to 8, in which assuming that
a focal length of the negative group is fUN, and
a focal length of the N lens group is fN,
Conditional Expression (3) is satisfied, which is represented by

$$0.118 < fUN / fN < 0.25 . \qquad ( 3 )$$

### Supplementary Note 10

The zoom lens according to any one of Supplementary Notes 1 to 9, in which during zooming from a wide angle end to a telephoto end, the N lens group moves along a locus convex toward the object side.

### Supplementary Note 11

The zoom lens according to any one of supplementary Notes 1 to 10,
in which a lens closest to the object side in the zoom lens is a negative lens, and
a lens which is second from the object side in the zoom lens is a positive lens.

### Supplementary Note 12

The zoom lens according to any one of Supplementary Notes 1 to 11, in which the first lens group includes one negative lens and four or more positive lenses.

### Supplementary Note 13

The zoom lens according to any one of Supplementary Notes 1 to 12, in which the first lens group includes, successively in order from a position closest to the object side to the image side, a negative lens, a positive lens, and a positive lens.

### Supplementary Note 14

The zoom lens according to any one of Supplementary Notes 1 to 13, in which in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing,
an EX group that changes a focal length of the zoom lens by being inserted in an optical path of the longest air spacing while keeping an imaging position constant is disposed to be insertable and extractable.

### Supplementary Note 15

The zoom lens according to Supplementary Note 14, in which a maximum image height changes as the EX group is inserted or extracted.

### Supplementary Note 16

The zoom lens according to Supplementary Note 5,
in which the first lens group includes, successively in order from a position closest to the object side to the image side, at least a first a-part group and a first b-part group,
a spacing between the first a-part group and the first b-part group changes during focusing, and
assuming that
   a focal length of the first a-part group is f1a,
   Conditional Expression (4) is satisfied, which is represented by

$$- 0.85 < f 1 / f 1 a < 0.15 . \qquad ( 4 )$$

### Supplementary Note 17

The zoom lens according to any one of Supplementary Notes 1 to 16, in which assuming that
a focal length of the negative group is fUN,
Conditional Expression (5) is satisfied, which is represented by

$$- 0.4 < fUN / f 1 < - 0.09 . \qquad ( 5 )$$

### Supplementary Note 18

The zoom lens according to any one of Supplementary Notes 1 to 17, in which assuming that
a distance on an optical axis from a lens surface closest to the object side in the first lens group to a paraxial entrance pupil position in a state where an infinite distance object is in focus at a wide angle end is Denw,
Conditional Expression (6) is satisfied, which is represented by

$$0.4 < Denw / f 1 < 1.6 . \qquad ( 6 )$$

### Supplementary Note 19

The zoom lens according to any one of Supplementary Notes 1 to 18, in which assuming that
a distance on an optical axis from a lens surface closest to the object side in the first lens group to a paraxial entrance pupil position in a state where an infinite distance object is in focus at a wide angle end is Denw, and
a maximum image height in a state where the infinite distance object is in focus at the wide angle end is IHw,
Conditional Expression (7) is satisfied, which is represented by

$$3.4 < Denw / IHw < 7.5 . \qquad ( 7 )$$

### Supplementary Note 20

The zoom lens according to any one of Supplementary Notes 1 to 19, in which assuming that
an amount of displacement of the N lens group in an optical axis direction during zooming from a wide angle end to a telephoto end is MovN,
a focal length of the zoom lens in a state where an infinite distance object is in focus at the telephoto end is ft,
a focal length of the zoom lens in a state where the infinite distance object is in focus at the wide angle end is fw, and
a sign of the amount of displacement is negative in a case where the N lens group moves toward the object side and is positive in a case where the N lens group moves toward the image side,
Conditional Expression (8) is satisfied, which is represented by

$$- 0.4 < MovN / ( f 1 / log ( ft / fw ) ) < 0.1 . \qquad ( 8 )$$

### Supplementary Note 21

The zoom lens according to any one of Supplementary Notes 1 to 20, in which assuming that
a back focal length at an air-equivalent distance in a state where an infinite distance object is in focus at a wide angle end is Bfw, and
a maximum image height in a state where the infinite distance object is in focus at the wide angle end is IHw,
Conditional Expression (9) is satisfied, which is represented by

$$1.9 < Bfw / IHw < 6. \qquad ( 9 )$$

### Supplementary Note 22

The zoom lens according to Supplementary Note 6 or 7, in which the first a-part group includes an aspherical lens having at least one surface of which an absolute value of a curvature radius at a position of a maximum effective diameter is greater than an absolute value of a paraxial curvature radius.

### Supplementary Note 23

The zoom lens according to Supplementary Note 6 or 7, in which the first c-part group includes an aspherical lens having at least one surface of which an absolute value of a curvature radius at a position of a maximum effective diameter is greater than an absolute value of a paraxial curvature radius.

### Supplementary Note 24

The zoom lens according to any one of Supplementary Notes 1 to 23, in which the negative group includes an aspherical lens having at least one surface of which an absolute value of a curvature radius at a position of a maximum effective diameter is less than an absolute value of a paraxial curvature radius.

### Supplementary Note 25

The zoom lens according to any one of Supplementary Notes 1 to 24, in which the P lens group includes an aspherical lens having at least one surface of which an absolute value of a curvature radius at a position of a maximum effective diameter is greater than an absolute value of a paraxial curvature radius.

### Supplementary Note 26

The zoom lens according to any one of Supplementary Notes 1 to 25, in which, in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing,
assuming that
   a Petzval sum from a lens surface closest to the object side in the first lens group to an object side surface constituting the longest air spacing is PF, and
   a maximum image height in a state where the infinite distance object is in focus at the wide angle end is IHw,
   Conditional Expression (10) is satisfied, which is represented by

$$0.12 < PF \times IHw < 0.25 . \qquad ( 10 )$$

### Supplementary Note 27

An imaging apparatus comprising: the zoom lens according to any one of Supplementary Notes 1 to 26.

What is claimed is:

1. A zoom lens comprising:
a first lens group that is disposed to be closest to an object side and that has a positive refractive power;
a negative group that is disposed to be adjacent to an image side of the first lens group, that consists of two or fewer lens groups, and that has a negative refractive power as a whole;
an N lens group that is disposed to be closer to the image side than the negative group and that has a negative refractive power;
a P lens group that is disposed to be closer to the image side than the negative group and that has a positive refractive power; and
a final lens group that is disposed to be closest to the image side,
wherein during zooming, all spacings between adjacent lens groups change, and
assuming that
a focal length of the N lens group is fN, and
a focal length of the first lens group is f1,
a conditional Expression (1) is satisfied, which is represented by
$$- 6 < fN / f 1 < - 0.55 . \qquad ( 1 )$$

2. The zoom lens according to claim 1,
wherein the first lens group remains stationary with respect to an image plane during zooming.

3. The zoom lens according to claim 1,
wherein the final lens group remains stationary with respect to an image plane during zooming.

4. The zoom lens according to claim 1,
wherein the P lens group is disposed to be adjacent to the image side of the N lens group, and
the final lens group is disposed to be adjacent to the image side of the P lens group.

5. The zoom lens according to claim 1,
wherein during focusing, a part of the first lens group moves along an optical axis.

6. The zoom lens according to claim 5,
wherein the first lens group includes, successively in order from a position closest to the object side to the image side, at least a first a-part group, a first b-part group, and a first c-part group, and
during focusing, a spacing between the first a-part group and the first b-part group changes, and a spacing between the first b-part group and the first c-part group changes.

7. The zoom lens according to claim 5,
wherein the first lens group consists of, in order from the object side to the image side, a first a-part group, a first b-part group, and a first c-part group, and
during focusing, the first a-part group remains stationary with respect to an image plane, and the first b-part group and the first c-part group move on tracks different from each other.

8. The zoom lens according to claim 1,
wherein assuming that
a distance on an optical axis from a lens surface closest to the object side in the first lens group to a paraxial entrance pupil position in a state where an infinite distance object is in focus at a wide angle end is Denw, and
a focal length of the zoom lens in a state where the infinite distance object is in focus at the wide angle end is fw,
Conditional Expression (2) is satisfied, which is represented by
$$1.2 < Denw / fw < 8. \qquad ( 2 )$$

9. The zoom lens according to claim 1,
wherein assuming that
a focal length of the negative group is fUN, and
a focal length of the N lens group is fN,
Conditional Expression (3) is satisfied, which is represented by
$$0.118 < fUN / fN < 0.25 . \qquad ( 3 )$$

10. The zoom lens according to claim 1,
wherein during zooming from a wide angle end to a telephoto end, the N lens group moves along a locus convex toward the object side.

11. The zoom lens according to claim 1,
wherein a lens closest to the object side in the zoom lens is a negative lens, and
a lens which is second from the object side in the zoom lens is a positive lens.

12. The zoom lens according to claim 1,
wherein the first lens group includes one negative lens and four or more positive lenses.

13. The zoom lens according to claim 1,
wherein the first lens group includes, successively in order from a position closest to the object side to the image side, a negative lens, a positive lens, and a positive lens.

14. The zoom lens according to claim 1,
wherein in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing,
an EX group that changes a focal length of the zoom lens by being inserted in an optical path of the longest air spacing while keeping an imaging position constant is disposed to be insertable and extractable.

15. The zoom lens according to claim 14,
wherein a maximum image height changes as the EX group is inserted or extracted.

16. The zoom lens according to claim 5,
wherein the first lens group includes, successively in order from a position closest to the object side to the image side, at least a first a-part group and a first b-part group,
a spacing between the first a-part group and the first b-part group changes during focusing, and
assuming that
a focal length of the first a-part group is f1a,
Conditional Expression (4) is satisfied, which is represented by
$$- 0.85 < f 1 / f 1 a < 0.15 . \qquad ( 4 )$$

17. The zoom lens according to claim 1,
wherein assuming that
a focal length of the negative group is fUN,
Conditional Expression (5) is satisfied, which is represented by
$$- 0.4 < fUN / f 1 < - 0.09 . \qquad ( 5 )$$

18. The zoom lens according to claim 1,
wherein assuming that
a distance on an optical axis from a lens surface closest to the object side in the first lens group to a paraxial entrance pupil position in a state where an infinite distance object is in focus at a wide angle end is Denw,
Conditional Expression (6) is satisfied, which is represented by
$$0.4 < Denw / f 1 < 1.6 . \qquad ( 6 )$$

19. The zoom lens according to claim 1,
wherein assuming that
a distance on an optical axis from a lens surface closest to the object side in the first lens group to a paraxial entrance pupil position in a state where an infinite distance object is in focus at a wide angle end is Denw, and
a maximum image height in a state where the infinite distance object is in focus at the wide angle end is IHw,
Conditional Expression (7) is satisfied, which is represented by
$$3.4 < Denw / IHw < 7.5 . \qquad ( 7 )$$

20. The zoom lens according to claim 1,
wherein assuming that
an amount of displacement of the N lens group in an optical axis direction during zooming from a wide angle end to a telephoto end is MovN,
a focal length of the zoom lens in a state where an infinite distance object is in focus at the telephoto end is ft,
a focal length of the zoom lens in a state where the infinite distance object is in focus at the wide angle end is fw, and
a sign of the amount of displacement is negative in a case where the N lens group moves toward the object side and is positive in a case where the N lens group moves toward the image side,
Conditional Expression (8) is satisfied, which is represented by
$$- 0.4 < MovN / ( f 1 / log ( ft / fw ) ) < 0.1 . \qquad ( 8 )$$

21. The zoom lens according to claim 1,
wherein assuming that
a back focal length at an air-equivalent distance in a state where an infinite distance object is in focus at a wide angle end is Bfw, and
a maximum image height in a state where the infinite distance object is in focus at the wide angle end is IHw,
Conditional Expression (9) is satisfied, which is represented by
$$1.9 < Bfw / IHw < 6. \qquad ( 9 )$$

22. The zoom lens according to claim 6,
wherein the first a-part group includes an aspherical lens having at least one surface of which an absolute value of a curvature radius at a position of a maximum effective diameter is greater than an absolute value of a paraxial curvature radius.

23. The zoom lens according to claim 6,
wherein the first c-part group includes an aspherical lens having at least one surface of which an absolute value of a curvature radius at a position of a maximum effective diameter is greater than an absolute value of a paraxial curvature radius.

24. The zoom lens according to claim 1,
wherein the negative group includes an aspherical lens having at least one surface of which an absolute value of a curvature radius at a position of a maximum effective diameter is less than an absolute value of a paraxial curvature radius.

25. The zoom lens according to claim 1,
wherein the P lens group includes an aspherical lens having at least one surface of which an absolute value of a curvature radius at a position of a maximum effective diameter is greater than an absolute value of a paraxial curvature radius.

26. The zoom lens according to claim 1,
wherein, in a case where an air spacing, which has a maximum length among air spacings on an optical axis from a lens surface closest to the object side in the P lens group to a lens surface closest to the image side in the final lens group in a state where an infinite distance object is in focus at a wide angle end, is set as a longest air spacing,
assuming that
a Petzval sum from a lens surface closest to the object side in the first lens group to an object side surface constituting the longest air spacing is PF, and
a maximum image height in a state where the infinite distance object is in focus at the wide angle end is IHw,
Conditional Expression (10) is satisfied, which is represented by
$$0.12 < PF \times IHw < 0.25 . \qquad ( 10 )$$

27. An imaging apparatus comprising:
the zoom lens according to claim 1.
